(19) United States
(12) Patent Application Publication
(10) Pub. No.: US 2006/0241869 A1
(43) Pub. Date: Oct. 26, 2006

(54) Computer systems and methods for inferring causality from cellullar constituent abundance data

(75) Inventors: Eric E. Schadt, Kirkland, WA (US); John Lamb, Shoreline, WA (US)

Correspondence Address: JONES DAY, 222 EAST 41ST ST, NEW YORK, NY, 10017, US

(73) Assignee: Rosetta Inpharmatics LLC

(21) Appl. No.: 11/361,871

(22) Filed: Feb. 23, 2006

Related U.S. Application Data
(63) Continuation-in-part of application No. 10/567,282.
(60) Provisional application No. 60/492,682, filed on Aug. 5, 2003.
(60) Provisional application No. 60/497,470, filed on Aug. 21, 2003.
(60) Provisional application No. 60/575,499, filed on May 28, 2004.

(51) Int. Cl. G06F 19/00

(52) U.S. Cl. 702/19

(57) ABSTRACT

Methods for determining whether a molecule affects a disorder are provided. A cell from an organism is contacted with the molecule, or the molecule is expressed within the cell. A determination is made as to whether the RNA or protein expression in the cell of at least one open reading frame is changed relative to the expression of the reading frame in the absence of the molecule. Each such open reading frame is regulated by a promoter native to SEQ ID NOS: 5-9, 11-12, 14, 16, 18, 20-21, 23, 25, 27, 29, 31, 33 or homologs of the foregoing. A determination is made as to whether the molecule affects the disorder when the RNA or protein expression of the at least one reading frame is changed. Alternatively, a determination is made that the molecule does not affect the disorder when the RNA or protein expression of the at least one reading frame is unchanged.

### CROSS REFERENCE TO RELATED APPLICATIONS

This application is a continuation-in-part of U.S. patent application Ser. No. 10/567,282 which claims benefit, under 35 U.S.C. § 119(e), of U.S. Provisional Patent Application No. 60/492,682 filed on Aug. 5, 2003, U.S. Provisional Patent Application No. 60/497,470 filed on on Aug. 21, 2003, and U.S. Provisional Patent Application No. 60/575,499, filed on May 28, 2004, each of which is hereby incorporated herein by reference in its entirety.

### 1. FIELD OF THE INVENTION

The field of this invention relates to computer systems and methods for identifying genes and biological pathways associated with traits.

### 2. BACKGROUND OF THE INVENTION

Cellular constituent abundance data from microarrays and, more generally, functional genomics, has become an important tool in life sciences as well as medical research. Cellular constituents are individual genes, proteins, mRNA expressing genes, and/or any other variable cellular component or protein activities such as the degree of protein modification (e.g., phosphorylation), for example, that is typically measured in biological experiments (e.g., by microarray) by those skilled in the art. Significant discoveries relating to the complex networks of biochemical processes underlying living systems, common human diseases, and gene discovery and structure determination can now be attributed to the application of cellular constituent abundance data as part of the research process. See, for example, Hughes et al., 2000, Cell 102, 109; Karp et al., 2000, Nat. Immunol. 1, 221; Schadt et al., 2003, Nature 422, 297; Eaves et al., 2002, Genome Res. 12, 232, and Shoemaker et al., 2001, Nature 409, 922. Cellular constituent abundance data have also helped to identify biomarkers, discriminate disease subtypes and identify mechanisms of toxicity. See, for example, DePrimo et al., 2003, BMC Cancer 3, 3; van de Vijver et al., 2002, N. Engl. J. Med. 347, 1999; van't Veer et al., 2002, Nature 415, 530; Waring et al., 2002, Toxicology 181-182, 537.

The use of cellular constituent abundance data from sources such as microarrays as a tool to identify genes responsible for traits, including common human diseases, continues to prove difficult. Elucidating hundreds or even thousands of genes whose expression changes are associated with a disease state does not directly lead to the identification of the key drivers involved in the disease processes. Subsequent validation of candidate genes identified from gene expression experiments is presently a hit-or-miss and time consuming process. This validation typically involves gene knock outs/ins, transgenic construction, siRNA, drug treatments targeting candidate genes, time series experiments, and/or the development of specific assays intended to test hypotheses generated from gene expression experiments. These validation methods do not easily lend themselves to high-throughput processes and can often take as long as eighteen months to complete. Developing methods that allow for the objective, data driven identification of the key drivers of common human diseases would significantly enhance the utility of cellular constituent abundance measurement experiments in the target discovery process. More generally, such methods would also provide a framework for elucidating genetic networks.

Cellular constituent abundance data has recently been combined with other experimental data to allow for the more immediate identification of key drivers for complex disease traits. See, for example, Schadt et al., 2003, Nature 422, 297; Brem et al., 2002, Science 296, 752; Klose et al., 2002, Nat. Genet 30, 385. One such technique involves treating cellular constituent abundance data (e.g., gene expression data) as a quantitative trait in segregating populations. In such a method, chromosomal regions controlling the level of expression of a particular gene are mapped as abundance quantitative trait loci (eQTL). Abundance QTL that contain the gene encoding the mRNA (cis-acting eQTL) are distinguished from the other (trans-acting) eQTL, and those cis-acting eQTL that co-localize with chromosomal regions controlling a disease (clinical) trait (cQTL) are identified. The identification of a common chromosomal location for both cis-acting eQTL and a cQTL is used to nominate susceptibility loci for the disease trait. See, for example, Karp et al., 2000, Nat. Immunol 1, 221; Schadt et al. Nature 422, 297; and Eaves et al., 2002, Genome Res. 12, 232.

While the approach of integrating genetic and cellular constituent abundance data holds promise as a method for identifying genes that contribute to disease in an objective fashion, it still has disadvantages that will ultimately limit its utility. First, it requires access to tissues relevant to the disease under study since, for example, the mRNAs regulated by the cis-acting eQTL need to be expressed in order to be identified. Second, identifying a cellular constituent (e.g., a gene) underlying a single QTL for a complex trait will likely explain only a small to moderate percentage of the variation in the trait since the total trait variation is a function of multiple genetic and environmental components. Third, this approach restricts attention to the small number of genes in common between cis-acting eQTL and cQTL, thereby limiting the search of key drivers of the trait to a small number of genes, despite the genome-wide transcription information potentially provided by the cellular constituent abundance data. Finally, this approach will most likely identify a gene encoding a protein with little therapeutic potential, and thus lead to additional experimental work to identify druggable candidates in the pathway shared with this protein.

Thus, given the above background, what is needed in the art are improved methods for using cellular constituent abundance data as well as genetic data to identify genes and biological pathways that affect traits such as diseases.

Discussion or citation of a reference herein will not be construed as an admission that such reference is prior art to the present invention.

### 3. SUMMARY OF THE INVENTION

Systems and methods for identifying genes that affect complex traits are provided. Advantageously, such systems and methods are not restricted to identifying causative genes within regions shared by cis-acting eQTL and cQTL. Instead, they make use of gene expression cis- and trans-acting QTL information as well as disease trait QTL information in order to identify cellular constituents that are under the control of the disease QTL. In other words, the present invention provides a process for identifying cellular constituents whose abundances are modulated by a disease trait QTL, and that, in turn, modulate the disease trait in a causal fashion. Additionally, the present invention provides a process for identifying disease traits that are causal for variations in cellular constituent levels. In the former case the cellular constituents are causal for the disease trait, whereas in the latter case the cellular constituents are reactive to the disease trait.

### 3.1. General Method

One aspect of the invention provides a method for determining whether cellular constituents are causal for a trait of interest T, exhibited by a plurality of organisms of a species. A cellular constituent i that has at least one abundance quantitative trait locus (eQTL) coincident with a respective clinical quantitative trait locus (cQTL) for the trait of interest T is identified. For each respective cQTL coincident with an eQTL, a test is made to determine whether (i) the genetic variation of the cQTL across the plurality of organisms and (ii) the variation of the trait of interest T across the plurality of organisms are correlated conditional on an abundance pattern of the cellular constituent i across the plurality of organisms. When the genetic variation of (i) the cQTL for the clinical trait of interest overlapping at least one eQTL and (ii) the variation of the trait of interest T across the plurality of organisms are uncorrelated conditional on an abundance pattern of the cellular constituent i across the plurality of organisms, the cellular constituent i is said to be causal for the trait of interest T.

Another way of stating this causality test is to say that a cellular constituent i is considered to be causal for a trait of interest T when the variation of the trait of interest T can be explained by the variation in the cellular constituent i, with respect to the cQTL (provided that the trait of interest T and the cellular constituent i are both geneticially linked to the locus where the cQTL is located). This test can be conceptualized as having two parts. In the first part, the amount of variation in the trait of interest T that is explained by (caused by, correlated with) the variation in the cQTL is determined (i.e., the coefficient of determination between the variation in the trait of interest T and the variation in the cQTL across the population is quantified). The coefficient of determination between the trait of interest T and the cQTL can be small. For example, a coefficient of 0.05 or less, meaning that, for example, just five percent or less of the total variation in the trait of interest T across the population is possible so long as the amount of variation is detectable. In the second part, a determination is made as to whether the variation in the trait of interest T identified in the first part of the test is still explained by the variation in the cQTL after conditioning on the cellular constituent i. If the variation in the cQTL no longer explains (causes, is correlated with) the variation in the trait of interest T identified in the first part of the test when the variation of the cellular constituent i is considered (after conditioning on the cellular constituent i), the variation of the cQTL and the variation in the trait T are said to be uncorrelated conditional on the variation in the abundance pattern of the cellular constituent i. In such instances, the cellular constituent i is causal for the trait of interest T. In other words, the second part of the test identifies the cQTL as causal for the trait T when the coefficient of determination between the variation of the cQTL and the variation of the trait T cannot statistically be distinguished from zero after conditioning on the variation of the cellular constituent i.

In some embodiments, an eQTL and overlapping cQTL are coincident with each other when the physical location of the eQTL in the genome of the species is within 40 cM or 10 cM of the physical location of the respective cQTL in the genome of the species.

In some embodiments, the method further comprises, prior to identifying cellular constituents that are causal for a given clinical trait, a step to determine the eQTL for each cellular constituent using a first quantitative trait locus (QTL) analysis, wherein the first QTL analysis uses a plurality of abundance statistics for the cellular constituent i as a quantitative trait, and wherein each abundance statistic in the plurality of abundance statistics represents an abundance value for the cellular constituent i in an organism in the plurality of organisms. In some embodiments, the method further comprises a step of determining the respective cQTL using a second QTL analysis, wherein the second QTL analysis uses a plurality of phenotypic values as a quantitative trait, each phenotypic value in the plurality of phenotypic values corresponding to an organism in the plurality of organisms. In some instances, an eQTL is coincident with the respective cQTL when the eQTL and the respective cQTL colocalize within 40 cM of a locus Q in the genome of the species, within 10 cM of a locus Q in the genome of the species, within 3 cM of a locus Q in the genome of the species, or within 1 cM of a locus Q in the genome of the species.

In some embodiments, the cellular constituent i is validated by a gene knock-out experiment, a transgenic construction experiment, or an siRNA experiment.

### 3.2. Genetic Map

In some embodiments, the first QTL analysis and the second QTL analysis each use a genetic map that represents the genome of the plurality of organisms. In some embodiments, a step of constructing the genetic map from a set of genetic markers associated with the plurality of organisms is performed. In some embodiments, the set of genetic markers comprises single nucleotide polymorphisms (SNPs), microsatellite markers, restriction fragment length polymorphisms, short tandem repeats, DNA methylation markers, sequence length polymorphisms, random amplified polymorphic DNA, amplified fragment length polymorphisms, or simple sequence repeats. In some embodiments, genotype data is used in the constructing step and wherein the genotype data comprises knowledge of which alleles, for each marker in the set of genetic markers, are present in each organism in the plurality of organisms.

In some embodiments, the plurality of organisms represents a segregating population and pedigree data is used in the constructing step. Further, the pedigree data shows one or more relationships between organisms in the plurality of organisms. In some embodiments, the plurality of organisms comprises an F₂ population, a Fₜ population, a F_{2:3} population, or a Design III population and the one or more relationships between organisms in the plurality of organisms indicates which organisms in the plurality of organisms are members of the F₂ population, the F₁ population, the F_{2:3} population, or the Design III population. More generally, the plurality of organisms comprises a human population consisting of any number of family structures with varying degrees of relatedness represented in the families.

### 3.3. Abundance Level Measurements

In some embodiments, each abundance value is a normalized abundance level measurement for the cellular constituent i in an organism in the plurality of organisms. In some embodiments, each abundance level measurement is determined by measuring an amount of the cellular constituent i in one or more cells from an organism in the plurality of organisms. The amount of the cellular constituent can be, for example, an abundance of an RNA present in the one or more cells of the organism. In some instances, the abundance of the RNA is measured by contacting a gene transcript array with the RNA from the one or more cells of the organism, or with nucleic acid derived from the RNA. The gene transcript array comprises a positionally addressable surface with attached nucleic acids or nucleic acid mimics. The nucleic acids or nucleic acid mimics are capable of hybridizing with the RNA species or with nucleic acid derived from the RNA species.

In some embodiments, the normalized abundance level measurement is obtained by a normalization technique selected from the group consisting of Z-score of intensity, median intensity, log median intensity, Z-score standard deviation log of intensity, Z-score mean absolute deviation of log intensity, calibration DNA gene set, user normalization gene set, ratio median intensity correction, and intensity background correction.

In some embodiments, an abundance value comprises an amount of the cellular constituent i in tissues of the organism, a concentration of the cellular constituent i in tissues of the organism, a cellular constituent activity level for the cellular constituent i in one or more tissues of the organism, or the state of modification of the cellular constituent i in the organism. In some instances, the state of modification of the cellular constituent i is a degree of phosphorylation of the cellular constituent i.

### 3.4. Representative eQTL Determination

In some embodiments, the first QTL analysis comprises (i) testing for linkage between (a) the genotype of the plurality of organisms at a position in the genome of the species and (b) the plurality of abundance statistics for the cellular constituent i; (ii) advancing the position in the genome by an amount; and (iii) repeating steps (i) and (ii) until all or a portion of the genome of the species has been tested. In some embodiments, the amount is less than 100 centiMorgans or less than 5 centiMorgans.

In some embodiments, the testing comprises performing linkage analysis or association analysis. In some embodiments, the linkage analysis or association analysis generates a statistical score for each position in the genome of the species that is tested. For example, in some embodiments, the testing is linkage analysis and the statistical score is a logarithm of the odds (lod) score. In some instances, an eQTL is represented by a lod score that is greater than 2.0, or greater than 4.0.

### 3.5. Representative cQTL Determination

In some embodiments, the second QTL analysis comprises (i) testing for linkage between (a) the genotype of the plurality of organisms at a position in the genome of the species and (b) the plurality of phenotypic values; (ii) advancing the position in the genome by an amount; and (iii) repeating steps (i) and (ii) until all or a portion of the genome of the species has been tested. In some embodiments, the amount is less than 100 centiMorgans, or less than 5 centiMorgans.

In some embodiments, the testing comprises performing linkage analysis or association analysis. Such analysis generates a statistical score for the position in the genome of the species. For example, in some embodiments, the testing is linkage analysis and the statistical score is a logarithm of the odds (lod) score. In some instances, the cQTL is represented by a lod score that is greater than 2.0 or greater than 4.0.

### 3.6. Complex Traits

In some embodiments, the trait of interest T is a complex trait. For instance, in some embodiments, the trait is characterized by an allele that exhibits incomplete penetrance in the species. In some embodiments, the trait is a disease that is contracted by an organism in the population, and the organism inherits no predisposing allele to the disease. In some embodiments, the trait arises when any of a plurality of different genes in the genome of the species are mutated. In some embodiments, the trait requires the simultaneous presence of mutations in a plurality of genes in the genome of the species. In some embodiments the trait requires the simultaneous presence of mutations in a plurality of genes in the genome of the species and a set of environmental conditions. For example, in some embodiments, the trait is the result of the genotype of a plurality of genes as well as one or more environmental conditions (e.g., an obesity trait that requires a person eating a lot in addition to that person having gene combinations that lead to obesity). In some embodiments, the trait is associated with a high frequency of disease-causing alleles in the species.

In some embodiments, the complex trait is a phenotype that does not exhibit Mendelian recessive or dominant inheritance attributable to a single gene locus. In some embodiments, the trait is asthma, ataxia telangiectasia, bipolar disorder, cancer, common late-onset Alzheimer's disease, diabetes, heart disease, hereditary early-onset Alzheimer's disease, hereditary nonpolyposis colon cancer, hypertension, infection, maturity-onset diabetes of the young, mellitus, migraine, nonalcoholic fatty liver, nonalcoholic steatohepatitis, non-insulin-dependent diabetes mellitus, obesity, polycystic kidney disease, psoriases, schizophrenia, or xeroderma pigmentosum.

### 3.7. Test for Pleiotropy

In some embodiments, the method further comprises testing whether the coincidence between an eQTL and a respective cQTL are a result of pleiotropy, or a result of two closely linked QTL, wherein when the coincidence between said eQTL and said respective cQTL is the result of two closely linked QTL, the cellular constituent i is not associated with said trait of interest. In some embodiments, this testing comprises comparing a model for the null hypothesis, indicating the result of pleiotropy, to a model for the alternative hypothesis, indicating two closely linked QTL.

In some embodiments, the model for the null hypothesis is:

$$( \begin{matrix}{y}_{1} \\ {y}_{2}\end{matrix} ) = ( \begin{matrix}{μ}_{1} \\ {μ}_{2}\end{matrix} ) + ( \begin{matrix}{β}_{1} \\ {β}_{2}\end{matrix} ) N + ( \begin{matrix}{ɛ}_{1} \\ {ɛ}_{2}\end{matrix} )$$

where

N is a categorical random variable indicating the genotypes at the position of the eQTL and the cQTL in the plurality of organisms;

$$( \begin{matrix}{ɛ}_{1} \\ {ɛ}_{2}\end{matrix} )$$

is distributed as a bivariate normal random variable with mean

$$( \begin{matrix}0 \\ 0\end{matrix} )$$

and covariance matrix

$$( \begin{matrix}{σ}_{1}^{2} & {σ}_{1} {σ}_{2} \\ {σ}_{2} {σ}_{1} & {σ}_{2}^{2}\end{matrix} ) ; and$$

μ and βᵢ are model parameters.

In some embodiments, the model for the alternative hypothesis is:

$$( \begin{matrix}{y}_{1} \\ {y}_{2}\end{matrix} ) = ( \begin{matrix}{μ}_{1} \\ {μ}_{2}\end{matrix} ) + ( \begin{matrix}{β}_{1} & {β}_{2} \\ {β}_{3} & {β}_{4}\end{matrix} ) ( \begin{matrix}{N}_{1} \\ {N}_{2}\end{matrix} ) + ( \begin{matrix}{ɛ}_{1} \\ {ɛ}_{2}\end{matrix} )$$

where

N₁ and N₂ are categorical random variables indicating the genotypes at the position of the eQTL and the cQTL in the plurality of organisms;

$$( \begin{matrix}{ɛ}_{1} \\ {ɛ}_{2}\end{matrix} )$$

is distributed as a bivariate normal random variable with mean

$$( \begin{matrix}0 \\ 0\end{matrix} )$$

and covariance matrix

$$( \begin{matrix}{σ}_{1}^{2} & {σ}_{1} {σ}_{2} \\ {σ}_{2} {σ}_{1} & {σ}_{2}^{2}\end{matrix} ) ;$$

and

μᵢ and βᵢ are model parameters.

In some embodiments, one of the conditions (i) through (iv) is valid:

(i) β/1≠0, β₄≠0, β₂=0, and β₃=0;
(ii) β₁≠0, β₄≠0, β₂≠0, and β₃=0;
(iii) β₁≠0, β₄≠0, β₂=0, and β₃≠0; and
(iv) β₁≠0, β₄≠0, β₂≠0, and β₃≠0.
   In some embodiments the loglikelihood for the null hypothesis and the alternative hypothesis are maximized with respect to the model parameters (μᵢ, βⱼ, and σₖ) using maximum likelihood analysis. After maximum likelihood estimates are obtained for each model, the likelihood ratio test statistic between the competing models is formed and the test statistic is used to determine whether the model for the alternative hypothesis provides for a statistically significant better fit to the data than the model for the null hypothesis.

### 3.8. Causality Test

In some embodiments the test to determine whether (i) the genetic variation of the CQTL across the plurality of organisms and (ii) the variation of the trait of interest T across the plurality of organisms are correlated conditional on an abundance pattern of the cellular constituent i across the plurality of organisms comprises considering a null test for causality having the relationship:
P(T,Q*|G)=P(T|G)P(Q*|G),
where

each function P is a probability density function;

T is a trait random variable for the trait of interest across the plurality of organisms;

Q* is a genotype random variable for a locus Q where an eQTL and a cQTL colocalize across the plurality of organisms; and

G is said abundance pattern of said cellular constituent i across said plurality of organisms.

In some embodiments, such testing comprises comparing the null test for causality, indicating that G is causal for T, to an alternative hypothesis that T and Q are dependent given G. In some embodiments, such testing comprises optimizing the log likelihood ratio of the null hypothesis and the alternative hypothesis using maximum likelihood analysis.

One embodiment of the present invention provides a method for determining whether a cellular constituent is causal for a trait of interest T. The trait of interest T is exhibited by a plurality of organisms of a species. The method comprises identifying a locus Q in the genome of the species that is a site of colocalization for (i) an abundance quantitative trait locus (eQTL) genetically linked to (correlated with) a variation in abundance levels of the cellular constituent across all or a portion of the plurality of organisms and (ii) a clinical quantitative trait locus (cQTL) that is genetically linked to (correlated with) a variation in the trait of interest T across all or a portion of the plurality of organisms. A first coefficient of determination is quantified between (i) the variation in the clinical quantitative trait locus (cQTL) across all or a portion of the plurality of organisms and (ii) the variation in the trait of interest T across all or a portion of said plurality of organisms. A second coefficient of determination is quantified between (i) the variation in the clinical quantitative trait locus (cQTL) across all or a portion of the plurality of organisms and (ii) the variation in the trait of interest T across all or a portion of the plurality of organisms, after conditioning on the variation of the abundance of the cellular constituent across all or a portion of the plurality of organisms. The cellular constituent is causal for the trait of interest T when the first coefficient of determination is other than zero and the second coefficient of determination is zero. In some embodiments, the cellular constituent is causal for the trait of interest T when the first coefficient of determination is greater than a predetermined threshold amount such as 0.03 or 0.10.

### 3.9. Candidate Causative Cellular Constituent Set

In some embodiments, the method further comprises identifying a candidate causative cellular constituent set. Each cellular constituent in the candidate causative cellular constituent set has at least one eQTL that is coincident with a respective cQTL for the trait of interest T.

In some embodiments, each cellular constituent in the candidate causative cellular constituent set that does not have a druggable domain is removed from the set. In some embodiments, a rank of a cellular constituent i in the candidate cellular constituent set is determined by the amount of genetic variation in the trait of interest T that is explained by the at least one eQTL of cellular constituent i. In some embodiments, the amount of genetic variation in the trait of interest T that is explained by the at least one eQTL of cellular constituent i is determined by a joint analysis of the trait of interest at each one of the eQTL in said at least one eQTL.

### 3.10. Cellular Constituents Whose Abundance Significantly Associates with the Trait of Interest

In some embodiments, only those cellular constituents whose abundance in the plurality of organisms significantly associates with the trait of interest T are considered. Accordingly, in some embodiments, the variation in the abundance level of cellular constituent i associates with the variation in the trait of interest T across the plurality of organisms. In some embodiments the association between (i) the variation in the abundance level of a cellular constituent i and (ii) the variation in the trait of interest T across the plurality of organisms is determined using a Pearson correlation, discriminant analysis or a regression model. In some embodiments, a Pearson correlation is used and (i) the variation in the abundance level of the cellular constituent i and (ii) the variation in the trait of interest T across the plurality of organisms is identified when the Pearson correlation coefficient (p-value) is less than 0.00001 or less than 0.0001.

### 3.11. Representative Computer Program Product

One aspect of the invention provides a computer program product for use in conjunction with a computer system. The computer program product comprises a computer readable storage medium and a computer program mechanism embedded therein. The computer program mechanism is for determining whether a cellular constituent is causal for a trait of interest, exhibited by a plurality of organisms of a species. The computer program mechanism comprises a cQTL/eQTL overlap module. The cQTL/eQTL overlap module comprises instructions for identifying a cellular constituent i that has at least one abundance quantitative trait locus (eQTL) coincident with a respective clinical quantitative trait locus (cQTL) for the trait of interest. The computer program mechanism further comprises a causality test module. The causality test module comprises instructions for testing, for one or more respective eQTL in the at least one eQTL, whether (i) the genetic variation of the eQTL across the plurality of organisms and (ii) the variation of the trait of interest across the plurality of organisms are correlated conditional on an abundance pattern of the cellular constituent i across the plurality of organisms.

Another aspect of the present invention provides a computer program product for use in conjunction with a computer system. The computer program product comprises a computer readable storage medium and a computer program mechanism embedded therein. The computer program mechanism is for determining whether a cellular constituent is causal for a trait of interest, exhibited by a plurality of organisms of a species. The computer program mechanism comprises an cQTL/eQTL overlap module. The cQTL/eQTL overlap module comprises instructions for identifying a cellular constituent that has at least one abundance quantitative trait locus (eQTL) coincident with a respective clinical quantitative trait locus (cQTL) for the trait of interest. The computer program mechanism further comprises a causality test module. The causality module comprises instructions for testing, for one or more respective eQTL in the at least one eQTL, (i) a causative model, (ii) a reactive model and (iii) an independent model using a maximum likelihood approach, wherein when, for each compared eQTL, the causative model gives rise to the largest likelihood relative to the corresponding reactive model and the corresponding independent model, the cellular constituent i is causal for the trait of interest.

In some embodiments, the computer program mechanism further comprises a quantitative genetics analysis module that comprises instructions for determining the eQTL using a first quantitative trait locus (QTL) analysis. The first QTL analysis uses a plurality of abundance statistics for the cellular constituent i as a quantitative trait, and each abundance statistic in the plurality of abundance statistics represents an abundance value for the cellular constituent i in an organism in the plurality of organisms.

In some embodiments, the quantitative genetics analysis module further comprises instructions for determining the respective cQTL using a second QTL analysis. The second QTL analysis uses a plurality of phenotypic values as a quantitative trait. Each phenotypic value in the plurality of phenotypic values corresponding to an organism in the plurality of organisms.

In some embodiments, the computer program mechanism further comprises a pleiotropy module that comprises instructions for testing whether the coincidence between an eQTL and a respective cQTL are a result of pleiotropy, or a result of two closely linked QTL. In some embodiments, the testing comprises comparing a null hypothesis, indicating said result of pleiotropy, to an alternative hypothesis, indicating two closely linked QTL.

### 3.12. Representative Computer System

One aspect of the invention provides a computer system for determining whether a cellular constituent is causal for a trait of interest that is exhibited by a plurality of organisms of a species. The computer system comprises a central processing unit and a memory, coupled to the central processing unit. The memory stores an cQTL/eQTL overlap module and a causality test module. The cQTL/eQTL overlap module comprises instructions for identifying a cellular constituent i that has at least one abundance quantitative trait locus (eQTL) coincident with a respective clinical quantitative trait locus (cQTL) for the trait of interest. The causality test module comprises instructions for testing, for one or more respective eQTL/cQTL pairs in the at least one eQTL/cQTL pair, whether (i) the genetic variation of the cQTL across the plurality of organisms and (ii) the variation of the trait of interest across the plurality of organisms are correlated conditional on an abundance pattern of the cellular constituent i across the plurality of organisms.

Another aspect of the present invention provides a computer system for determining whether a cellular constituent is causal for a trait of interest that is exhibited by a plurality of organisms of a species. The computer system comprises a central processing unit and a memory coupled to the central processing unit. The memory storing an cQTL/eQTL overlap module and a causality test module. The cQTL/eQTL overlap module comprises instructions for identifying a cellular constituent that has at least one abundance quantitative trait locus (eQTL) coincident with a respective clinical quantitative trait locus (cQTL) for the trait of interest. The causality test module comprises instructions for testing, for one or more respective eQTL/cQTL pairs in the at least one eQTL/cQTL pair, (i) a causative model, (ii) a reactive model and (iii) an independent model using a maximum likelihood approach.

### 3.13. Methods for Treating Diseases

One embodiment of the present invention provides a method for determining whether a candidate molecule affects a body weight disorder associated with an organism. In a first step of the method, a cell from the organism is contacted with the candidate molecule or the candidate molecule is recombinantly expressed within the cell from the organism. Then, in a second step of the method, a determination is made as to whether the RNA expression or protein expression in the cell of at least one open reading frame is changed in the first step of the method relative to the expression of the open reading frame in the absence of the candidate molecule, each referenced open reading frame being regulated by a promoter native to a nucleic acid sequence selected from the group consisting of SEQ ID NO: 5, SEQ ID NO: 6, SEQ ID NO: 7, SEQ ID NO: 8, SEQ ID NO: 9, SEQ ID NO: 1, SEQ ID NO: 12, SEQ ID NO: 14, SEQ ID NO: 16, SEQ ID NO: 18, SEQ ID NO: 20, SEQ ID NO: 21, SEQ ID NO: 23 and homologs of each of the foregoing. In a third step of the method, a determination is made as to whether (i) the candidate molecule affects a body weight disorder associated with the organism when the RNA expression or protein expression of the at least one open reading frame is changed, or (ii) the candidate molecule does not affect a body weight disorder associated with the organism when the RNA expression or protein expression of the at least one open reading frame is unchanged. In some embodiments, a cell from the organism contacted with the candidate molecule exhibits a lower expression level of a protein sequence selected from the group consisting of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, and homologs of each of the forgoing, than a cell from the organism that is not contacted with the candidate molecule. In some embodiments, the body weight disorder is obesity, anorexia nervosa, bulimia nervosa or cachexia.

In some embodiments, the second step comprises determining whether RNA expression is changed or whether protein expression is changed. In some embodiments, the second step comprises determining whether RNA or protein expression of at least two of the open reading frames is changed. In some embodiments, the first step comprises contacting the cell with the candidate molecule and the first step is carried out in a liquid high throughput-like assay.

In some embodiments, the cell comprises a promoter region of at least one gene selected from the group consisting of SEQ ID NO: 5, SEQ ID NO: 6, SEQ ID NO: 7, SEQ ID NO: 8, SEQ ID NO: 9, SEQ ID NO: 11, SEQ ID NO: 12, SEQ ID NO: 14, SEQ ID NO: 16, SEQ ID NO: 18, SEQ ID NO: 20, SEQ ID NO: 21, SEQ ID NO: 23, and homologs of each of the foregoing, each promoter region being operably linked to (correlated with) a marker gene. Further, the second step comprises determining whether the RNA expression or protein expression of the marker gene(s) is changed in the first step relative to the expression of the marker gene in the absence of the candidate molecule. In some embodiments, the marker gene is selected from the group consisting of green fluorescent protein, red fluorescent protein, blue fluorescent protein, luciferase, LEU2, LYS2, ADE2, TRP1, CAN1, CYH2, GUS, CUP1 and chloramphenicol acetyl transferase.

Another embodiment of the present invention provides a method of treating or preventing a body weight disorder. The method comprises administering to a subject in which treatment is desired a therapeutically effective amount of a compound that antagonizes in the subject a protein comprising a sequence selected from the group consisting of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24 and homologs of each of the foregoing. In some embodiments the subject is human. In some embodiments the compound:

(i) inhibits a function of one or more of the group consisting of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, and homologs of each of the foregoing, and

(ii) is selected from the group consisting of:

an antibody that binds to one of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, and homologs of each of the foregoing or a fragment or derivative therefore containing the binding region thereof, or is selected from the group consisting of:

a nucleic acid complementary to the RNA produced by transcription of a gene encoding one of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, and homologs of each of the foregoing.

In some embodiments, the compound that inhibits a function of one or more of the group consisting of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, and homologs of each of the foregoing, is a small interfering RNA (siRNA) or RNAi. For information on siRNA and RNAi see, for example, Xia, et al., 2002, Nature Biotechnology 20, p. 1006; Hannon, 2002, Nature 418, p. 244; Carthew, 2001, Current Opinion in Cell Biology 13, p. 244; Paddison, 2002, Genes & Development 16, p. 948; Paddison & Hannon, 2002, Cancer Cell 2, p. 17; Jang et al., 2002, Proceedings National Academy of Science 99, p. 1984; and Martinez et al., 2002, Proceedings National Academy of Science 99, p. 14849, where are hereby incorporated by reference in their entireties.

In some embodiments the compound that inhibits a function of one or more of the group consisting of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, and homologs of each of the foregoing, is an oligonucleotide that:

(a) consists of at least six nucleotides;

(b) comprises a sequence complementary to at least a portion of an RNA transcript of a gene encoding one of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, and homologs of each of the foregoing; and

(c) is hybridizable to the RNA transcript under moderately stringent conditions.

Another embodiment of the present invention provides a method of treating or preventing a body weight disorder comprising administering to a subject in which treatment is desired a therapeutically effective amount of a compound that enhances a function of one or more of the group consisting of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, and homologs of each of the foregoing. In some embodiments, the subject is human.

Still another embodiment of the present invention provides a method of diagnosing a disease or disorder or the predisposition to the disease or disorder. In this embodiment the disease or disorder is characterized by an aberrant level of one of SEQ ID NO: 1 through SEQ ID NO: 24, or a homolog thereof, in a subject. The method comprises measuring the level of any one of SEQ ID NO: 1 through SEQ ID NO: 24, or a homolog thereof, in a sample derived from the subject, in which an increase or decrease in the level of one of SEQ ID NO: 1 through SEQ ID NO: 24, or a homolog thereof, in the sample, relative to the level of a corresponding one of said SEQ ID NO: 1 through SEQ ID NO: 24, or a homolog thereof, found in an analogous sample not having the disease or disorder, indicates the presence of the disease or disorder in the subject. In some instances, the disease or disorder is a body weight disorder such as obesity, anorexia nervosa, bulimia nervosa, or cachexia.

Yet another embodiment of the present invention provides a method of diagnosing or screening for the presence of or predisposition for developing a disease or disorder involving a body weight disorder in a subject. The method comprises detecting one or more mutations in at least one of SEQ ID NO: 1 through SEQ ID NO: 24, or a homolog thereof, in a sample derived from the subject, in which the presence of the one or more mutations indicates the presence of the disease or disorder or a predisposition for developing the disease or disorder.

### 3.14. Generalized Causality Methods

In addition to the foregoing embodiments, the present invention provides embodiments that can be used to determine whether a first trait is causal for a second trait. For example, the first trait can represent variance in abundance of a first cellular constituent across a population and the second trait can represent variance in a second cellular constituent across a population. In such an example, the present invention provides a test to determine whether the first trait drives (is causal for) the second trait. In order to accept the results of the test however, it must be the case that there exists some QTL that is linked to (correlated with) both the first trait and the second trait.

More specifically, one embodiment of the present invention provides a method for determining whether a first trait T₁ is causal for a second trait T₂ in a plurality of organisms of a species. In the method, at least one locus in the genome of the species is identified. Each locus Q in the at least one locus is a site of colocalization for (i) a respective quantitative trait locus (QTL₁) linked to (correlated with) a variation in the first trait T₁ across the plurality of organisms and (ii) a respective quantitative trait locus (QTL₂) that is linked to (correlated with) a variation in the second trait T₂ across the plurality of organisms. Each respective locus Q in the at least one locus is tested to determine whether (i) the genetic variation at QTL₂ across the plurality of organisms and (ii) the variation in the second trait T₂ across the plurality of organisms are correlated conditional on the variation in the first trait T₁ across the plurality of organisms. When the genetic variation of (i) at least one locus Q tested and (ii) the variation in the second trait T₂ across the plurality of organisms are uncorrelated conditional on the variation in the first trait T₁ across the plurality of organisms, the first trait T₁ is causal for the second trait T₂. In other words when the variation in the second trait T₂ is fully or predominantly explained by the variation in the first trait T₁, T₁ is causal for the second trait T2.

In some embodiments, a respective QTL₁ is identified using a first quantitative trait locus (QTL) analysis. This first QTL analysis uses a plurality of quantitative measurements of the first trait. Each quantitative measurement in the plurality of quantitative measurements of the first trait is associated with an organism in the plurality of organisms. In some embodiments, a respective QTL₂ is determined using a second QTL analysis. The second QTL analysis uses a plurality of quantitative measurements of the second trait. Each quantitative measurement in the plurality of quantitative measurements of the second trait is associated with an organism in the plurality of organisms.

In some embodiments, the respective QTL₁ and the respective QTL₂ colocalize at a locus Q in the at least one locus when the respective QTL₁ and said respective QTL₂ are within 40 cM of a common locus Q, within 10 cM of a common locus Q, within 3 cM of a common locus Q or within 1 cM of the locus Q in the genome of the species.

In some embodiments, the first trait is a variation in abundance levels of a first cellular constituent across the plurality of organisms and each quantitative measurement of the first trait is an abundance level of the first cellular constituent in an organism in the plurality of organisms. Further, the second trait is a variation in abundance levels of a second cellular constituent across the plurality of organisms and each quantitative measurement of the second trait is an abundance level of the second cellular constituent in an organism in the plurality of organisms. In some embodiments each of the abundance levels of the first cellular constituent are normalized and each of the abundance levels of the second cellular constituent is normalized. In some embodiments, the abundance levels of the first cellular constituent are determined by measuring amounts of the first cellular constituent in one or more cells from organisms in the plurality of organisms. In some embodiments, the abundance levels of the second cellular constituent are determined by measuring amounts of the second cellular constituent in one or more cells from organisms in the plurality of organisms. Such amounts can be, for example, RNA levels. Such RNA levels can be measured by, for example, contacting a gene transcript array with the RNA, or with nucleic acid derived from the RNA. Such gene transcript arrays comprise a positionally addressable surface with attached nucleic acids or nucleic acid mimics. Such nucleic acids or nucleic acid mimics are capable of hybridizing with the RNA, or with nucleic acid derived from the RNA In some embodiments, the first QTL analysis comprises (i) testing for linkage between (a) the genotype of the plurality of organisms at a position in the genome of the species and (b) the plurality of quantitative measurements of the first trait; (ii) advancing the position in said genome by an amount; and (iii) repeating steps (i) and (ii) until all or a portion of the genome of the species has been tested. In some embodiments, the second QTL analysis comprises (i) testing for linkage between (a) the genotype of said plurality of organisms at a position in the genome of the species and (b) the plurality of quantitative measurements of the second trait; (ii) advancing the position in the genome by an amount; and (iii) repeating steps (i) and (ii) until all or a portion of the genome of the species has been tested. In some embodiments, the amount is less than 100 centiMorgans or less than 5 centiMorgans. In some embodiments, the testing comprises performing linkage analysis or association analysis. Such linkage analysis or association analysis can generate a statistical score, such as a logarithm of the odds (lod) score, for the position in the genome of the species.

In some embodiments, a respective QTL₁ is represented by a lod score that is greater than 2.0 or greater than 4.0. In some embodiments, a respective QTL₂ is represented by a lod score that is greater than 2.0 or greater than 4.0.

In some embodiments, each quantitative measurement in the plurality of quantitative measurements of the first trait is:

an amount or a concentration of a first cellular constituent in one or more tissues of an organism in the plurality of organisms,

a cellular constituent activity level of the first cellular constituent in one or more tissues of an organism in the plurality of organisms, or

a state of cellular constituent modification of the first cellular constituent in one or more tissues of an organism in the plurality of organisms.

In some embodiments, each quantitative measurement in the plurality of quantitative measurements of the second trait is

an amount or a concentration of a second cellular constituent in one or more tissues of an organism in the plurality of organisms,

a cellular constituent activity level of the second cellular constituent in one or more tissues of an organism in the plurality of organisms, or

a state of cellular constituent modification of the second cellular constituent in one or more tissues of an organism in the plurality of organisms.

In some embodiments, a respective QTL₁ and a respective QTL₂ colocalize at a locus Q in the at least one locus when the respective QTL₁ and the respective QTL₂ satisfy a pleiotropy test. In such embodiments, failure of the pleiotropy test indicates that the respective QTL₁ and the respective QTL₂ are two closely linked QTL, the causality test is not performed, and the first trait T₁ is not determined to be causal for the second trait T₂.

In some embodiments, this pleiotropy test comprises comparing a model for a null hypothesis, indicating that the respective QTL₁ and the respective QTL₂ colocalize as a QTL, to a model for an alternative hypothesis, indicating that the QTL₁ and the respective QTL₂ are two closely linked QTL. In some embodiments, the model for the null hypothesis is:

$$( \begin{matrix}{y}_{1} \\ {y}_{2}\end{matrix} ) = ( \begin{matrix}{μ}_{1} \\ {μ}_{2}\end{matrix} ) + ( \begin{matrix}{β}_{1} \\ {β}_{2}\end{matrix} ) N + ( \begin{matrix}{ɛ}_{1} \\ {ɛ}_{2}\end{matrix} )$$

where,

N is a categorical random variable indicating the genotype at locus Q across the plurality of organisms;

$$( \begin{matrix}{ɛ}_{1} \\ {ɛ}_{2}\end{matrix} )$$

is distributed as a bivariate normal random variable with mean

$$( \begin{matrix}0 \\ 0\end{matrix} )$$

and covariance matrix

$$( \begin{matrix}{σ}_{1}^{2} & {σ}_{1} {σ}_{2} \\ {σ}_{2} {σ}_{1} & {σ}_{2}^{2}\end{matrix} ) ;$$

and

μᵢ and βᵢ are model parameters.

In some embodiments, the model for the alternative hypothesis is:

$$( \begin{matrix}{y}_{1} \\ {y}_{2}\end{matrix} ) = ( \begin{matrix}{μ}_{1} \\ {μ}_{2}\end{matrix} ) + ( \begin{matrix}{β}_{1} & {β}_{2} \\ {β}_{3} & {β}_{4}\end{matrix} ) ( \begin{matrix}{N}_{1} \\ {N}_{2}\end{matrix} ) + ( \begin{matrix}{ɛ}_{1} \\ {ɛ}_{2}\end{matrix} )$$

where,

N₁ and N₂ are categorical random variables indicating the genotype at locus Q across the plurality of organisms;

$$( \begin{matrix}{ɛ}_{1} \\ {ɛ}_{2}\end{matrix} )$$

is distributed as a bivariate normal random variable with mean

$$( \begin{matrix}0 \\ 0\end{matrix} )$$

and covariance matrix

$$( \begin{matrix}{σ}_{1}^{2} & {σ}_{1} {σ}_{2} \\ {σ}_{2} {σ}_{1} & {σ}_{2}^{2}\end{matrix} ) ;$$

and

μᵢ and βᵢ are model parameters.

In some embodiments, the model for the alternative hypothesis is:

$$( \begin{matrix}{y}_{1} \\ {y}_{2}\end{matrix} ) = ( \begin{matrix}{μ}_{1} \\ {μ}_{2}\end{matrix} ) + ( \begin{matrix}{β}_{1} & {β}_{2} \\ {β}_{3} & {β}_{4}\end{matrix} ) ( \begin{matrix}{N}_{1} \\ {N}_{2}\end{matrix} ) + ( \begin{matrix}{ɛ}_{1} \\ {ɛ}_{2}\end{matrix} )$$

where

N₁ and N₂ are categorical random variables indicating the genotype at locus Q across the plurality of organisms;

$$( \begin{matrix}{ɛ}_{1} \\ {ɛ}_{2}\end{matrix} )$$

is distributed as a bivariate normal random variable with mean

$$( \begin{matrix}0 \\ 0\end{matrix} )$$

and covariance matrix

$$( \begin{matrix}{σ}_{1}^{2} & {σ}_{1} {σ}_{2} \\ {σ}_{2} {σ}_{1} & {σ}_{2}^{2}\end{matrix} ) ;$$

μᵢ and βᵢ are model parameters; and one of the conditions (i) through (iv) is valid:
(i) β₁≠0, β₄≠0, β₂=0, and P₃=0;
(ii) β₁≠0, β₄≠0, β₂≠0, and β₃=0;
(iii) β₁≠0, β₄≠0, β₂=0, and β₃≠0; and
(iv) β₁≠0, β₄≠0, β₂≠0, and β₃≠0.

In some embodiments, the testing comprises considering a null test for causality having the relationship:
P(T₂,Q*|T₁)=P(T₂|T₁)P(Q*|T₁),
where

each function P is a probability density function;

T₂ is a trait random variable for the second trait across the plurality of organisms;

Q* is a genotype random variable for locus Q in the at least one locus across the plurality of organisms; and

T₁ is a trait random variable for the first trait across the plurality of organisms.

Still another aspect of the invention provides a computer program product for use in conjunction with a computer system. The computer program product comprises a computer readable storage medium and a computer program mechanism embedded therein. The computer program mechanism is for determining whether a first trait T₁ is causal for a second trait of interest T₂ in a plurality of organisms of a species. The computer program mechanism comprises a T₁/T₂ overlap module and a causality test module. The T₁/T₂ overlap module comprises instructions for identifying at least one locus in the genome of the species. Each locus Q in the at least one locus is a site of colocalization for (i) a respective quantitative trait locus (QTL₁) linked to (correlated with) a variation in the first trait T₁ across the plurality of organisms and (ii) a respective quantitative trait locus (QTL₂) that is linked to (correlated with) a variation in the second trait T₂ across the plurality of organisms. The causality test module comprises instructions for testing, for one or more locus Q in the at least one locus, whether (i) a genetic variation Q of the respective locus Q across the plurality of organisms and (ii) the variation in the second trait T₂ across the plurality of organisms are correlated conditional on the variation in the first trait T₁ across the plurality of organisms.

Yet another aspect of the invention provides a computer system for determining whether a first trait T₁ is causal for a second trait of interest T₂ in a plurality of organisms of a species. The computer system comprises a central processing unit and a memory. The memory is coupled to the central processing unit and stores an Q₁/Q₂ overlap module and a causality test module. The T₁/T₂ overlap module comprises instructions for identifying at least one locus in the genome of the species. Each locus Q in the at least one locus is a site of colocalization for (i) a respective quantitative trait locus (QTL₁) linked to (correlated with) a variation in the first trait T₁ across the plurality of organisms and (ii) a respective quantitative trait locus (QTL₂) that is linked to (correlated with) a variation in the second trait T₂ across the plurality of organisms. The causality test module comprises instructions for testing, for one or more locus Q in the at least one locus, whether (i) a genetic variation Q* of the respective locus Q across the plurality of organisms and (ii) the variation in the second trait T₂ across the plurality of organisms are correlated conditional on the variation in the first trait T₁ across the plurality of organisms.

Another aspect of the invention provides a method for determining whether a first trait T₁ is causal for a second trait T₂ in a plurality of organisms of a species. The method comprises identifying a locus Q in the genome of the species that is a site of colocalization for (i) a quantitative trait locus (QTL₁) that is genetically linked to (correlated with) a variation in the first trait T₁ across all or a portion of the plurality of organisms and (ii) a quantitative trait locus (QTL₂) that is genetically linked to (correlated with) a variation in the second trait T₂ across all or a portion of the plurality of organisms. A first coefficient of determination is computed between (i) a genetic variation Q* of the locus Q across all or a portion of the plurality of organisms and (ii) the variation in the first trait T₁ across the plurality of organisms. A second coefficient of determination is quantified between (i) the genetic variation Q* of the locus Q across the plurality of organisms and (ii) the variation in the first trait T₁ across all or a portion of the plurality of organisms, after conditioning on the variation in the second trait T₂ across all or a portion of the plurality of organisms. The first trait T₁ is causal for the second trait T₂ when the first coefficient of determination is other than zero and the second coefficient of determination is zero.

In some embodiments, the cellular constituent is causal for the trait of interest T when the first coefficient of determination is greater than a predetermined threshold amount, such as 0.03 or 0.10.

Still another embodiment of the present invention provides a method for determining whether a cellular constituent is causal for a trait of interest T, the trait of interest T exhibited by at least one organism in a plurality of organisms of a species, the method comprising:

(A) identifying a locus Q in the genome of the species that is a site of colocalization for (i) an abundance quantitative trait locus (eQTL) genetically linked to a variation in abundance levels of the cellular constituent across all or a portion of the plurality of organisms, and (ii) a clinical quantitative trait locus (CQTL) that is genetically linked to a variation in the trait of interest T across all or a portion of the plurality of organisms;

(B) quantifying a first coefficient of determination between (i) the variation in the clinical quantitative trait locus (CQTL) across all or a portion of the plurality of organisms and (ii) the variation in the trait of interest T across all or a portion of the plurality of organisms; and

(C) quantifying a second coefficient of determination between (i) the variation in the clinical quantitative trait locus (cQTL) across all or a portion of the plurality of organisms and (ii) the variation in the trait of interest T across all or a portion of the plurality of organisms, after conditioning on the variation of the abundance of the cellular constituent across all or a portion of the plurality of organisms; wherein the cellular constituent is causal for the trait of interest T when the first coefficient of determination is other than zero and the second coefficient of determination cannot be distinguished from zero. Here, each of the portions described in steps (A), (B), and (C) can be the same, different, or overlapping portions.

### 3.15. Subdividing a Population Using Boosting

Another embodment of the present invention provides a method for identifying a quantitative trait locus for a trait that is exhibited by a plurality of organisms in a population. In the method, the population is divided into a plurality of sub-populations using a classification scheme that classifies each organism in the population into at least one of the subpopulations. The classification scheme is derived from a plurality of cellular constituent measurements for each of a plurality of respective cellular constituents that are obtained from each the organism. Furthermore, the classification scheme uses a classifier constructed using boosting. For at least one sub-population in the plurality of sub-populations, the method further comprises performing quantitative genetic analysis on the sub-population in order to identify the quantitative trait locus for the trait.

### 4. BRIEF DESCRIPTION OF THE DRAWINGS

FIG. 1 illustrates a computer system for associating a gene with a trait exhibited by one or more organisms in a plurality of organisms in accordance with one embodiment of the present invention.

FIG. 2 illustrates a topology for how causal genes affect pathways that affect a primary disease which, in turn, affects reactive genes.

FIG. 3A illustrates possible relationships between quantitative trait loci (QTL), genes and disease traits once the expression of the gene (G) and the disease trait (T) have been shown to be under the control of a common QTL (O).

FIG. 3B illustrates obese and lean animals segregating with the genotypes given at the locus, with up arrows indicating up regulation of the gene, horizontal arrows indicating no differential regulation, and down arrows indicating down regulation.

FIG. 3C illustrates an analysis of the observed correlation structure between the locus, gene expression trait, and obesity trait of FIG. 3B under a causal model.

FIG. 3D illustrates an analysis of the observed correlation structure between the locus, gene expression trait, and obesity trait of FIG. 3B under a reactive model.

FIG. 3E illustrates an analysis of the observed correlation structure between the locus, gene expression trait, and obesity trait of FIG. 3B under an independent model.

FIG. 4 illustrates the genomic positions of the cQTL that are linked to (correlated with) the trait omental fat pad masses (OFPM) as well as the eQTL that are linked to (correlated with) expression of the gene HSD1 in a segregating mouse population.

FIG. 5 illustrates a potential relationship between a specific QTL (which controls for both the trait OFPM and HSD1 expression), HSD1, and OFPM.

FIG. 6 illustrates LOD score curves for HSD1 expression, the trait OFPM, the simultaneous consideration of HSD1 expression and the trait OFPM, as well as OFPM after conditioning on HSD1 expression.

FIG. 7 illustrates processing steps for identifying a gene that affects a trait in accordance with one embodiment of the present invention.

FIG. 8 illustrates the data structure for phenotypic statistic sets in accordance with one embodiment of the present invention.

FIG. 9 illustrates a data structure for storing cellular constituent abundance data in accordance with one embodiment of the present invention.

FIG. 10 illustrates the data structure for a cellular constituent expression statistic in accordance with one embodiment of the present invention.

FIG. 11 illustrates a data structure for storing cellular constituent abundance data from a plurality of different tissue types in accordance with one embodiment of the present invention.

FIG. 12 illustrates a QTL results database in accordance with the present invention FIGS. 13A-13E illustrates several possible genetic relationships.

FIG. 14 illustrates gives a scatter plot for values for two traits in a hypothetical dataset.

FIG. 15 illustrates the results of hypothetical QTL analyses in accordance with the present invention.

FIG. 16 illustrates how polymorphism in a multi-cross environment can be used to localize a gene underlying a QTL.

FIG. 17 is the amino acid sequence of cytosolic homo sapiens malic enzyme ME1 (SEQ ID NO: 1).

FIG. 18 is the amino acid sequence of the enzyme mus musculus Mod1 (SEQ ID NO: 2).

FIG. 19A illustrates that quantitative trait loci that control the genetic variation in OFPM (log of OFPM or logomen, left panel) in mice and Mod1 (SEQ ID NO:2) expression (right panel).

FIG. 19B lists various mouse traits and the number of overlapping QTLs they have with Mod1.

FIG. 20, top panel, shows a scatter gram of the OFPM values in grams (X axis) versus Mod1 (SEQ ID NO: 2) mRNA levels as mlratio's (Y axis) and the lower panel shows a comparison of Mod1 to the log of the OFPM values (LogOmen).

FIG. 21 illustrates scatter grams comparing Mod1 (SEQ ID NO: 2) ml ratios (Y axes) to OFPM (top left), subcutaneous fat pat mass (top right), leptin protein levels (bottom left) and insulin protein levels (bottom right) all X axis.

FIG. 22 illustrates the correlation coefficients of various measures of fat pad masses and adiposity and Mod1 (SEQ ID NO: 2) mRNA levels.

FIG. 23 is the amino acid sequence of homo sapiens ME3 (SEQ ID NO: 3).

FIG. 24 is the amino acid sequence of homo sapiens ME2 (SEQ ID NO: 4).

FIG. 25 illustrates the relative levels of expression of the cytoslic malic enzyme Mod1 (ME1) in various tissues of monkeys.

FIG. 26 provides the position of mus musculus Mod1 (SEQ ID NO: 2) in a schematic representation of intermediate metabolism. Above the line 2602 is cytosol, below is mitochondria.

FIG. 27 is the nucleic acid sequence of homo sapiens mitochondrial NADP(+)-dependent malic enzyme 3 (NCBI accession number X79440; SEQ ID NO: 5).

FIG. 28 is the nucleic acid sequence of homo sapiens mitochondrial NAD-dependent malic enzyme 2 (NCBI accession number M55905; SEQ ID NO: 6).

FIG. 29 is the nucleic acid sequence of homo sapiens cytosolic malic enzyme 1 (SEQ ID NO: 7).

FIG. 30 is the mus musculus nucleic acid sequence A1506234 (SEQ ID NO: 8).

FIG. 31 is the mus musculus nucleic acid sequence NM_{—}011764 for Zfp90 (SEQ ID NO: 9).

FIG. 32 is the mus musculus amino acid sequence gi:28279474 for Zfp90 (SEQ ID NO: 10).

FIG. 33 is the mus musculus nucleic acid sequence AY027436 for Kruppel-like protein Klf6 (SEQ ID NO: 11).

FIG. 34 is the mus musculus nucleic acid sequence NM_{—}008288 for hydroxysteroid 11-beta dehydrogenase 1 (SEQ ID NO: 12).

FIG. 35 is the mus musculus amino acid sequence hydroxysteroid 11-beta dehydrogenase (SEQ ID NO: 13).

FIG. 36 is the mus musculus nucleic acid sequence AK004942 (SEQ ID NO: 14).

FIG. 37 is the mus musculus amino acid sequence for Gpx3 (SEQ ID NO: 15).

FIG. 38 is the mus musculus nucleic acid sequence NM_{—}030717 for lactamase, beta (Lactb) (SEQ ID NO: 16).

FIG. 39 is the mus musculus amino acid sequence for Lactb (SEQ ID NO: 17).

FIG. 40 is the mus musculus nucleic acid sequence NM_{—}026508 for TNF receptor-associated protein 1 (Trap1) (SEQ ID NO: 18).

FIG. 41 is the mus musculus amino acid sequence for 2410002K23Rik (SEQ ID NO: 19).

FIG. 42 is the mus musculus nucleic acid sequence for AK004980 malic enzyme Mod1 (SEQ ID NO: 20).

FIG. 43 is the mus musculus nucleic acid sequence NM_{—}008194 for glycerol kinase (Gyk), transcript variant 1 (SEQ ID NO: 21).

FIG. 44 is the mus musculus amino acid sequence for glycerol kinase (Gyk) (SEQ ID NO: 22).

FIG. 45 is the mus musculus nucleic acid sequence NM_{—}008509 for lipoprotein lipase (Lpl) (SEQ ID NO: 23).

FIG. 46 is the mus musculus amino acid sequence for Lipoprotein lipase (SEQ ID NO: 24).

FIG. 47 illustrates how a population can be stratified, with respect to a trait under study, into subpopulations (subtypes) and causal determinants can be identified for each of the subpopulations using the methods of the present invention.

FIG. 48 illustrates processing steps for subdividing a disease population P into n subgroups and then subjecting one or more of the n subgroups to quantitative genetic analysis in accordance with another embodiment of the present invention.

FIG. 49 illustrates hierarchically clustered genes and extreme fat pad mass mice.

FIG. 50 illustrates the results of a QTL analysis of a portion of mouse chromosome 2 in accordance with one embodiment of the present invention.

FIG. 51 illustrates the results of a QTL analysis of a portion of mouse chromosome 19 in accordance with one embodiment of the present invention.

FIG. 52 illustrates the LOD scores for various obesity related genes.

FIG. 53 illustrates processing steps for subdividing a disease population P into n subgroups and then subjecting one or more of the n subgroups to quantitative genetic analysis in accordance with a preferred embodiment of the present invention.

FIG. 54 illustrates a data structure that comprises that data used to identify cellular constituents that discriminate a trait under study.

FIG. 55 illustrates the classification of a trait of interests into subtraits in accordance with one embodiment of the present invention.

FIG. 56 illustrates processing steps for subdividing a population into subgroups in accordance with one embodiment of the present invention.

FIG. 57A illustrates the genetic organization of a naturally occurring Mod1 null mice in accordance with an embodiment of the present invention.

FIG. 57B illustrates the Southern blot analysis of wild type and Mod1 null mice in accordance with an embodiment of the present invention.

FIG. 58A illustrates the effects of high sucrose diets on the body weigh change of male Mod1 null mice and control mice, in accordance with an embodiment of the present invention.

FIG. 58B illustrates daily food intake comparison between male Mod1 null mice and wild type controls, in accordance with an embodiment of the present invention.

FIG. 59 illustrates the effects of carbohydrate-rich diet on male and female Mod1 null mice in comparison with wild type controls, in accordance with an embodiment of the present invention.

FIG. 60A illustrates the effects of high fat diets on body weight change of male Mod1 null mice and WT controls, in accordance with an embodiment of the present invention.

FIG. 60B illustrates the effects of high fat diets on body weight change of female Mod1 null mice and WT controls, in accordance with an embodiment of the present invention.

FIG. 61A illustrates daily food intake of male Mod1 null mice and WT controls on high fat diets, in accordance with an embodiment of the present invention.

FIG. 61B illustrates daily food intake of female Mod1 null mice and WT controls on high fat diets, in accordance with an embodiment of the present invention.

FIG. 61C illustrates cumulative food intake of Mod1 null mice and WT controls on high fat diets, in accordance with an embodiment of the present invention.

FIG. 62 illustrates the expression of human ZFP90 and murine Zfp90 in six mouse tissues, in accordance with an embodiment of the present invention.

FIG. 63 illustrates the genetic subnetwork for liver expression in the BxD mouse cross, in accordance with an embodiment of the present invention.

FIG. 64 illustrates the strategy for genetic disruption of the C3ar1 gene (SEQ ID NO: 27), in accordance with an embodiment of the present invention.

FIG. 65 illustrates the strategy for genetic disruption of the Tgfbr2 gene (SEQ ID NO: 31), in accordance with an embodiment of the present invention.

FIG. 66 illustrates the growth curves for C3ar1−/− mice and wild type controls, in accordance with an embodiment of the present invention.

FIG. 67 illustrates the growth curves for Tgfbr2+/− mice and wild type controls, in accordance with an embodiment of the present invention.

FIG. 68 is the homo sapiens C3ar1 nucleic acid sequence NM_{—}004054 (SEQ ID NO: 25).

FIG. 69 is the homo sapiens C3ar1 protein sequence (SEQ ID NO: 26).

FIG. 70 is the mus musculus C3ar1 nucleic acid sequence NM_{—}00979 (SEQ ID NO: 27).

FIG. 71 is the mus musculus C3ar1 protein sequence (SEQ ID NO: 28).

FIG. 72 is the homo sapiens Tgfbr2 nucleic acid sequence NM_{—}003242 (SEQ ID NO: 29).

FIG. 73 is the homo sapiens Tgfbr2 protein sequence (SEQ ID NO: 30).

FIG. 74 is the mus musculus Tgfbr2 nucleic acid sequence NM_{—}009371 (SEQ ID NO: 31).

FIG. 75 is the mus musculus Tgfbr2 protein sequence (SEQ ID NO: 32).

FIG. 76 is the homo sapiens nucleic acid sequence for Zfp90 (SEQ ID NO: 33).

FIG. 77 is the homo sapiens amino acid sequence for Zfp90 (SEQ ID NO: 34).

Like reference numerals refer to corresponding parts throughout the several views of the drawings.

### 5. DETAILED DESCRIPTION

A key goal of biomedical research is to identify the basis of common human diseases. Here, systems and methods for the identification of key drivers of complex traits, including common human diseases, using cellular constituent abundance data in a population are described. Central to such systems and methods is the integration of genetic and cellular constituent abundance (e.g., gene expression) information with clinical trait data to infer causal patterns of association between key drivers and disease phenotypes. Such procedures allow for the objective identification of druggable targets for common human diseases. In particular, the present invention provides apparatus and methods for associating genes with complex traits exhibited by one or more organisms in a plurality of organisms of a species.

Exemplary organisms include, but are not limited to, plants and animals. In specific embodiments, exemplary organisms include, but are not limited to plants such as corn, beans, rice, tobacco, potatoes, tomatoes, cucumbers, apple trees, orange trees, cabbage, lettuce, and wheat. In specific embodiments, exemplary organisms include, but are not limited to animals such as mammals, primates, humans, mice, rats, dogs, cats, chickens, horses, cows, pigs, and monkeys. In yet other specific embodiments, organisms include, but are not limited to, Drosophila, yeast, viruses, and C. elegans. In some instances, the gene is associated with the trait by identifying a biological pathway in which the gene product participates. In some embodiments of the present invention, the trait of interest is a complex trait such as a human disease. Exemplary human diseases include, but are not limited to, diabetes, obesity, cancer, asthma, schizophrenia, arthritis, multiple sclerosis, and rheumatosis. In some embodiments, the trait of interest is a preclinical indicator of disease, such as, but not limited to, high blood pressure, abnormal triglyceride levels, abnormal cholesterol levels, or abnormal high-density lipoprotein/low-density lipoprotein levels. In a specific embodiment of the present invention, the trait is low resistance to an infection by a particular insect or pathogen. Additional exemplary diseases are found in Section 5.12, below.

### 5.1. Overview of the Invention

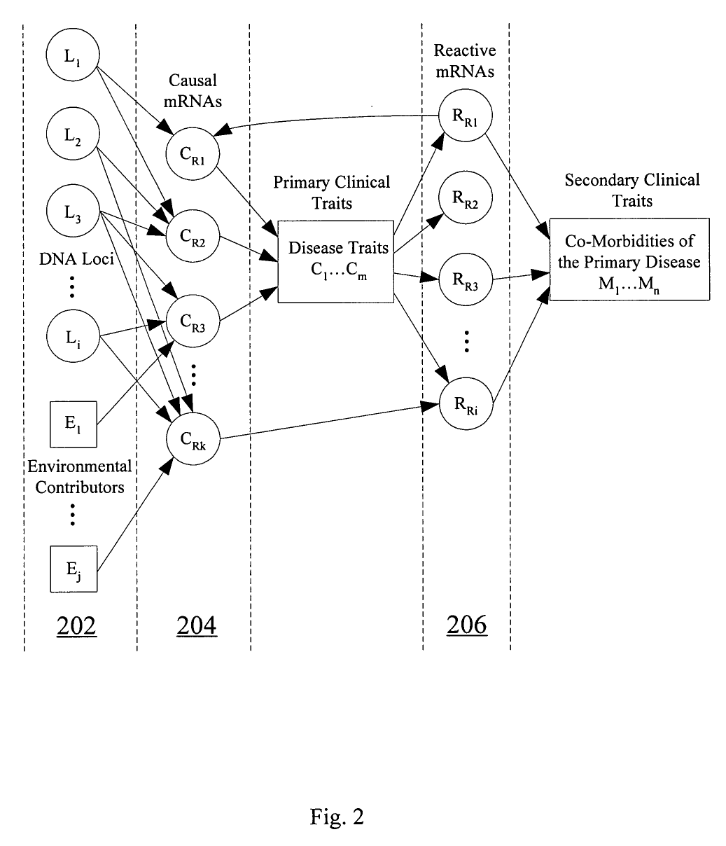

The starting point for the traditional forward genetics approach to dissecting complex traits, including common human diseases, is identification of QTL controlling for a disease trait of interest. For more information on complex traits, see Section 5.11, below. Genome-wide scans are performed to identify markers spaced along the length of the genome that are correlated with the disease trait under study. The end result of such a screen is a number of cQTL identified for the disease trait. This is graphically depicted in FIG. 2. In particular, FIG. 2 illustrates a hypothetical disease-specific genetic network for disease traits and related co-morbidities. The quantitative trait loci (Lₙ) and environmental effects (Eₙ) (panel 202) represent the most upstream drivers of the disease traits in a given population. In other words, a quantitative disease trait in a segregating population can be described as being made up of genetic and environmental components, with or without interactions among the genetic components and/or between the genetic and environmental components. As depicted in FIG. 2, the QTL and environmental effects (202) influence other “causative” mRNAs (C_{Rk}) (panel 204) singly or in pathways that can interact in complicated ways (most generally, as a genetic network), but that ultimately lead to the disease state (primary clinical traits). A genetic network can be represented as an acyclic directed graph having nodes and edges, where the nodes represent genes and each respective edge represents confidence that the two nodes, connected by the respective edge, are related as determined by an analysis of genotypic and gene expression data using the methods of the present invention. Variations in the causal mRNAs or in the primary clinical traits can in turn affect reactive mRNAs (R_{Ni}) (panel 206) in other pathways that in turn lead to co-morbidities of the disease trait, or they can provide positive/negative feedback control to the causal pathways. Instead of restricting the search for disease-causing genes to the QTL regions associated with the complex trait, the classic approach in mouse and human genetics, the present invention broadens the search to any of the cellular constituents that operate in the causal portion of the genetic network associated with the disease trait (circles 204). Identifying cellular constituents in pathways that are under the control of the same QTL that are controlling for the disease trait, where the cellular constituents can be shown to act as transmitters of information from these multiple QTL to the disease trait itself (as opposed to acting as responders to the disease trait), potentially represent key intervention points that can be targeted to modulate the disease trait.

In the absence of cellular constituent abundance data or other molecular phenotyping data on the population under study, the biological/biochemical processes that take place that ultimately lead to the disease state, starting from the most upstream genetic components of the disease detected as QTL, are completely hidden from view. Therefore, as depicted in FIG. 2, those pathways (cellular constituents 204) that are impacted by the DNA variations underlying the QTL and that ultimately lead to the disease state (causal), in addition to those pathways that are impacted as a result of the system being in the disease state (reactive cellular constituents 206), are not available for study.

The generation of large-scale gene expression data on the relevant populations can significantly expose the many pathways and complicated interactions among cellular constituents associated with disease, as detailed by Schadt et al., 2003, Nature 422, 297. The complex networks of interactions that are causal for the disease (204), as well as those that are reactive to it (206), make up the patterns of expression that are associated with a disease trait. Several examples of this have been provided in the recent literature. See, for example, Schadt et al., 2003, Nature 422, 297, van de Vijver et al., 2002, N. Engl. J. Med 347; van't Veer et al., 2002, Nature 415, 530, each of which is hereby incorporated herein by reference in its entirety.

Gene expression traits and disease traits can be modulated by the same QTL. Therefore, performing genome-wide scans to map eQTL for the gene expression traits allows one to assess the amount of correlation between the gene expression and disease traits that is due to common genetic effects. The QTL provide anchors in the complex network of interactions that lead to disease, and it is this causal information that provides for the opportunity to identify cellular constituents 204 that transmit “information” from single or multiple disease QTL, to the disease trait itself. Because the QTL can modulate the disease trait through intermediates, identifying the intermediates using the combination of genetics and gene expression data (or other cellular constituent abundance data) has the potential to elucidate key control points in the complex network associated with the disease.

Since one of the primary aims of the target discovery process is to identify targets for therapeutic intervention in complex human diseases, it is advantageous to partition cellular constituents (e.g., genes) making up the patterns of expression associated with the disease trait and that are modulated by QTL overlapping the disease trait QTL, into two groups: 1) cellular constituents under the control of the disease QTL that fall between the causal and reactive boundaries depicted in FIG. 2 (cellular constituents 204), and 2) cellular constituents that appear to be reactive to the disease state (cellular constituents 206). Once cellular constituents have been partitioned into causal set 204 and reactive set 206, attention can shift to those cellular constituents in causative set 204 to identify key targets for the disease.

Approaching the dissection of complicated genetic networks associated with disease from this partitioning standpoint greatly simplifies the more general problem of reconstructing whole genetic networks. The reconstruction of genetic networks has been vigorously pursued in many settings and has met with some success in microbial organisms. See, for example, Marcotte, 1999, Science 285, 751; and Lee et al., 2002, Science 298, p. 799, each of which is hereby incorporated herein by reference in its entirety. The genetic network reconstruction problem is not yet tractable for mammalian systems, mainly due to the complexity and extent of data that would be required to undertake such a reconstruction. See, for example, van Someren et al., 2002, Pharmacogenomics 3, 507. Reducing the genetic network problem to one of partitioning sets of cellular constituents should make the problem tractable and directly relevant to the identification of targets for complex human diseases.

The partitioning approach requires that a basic set of causal scenarios be tested to determine whether a cellular constituent under the control of disease QTL is causal for the disease or reactive to it. For each cellular constituent under consideration, first a determination is made as to whether changes in the abundance (e.g., expression) of the cellular constituent are associated with QTL that explain variations in the disease trait. Then a determination is made as to whether the QTL act on the disease trait through the gene.

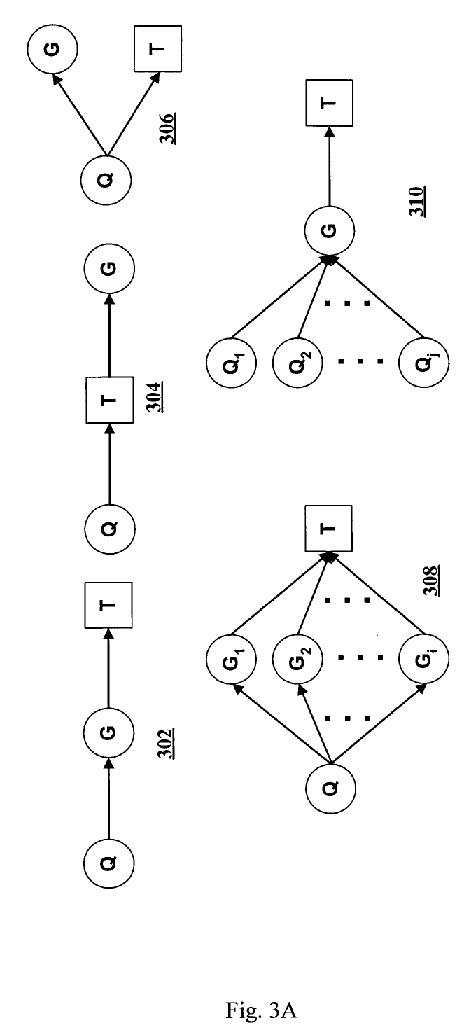

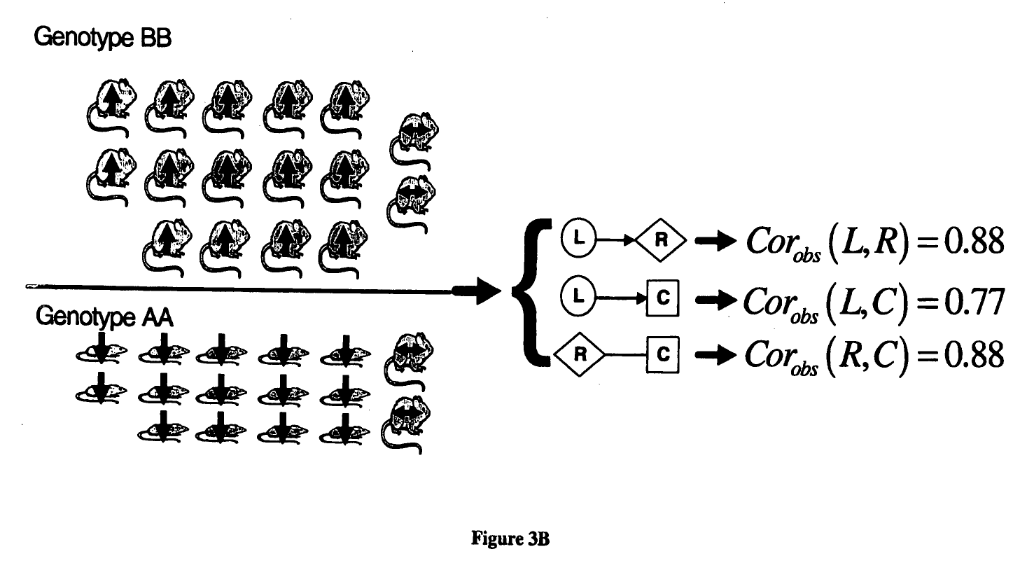

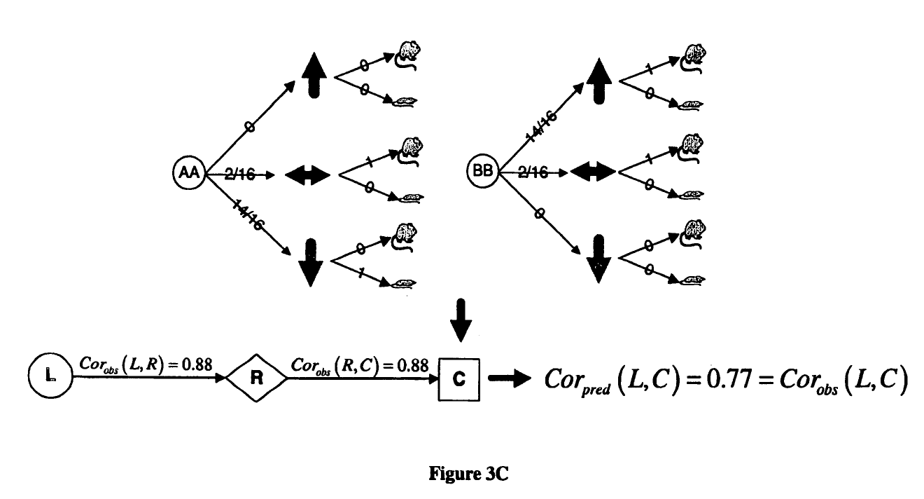

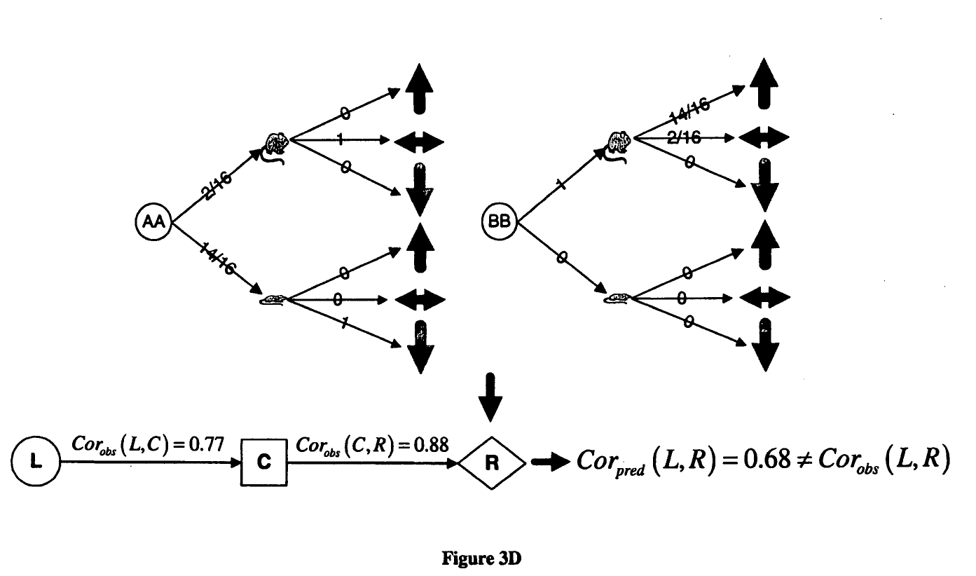

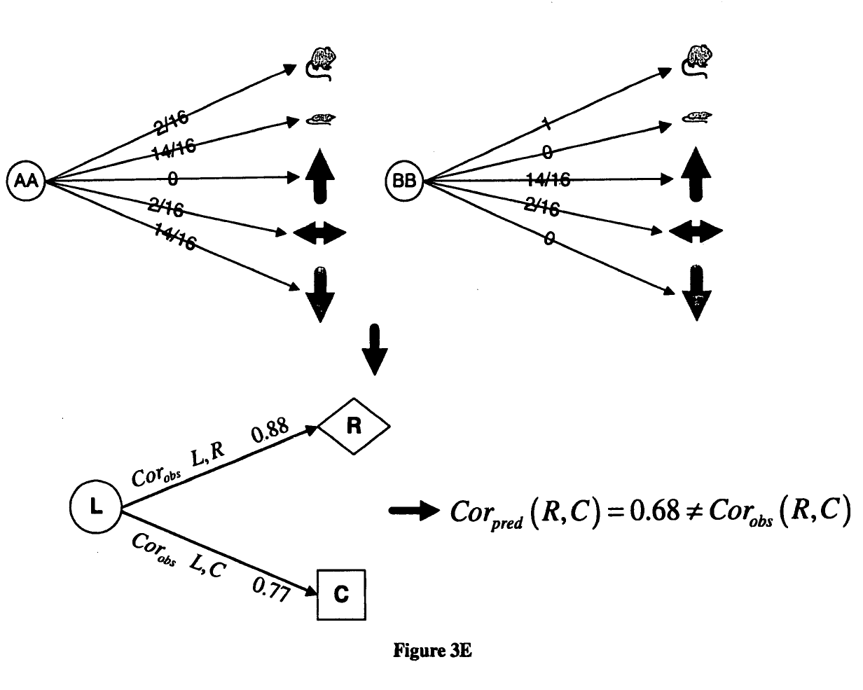

FIG. 3A presents the possible relationships between QTL, cellular constituents and disease traits once the abundance of a cellular constituent (e.g., gene G) and the disease trait (T) have been shown to be under control of a common QTL (O). Pathway 302 represents the simplest causal relationship of a single QTL, Q, for the quantitative trait T, where Q acts on T through cellular constituent G. Pathway 304 represents the simplest reactive diagram for a single QTL, Q, for the quantitative trait T, where in this case the abundance of cellular constituent G is responding to T. In pathway 306, the QTL, Q, is causative for the trait T and the abundance of cellular constituent G, but acts on these traits independently. Pathway 306 may arise when the QTL, Q, is actually two closely linked, independent QTL rather than a single QTL. Pathway 308 represents a more complicated causal diagram where QTL Q affects the abundance of cellular constituents, and these cellular constituents, in turn, act on the trait T. Pathway 310 represents the ideal causal diagram for target identification, where a number of QTL explain a significant amount of the variation in the trait T, but all of these QTL act on T through a single cellular constituent G.

To illustrate how partitioning genes into causal and reactive classes can be accomplished given gene expression data from a segregating population, consider a hypothetical mouse population in which half of the mice have the AA genotype and the other half have the BB genotype at a given locus. As depicted in FIG. 3B, all mice with the BB genotype are obese, while 87.5% of the mice with the AA genotype are lean and the other 12.5% are obese. Further, 87.5% of the BB mice have higher transcript levels of a specific gene, while the other 12.5% have unchanged levels, and similarly, 87.5% of the AA mice have lower transcript levels of the same gene, while the other 12.5% have unchanged levels. If the clinical and expression trait were uncorrelated with the genotype at locus L (e.g., not significantly linked to this locus), it is expected that an equal percentage for each of the expression/clinical trait combinations for each genotype at locus L. Since this is clearly not true in FIG. 3B, the expression and clinical traits are significantly linked to (correlated with) locus L.

To determine in this case if the mRNA is a cause or consequence of the clinical state, the data are fit to the three competing models. FIG. 3C highlights the Causative model, where the correlation between genotype and clinical trait predicted from the model is seen to be consistent with the observed correlation. In one embodiment described below, this scenario will translate into a situation where the correlation between the clinical trait and genotype, given the gene expression state, is seen to be zero. Because the clinical trait and genotype are uncorrelated once we condition on transcript abundances, we can tentatively conclude the mRNA is causal for the clinical trait. FIG. 3D highlights the Reactive model, where the observed correlation between the gene expression trait and genotype is 0.88, but now the correlation between the gene expression trait and genotype given any of the clinical trait values is not equal to 0, e.g., the correlation between the expression trait and genotype predicted from the model does not equal the observed correlation. Because the expression trait and genotypes are still significantly correlated after conditioning on the clinical trait values, it is possible to confirm that the mRNA levels are not responding to the clinical trait. Finally, FIG. 3E highlights the Independent model, where again the correlation between the gene expression and clinical traits predicted from the model is not consistent with the observed correlation. Therefore, given the results of the fits to these three models, the data for this hypothetical example indicate that the Causative model is the most parsimonious and thus is the best explanation of the underlying biology. It is concluded that the AA/BB locus controls variation in the mRNA levels and that this mRNA, in turn, controls variation in the clinical trait, rather than the mRNA levels changing as a consequence of the obesity. By applying a statistically rigorous version of this causality testing to the whole genome (described below), the genes controlling variation in mRNA levels that in turn control clinical traits can be identified. In another embodiment, likelihoods are created for each of the possible models (independent, causative, and reactive) based on relationships depicted in each model and then maximized with respect to model parameters. In this other embodiment, the causative model gives rise to the largest likelihood.

The models in FIG. 3A are the ideal, simplest cases. In reality there will usually be a number of loci and mRNAs that cause disease, related by a complex network of interactions, as depicted in FIG. 2. In the approach detailed below, this complexity in a segregating population can be harnessed to identify specific genes that transmit information from the disease trait QTL to the clinical disease trait itself. Specially, a disease trait QTL will modulate the disease trait through intermediates. Identifying the intermediates using the combination of genetics and gene expression data has the potential to elucidate key control points in the complex network associated with the disease.

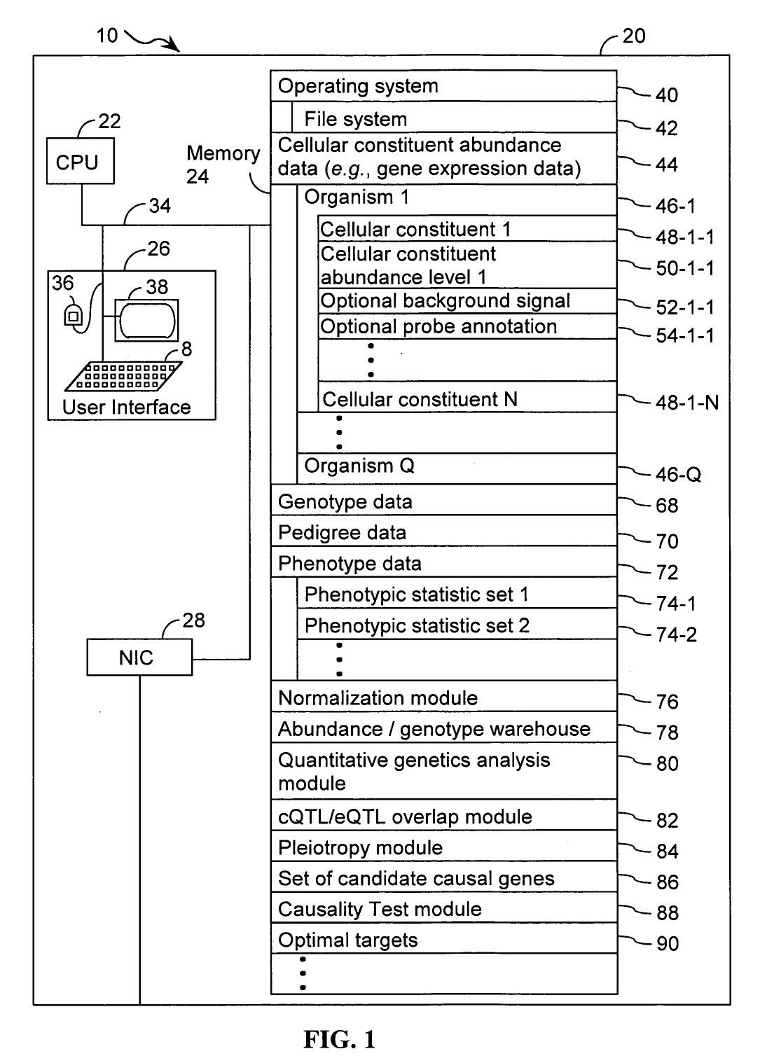

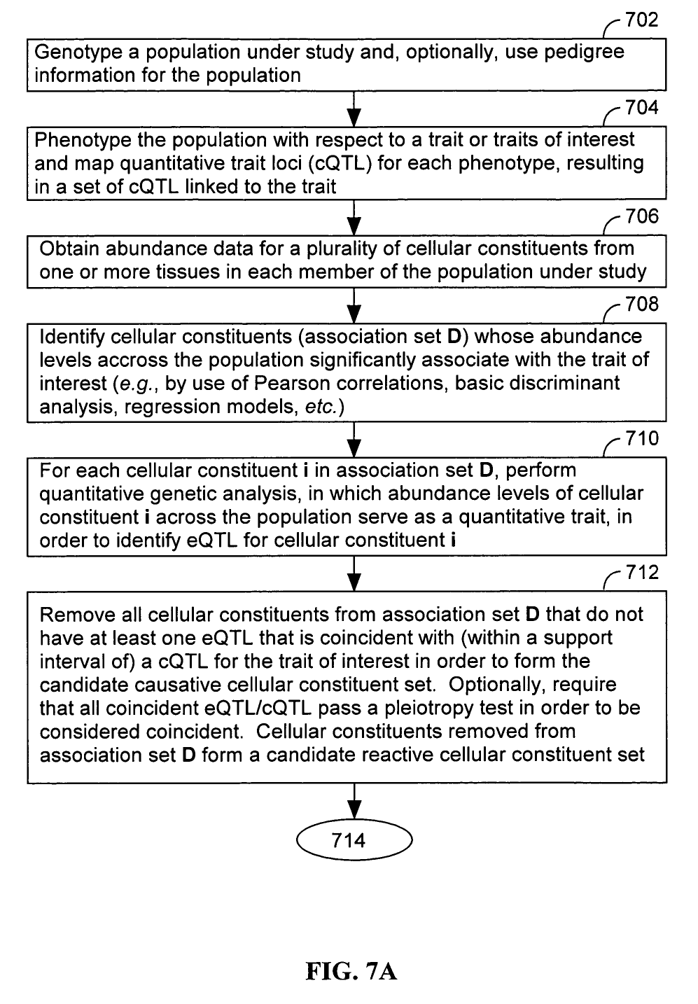

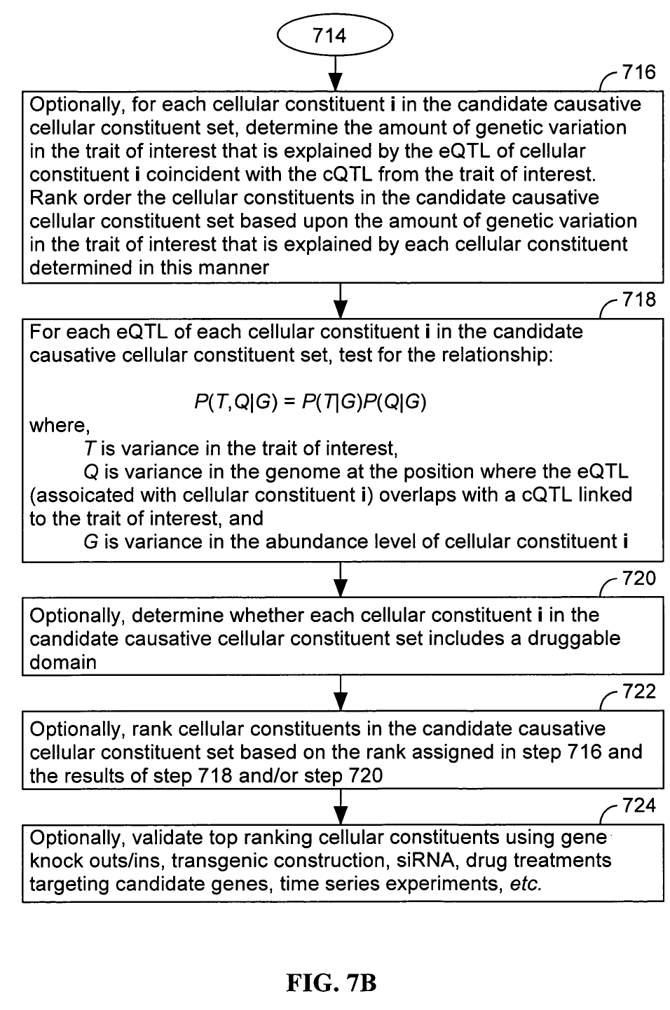

FIG. 1 illustrates a system 10 that is operated in accordance with one embodiment of the present invention. In addition, FIGS. 7A and 7B illustrate the processing steps that are performed in accordance with one embodiment of the present invention. These figures will be referenced in this section in order to disclose the advantages and features of the present invention. System 10 comprises at least one computer 20 (FIG. 1). Computer 20 comprises standard components including a central processing unit 22, and memory 24 (including high speed random access memory as well as non-volatile storage, such as disk storage) for storing program modules and data structures, user input/output device 26, a network interface 28 for coupling server 20 to other computers via a communication network (not shown), and one or more busses 34 that interconnect these components. User input/output device 26 comprises one or more user input/output components such as a mouse 36, display 38, and keyboard 8.

Memory 24 comprises a number of modules and data structures that are used in accordance with the present invention. It will be appreciated that, at any one time during operation of the system, a portion of the modules and/or data structures stored in memory 24 is stored in random access memory while another portion of the modules and/or data structures is stored in non-volatile storage. In a typical embodiment, memory 24 comprises an operating system 40. Operating system 40 comprises procedures for handling various basic system services and for performing hardware dependent tasks. Memory 24 further comprises a file system 42 for file management. In some embodiments, file system 42 is a component of operating system 40.

Step 702. The present invention begins with the step of obtaining genotype data 68. Genotype data 68 comprises the actual alleles for each genetic marker typed in each individual in a plurality of individuals under study. In some embodiments, the plurality of individuals under study is human. Genotype data 68 includes marker data at intervals across the genome under study or in gene regions of interest. In some embodiments, such data is used to monitor segregation or detect associations in a population of interest. Marker data comprises those markers that will be used in the population under study to assess genotypes. In one embodiment, marker data comprises the names of the markers, the type of markers, and the physical and genetic location of the markers in the genomic sequence. Exemplary types of markers include, but are not limited to, restriction fragment length polymorphisms “RFLPs”, random amplified polymorphic DNA “RAPDs”, amplified fragment length polymorphisms “AFLPs”, simple sequence repeats “SSRs”, single nucleotide polymorphisms “SNPs”, microsatellites, etc.). Further, in some embodiments, marker data comprises the different alleles associated with each marker. For example, a particular microsatellite marker consisting of ‘CA’ repeats can represent ten different alleles in the population under study, with each of the ten different alleles, in turn, consisting of some number of repeats. Representative marker data in accordance with one embodiment of the present invention is found in Section 5.2, below. In one embodiment of the present invention, the genetic markers used comprise single nucleotide polymorphisms (SNPs), microsatellite markers, restriction fragment length polymorphisms, short tandem repeats, DNA methylation markers, sequence length polymorphisms, random amplified polymorphic DNA, amplified fragment length polymorphisms, or simple sequence repeats.

In some embodiments, step 702 uses pedigree data 70. Pedigree data 70 comprises the relationships between individuals in the population under study. The extent of the relationships between the individuals under study can be as simple as an inbred F₂ population, an Fₜ population, an F_{2:3} population, a Design_{III} population, or as complicated as extended human family pedigrees. Exemplary sources of genotype and pedigree data are described in Section 5.2.

In some embodiments, a genetic map is generated from genotype data 68 and pedigree data 70. Such a genetic map includes the genetic distance between each of the markers present in the genotype data 68. These genetic distances are computed using pedigree data 70. In some embodiments, the plurality of organisms under study represents a segregating population and pedigree data is used to construct the marker map. As such, in one embodiment of the present invention, genotype probability distributions for the individuals under study are computed. Genotype probability distributions take into account information such as marker information of parents, known genetic distances between markers, and estimated genetic distances between the markers. Computation of genotype probability distributions generally require pedigree data 70. In some embodiments of the present invention, pedigree data 70 is not provided and genotype probability distributions are not computed. In some embodiments, a genetic map is not computed.

### Using Populations Derived from Multiple Founders

In some embodiments, the population that is used for the methods illustrated in FIG. 7 is a population that is derived from a select set of strains (e.g., a small, but diverse number of founding mice) or individuals (e.g., the Icelandic population, which was founded by a small to moderate number of individuals). In some embodiments, between 2 and 100, between 5 and 500, more than five, or less than 1000 strains of a species diverse with respect to complex phenotypes associated with common human disease are chosen. In some embodiments, the species is mice. In some embodiments, between 2 and 10 (e.g., 6) strains of mice that are diverse with respect to complex phenotypes associated with common human disease are selected. Representative common human diseases include, but are not limited to, obesity, diabetes, atherosclerosis and associated morbidities, metabolic syndrome, depression/anxiety, osteoporosis, bone development, asthma, and chronic obstructive pulmonary disease. The actual number of founding strains is not as important a factor as ensuring that these “founders” are diverse so as to introduce extensive heterogeneity into the population. In one representative embodiment, the species under study is mice and all or a portion of the following strains are used: B6_DBA GTMs (Jake Lusis, University of California, Los Angeles), B6_CAST GTMs (Jake Lusis, University of California, Los Angeles), B6_DBA Consomics (Joe Nadaeu, Case Western Reserve University), AXB recombinant inbred (RI) lines (JAX, Bar Harbor Me.), BXA RI lines (JAX), LXS RI lines (Rob Williams, University of Tennessee), AKXD RI lines (JAX), 8-way cross mice (Rob Hitzmann, Oregon Health and Science University), D129S1/SvImJ (JAX), A/J (JAX), C57BL/6J (JAX), BALB/cJ (JAX), C3H/HeJ (JAX), CAST/Ei (JAX), DBA/2J (JAX), NOD/LtJ (JAX), NZB/B1NJ (JAX), SJL/J (JAX), AKR/J (JAX), CBA/J (JAX), FVB/NJ (JAX), and SWR/J (JAX).

In preferred embodiments, the species that is selected for study using the methods illustrated in FIG. 7 can be crossed. In such preferred embodiments, crosses (e.g. F₂ intercrosses) between all pairs of the founding strains are performed. For example, in one embodiment, six founding strains are used so a total of 15 crosses are performed. In some embodiments, rather than performing an F₂ intercross, other cross designs are used. For example, in some embodiments, a backcross or F₂ random mating scheme is employed. In some embodiments “random” intercrossing at the F₁ level is performed. Such embodiments begin with a predetermined number of parental strains that are crossed in various ways in order to obtain F₁ mice. These F₁ mice are allowed to breed with any other F₁ mice irrespective of the identity of the parents from which such mice were derived. In this way, a diverse population of mice is achieved. In specific embodiments, the mice from the crosses (for example the mice from the 15 crosses using the 6 founder strains) is collectively treated as a single large pedigree. In some embodiments, the final population size that is studied has a size of more than 1,000 organisms, between 100 and 100,000 organisms, less than 500,000 organisms, or, more preferably, between 5,000 and 25,000 organisms. This population is treated as a single large pedigree and genotype information is collected from this population using a standard set of, for example, more than 500 markers.

The advantage of the different crosses and large numbers is that it introduces a significant amount of trait heterogeneity into the population, which allows for more connections between more pathways relating directly to the diseases of interest, and with such large numbers, it will be possible to detect first and second order interactions. Further, with such large numbers of organisms 46 over different strains, there will be enough recombination to solve problems regarding describing genetic correlation (genetic correlation is a function of linkage disequilibrium and pleiotropy, and in single small crosses, these components are confounded). Further, as illustrated below, detection of epistatic interactions and minimization of the effects of linkage disequilibrium on genetic correlation would allow for the reconstruction of pathways more reliably.

Step 704. In step 704, the population under study is phenotyped with respect to a trait or traits of interest using quantitative trait loci (QTL) analysis in which a phenotypic statistic set 74, representing the trait of interest, is used as the quantitative trait in the QTL analysis thereby identifying one or more clinical quantitative trait locus (cQTL) that link to the trait. In processing step 704, a cQTL that is linked to (correlated with) a trait of interest is identified using QTL analysis. In some embodiments of the present invention, step 704 is performed by an embodiment of quantitative genetics analysis module 80.

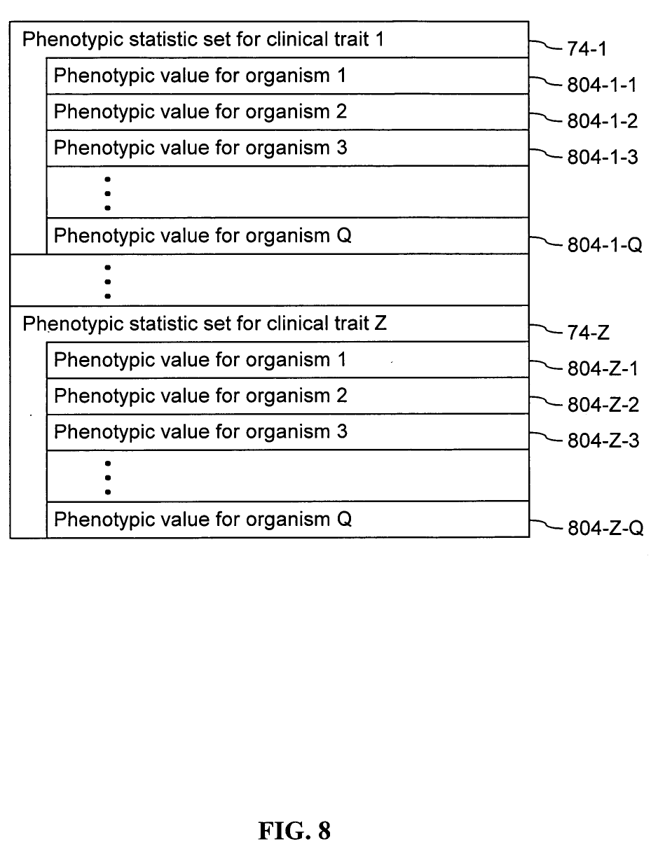

In some embodiments, a phenotypic statistic set 74 (plurality of phenotypic values) for the trait of interest serves as the clinical trait used in the QTL analysis. FIG. 8 illustrates exemplary phenotypic statistic sets 74 that are stored as phenotypic data 72 in memory 24 within system 10 (FIG. 1). In FIG. 8, each phenotypic statistic set 74 includes a phenotypic value 804 for a given phenotype for a each organism in a plurality of organisms under study. As used herein, a phenotypic value is any form of measurement of a phenotypic trait associated with the trait of interest (e.g., complex disease). For example, if the trait of interest is obesity, a suitable phenotypic trait could include cholesterol level in the blood of the organism. In such an example, the phenotypic value can be milligrams of cholesterol per liter of blood. More information on representative phenotypic data 72 is found in Section 5.13.1, below.

In one embodiment, processing step 704 comprises a classical form of QTL analysis in which a phenotypic trait is quantified to form a phenotypic statistic set. In some embodiments, processing step 704 employs a whole genome search of genetic markers using the genotypic data from step 702. For each genotypic position in the genome of the population that is analyzed by genetics analysis module 80, processing step 704 provides a statistical measure (e.g., statistical score), such as the maximum lod score between the genomic position and the phenotypic statistic set 74. Thus, processing step 704 yields all the positions in the genome of the organism of interest that are linked to (correlated with) the expression statistic set 74 tested. Such embodiments of processing step were described by Lander and Botstein in Genetics 121, 174-179 (1989), which is hereby incorporated herein by reference in its entirety. They are also described in International Application WO 90/04651, International Application WO 99/13107, Lander and Schork, Science 265, 2037-2048 (1994), and Doerge, Nature Reviews Genetics 3, 43-62, (2002), each of which is hereby incorporated herein by reference in its entirety. In other embodiments of processing step 704, association analysis, as described in Section 5.14 is used rather than linkage analysis.

In one embodiment of the present invention, the QTL analysis (FIG. 7, step 704) comprises: (i) testing for linkage between (a) the genotype of a plurality of organisms at a position in the genome of a single species and (b) the phenotypic statistic set 74 (e.g., plurality of phenotypic values), (ii) advancing the position in the genome by an amount, and (iii) repeating steps (i) and (ii) until all or a portion of the genome has been tested. In some embodiments, the amount advanced in each instance of (ii) is less than 100 centiMorgans, less than 10 centiMorgans, less than 5 centiMorgans, or less than 2.5 centiMorgans, or between 2.5 centiMorgans and 500 centiMorgans. A Morgan is a unit that expresses the genetic distance between markers on a chromosome. A Morgan is defined as the distance on a chromosome in which one recombinational event is expected to occur per gamete per generation. In some embodiments, the testing comprises performing linkage analysis (Section 5.13) or association analysis (Section 5.14) that generates a statistical score for the position in the genome of the single species. In some embodiments, the testing is linkage analysis and the statistical score is a logarithm of the odds (lod) score (Section 5.4). Thus, in some embodiments, a cQTL identified in processing step 704 is represented by a lod score that is greater than 2.0, greater than 3.0, greater than 4.0, or greater than 5.0.

In embodiments where more than one cross is considered in step 702, a separate phenotypic statistic set 74 is created for the progeny of each cross. For example, consider the case where the phenotypic value under consideration is plasma cholesterol level. Further, in this example, there are six founder strains and a total of fifteen crosses. In this example, fifteen phenotypic statistic sets 74 are constructed for plasma cholesterol level, one for the progeny of each of the fifteen strains. Then, a separate QTL analysis is performed with the progeny of each of the fifteen crosses. For each of these crosses, the phenotypic statistic set 74 associated with the cross is used as the quantitative trait in the QTL analysis. It will be appreciated that a large number of clinical traits can be considered. For each such clinical trait, measurements of the organisms 46 are made. Then, phenotypic statistic sets are created for each clinical trait considered. Further, as described above, in the case where there are multiple crosses, the phenotypic measurements from the progeny of each cross are used to form a respective phenotypic statistic set 74 that is associated with the cross.

In some embodiments, the progeny of each cross are subjected to a perturbation prior to phenotyping. In some embodiments, this perturbation is a drug treatment, variable diet and/or fasting/refeeding. Then, a phenotypic statistic set 74 is created from the progeny of the crosses prior to quantitative trait loci (QTL) analysis.

In the case where multiple QTL analyses are performed with the same trait, each such analysis corresponding to the progeny of a different cross in a plurality of crosses, there remains the task of combining the results of each such QTL analysis. For example, in the case where the phenotype is plasma cholesterol level and there are fifteen crosses in the population, fifteen QTL analyses are performed using plasma cholesterol as the quantitative trait, resulting in fifteen lod score curves across the genome of the species under consideration. In some embodiments, the lod score curves for the QTL overlapping in each of the crosses are combined in an additive fashion to assess the overall significance of the QTL over the different crosses. However, this type of method ignores the relationship between the crosses that exists if they share a common parent. For example, if you have two crosses constructed from three inbred lines of mice (so they share a common parent), then the progeny of each cross will share a larger percentage of alleles over the entire genome than would be expected by chance. By taking this relationship into account over the multiple crosses that are present in some embodiments of the present invention, a significant increase in the power to detect QTL, detect interactions between QTL, and detect interactions between QTL and environmental conditions is achieved.

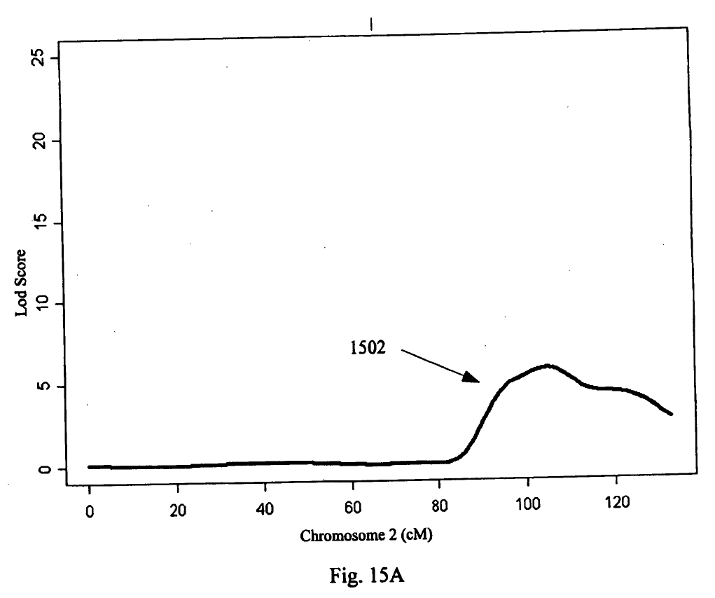

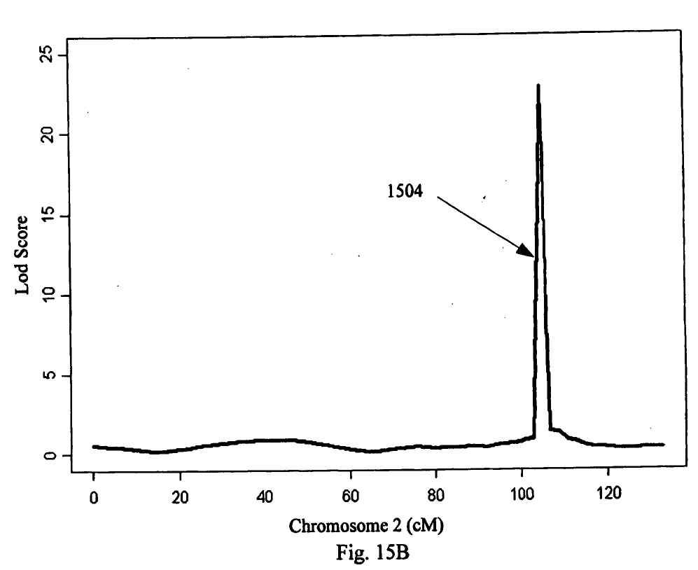

In one embodiment of the present invention, multiple lod score curves, where each curve represents a QTL analysis of the progeny of a different cross using a given quantitative trait, are simultaneously considered. However, rather than simply combining the lod score curves in an additive fashion, “identical by descent” (IBD) matrices are calculated. Such matrices assess the probability that any two animals from the different crosses have inherited a common allele at any given position in the genome. These IBD matrices are then used to appropriately weight the different distributions in the phenotype of interest that can arise when the phenotype is linked to (correlated with) a particular region in the genome. For example, regions that are likely to have inherited a common allele are downweighted relative to regions that are likely to have inherited from different alleles. FIG. 15 illustrates how mapping of QTL for clinical traits in a multi-cross environment in this way leads to significantly increased power to detect and localize quantitative trait loci. FIG. 15A represents a QTL analysis when the progeny of a single cross are considered. QTL 1502 in FIG. 15A is only a moderately significant linkage peak. Furthermore, QTL 1502 is broad and encompasses hundreds of genes, making identification of the genes that are causative of the clinical trait difficult. FIG. 15B represents a QTL analysis when the progeny of a plurality of crosses are considered simultaneously. QTL 1504 in FIG. 15B is a very significant linkage peak. Furthermore, QTL 1504 is much more narrow than peak 1502, containing tens of genes rather than hundreds of genes.

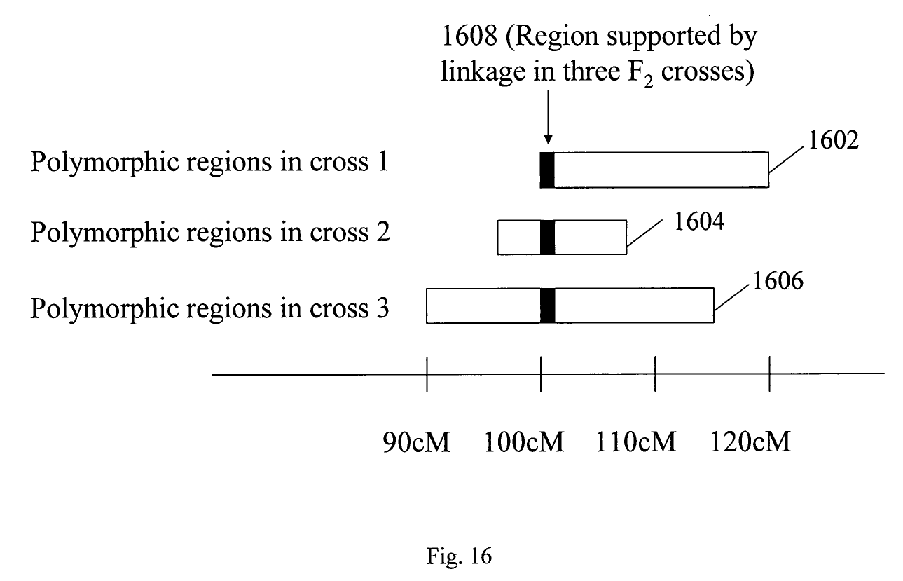

FIG. 16 illustrates how mapping of cQTL for clinical traits independently in the progeny of each cross in a plurality of crosses significantly increases the ability to identify genes underlying a given QTL. A different phenotypic statistic set 74 is constructed for the progeny of each of three crosses and these phenotypic statistic sets 74 are then separately subjected to QTL analysis using genotypic data from progeny of the respective crosses in order to identify cQTL in each of the three populations that link to the clinical trait represented by the three different phenotypic statistic sets 74. In more detail, the progeny of a first cross are phenotyped and genotyped and this information is compared using a first QTL analysis to find cQTL, the progeny of a second cross are phenotyped and genotyped and this information is compared using a second QTL analysis to find cQTL, the progeny of a third cross are phenotyped and genotyped and this information is compared using a third QTL analysis to find CQTL. In FIG. 16, the results of the three separate QTL analysis are shown for a particular portion of the genome of the species under study. Boxed regions 1602, 1604 and 1606 show the polymorphic regions (gene loci that exhibit more than one allele) of the genome in the region where QTL 1608 has been found by the respective QTL analyses. The fact that QTL 1608 is consistently in a polymorphic region in each of the crosses makes it more likely that the QTL is linked to (correlated with) the trait under study. Furthermore, differences in the boundaries of the polymorphic regions help localize where the genes underlying this QTL could be located (e.g., would be localized to a region that is polymorphic in all three strains).

The embodiments that follow in this paragraph apply to instances where the species under study are mice. Based on this disclosure, those of skill in the art will realize corresponding phenotypes that can be measured in other species and all such phenotypes are within the scope of the present invention. In some embodiments, the disease of interest is diabetes and/or insulin resistance and the phenotypes that are measured in step 704 include plasma glucose, plasma insulin, insulin glucose, and a glucose tolerance test (GTT). In some embodiments, the disease of interest is atherosclerosis, and the phenotypes that are measured in step 704 include aortic lesion and fatty streak (i. levels, ii. parafilm 5 μm section immunohistochemistry for several markers such as FLAP, 5LO, dendritic cells, T cells, CD11b mono infiltration, Brdu proliferation, apoptosis, iii. endothelial cells and macrophage function), brain lesion, vascular calcification, paraoxonase, osteopontin, and PAI-1. In some embodiments, the disease of interest is obesity, and the phenotypes that are measured in step 704 include body weight, anal-nasal length, fat pad weights (e.g., perimetrial fat pad mass, mesenteric omental fat pad mass, subcutaneous fat pad mass, and retroperitoneal fat pad mass), NMR fat mass, NMR muscle mass, leptin levels, food intake, liver weight, glucagon, adiponectin, and IGF-1. In some embodiments, the disease of interest is hypertension, and the phenotypes that are measured in step 704 include blood pressure, and response to angiotensin II. In some embodiments, the disease of interest is asthma and chronic obstructive pulmonary disease (COPD) and the phenotypes that are measured in step 704 include airway hyper-responsiveness with and without antigen challenge and airway hyper-responsiveness in mice exposed to smoke for a significant length of time. In some embodiments, the trait of interest is plasma lipase activity and the phenotypes that are measured in step 704 include lipoprotein lipase (LPL), hepatic lipase (HL), and endothelial lipase activity. In some embodiments, the trait of interest is plasma lipids and the phenotypes that are measured in step 704 include total cholesterol (TC), high-density lipoprotein cholesterol (HDL), very low density lipid lipoprotein/low density lipoprotein (VLDL/LDL), triglycerides, fatty acids, ketone bodies, lactate, LDL oxidation, and HDL protection. In some embodiments, the trait of interest is plasma cytokines and the phenotypes that are measured in step 704 include interleukin 6 levels, interleukin1-beta levels, tumor necrosis factor alpha/gamma (TNF-alpha/gamma), and interleukin 4 levels. In some embodiments, the phenotypes that are measured include monocyte isolation from plasma and ELISA or LC-MS for leukotrienes. In some embodiments, the disease under study is inflammation and the phenotypes that are measured in step 704 include EO6/MDA oxLDL ELISA, lipoprotein properties, macrophage/T cell interactions, and INF-gamma levels. In some embodiments, cardial related traits are of interest and the phenotypes that are measured in step 704 include heart/brain weight ratio, heart rate/femur length, cardiac fibrosis, and myocardial calcification. In some embodiments, bone traits are of interest and the phenotypes that are measured in step 704 include bone density (scans), femur CT BMD, total femur x-ray BMD, total femur x-ray BMC, femur CT-determined BMC, femur diaphyseal BMC, femur diaphyseal BMD, intertrochanteric BMC, intertrochanteric BMD, femur volume by CT, femur x-ray area, femur diaphyseal cortical thickness, femur width at the diaphysis, right and left femur length, right and left tibia length, right and left length of forepaw 1^{st}, 2^{nd}, 3^{rd}, 4^{th}, and 5^{th} digits, right and left humerus length, right and left radius length, right and left ulna length, femure width at the intertrochanteric region, femur fracture energy, stiffness of femur, and strength of femur.

Step 706. In step 706 cellular constituent abundance data 44 (e.g., from a gene expression study or a proteomics study) is obtained for a plurality of cellular constituents from one or more tissues in each member of the population under study. In some embodiments, cellular constituent abundance data 44 comprises the processed microarray images for each individual (organism) 46 in a population under study. For example, in one such embodiment, this data comprises, for each individual 46, cellular constituent abundance information 50 for each cellular constituent 48 represented on the array, optional background signal information 52, and optional associated annotation information 54 describing the probe used for the respective cellular constituent 48 (FIG. 1). See, for example, Section 5.8, below.

In various embodiments of the present invention, aspects of the biological state other than the transcriptional state, such as the translational state, the activity state, or mixed aspects can be measured and used as cellular constituent abundance data. See, for example, Section 5.9, below. For instance, in some embodiments, cellular constituent abundance data 44 is, in fact, protein levels for various proteins in the organisms 46 under study. Thus, in some embodiments, cellular constituent abundance data comprises amounts or concentrations of the cellular constituent in tissues of the organisms under study, cellular constituent activity levels in one or more tissues of the organisms under study, the state of cellular constituent modification (e.g., phosphorylation), or other measurements relevant to the trait under study.

In one aspect of the present invention, the expression level of a gene in an organism in the population of interest is determined by measuring an amount of at least one cellular constituent that corresponds to the gene in one or more cells of the organism. In one embodiment, the amount of the at least one cellular constituent that is measured comprises abundances of at least one RNA species present in one or more cells. Such abundances can be measured by a method comprising contacting a gene transcript array with RNA from one or more cells of the organism, or with cDNA derived therefrom. A gene transcript array comprises a surface with attached nucleic acids or nucleic acid mimics. The nucleic acids or nucleic acid mimics are capable of hybridizing with the RNA species or with cDNA derived from the RNA species. In one particular embodiment, the abundance of the RNA is measured by contacting a gene transcript array with the RNA from one or more cells of an organism in the plurality of organisms under study, or with nucleic acid derived from the RNA, such that the gene transcript array comprises a positionally addressable surface with attached nucleic acids or nucleic acid mimics, where the nucleic acids or nucleic acid mimics are capable of hybridizing with the RNA species, or with nucleic acid derived from the RNA species.

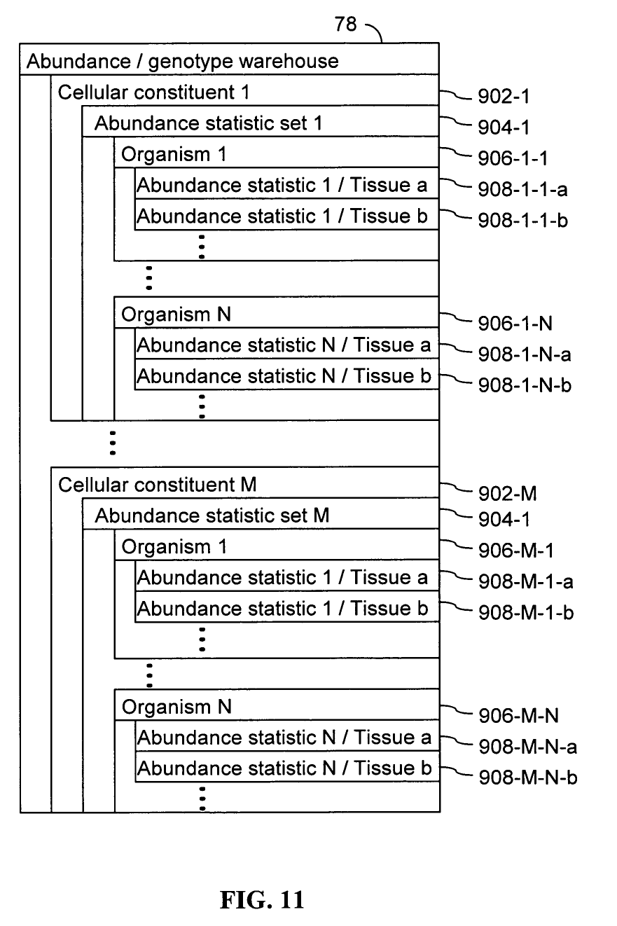

In some embodiments, cellular constituent abundance data 44 is taken from tissues that have been associated with a trait under study. For example, in one nonlimiting embodiment where the complex trait under study is human obesity, cellular constituent abundance data 44 is taken from the liver, brain, or adipose tissues. More generally, in some embodiments of the present invention, cellular constituent abundance data 44 is measured from multiple tissues of each organism 46 (FIG. 1) under study. For example, in some embodiments, cellular constituent abundance data 44 is collected from one or more tissues selected from the group of liver, brain, heart, skeletal muscle, white adipose from one or more locations, and blood. In such embodiments, the data is stored in a data structure such as data structure 78 of FIG. 11. This data structure is described in more detail below.

In some embodiments, particularly in embodiments where multiple crosses are simultaneously considered, each progeny mouse (and a number of parental and F1 mice) are extensively phenotyped by collecting multiple tissues from each such mouse for expression profiling. For example, tissue samples that can be collected for profiling include, but are not limited to, brain (possibly different brain parts), liver, white adipose tissue, skeletal muscle, heart, blood, kidney, lung, intestine, and stomach. In some embodiments, expression profiles for at least three of these tissues across some number of animals is performed. This rich set of clinical/biochemical phenotypes and gene expression traits over many tissues across multiple crosses allows for reconstruction of pathways involved in any of the clinical traits represented.

In some embodiments, once cellular constituent abundance data has been assembled, the data is transformed into abundance statistics that are used to treat each cellular constituent abundance in cellular constituent abundance data 44 as a quantitative trait. In some embodiments, cellular constituent abundance data 44 (FIG. 1) comprises gene expression data for a plurality of genes (or cellular constituents that correspond to the plurality of genes). In one embodiment, the plurality of genes comprises at least five genes. In another embodiment, the plurality of genes comprises at least one hundred genes, at least one thousand genes, at least twenty thousand genes, or more than thirty thousand genes. The expression statistics commonly used as quantitative traits in the analyses in one embodiment of the present invention include, but are not limited to the mean log ratio, log intensity, and background-corrected intensity. In other embodiments, other types of expression statistics are used as quantitative traits. In one embodiment, the transformation of cellular constituent abundance data 44 is performed using normalization module 72 (FIG. 1). In such embodiments, the expression levels of a plurality of genes in each organism under study are normalized. Any normalization routine can be used by normalization module 72. Representative normalization routines include, but are not limited to, Z-score of intensity, median intensity, log median intensity, Z-score standard deviation log of intensity, Z-score mean absolute deviation of log intensity calibration DNA gene set, user normalization gene set, ratio median intensity correction, and intensity background correction. Furthermore, combinations of normalization routines can be used. Exemplary normalization routines in accordance with the present invention are disclosed in more detail in Section 5.3, below. The expression statistics formed from the transformation are then stored in abundance/genotype warehouse 78, where they are ultimately matched with the corresponding genotype information.

Once cellular constituent abundance data has been transformed into corresponding expression statistics and a genetic marker map has been constructed, the data is transformed into a structure that associates all marker, genotype and expression data for input into QTL analysis software. This structure is stored in abundance/genotype warehouse 78.

Step 708. Given gene expression data for a specific tissue of interest in a population that has been genotyped and phenotyped with respect to a disease trait of interest, the next step is to identify all cellular constituents that are significantly associated with the disease trait. A variety of methods can be used to establish associations between cellular constituent abundance and clinical traits, including simple Pearson correlations, basic discriminant analysis, t-tests, and ANOVA, in order to identify those cellular constituent abundance values that discriminate the extremes of the clinical trait, as well as more advanced regression models that specifically assess relationships between cellular constituent abundance values and clinical traits. In some embodiments, only the cellular constituents that are differentially expressed in at least ten percent, at least twenty percent, or at least thirty percent of the organisms profiled are considered. Then, of these differentially expressed cellular constituents, only those cellular constituents whose abundance values across the population has a Pearson correlation coefficient (p-value) that is less than 0.00001, 0.0001, 0.001 or 0.01 with the trait of interest T, as exhibited by organisms profiled, are considered. The product of step 708 is a set of cellular constituents (association set D) whose abundance levels across the population under study significantly associate with the trait of interest.

To illustrate, consider the hypothetical cellular constituent A in a population of 100 organisms. If just one tissue is considered in this population, then there will be 100 abundance values for cellular constituent A, one from each of the 100 organisms. Likewise, there will be 100 measurements of the trait of interest (e.g., tail length), one for each of the 100 organisms. In step 708, then, the question is asked whether the 100 cellular constituent abundance values significantly correlate with the 100 trait measurement values. As indicated above, a statistical measure, such as the Pearson correlation coefficient between the abundance value and the Trait measurements, can be used. If a certain threshold correlation value or other metric is achieved, the cellular constituent is considered significantly associated with the trait.

In some embodiments, multiple crosses are considered simultaneously. For the purposes of step 708, the progeny of the multiple crosses can be treated as a single large population. So that, for example, if there are fifty organisms from a first cross and fifty organisms from a second cross, the combined total of 100 organisms is treated as a single population. Alternatively, the progeny of each cross can be considered independently. Thus, in the example where there are two crosses, each with fifty progeny, an independent determination can be made of the cellular constituents whose abundance levels significantly associate with the trait of interest. Then the test sets of cellular constituents that associate with the trait in the respective crosses can be combined. For instance, consider the case where cellular constituents A and B significantly associate with the trait in the progeny of a first cross and cellular constituents B and C significantly associate with the trait in the progeny of the second cross. In this instance, the sets can be combined such that step 708 realizes an association set D comprising cellular constituents A, B, and C. There are any number of rules that can be devised to combine the results when crosses are considered separately in step 708. The case of single addition (e.g., A, B, and C) has been presented above. Alternatively, only those cellular constituents that are significantly associated with the trait in all the crosses (or a majority of the crosses or some other percentage of the crosses) are placed in association set D.

Step 710. In step 710, a quantitative trait locus (QTL) analysis is performed using data corresponding to each cellular constituent i in association set D. For 1,000 cellular constituents, this results in 1,000 separate QTL analyses. In some embodiments of the invention, step 710 is performed by quantitative genetics analysis module 80 (FIG. 1). For embodiments in which multiple tissue samples are collected for each organism, this results in even more separate QTL analyses. For example, in embodiments in which samples are collected from two different tissues, an analysis of 1,000 cellular constituents can require 2,000 separate QTL analyses. In embodiments where multiple crosses are considered, the crosses are preferably considered in the QTL analysis as a single population. In one embodiment, each QTL analysis is performed by quantitative genetics analysis module 80 (FIG. 1). In one example, each QTL analysis steps through the genome of the organism of interest. Linkages to the gene under consideration are tested at each step or location along the length of the genome. In such embodiments, each step or location along the length of the chromosome is at regularly defined intervals. In some embodiments, these regularly defined intervals are defined in Morgans or, more typically, centiMorgans (cM). In other embodiments, each regularly defined interval is less than 10 cM, less than 5 cM, or less than 2.5 cM.

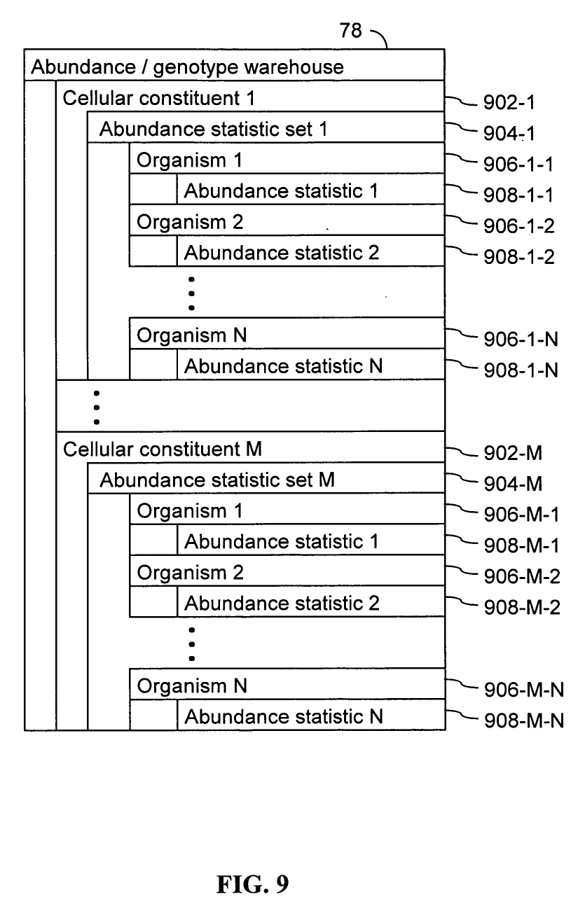

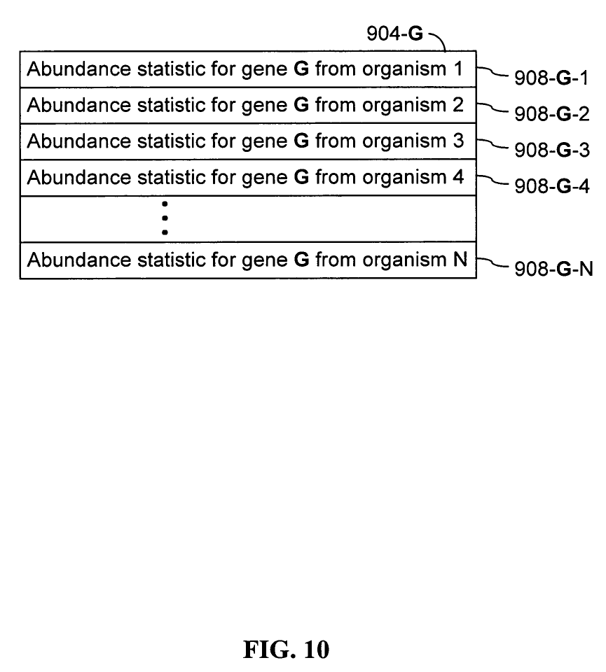

In each QTL analysis, data, corresponding to a cellular constituent selected from discriminating set D, is used as a quantitative trait. More specifically, for any given cellular constituent i, the quantitative trait used in the QTL analysis is an abundance statistic set such as set 904 (FIG. 9). Abundance statistic set 904 comprises the corresponding abundance statistic 908 for the corresponding cellular constituent 902 from each organism 906 in the population under study. FIG. 10 illustrates an exemplary abundance statistic set 904 in accordance with one embodiment of the present invention for the case in which abundance data from only one tissue type is considered and cellular constituent abundance is gene expression. The exemplary abundance statistic set 904 of FIG. 10 includes the abundance level 908 of a gene G (or cellular constituent that corresponds to gene G) from each organism in a plurality of organisms. For example, consider the case where there are ten organisms in the plurality of organisms, and each of the ten organisms expresses gene G. In this case, abundance statistic set 904 includes ten entries, each entry corresponding to a different one of the ten organisms in the plurality of organisms. Further, each entry represents the abundance level (e.g., expression level) of gene G in the organism represented by the entry. So, entry “1” (908-G-1) (FIG. 10) corresponds to the abundance level of gene G in organism 1, entry “2” (908-G-2) (FIG. 10) corresponds to the abundance level of gene G in organism 2, and so forth.

Referring to FIG. 11, in some embodiments of the present invention, abundance data from multiple tissue samples of each organism 906 (FIG. 1, 46) under study are collected. When this is the case, the data can be stored in the exemplary data structure illustrated in FIG. 11. In FIG. 11, a plurality of cellular constituents 902 are represented.

Further, there is an abundance statistic set 904 for each cellular constituent 902. Each abundance statistic set 904 represents an abundance of the corresponding cellular constituent in each of a plurality of organisms 906 (FIG. 1, 46).

In one embodiment of the present invention, each QTL analysis (FIG. 7, step 710) comprises: (i) testing for linkage between a position in a genome and an abundance statistic set 904 (plurality of abundance statistics 908), (ii) advancing the position in the genome by an amount (e.g., less than 100 cM, less than 5 cM), and (iii) repeating steps (i) and (ii) until the entire genome is tested. In some embodiments, testing for linkage between a given position in the genome and the abundance statistic set 904 comprises correlating differences in the abundance found in the abundance level statistic with differences in the genotype at the given position using single marker tests (for example using t-tests, analysis of variance, or simple linear regression statistics). See, e.g., Statistical Methods, Snedecor and Cochran, 1985, Iowa State University Press, Ames, Iowa, which is hereby incorporated herein by reference in its entirety. However, there are many other methods for testing for linkage between abundance statistic set 904 and a given position in the chromosome. In particular, if abundance statistic set 904 is treated as the phenotype (in this case, a quantitative phenotype), then methods such as those disclosed in Doerge, 2002, Mapping and analysis of quantitative trait loci in experimental populations, Nature Reviews: Genetics 3:43-62, may be used. Concerning steps (i) through (iii) above, if the genetic length of a given genome is N cM and 1 cM steps are used, then N different tests for linkage are performed.

In some embodiments, the QTL data produced from each respective QTL analysis comprises a logarithm of the odds score (lod) computed at each position tested in the genome under study. A lod score is a statistical estimate of whether two loci are likely to lie near each other on a chromosome and are therefore likely to be genetically linked. In the present case, a lod score is a statistical estimate of whether a given position in the genome under study is linked to (correlated with) the quantitative trait corresponding to a given gene. Lod scores are further defined in Section 5.4, below. In some embodiments, a lod score of 2.0 or more is generally taken to indicate that two loci are genetically linked. In some embodiments, a lod score of 3.0 or more is generally taken to indicate that two loci are genetically linked. In some embodiments, a lod score of 4.0 or more is generally taken to indicate that two loci are genetically linked. The generation of lod scores requires pedigree data 70. Accordingly, in embodiments in which a lod score is generated, processing step 710 is essentially a linkage analysis, as described in Section 5.13, with the exception that the quantitative trait under study is derived from data, such as cellular constituent expression statistics, rather than classical phenotypes such as eye color.

In situations where pedigree data is not available, genotype data 68 from each of the organisms 46 (FIG. 1) can be compared to each abundance statistic set 904 using allelic association analysis, as described in Section 5.14, below, in order to identify QTL that are linked to (correlated with) each expression statistic set 904. In one form of association analysis, an affected population is compared to a control population. In particular, haplotype or allelic frequencies in the affected population are compared to haplotype or allelic frequencies in a control population in order to determine whether particular haplotypes or alleles occur at significantly higher frequency amongst affected compared with control samples. Statistical tests such as a chi-square test are used to determine whether there are differences in allele or genotype distributions.

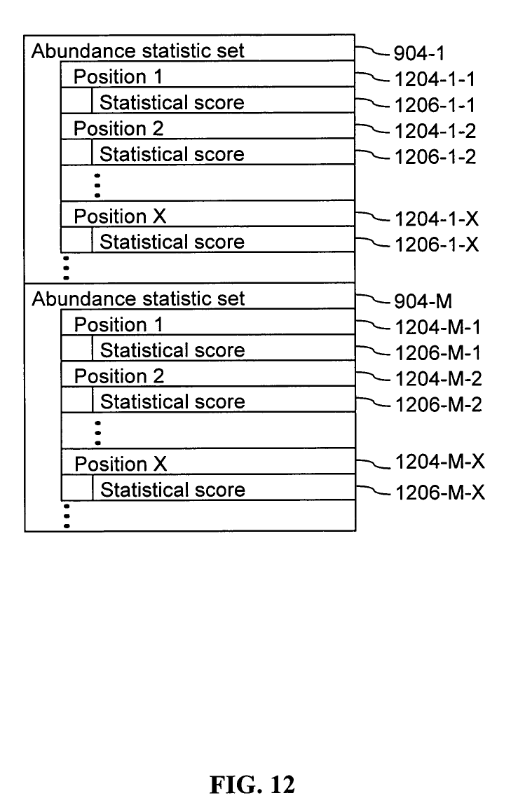

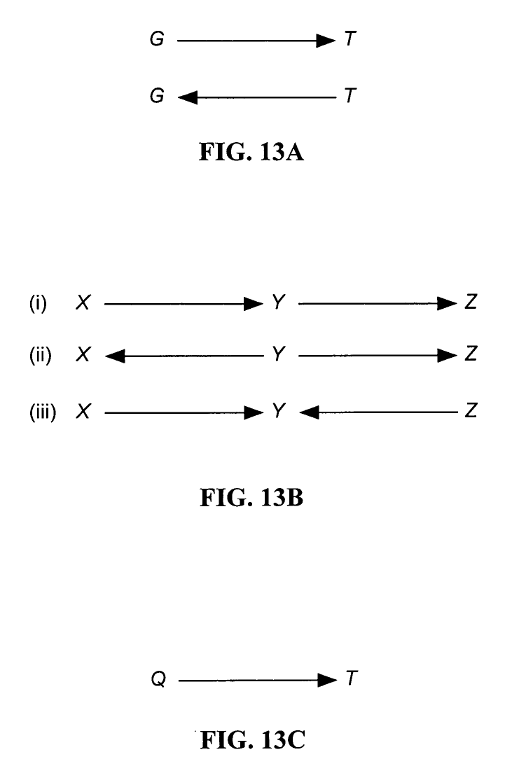

Regardless of whether linkage analysis or association analysis is used in step 710, the results of each QTL analysis can be stored in a QTL results database 1200 (FIG. 12). QTL results database 1200 can be stored in memory 24 of computer 24 (FIG. 1, not shown). For each abundance statistic set 904 (FIG. 9), QTL results database 1200 comprises all tested positions 1204 in the genome of the organism that were tested for linkage to the quantitative trait (expression statistic 904). For each position 1204, genotype data 68 provides the genotype at position 86 for each organism in the plurality of organisms under study. For each such position 1204 analyzed by quantitative genetic analysis in step 710, a statistical measure (e.g., statistical score 1206), such as the maximum lod score between the position and the abundance statistic 904, is listed. Thus, data structure 1200 comprises all the positions in the genome of the organism of interest that are genetically linked to (correlated with) each abundance statistic 904 tested.

Step 712. In step 712, those cellular constituents in association set D that do not have at least one eQTL coincident with at least one cQTL from step 704 form a candidate reactive cellular constituent set (FIG. 2, 206). In some embodiments, step 712 is performed by cQTL/eQTL overlap module 82 (FIG. 1). All cellular constituents in association set D that have at least one eQTL coincident with at least one cQTL from step 704 form a candidate causal cellular constituent set (FIG. 2, 204). In some embodiments, an eQTL is coincident with a cQTL when the eQTL and the cQTL colocalize within 40 cM of each other, within 30 cM of each other, within 20 cM of each other, within 10 cM of each other, within 3 cM of each other, or within 1 cM of each other in the genome of the species under consideration.

As an example of step 712, consider the case in which the phenotypic statistic set 74 is omental fat pad mass in a mouse population and that a QTL analysis in accordance with step 704 yields 5 cQTL with LOD scores over 2.0 located on chromosomes 1 at 111 cM, 5 at 90 cM, 6 at 43 cM, 9 at 8 cM, and 19 at 28 cM. All cellular constituents in association set D that form eQTL at any of these chromosomal locations will be placed in the causal candidate cellular constituent set (FIG. 2, 204). All cellular constituents in association set D that do not form eQTL at any of these chromosomal locations will be placed in the reactive candidate cellular constituent set (FIG. 2, 206).

Each cellular constituent in the candidate causal cellular constituent set gives rise to at least one eQTL that overlaps with at least one cQTL from step 704 (an eQTL/cQTL overlap). There are generally two reasons that two or more traits (here an eQTL and a CQTL) can be genetically correlated: 1) gametic phase disequilibrium (also known as linkage disequilibrium) and 2) a single gene affecting multiple traits (pleiotropy). In some embodiments of the present invention, in order for an eQTL and a cQTL to be coincident, the QTL associated with the position of the eQTL and cQTL must truly be common to the clinical and expression trait (due to a pleiotropic effect of a common QTL) rather than simply representing two closely linked QTL (due to linkage disequilibrium between two distinct QTL).

In some embodiments, a test for pleiotropy is performed. The pleiotropy test determines whether the eQTL linked to (correlated with) the trait under study and the cQTL linked to the cellular constituent under study are statistically indistinguishable QTL. In some embodiments of the present invention, this test is performed by pleiotropy module 84. In considering a test for pleiotropy in accordance with the present invention, let Y₁ and Y₂ represent quantitative trait random variables, with QTL Q₁ and Q₂ at positions p₁ and p₂, respectively. It is of interest to determine whether p₁=p₂, indicating a pleiotropic effect at the QTL for traits Y₁ and Y₂. Jiang and Zeng, 1995, Genetics 140, 1111, devised statistical tests to assess whether the positions are equal. A generalization of this test is implemented in some embodiment of step 714. Since the positions under consideration usually will be relatively close together on a given chromosome (e.g., within 20 cM), it is expected that Y₁ and Y₂ will be correlated, and so the most basic model for these traits under the control of a single, common QTL is formed as:

$$( \begin{matrix}{y}_{1} \\ {y}_{2}\end{matrix} ) = ( \begin{matrix}{μ}_{1} \\ {μ}_{2}\end{matrix} ) + ( \begin{matrix}{β}_{1} \\ {β}_{2}\end{matrix} ) Q + ( \begin{matrix}{ɛ}_{1} \\ {ɛ}_{2}\end{matrix} ) ,$$

where Q is a categorical random variable indicating the genotypes at the position of interest, and

$$( \begin{matrix}{ɛ}_{1} \\ {ɛ}_{2}\end{matrix} )$$

is distributed as a bivariate normal random variable with mean

$$( \begin{matrix}0 \\ 0\end{matrix} )$$

and covariance matrix

$$( \begin{matrix}{σ}_{1}^{2} & {σ}_{1} {σ}_{2} \\ {σ}_{2} {σ}_{1} & {σ}_{2}^{2}\end{matrix} ) .$$

The case where p₁=p₂ represents the null hypothesis of pleiotropy. The aim is to test this null against a more general alternative hypothesis that indicates p₁≠p₂. The alternative hypotheses of interest can be captured by the following model:

$$( \begin{matrix}{y}_{1} \\ {y}_{2}\end{matrix} ) = ( \begin{matrix}{μ}_{1} \\ {μ}_{2}\end{matrix} ) + ( \begin{matrix}{β}_{1} & {β}_{2} \\ {β}_{3} & {β}_{4}\end{matrix} ) ( \begin{matrix}{Q}_{1} \\ {Q}_{2}\end{matrix} ) + ( \begin{matrix}{ɛ}_{1} \\ {ɛ}_{2}\end{matrix} ) ,$$

where the εᵢ are distributed as for the pleiotropy model. The null hypothesis can be compared against any of a series of alternative hypotheses. The likelihoods for the two competing models (null hypothesis and alternative hypothesis) are easily formed, and maximum likelihood methods are then employed to estimate the model parameters (μᵢ, βⱼ, and σₖ). With the maximum likelihood estimates in hand, the likelihood ratio test statistic can be formed to directly test the null hypothesis against the alternative.

There are several alternative hypotheses that can be tested in this setting including: indicating closely linked QTL with no pleiotropic effects,

H_{A}:β₁≠0,β₄≠0,β₂=0,β₃=0,

indicating closely linked QTL with no pleiotropic effects,

H_{A}:β₁≠0,β₄≠0,β₂≠0,β₃=0,

indicating closely linked QTL with pleiotropic effects at the first position,

H_{A}:β₁≠0,β₄≠0,β₂=0,β₃≠0,

indicating closely linked QTL with pleiotropic effects at the second position, and

H_{A}:β₁≠0,β₄≠0,β₂≠0,β₃≠0,

indicating closely linked QTL with pleiotropic effects at both positions. Other null hypotheses and corresponding alternative hypotheses naturally follow from the general models presented here.

Thus, in embodiments where a pleiotropy test is applied, each cellular constituent in the candidate cellular constituent has at least one eQTL that is coincident with a respective cQTL for the trait of interest, where the at least one eQTL passes a test for pleiotropy with the respective cQTL. In some embodiments, the pleiotropy test is optional.

Step 716. In step 716, the cellular constituents in the candidate causative cellular constituent set are optionally ranked ordered based upon the amount of genetic variation in the trait of interest that is explained by the eQTL of the cellular constituent that are coincident with cQTL from the trait of interest. More specifically, for each cellular constituent i in the candidate causative cellular constituent set, a determination is made as to the amount of genetic variation in the trait of interest that is explained by the eQTL of the respective cellular constituent i coincident with the cQTL from the trait of interest. Then, the cellular constituents in the candidate causative cellular constituent set are rank ordered based upon the amount of genetic variation in the trait of interest that is explained by each cellular constituent determined in this manner.

To illustrate, consider the case in which the trait of interest produces five cQTL. Further, a cellular constituent i in the candidate causative cellular constituent set has five eQTL. Four of the eQTL overlap with four of the cQTL for the trait of interest. However, only three of the eQTL pass the test for pleiotropy. In this example, only the three eQTL that are coincident with respective cQTL for the trait of interest and that pass the test for pleiotropy described in step 712, above, are used to determine how well they explain the genetic variation in the trait of interest. Thus, in the example, if the first of the three qualifying eQTL explains ten percent of the genetic variation in the trait of interest, the second of the three qualifying eQTL explains twenty percent of such genetic variation, and the third eQTL explains thirty percent of such genetic variation, the three eQTL, together, explain sixty percent of the genetic variation in the trait of interest.

In some embodiments, the determination as to how much the qualifying eQTL of a given cellular constituent explain the genetic variation in the trait of interest is performed using a joint analysis of the trait of interest at each of the qualifying coincident eQTL. This joint analysis leads to a lod score as described by Jiang and Zeng, 1995, Genetics 140, p. 1111 and applied by Schadt et al., 2003, Nature 422, p. 297, to gene expression traits. Then, cellular constituent can be rank ordered based on their lod scores.

Step 718. Steps 702 through 712 define a candidate causative cellular constituent set. Each cellular constituent in this candidate causative cellular constituent set is linked to at least one eQTL that colocalizes with a respective cQTL where, in turn, the respective cQTL is linked to the trait or traits of interest. Thus, the quantitative genetic analysis of steps 704 and 712 define at least one locus in the genome of a species for each cellular constituent in the candidate causative cellular constituent set. In other words, for each respective cellular constituent i in the candidate causative cellular constituent set, there is at least one locus in the genome of the species under study that is a site of colocalization for both (i) a cQTL that is linked to the trait or traits under study and (ii) an eQTL that is linked to the respective cellular constituent i. Step 718 considers each of the loci Q in the at least one locus associated with each respective cellular constituent i in the candidate causative cellular constituent set using a novel causality test in order to determine whether the respective cellular constituent i is causal for the trait or traits of interest.

Step 718 tests the cellular constituents in the candidate causative cellular constituent set in a manner that is independent of the pleiotropy test of step 712. The pleiotropy test is designed to determine whether a cQTL and an eQTL that colocalize to a locus Q in the genome of the species under study are truly coincident (a single QTL, in which case the pleiotropy test is satisfied) or whether they are two closely linked QTL (in which case the pleiotropy test fails). In order to run the causality test of step 718 on a given locus (e.g., the site of colocalization of an eQTL and a cQTL) in the genome of the species under study, the cQTL and eQTL must be a single QTL Q, as opposed to two closely linked QTL. In this regard, the pleiotropy test of step 712 can serve as an important validation that a given locus Q is a requisite site of colocalization of an eQTL and a cQTL. However, the pleiotropy test does not always give unambiguous results. Moreover, as will be discussed in further detail below, the causality test itself can be used to help determine whether two traits are driven by (e.g., linked to) a common QTL. For these reasons, the pleiotropy test of step 712 is optional.

In some embodiments of the present invention, step 718 is performed by causality test module 88. Step 718 applies a causality test that, in one embodiment, serves to determine whether the genetic variation in each eQTL of a given cellular constituent that is coincident with a cQTL of a trait of interest is correlated with the variation in the trait of interest conditional on an abundance pattern of the cellular constituent i in the plurality of organisms.

Specific tests can be developed to identify the true relationship between QTL (O), cellular constituent abundance (G) and disease trait (7) from the set of possible relationships depicted in FIG. 3A where the QTL (O) is the site of colocaliation of a cQTL and an eQTL. However, to maximize the information that can be derived from the genetics and expression data, the causality test used in step 718 is best considered in the context of scenario 310 of FIG. 3A. Scenario 310 represents the situation where a cellular constituent (e.g., gene) is under the control of multiple disease QTL and is still causative for the disease, thereby providing maximal causal information relating to the disease under study.

The aim of the causality test is to distinguish between the relationships that indicate a cellular constituent is causal for the clinical trait (scenarios 302, 308, and 310 of FIG. 3A) from those that are reactive to, or independent of the disease trait (scenarios 304 and 306, respectively, of FIG. 3A). The test for causality involving QTL, cellular constituent abundance (e.g., gene expression) and disease trait data is based on the same conditional probabilities that underlie mutual information measures that form the basis of the more general Bayesian network reconstruction problems. See, for example, Pearl, 1983, Probablistic Reasoning in Intelligent Systems: Networks of plausible Inference, Morgan Kaufman Publishers, Inc., San Francisco, which is hereby incorporated herein by reference in its entirety. The causality test assesses whether the QTL (O) and the disease trait (T) are correlated conditional on the cellular constituent abundance trait (G).

Genetic linkages for disease and cellular constituent abundance traits give rise to information on causality, thereby restricting the number of relationships to consider since they establish sub-relationships with absolute certainty (e.g., it is known that Q causes variations in G and T). In accordance with the present invention, this restriction allows for a robust, statistical test to determine whether scenarios 302, 308, and 310 of FIG. 3A hold over the relationships given by scenarios 304 and 306. Since the test begins with data that indicate G and T are partially under the control of a common QTL Q (because G has an eQTL that colocalizes with locus Q and T has a cQTL at that colocalizes with locus Q), the problem is significantly simplified over that of the classic network reconstruction problem, where positioning G with respect to T would require additional traits related to G and T. If one started with no a priori information on causality between the traits, the exact relationship could not be unambiguously identified without additional experimentation. See, for example, Pearl, 1983, Probablistic Reasoning in Intelligent Systems: Networks of Plausible Inference, Morgan Kaufman Publishers, Inc., San Francisco.

If it is assumed that traits T and G are jointly distributed as a bivariate normal random variable with a common QTL between them, then a determination can be made as to whether the following relationship holds:
P(T,Q*|G)=P(T|G)P(Q*|G),
where Q* a genotype random variable for locus Q of said one or more loci across a plurality of organisms under study and the P's represent probability density functions and, by definition,

$$P ( T , {Q}_{*} \text{\vert} G ) = \frac{P ( T , {Q}_{*} , G )}{P ( G )}$$

$$P ( T \text{\vert} G ) = \frac{P ( T , G )}{P ( G )} = \frac{P ( G \text{\vert} {Q}_{*} ) P ( {Q}_{*} )}{P ( G )} and$$

$$P ( {Q}_{*} \text{\vert} G ) = \frac{P ( {Q}_{*} , G )}{P ( G )}$$

Here, P(T,Q*|G) is read, “the probability of T and Q* given G.” This relationship P(T,Q*|G)=P(T|G)P(Q*|G), indicates that even though T and Q* can be significantly correlated (this holds by definition for a QTL), conditioning on relative abundances G leads to functional independence between Q* and T, as was noted in the example for FIG. 3C. If this relationship holds, then it can be concluded that the information passed from Q to disease trait T is via G, which supports G as being causal for T. See, for example, Pearl, 1983, Probabilistic Reasoning in Intelligent Systems: Networks of Plausible Inference, Morgan Kaufman Publishers, Inc., San Francisco, Section 3.1.2, which is hereby incorporated herein by reference in its entirety. If G, Q* and T are not independent (e.g., P(T,Q*|G)≠P(T|G)P(Q*|G),), then one of the relationships given in scenarios 304 and 306 more likely holds (the relationships in these figures can be tested in a like manner). Conditional independence is tested by first forming the likelihood functions based on the conditional probabilities discussed above, for the two competing hypotheses: 1) the null hypothesis that T and Q are independent given G (G is causal for T), and 2) the alternative hypothesis that T and Q are dependent given G (G is not causal for T). The likelihood functions can then be maximized with respect to the parameters of the underlying genetic model, and the likelihood ratio test statistic formed, which in the present case, under the null hypothesis, would be chi-square distributed with two degrees of freedom. For more information on the likelihood functions and likelihood ratio statistics used, see Section 5.5, below.

In one embodiment, the correlation between T and Q* is considered in terms of a LOD score. Significant correlation between T and Q* is consistent with a significant LOD score for T at position Q. After conditioning on the gene expression trait G, the causality test determines whether there is still a significant LOD score for T at Q. If the LOD score for the QTL drops to zero (e.g., is statistically indistinguishable from zero) after conditioning on G, this indicates G effectively blocks transmission of the information from the QTL to the trait, indicating that scenario 302 (FIG. 3A) is the more likely explanation of the relationship between T and G (or one of the variants given in scenarios 308 or 310 of FIG. 3A). While this form of the null hypothesis given above has interesting statistical issues to consider, given causality is assumed under the null hypothesis, it is consistent with the traditional null hypothesis of linkage analysis that a given trait is not linked to a particular locus under consideration.

Those cellular constituents in the candidate causative cellular constituent set in which the null hypothesis of causality is accepted for all of their associated eQTL overlapping with (coincident with) cQTL represent the strongest set of causal candidates for the trait of interest.

In another embodiment, models 302 (causative), 304 (reactive), and 306 (independent) of FIG. 3A are compared directly using a maximum likelihood approach. In this approach, for each model (independent, causative and reactive), the following likelihoods are formed based on the relationships depicted in the model:
model 302 (causative) P(Q*,G,T)=P(G|Q*)P(T|G)
model 304 (reactive) P(Q*,G,T)=P(T|Q*)P(G|T)
model 306 (independent) P(Q,G,T)=P(T|Q*)P(G|Q*)
where, as in FIG. 3A, Q is the DNA locus controlling cellular constituent levels and/or clinical traits, Q* is a genotype random variable for a locus Q across a population of organisms under study, G is cellular constituent level, and T is clinical trait. The likelihoods are then maximized with respect to the model parameters, given the genotypic data 68, cellular constituent abundance data 44, and phenotype data 72 (FIG. 1) for the trait (or traits) of interest. These maximum likelihood values are then compared using standard techniques, where the model giving rise to the largest likelihood is declared the best model.

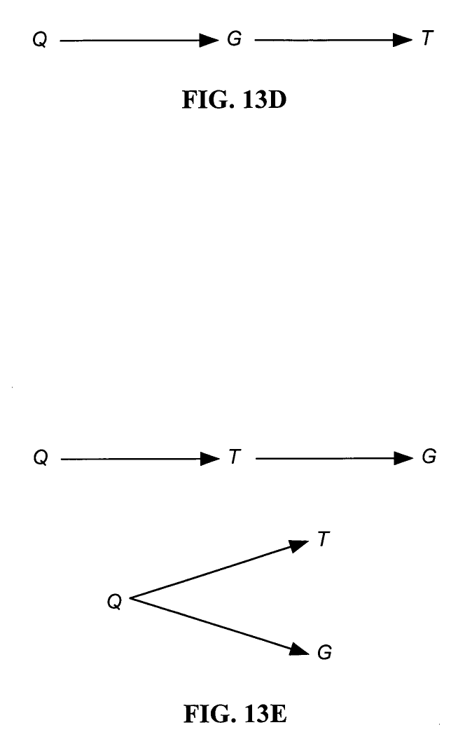

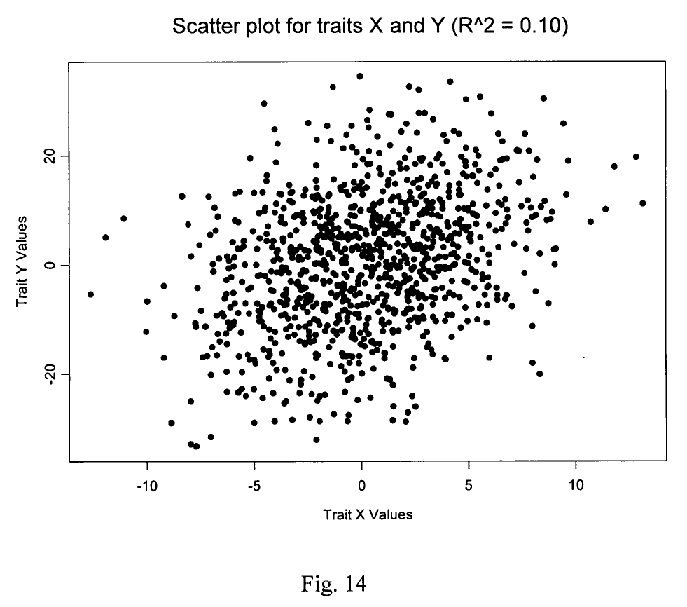

To illustrate, consider the case in which a particular trait, say X, in which 3.3 percent of the trait's variation is explained by a single QTL. Let Y be another trait such that X is partially causal for Y but the QTL that explains 3.3 percent of X's variation only explains 1.1% of Y's variation in a given population. Further, the coefficient of determination between X and Y is only 0.1 (so ten percent of Y's variation is explained by the variation in X). FIG. 14 gives the scatter plot for these two traits. Clearly, if X and Y were expression or clinical traits, the degree of association between X and Y here would not be striking and, in fact, would most likely be missed using conventional techniques such as agglomerative hierarchical clustering of the data.

Table 1 below gives the Akaike Information Criterion (AIC) for three models in this case (the AIC value is defined as −2 times the loglikelihood added to two times the number of parameters in the model). The AIC is used to select the “best” model from a list of theoretical functions. See, for example, Akaike Information Criterion Statistics Mathematics and Its Applications, Japanese Series, Sakamoto et al., D. Reidel Pub. Co., January 1987, which is hereby incorporated herein by reference in its entirety. The model with the smallest AIC value represents the model that best fits the data and therefore has the highest likelihood given the data.

TABLE 1

| | AIC for model | | |
|---|---|---|---|
| LOD scores | 306 | AIC for model | AIC for model |
| (X/Y) | (independent) | 302 (causal) | 304 (reactive) |
| 7.3/2.4 | 13354.5 | 13254.3 | 13276.8 |

From Table 1, it can be seen that causality model 302 provides the best fit to the data, as would be expected given the hypothetical data. Next, a determination is made as to whether the difference in AIC values is statistically significant. Differences between AIC values essentially represent a likelihood ratio test statistic with one degree of freedom (in this case). These statistics are chi-square distributed when the models are nested, so if this were the case here, then the p-value associated with the difference in AIC values between the causal and reactive model would be 0.000002 (indicating statistical significance). However, the models in the hypothetical case are not nested, and so the standard likelihood ratio test theory does not strictly apply but can be used as an approximate test to determine whether the AIC values are statistically significant.

Permutation testing can also be used to assess the significance of the AIC differences. If the trait values are permuted in a way that maintains the correlation between them, but randomizes them with respect to the genotypes, an assessment can be made as to whether the observed differences are as big as those observed from the actual data. In this present example, 1000 permutations were tested and in no case was the difference between the causal and reactive models as large as it is in Table 1. This example demonstrates the power of the new causality test. It is effectively able to identify a strong causal relationship between two traits that were only moderately associated and weakly linking to a common QTL.

To further highlight the utility consideration of genotypic information 68 (FIG. 1) brings in resolving this causal relationship between these moderately associated traits, the genotypes were randomized at the locus to which the two traits link. This effectively destroys the genetic association between the traits and the locus. The resulting AIC values for each of the models is given in Table 2:

TABLE 2

| | AIC for model | | |
|---|---|---|---|
| LOD scores | 306 | AIC for model | AIC for model |
| (X/Y) | (independent) | 302 (causal) | 304 (reactive) |
| 7.3/2.4 | 13397.9 | 13287.0 | 13287.5 |

Interestingly, the causal and reactive models were significantly better than the independent model, indicating the models were still able to capture the correlation structure between the traits (so randomizing the genotypes does not affect the correlation structure between the two traits), but the AIC values for the causal and reactive models are now statistically equivalent. That is, the causality between these associated traits can no longer be established because the genotypic information was destroyed.

To demonstrate how this procedure can also be used to discriminate between traits related in a causal/reactive way from those related in an independent way (e.g., linked to the same QTL but otherwise independent), a data set for traits Q and Z, where both traits are strongly linked to the same QTL, but are otherwise independent, was tested using the inventive procedure. The results of the analysis are given in Table 3. Here, despite traits Q and Z being very strongly linked to the same locus, with trait Q significantly more strongly linked to the locus, the independent model fits the data much better than the other two alternatives:

TABLE 3

| | AIC for model | | |
|---|---|---|---|
| LOD scores | 306 | AIC for model | AIC for model |
| (Q/Z) | (independent) | 302 (causal) | 304 (reactive) |
| 37.8/21.5 | 9202.8 | 9288.5 | 9361.1 |

Different likelihood models (causative, reactive, and independent) that are designed to discriminate between causal, reactive and independent relationships between two or more traits have been presented. Further, it was noted in step 712 that an optional pleiotropy test is performed to determine whether two traits are linked to a single QTL or whether they are driven by two independent QTL. However, in some embodiments, the likelihood models of step 718 can be used to make such a determination. For instance, if two traits test as strongly causal or reactive with respect to one another, this indicates that the traits are driven by a single QTL. If the traits are in fact driven by two closely linked, independent QTL, then the causality test would indicate that the independent model is best because the traits would not test as strongly causal or reactive. So, if the tests indicated causality or reactivity, then you could also conclude that the two traits were driven by the same QTL. The would hold even if the pleiotropy test currently described in the application could not distinguish whether it was two QTL or one (because the pleiotropy test is dependent on QTL position and the extent of recombination between the two QTL, whereas the causality test is based on correlation between the two traits). If the causality test of step 718 indicates that the independent model is preferred, then you would not be able to tell whether it was one or two QTL driving the two traits. In such instances, the optional pleiotropy test of step 712 could be used.

Maximum likelihood approaches to discriminating between causal, reactive, and independent relationships between two or more traits (e.g., T and G) have been presented in step 718. Further, in step 714 a pleiotropy test for determining whether two traits (e.g., T and G) that appear to be linked to (correlated with) a single QTL are driven by a single QTL, or whether they are driven by two independent QTL is provided. However, in many instances the causality test can be used directly to determine the relationship between two or more traits.

The causality test can be applied to any pair of traits that are linked to (correlated with) a common QTL. The case in which one trait is a phenotype T associated with a disease of interest and the other trait is variance in abundance of a cellular constituent G has been described. In that case, there was a cQTL linked to the variance in the phenotypic trait T in a population under study, an eQTL that linked to the variance in the abundance of the cellular constituent G in the population such that the cQTL and eQTL colocalized at loci Q. The causality test was of the form:
P(T,Q*|G)=P(T|G)P(Q*|G),
In other words, if conditioning on relative abundances G leads to functional independence between Q* and T, it can be argued that G is causal for T.

However, the causality test is not limited to the traits G and T. In other words, there is no requirement that one of the traits considered by the causality test be for variance in cellular constituent abundance and the other trait be variance in a phenotypically observable trait (e.g. an obesity index). The causality test can be more generally applied to any two traits so long as there is some common QTL that genetically links with both traits. Accordingly, in the case of Q and T presented above, where Q and T are linked to a QTL Q, the causality test can also be used to determine whether T is causal for G:
P(G,Q*|T)=P(G|T)P(Q*|T)
Thus, using the causality test, a determination can be made as to whether T is causal for G and whether G is causal for T. If two traits test as strongly causal or reactive with respect to one another, this argues that that the traits are driven by a single QTL (model 302 or 304 of FIG. 3A). If the traits were in fact driven by two closely linked, independent QTL, then the causality test would indicate that the independent model (model 306) was best. In other words they would not test as strongly causal or reactive.

The following table details how the causality test, used in conjunction with the pleiotropy test presented in step 712 can determine whether the causative model (model 302), reactive model (model 304), or independent model (model 306) describes two traits (X and Y) with respect to a QTL Q to which the two traits are linked

| MODEL | CAUSALITY TEST | PLEIOTROPY TEST |
|---|---|---|
| X causal | X causal for Y | Test is either satisfied, indicating |
| for Y (302) | Y reactive for X | that Q is a single QTL that drives |
| | Indicates that Q is a | multiple traits (X and Y) or the |
| | single QTL | test fails to determine whether Q |
| | | drives X and Y as one QTL or two |
| | | closely linked QTL (because the |
| | | test is dependent on QTL position |
| | | and the extent of recombination |
| | | between the two QTL) |
| X reactive | X reactive for Y | Test is either satisfied, indicating |
| to Y (304) | Y causal for X | that Q is a single QTL that drives |
| | Indicates that Q is a | multiple traits (X and Y) or the |
| | single QTL | test fails to determine whether Q |
| | | drives X and Y as one QTL or two |
| | | closely linked QTL (because the |
| | | test is dependent on QTL position |
| | | and the extent of recombination |
| | | between the two QTL) |
| X and Y | X and Y do not test as | Test fails, indicating that Q is in |
| independent | strongly causal or | fact two closely linked QTL |
| | reactive with respect | (model 306 of FIG. 3a) |
| | to each other; unclear | |
| | as to whether Q is a | |
| | single QTL or closely | |
| | linked QTL | |

Step 720. In optional step 720, a determination is made as to whether the cellular constituents in the candidate causative cellular constituent set are druggable. Hopkins and Groom, 2002, Nature Reviews 1, p. 727 provide one definition of a druggable target. To develop a definition of a druggable genome, Hopkins and Groom identified the molecular targets to rule-of-five compliant compounds. As put forth by Lipinski et al., 1997, Adv. Drug Deliv. Rev. 23, 3, a rule-of-five compliant synthetic compound (e.g., compounds other than those derived from natural products) has less than five hydrogen-bond donors, the molecular mass of the compound is less than 500 Daltons, the lipophilicity is less than 5, and the sum of the nitrogen and oxygen atoms is less than 10. A thorough review of the literature by Hopkins and Groom identified 399 non-redundant molecular targets that have been shown to bind rule-of-five compliant compounds with binding affinities below 10 μM. Next, Hopkins and Groom took the drug-binding domains of the 399 non-redundant molecular targets and determined the families that they represent, as captured by their InterPro domain (Hopkins and Groom, 2002, Nature Reviews 1, p. 727; Apweiler et al., 2001, Nucleic Acids Res. 29, 37). A total of 130 protein families represent the 399 non-redundant molecular targets. These protein families are provided in the online supplemental information for Hopkins and Groom, 2002, Nature Reviews Drug Discovery 1, p. 727 at www.nature.com/reviews/drugdisc and include G-protein coupled receptors, serine/threonine and tyrosine protein kinases, zinc metallo-peptidases, serine proteases, nuclear hormone receptors and phosphodiesterases. Thus, in one embodiment of the present invention step 720 comprises determine whether each cellular constituent in the candidate causative cellular constituent set includes a druggable domain as defined by Hopkins and Groom.

Other methods for defining whether a given cellular constituent includes a druggable domain are available and any such definition can be used in optional step 720. For example, in a comprehensive review of the accumulated portfolio of the pharmaceutical industry, Drews, 1996, Nature Biotechnol. 14, 1516 and Drews and Ryser, 1997, Nature Biotechnol. 15, 1318 identified 483 molecular targets and concluded there could be 5,000-10,000 potential targets on the basis of an estimate of the number of disease related genes. See, Drews, 2000, Science 287, 1960. Thus, in one embodiment of the present invention, the molecular targets identified by Drews are considered the class of cellular constituents that have a druggable domain. In still another embodiments of the present invention, the class of cellular constituents that have a druggable domain are any cellular constituents that are the molecular target of any drug product that has been approved under section 505 of the United States Federal Food, Drug, and Cosmetic Act.

Step 722. In optional step 722, the cellular constituents in the candidate causative cellular constituent set are ranked and filtered based on the rank assigned in step 716 and and/or the results of steps 718 and 720. A purpose of optional step 722 is to reduce the number of cellular constituents under consideration as molecular targets of a therapeutic drug discovery program directed at alleviating the trait under study. As such, optional ranking step 722 serves to prioritize the cellular constituents and/or filter out cellular constituents from the candidate causative cellular constituent set. In some embodiments, for example, the only cellular constituents that are allowed to remain in the candidate causal cellular constituent set are those cellular constituents that (i) are highly ranked in step 716 (ii), have the null hypothesis of causality accepted in step 718 for all their associated eQTL that overlap a trait cQTL, and, optionally, (iii) have a druggable domain as determined by step 720. In some representative embodiments, a high rank means within the top 300, top 200, top 20%, or top 10% of the cellular constituents in the candidate causal cellular constituent set.

Step 724. The preceding steps describe an analysis of a candidate causal cellular constituent set in order to identify cellular constituents that are causal for a trait of interest. However, the causality test of step 718 can easily be rewritten to determine whether (i) each eQTL, linked to a trait of interest T, and (ii) a cellular constituent in the candidate causal cellular constituent set, are correlated conditional on the disease trait in the plurality of organisms. Thus, in addition to determining whether a cellular constituent is causal for a trait (as depicted in FIG. 13D), the methods of the present invention can be used to determine whether a cellular constituent is reactive to a trait of interest T (first graphical relationship given in FIG. 13E). Further, the causality test of step 718 can easily be rewritten to determine whether (i) the trait of interest T, and (ii) a cellular constituent in the candidate causal cellular constituent set are correlated conditional on the QTL common to both traits. This last test determines whether a QTL common to the trait of interest T and cellular constituent trait drives each of the traits independently, so that the cellular constituent trait is neither causal nor reactive to the trait T of interest (second graphical relationship given in FIG. 13E). Information on which genes are causal and which genes are reactive for a trait of interest can be used to reconstruct a genetic network using Bayesian analysis.

Section 5.10, below, outlines methods that can be used to validate the hypothesis that certain cellular constituents are either causal or reactive to a trait of interest. Further, multivariate analysis can be used to determine whether such cellular constituents act in concert, in the form of a biological pathway, in order to affect the trait under study. In one embodiment in accordance with the present invention, the degree to which each high ranking cellular constituent makes up a candidate pathway group that affect the trait of interest (or are affected by the trait of interest) is tested by fitting a multivariate statistical model to the eQTL of the high ranking cellular constituents. Multivariate statistical models have the capability to consider multiple quantitative traits simultaneously, model epistatic interactions between the QTL and test other interesting variations that test whether a group of cellular constituents belong to the same or related biological pathway. Specific tests can be done to determine if the traits under consideration are actually controlled by the same QTL (pleiotropic effects) or if they are independent.

Importantly, multivariate statistical analysis can be used to simultaneously consider multiple traits. This is of use to determine whether the traits are genetically linked to each other. Accordingly, in such embodiments, the eQTL of high ranking cellular constituents can be subjected to multivariate statistical analysis in order to determine whether the QTL are all genetically linked. Such an analysis can determine that some of the QTL in the cluster found in the QTL interaction map are, in fact, linked whereas other QTL in the cluster are not linked.

Multivariate statistical analysis can also be used to study the same trait from multiple tissues. Multivariate statistical analysis of the same trait from multiple tissues can be used to determine whether genetic linkage varies on a tissue specific basis. Such techniques are of use, for example, in instances where a complex disease has a tissue specific etiology. Exemplary multivariate statistical models that can be used in accordance with the present invention are found in Section 5.6, below.

### 5.1.1. Alternative Embodiments

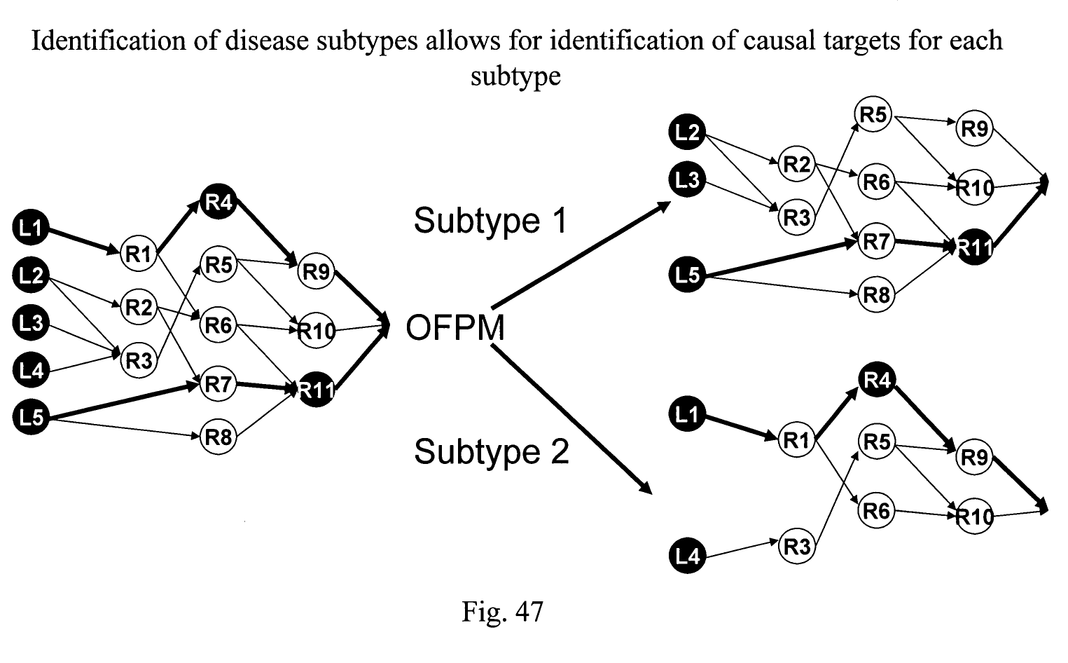

In some embodiments of the present invention, the population under study is subdivided before performing steps 708 through 724 using the methods disclosed in copending application PCT/US03/15768, filed May 20, 2003, entitled “Computer Systems and Methods for Subdividing a Complex Disease Into Component Diseases,” U.S. provisional Patent Application Ser. No. 60/460,304, filed Apr. 2, 2003, entitled “Computer Systems and Methods for Subdividing a Complex Disease Into Component Diseases,” and U.S. provisional Patent Application Ser. No. 60/382,036, filed May 20, 2002, entitled “Computer Systems and Methods for Subdividing a Complex Disease Into Component Diseases,” each of which is hereby incorporated herein by reference in its entirety Such a process is illustrated in FIG. 47 and discussed in Sections 5.1.1.1 and 5.1.1.2 below. Then, steps 708 through 724 are performed on each identified subpopulation.

### 5.1.1.1. Subdividing First Embodiment

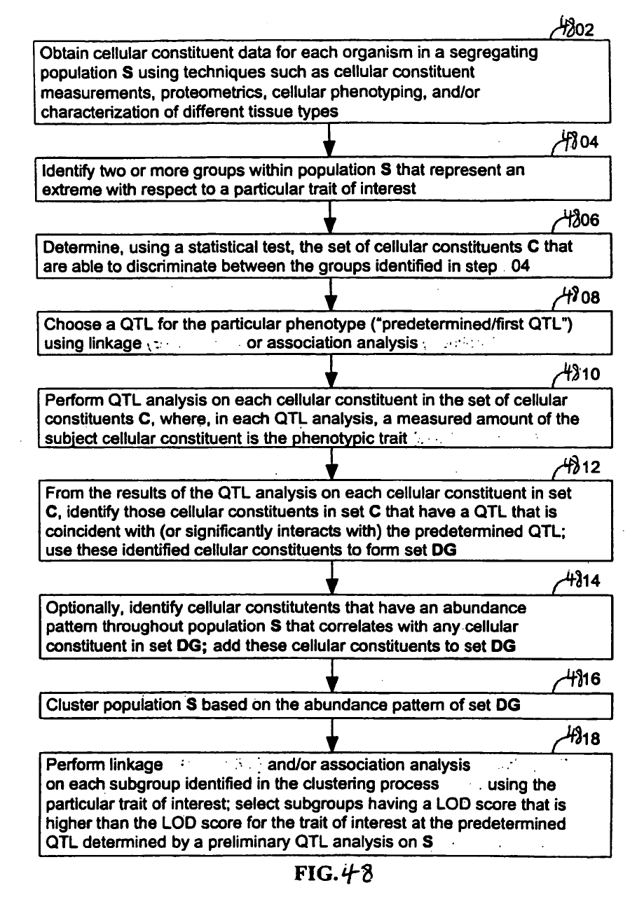

The following section describes an embodiment of the present invention and is made with reference to FIG. 48. While the subdividing embodiment can be used as a precursor to the causality test described above, it will be appreciated by those of skill in the art that the subdividing embodiments described in Section 5.1. 1.1 and 5.1.1.2 can be used to divide any population into genetic subgroups that can then be studied using any quantitative genetic analysis technique in order to identify QTL that are linked to phenotypic traits (e.g., diseases) of interest.

Steps 4802 and 4804. The independent extremes of the population with respect to a particular quantifiable phenotype (e.g., complex trait) are identified. In one embodiment, an organism is within the group that represents an independent extreme with respect to a particular phenotype (e.g., complex trait) when the magnitude of the particular phenotype exhibited by the organism is greater than the magnitude of the particular phenotype exhibited by at least seventy percent, seventy-five percent, eighty percent, eighty-five percent, or ninety percent of the organisms in a population under study (e.g., plurality of organisms S).

Step 4806. Once the independent extremes have been identified, all cellular constituents (e.g. transcripts of genes) with abundances that are able to discriminate between extreme phenotypic groups (independent extremes) with reasonable accuracy are identified. In some embodiments, there are two independent extreme phenotypic groups. In other embodiments, there are more than two independent extreme phenotypic groups. The set of cellular constituents that can discriminate between independent extreme phenotypic groups is referred to in this embodiment as the set of cellular constituents C. Many types of statistical analysis, such as a t-test, can be used to identify cellular constituents in the set G.

Step 4808. Next, QTL for the primary trait of interest are identified using standard linkage analysis, such as that described in Section 5.13. That is, the pedigree data for population S, the phenotypic data for the trait of interest, and the genetic marker map for the species under study is used to identify clinical trait QTL (cQTL) that are linked to the trait under study. In embodiments where pedigree information is not available, an association analysis can be used to identify loci that are linked to the trait of interest. Association analyses is described in Section 5.14.

Step 4810. Quantitative genetic analysis is performed using each cellular constituent in the set of cellular constituents C. In each analysis, the expression level of a cellular constituent selected from among the set of cellular constituents C serves as a phenotypic trait. Each analysis is performed using quantitative genetic analysis described herein. Each quantitative genetic analysis that uses the abundance data (e.g., expression data) for a given cellular constituent C in population S identifies the expression QTL (loci; eQTL) associated with the cellular constituent.

Step 4812. The data obtained in step 4810 is used to select which cellular constituents will remain in discriminating set G. In one embodiment, only those cellular constituents C that have an eQTL (loci) that is linked with a cQTL or that, in fact, overlaps with cQTL are allowed to remain in set G. Cellular constituents that do not have an eQTL that is linked with a cQTL and do not have an eQTL that overlaps a cQTL are discarded. For clarity, the refined set of cellular constituents is termed “DG” in this and subsequent steps.

Step 4814. An optional step can be performed in order to increase the number of cellular constituents in set DG. In this optional step, the abundance patterns of several cellular constituents in the organism under study, across the population under study, is compared to the abundance pattern of any cellular constituent in set DG. Cellular constituents having abundance patterns that are highly correlated with the abundance pattern of a cellular constituent in set DG across population S are added to set DG. More information on how this type of correlation may be computed is found in PCT International Publication WO 00/39338 dated Jul. 6, 2000.

Step 4816. Next, population S is clustered based on the abundance pattern of cellular constituent set C. Therefore, those organisms in population S that have similar abundance patterns across cellular constituent set C will form clusters. The type of clustering can be any of the various clustering methods described in Sections 5.16. The clustering results in a set of clusters (e.g. subgroups) of population S having similar abundance patterns across cellular constituent set C.

Step 4818. Next, linkage analysis (Section 5.13) or association analysis (Section 5.14) on the trait of interest is performed using the different identified subgroups. Those subgroups leading to significantly increased cQTL lod scores for the trait of interest are analyzed further. In particular, such subgroups are subjected to a series of quantitative genetic analyses. In each quantitative genetic analysis in the series, the expression level of a cellular constituent selected from among the cellular constituents in set DG is used as a quantitative trait. The end result of this analysis is the identification of eQTL that are linked with the abundance pattern of cellular constituents in set DG across a particular subgroup. Analysis of these genes using, for example, multivariate techniques such as those described in Section 5.6 leads to the identification of genes that affect the complex trait under study. Analysis of the cellular constituents in set DG is of particular interest because these cellular constituents were able to discriminate between phenotypic extremes for the complex trait under study.

### 5.1.1.2. Subdividing Second Embodiment

This section describes additional methods for subdividing a population exhibiting a complex disease into subpopulations in conjunction with FIG. 53.

Step 5302. In step 5302 (FIG. 53A), a trait is selected for study in a species. In some embodiments, the trait is a complex trait. The species can be a plant, animal, human, or bacterial. In some embodiments, the species is human, cat, dog, mouse, rat, monkey, pigs, Drosophila, or corn. In some embodiments, a plurality of organisms representing the species are studied. The number of organism in the species can be any number. In some embodiments, the plurality of organisms studied is between 5 and 100, between 50 and 200, between 100 and 500, or more than 500.

In some embodiments, a portion of the organisms under study are subjected to a perturbation that affects the trait. The perturbation can be environmental or genetic. Examples of environmental perturbations include, but are not limited to, exposure of an organism to a test compound, an allergen, pain, hot or cold temperatures. Additional examples of environmental perturbations include diet (e.g. a high fat diet or low fat diet), sleep deprivation, isolation, and quantifying a natural environmental influences (e.g., smoking, diet, exercise). Examples of genetic perturbations include, but are not limited to, the use of gene knockouts, introduction of an inhibitor of a predetermined gene or gene product, N-Ethyl-N-nitrosourea (ENU) mutagenesis, siRNA knockdown of a gene, or quantifying a trait exhibited by a plurality of organisms of a species.

The perturbation optionally used in step 5302 is selected because of some relationship between the perturbation and the trait. For example, the perturbation could be the siRNA knockdown of a gene that is thought to influence the trait under study.

Step 5304. The levels of cellular constituents are measured from the plurality of organisms 46 in order to derive gene expression/cellular constituent data. The identity of the tissue from which such measurements are made will depend on what is known about the trait under study. In some embodiments, cellular constituent measurements are made from several different tissues.

Generally, the plurality of organisms 46 exhibit a genetic variance with respect to the trait. In some embodiments, the trait is quantifiable. For example, in instances where the trait is a disease, the trait can be quantified in a binary form (e.g., “1” if the organism has contracted the disease and “0” if the organism has not contracted the disease). In some embodiments, the trait can be quantified as a spectrum of values and the plurality of organisms 46 will represent several different values in such a spectrum. In some embodiments, the plurality of organisms 46 comprise an untreated (e.g., unexposed, wild type, etc.) population and a treated population (e.g., exposed, genetically altered, etc.). In some embodiments, for example, the untreated population is not subjected to a perturbation whereas the treated population is subjected to a perturbation. In some embodiments, the tissue that is measured in step 5304 is blood, white adipose tissue, or some other tissue that is easily obtained from organisms 46.

In varying embodiments, the levels of between 5 cellular constituents and 100 cellular constituents, between 50 cellular constituents and 100 cellular constituents, between 300 and 1000 cellular constituents, between 800 and 5000 cellular constituents, between 4000 and 15,000 cellular constituents, between 10,000 and 40,000 cellular constituents, or more than 40,000 cellular constituents are measured.

In one embodiment, gene expression/cellular constituent data comprises the processed microarray images for each individual (organism) 46 in a population under study. In some embodiments, such data comprises, for each individual 46, intensity information for each gene/cellular constituent represented on the microarray. In some embodiments, cellular constituent data is, in fact, protein expression levels for various proteins in a particular tissue in organisms 46 under study.

In one aspect of the present invention, cellular constituent levels are determined in step 5304 by measuring an amount of the cellular constituent in a predetermined tissue of the organism. As used herein, the term “cellular constituent” comprises individual genes, proteins, mRNA, metabolites and/or any other cellular components that can affect the trait under study. The level of a cellular constituent can be measured in a wide variety of methods. Cellular constituent levels, for example, can be amounts or concentrations in tissues of the organisms, their activities, their states of modification (e.g., phosphorylation), or other measurements relevant to the trait under study.

In one embodiment, step 5304 comprises measuring the transcriptional state of cellular constituents in tissues of organisms. The transcriptional state includes the identities and abundances of the constituent RNA species, especially mRNAs, in the tissue. In this case, the cellular constituents are RNA, cRNA, cDNA, or the like. The transcriptional state of the cellular constituents can be measured by techniques of hybridization to arrays of nucleic acid or nucleic acid mimic probes, or by other gene expression technologies.

In another embodiment, step 5304 comprises measuring the translational state of cellular constituents. In this case, the cellular constituents are proteins. The translational state includes the identities and abundances of the proteins in the organisms. In one embodiment, whole genome monitoring of protein (i.e., the “proteome,” Goffeau et al., 1996, Science 274, p. 546, which is hereby incorporated herein by reference in its entirety) can be carried out by constructing a microarray in which binding sites comprise immobilized, preferably monoclonal, antibodies specific to a plurality of protein species found in one or more tissues of the organisms under study. Preferably, antibodies are present for a substantial fraction of the encoded proteins. Methods for making monoclonal antibodies are well known. See, for example, Harlow and Lane, 1998, Antibodies: A Laboratory Manual, Cold Spring Harbor, N.Y., which is hereby incorporated herein by reference in its entirety. In one embodiment, monoclonal antibodies are raised against synthetic peptide fragments designed based on genomic sequences. With such an antibody array, proteins from the organism are contacted with the array and their binding is assayed with assays known in the art. In some embodiments, antibody arrays for high-throughput screening of antibody-antigen interactions are used. See, for example, Wildt et al., Nature Biotechnology 18, p. 989, which is hereby incorporated herein by reference in its entirety.

Alternatively, large scale quantitative protein expression analysis can be performed using radioactive (e.g., Gygi et al., 1999, Mol. Cell. Biol 19, p. 1720) and/or stable iostope (¹⁵N) metabolic labeling (e.g., Oda et al. Proc. Natl. Acad. Sci. USA 96, p. 6591, which is hereby incorporated herein by reference in its entirety) followed by two-dimensional (2D) gel separation and quantitative analysis of separated proteins by scintillation counting or mass spectrometry. Two-dimensional gel electrophoresis is well-known in the art and typically involves focusing along a first dimension followed by SDS-PAGE electrophoresis along a second dimension. See, e.g., Hames et al., 1990, Gel Electrophoresis of Proteins: A Practical Approach, IRL Press, New York; Shevchenko et al., 1996, Proc Natl Acad. Sci. USA 93, p. 1440; Sagliocco et al., 1996, Yeast 12, p. 1519; Lander 1996, Science 274, p. 536; and Naaby-Haansen et al., 2001, TRENDS in Pharmacological Science 22, p. 376, each of which is hereby incorporated herein by reference in its entirety. Electropherograms can be analyzed by numerous techniques, including mass spectrometric techniques, western blotting and immunoblot analysis using polyclonal and monoclonal antibodies, and internal and N-terminal micro-sequencing. See, for example, Gygi, et al., 1999, Nature Biotechnology 17, p. 994, which is hereby incorporated herein by reference in its entirety. In some embodiments, fluorescence two-dimensional difference gel electrophoresis (DIGE) is used. See, for example, Beaumont et al., Life Science News 7, 2001, which is hereby incorporated herein by reference in its entirety. In some embodiments, quantities of proteins in organisms 246 are determined using isotope-coded affinity tags (ICATs) followed by tandem mass spectrometry. See, for example, Gygi et al., 1999, Nature Biotech 17, p. 994, which is hereby incorporated herein by reference in its entirety. Using such techniques, it is possible to identify a substantial fraction of the proteins expressed in one or more predetermined tissues in organisms 46.

In other embodiments, step 5304 comprises measuring the activity or post-translational modifications of the cellular constituents in the plurality of organisms 246. See for example, Zhu and Snyder, Curr. Opin. Chem. Biol 5, p. 40; Martzen et al., 1999, Science 286, p. 1153; Zhu et al., 2000, Nature Genet. 26, p. 283; and Caveman, 2000, J. Cell. Sci. 113, p. 3543, each of which is hereby incorporated herein by reference in its entirety. In some embodiments, measurement of the activity of the cellular constituents is facilitated using techniques such as protein microarrays. See, for example, MacBeath and Schreiber, 2000, Science 289, p. 1760; and Zhu et al., 2001, Science 293, p. 2101, each of which is hereby incorporated herein by reference in its entirety. In some embodiments, post-translation modifications or other aspects of the state of cellular constituents are analyzed using mass spectrometry. See, for example, Aebersold and Goodlett, 2001, Chem Rev 101, p. 269; Petricoin III, 2002, The Lancet 359, p. 572, each of which is hereby incorporated herein by reference in its entirety.

In some embodiments, the proteome of organisms 46 under study is analyzed in step 5304. The analysis of the proteome (e.g., the quantification of all proteins and the determination of their post-translational modifications) typically involves the use of high-throughput protein analysis methods such as microarray technology. See, for example, Templin et al., 2002, TRENDS in Biotechnology 20, p. 160; Albala and Humphrey-Smith, 1999, Curr. Opin. Mol. Ther. 1, p. 680; Cahill, 2000, Proteomics: A Trends Guide, p. 47-51; Emili and Cagney, 2000, Nat. Biotechnol., 18, p. 393; and Mitchell, Nature Biotechnology 20, p. 225, each of which is hereby incorporated herein by reference in its entirety.

In still other embodiments, “mixed” aspects of the amounts cellular constituents are measured in step 5304. In one example, the amounts or concentrations of one set of cellular constituents in the organisms 46 under study are combined with measurements of the activities of certain other cellular constituents in such organisms.

In some embodiments, different allelic forms of a cellular constituent in a given organism are detected and measured in step 5304. For example, in a diploid organism, there are two copies of any given gene, one descending from the “father” and the other from the “mother.” In some instances, it is possible that each copy of the given gene is expressed at different levels. This is of significant interest since this type of allelic differential expression could associate with the trait under study, particularly in instances where the trait under study is complex.

Step 5306. Once gene expression/cellular constituent data has been obtained, the data is transformed into expression statistics. In some embodiments, cellular constituent data comprises transcriptional data, translational data, activity data, and/or metabolite abundances for a plurality of cellular constituents. In one embodiment, the plurality of cellular constituents comprises at least five cellular constituents. In another embodiment, the plurality of cellular constituents comprises at least one hundred cellular constituents, at least one thousand cellular constituents, at least twenty thousand cellular constituents, or more than thirty thousand cellular constituents.

The expression statistics commonly used as quantitative traits in the analyses in one embodiment of the present invention include, but are not limited to, the mean log ratio, log intensity, and background-corrected intensity derived from transcriptional data. In other embodiments, other types of expression statistics are used as quantitative traits.

In one embodiment, this transformation is performed using a normalization software known in the art. In such embodiments, the expression level of each of a plurality of genes in each organism under study is normalized. Any normalization routine can be used by the normalization module. Representative normalization routines include, but are not limited to, Z-score of intensity, median intensity, log median intensity, Z-score standard deviation log of intensity, Z-score mean absolute deviation of log intensity calibration DNA gene set, user normalization gene set, ratio median intensity correction, and intensity background correction. Furthermore, combinations of normalization routines can be run.

Step 5350. In the preceding steps, a trait is identified, cellular constituent level data is measured, and the cellular constituent data is transformed into expression statistics. In step 5350 (FIG. 53A), one or more phenotypes are measured for all or a portion of the organisms 46 in the population under study. FIG. 54 summarizes the data that is measured as a result of steps 5302-5306 and 5350. For each organism 46 in the population under study there are at least two classes of data collected. The first class of data collected is phenotypic information 1301. Phenotypic information 1301 can be anything related to the trait under study. For example, phenotypic information 1301 can be a binary event, such as whether or not a particular organism exhibits the phenotype (+/−). The phenotypic information can be some quantity, such as the results of an obesity measurement for the respective organism 46. As illustrated in FIG. 54, there can be more than one phenotypic measurement made per organism 46.

The second class of data collected for each organism 46 in the population under study is cellular constituent levels 250 (e.g., amounts, abundances) for a plurality of cellular constituents (steps 5304-5306, FIG. 53A). Although not illustrated in FIG. 54, there can be several sets of cellular constituent measurements for each organism. Each of these sets could represent cellular constituent measurements measured in the respective organism 46 after the organism has been subjected to a perturbation that affects the trait under study. Representative perturbations include, but are not limited to, exposing the organism 46 to an amount of a compound. Further, each set of cellular constituents for a respective organism 46 could represent measurements taken from a different tissue in the organisms. For example, one set of cellular constituent measurements could be from a blood sample taken from the respective organism while another set of cellular constituent measurements could be from fat tissue from the respective organism.

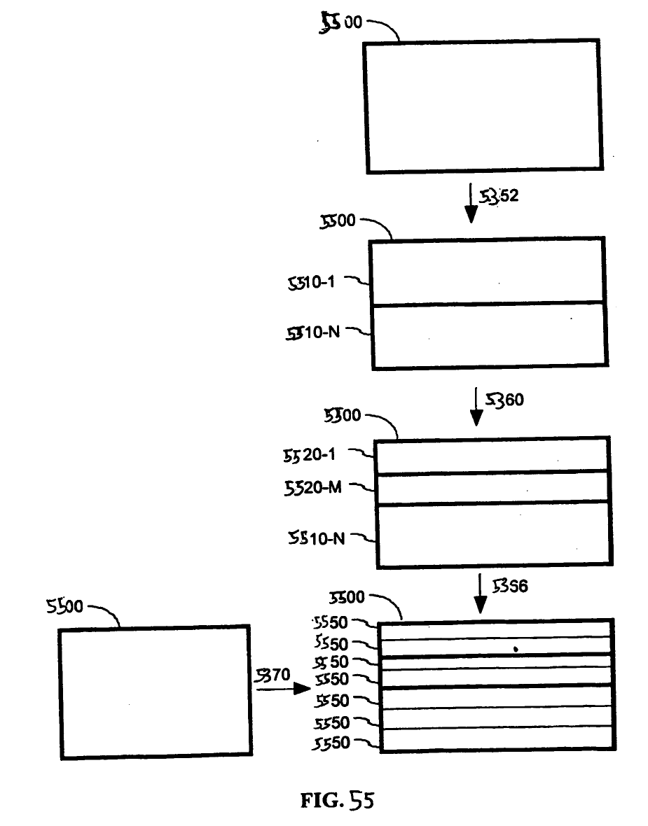

Step 5352. In step 5352 (FIG. 53A), the phenotypic data 1301 (FIG. 54) collected in step 5350 is used to divide the population (5500) into phenotypic groups 5510 (FIG. 55). The method by which step 5352 is accomplished is dependent upon the type of phenotypic data measured in step 5350. For example, in the case where the only phenotypic data is whether or not the organism 46 exhibits a particular trait, step 5352 is straightforward. Those organisms 46 that exhibit the trait are placed in a first group and those organisms 46 that do not exhibit the trait are placed in a second group. A slightly more complex example is where amounts 1301 represent gradations of a quantified trait exhibited by each organism 46. For example, in the case where the trait is obesity, each amount 1301 can correspond to an obesity index (e.g., body mass index, etc.) for the respective organism 46. In this second example, organisms 46 can be binned into phenotypic groups 5510 as a function of the obesity index.

In yet another example in accordance with the invention, a plurality of phenotypic measurements (e.g., 2, 3, 4, 5, 8, 10, 20 or more, between 10 and 20, 20 or more, etc.) can be obtained from a given organism. In such embodiments, each phenotypic measurement for a respective organism can be treated as elements of a phenotypic vector corresponding to the respective organism. These phenotypic vectors can then be clustered using, for example, any of the clustering techniques disclosed in Section 5.16 in order to derive phenotypic groups. To illustrate, in one example, the organisms are human and phenotypic measurements are derived from a standard 12-lead electrocardiogram graph (ECG). The standard 12-lead ECG is a representation of the heart's electrical activity recorded from electrodes on the body surface. The ECG provides a wealth of phenotypic data including, but not limited to, heart rate, heart rhythm, conduction, wave form description, and ECG interpretation (typically a binary event, e.g., normal, abnormal). Each of these different phenotypes (heart rate, heart rhythm) can be quantified as elements in a phenotypic vector. Further, some elements of the phenotypic vector (e.g., ECG interpretation) can be given more weight during clustering. For instance, the ECG measurements can be augmented by additional phenotypes such as plasma cholesterol level, blood triglyceride level, sex, or age in order to derive a phenotypic vector for each respective organism 246. Once suitable phenotypic vectors are constructed, they can be clustered using any of the clustering algorithms in Section 5.16 in order to identify phenotypic groups.

In some embodiments, the step of identifying phenotypic groups is an iterative process in which various phenotypic vectors are constructed and clustered until a form of phenotypic vector that produces clear, distinct groups is identified. Of particular interest are those phenotypic vectors that are capable of producing phenotypic groups that are uniquely characterized by certain phenotypes (e.g., an abnormal ECG/high cholesterol subgroup, a normal ECG/low cholesterol subgroup).

Using the example presented above, phenotypic vectors that can be iteratively tested include a vector that has ECG data only, one that has blood measurements only, one that is a combination of the ECG data and blood measurements, one that has only select ECG data, one that has weighted ECG data, and so forth. Furthermore, optimal phenotypic vectors can be identified using search techniques, such as stochastic search techniques (e.g., simulated annealing, genetic algorithm). See, for example, Duda et al., 2001, Pattern Recognition, second edition, John Wiley & Sons, New York.

Step 5354. Once phenotypic groups have been identified, the phenotypic extremes within the population are identified. Such phenotypic extremes can be referred to as a set of extreme organisms. For example, in one case, the trait of interest is obesity. In this step, very obese and very lean organisms can be selected as the phenotypic extremes. In various embodiments of the present invention, a phenotypic extreme is defined as the top or lowest 40^{th}, 30^{th}, 20^{th}, or 10^{th} percentile of the population with respect to a given phenotype exhibited by the population. In some embodiments, there are more than 5, more than 10, more than 20, more than 100, more than 1000, between 2 and 100, between 25 and 500, less than 100, or less than 1000 organisms in the set of extreme organisms that are referred to as phenotypic extremes.

Step 5356. Next, a plurality of cellular constituents for the species represented by the set of extreme organisms are filtered. Only levels measured for phenotypically extreme organisms (the set of extreme organisms) are used in this filtering. To illustrate, consider the case in which a first organism and a second organism represent phenotypic extremes with respect to some phenotype whereas a third organism does not. Then, in this instance, phenotypic measurements for the first organism and the second organism will be considered in the filtering whereas levels measured for the third organism will not be considered in the filtering.

In some embodiments, cellular constituent levels (measured in phenotypically extreme organisms) for a given cellular constituent are subjected to a t-test (or some other test such as a multivariate test) to determine whether the given cellular constituent can discriminate between the extreme phenotypic groups identified above. A cellular constituent will discriminate between extreme phenotypic groups when the cellular constituent is found at characteristically different levels in each of the phenotypic groups. For example, in the case where there are two phenotypic groups, a cellular constituent will discriminate between the two groups when levels of the cellular constituent (measured in phenotypically extreme organisms) are found at a first level in the first phenotypic group and are found at a second level in the second phenotypic group, where the first and second level are distinctly different.

In preferred embodiments, each cellular constituent is subjected to a t-test and/or a corresponding non-parametric test such as the Wilcoxon sign rank test without consideration of the other cellular constituents in the organism. However, in other embodiments, groups of cellular constituents are compared in a multivariate analysis in order to identify those cellular constituents that discriminate between phenotypic groups.

Step 5358. Typically, there will be a large number of cellular constituents expressed in phenotypically extreme organisms that appear to differentiate between the phenotypic groups. In some instances, this number of cellular constituents can exceed the number of organisms available for study. For instance, in some embodiments, 25,000 genes or more are considered in previous steps. Thus, there may be hundreds if not thousands of genes that discriminate the phenotypically extreme groups. In some instances, these discriminating cellular constituents are analyzed in subsequent steps with statistical models that involve many statistical parameters that cannot accommodate more cellular constituents than organisms as this leads to an over-determined system. In such instances, it is desirable to reduce the number of cellular constituents using a reducing algorithm. However, in other instances, other forms of statistical analysis are used that do not require reduction in the number of cellular constituents under consideration.

The reducing algorithms that are optionally used can involve use of the p-value or other form of metric computed for each cellular constituent as a basis for reducing the dimensionality of the previously identified cellular constituent set. A few exemplary reducing algorithms will be discussed. However, those of skill in the art will appreciate that many reducing algorithms are known in the art and all such algorithms can be used.

One reducing algorithm is stepwise regression. The basic procedure in stepwise regression involves (1) identifying an initial model (e.g., an initial set of cellular constituents), (2) iteratively “stepping,” that is, repeatedly altering the model at the previous step by adding or removing a predictor variable (cellular constituent) in accordance with the “stepping criteria,” and (3) terminating the search when stepping is no longer possible given the stepping criteria, or when a specified maximum number of steps has been reached. Forward stepwise regression starts with no model terms (e.g., no cellular constituents). At each step the regression adds the most statistically significant term until there are none left. Backward stepwise regression starts with all the terms in the model and removes the least significant cellular constituents until all the remaining cellular constituents are statistically significant. It is also possible to start with a subset of all the cellular constituents and then add significant cellular constituents or remove insignificant cellular constituents until a desired dimensionality reduction is achieved.

Another reducing algorithm that can be used is all-possible-subset regression. In fact, all-possible-subset regression can be used in conjunction with stepwise regression. The stepwise regression search approach presumes there is a single “best” subset of cellular constituents and seeks to identify it. In the all-possible-subset regression approach, the range of subset sizes that could be considered to be useful is made. Only the “best” of all possible subsets within this range of subset sizes are then considered. Several different criteria can be used for ordering subsets in terms of “goodness”, such as multiple R-square, adjusted R-square, and Mallow's Cp statistics. When all-possible-subset regression is used in conjunction with stepwise methods, the subset multiple R-square statistic allows direct comparisons of the “best” subsets identified using each approach.

Another approach to reducing higher dimensional space into lower dimensional space is the use of linear combinations of cellular constituents. In effect, linear methods project high-dimensional data onto a lower dimensional space. Two approaches for accomplishing this projection include Principal Component Analysis (PCA) and Multiple-Discriminant Analysis (MDA). PCA seeks a projection that best represents the data in a least-squares sense whereas MDA seeks a projection that bests separates the data in a least-squares sense. See, for example, Duda et al., 2001, Pattern Classification, Chapters 3 and 10.

The ultimate goal is to identify a classifier derived from the previously identified set of cellular constituents or a subset of the cellular constituents identified in step 1256 that satisfactorily classifies organisms into the phenotypic groups. In some embodiments of the present invention, stochastic search methods such as simulated annealing can be used to identify such a classifier or subset. In the simulated annealing approach, for example, each cellular constituent under consideration can be assigned a weight in a function that assesses the aggregate ability of the set of cellular constituents identified to discriminate the organisms into the phenotypic classes. During the simulated annealing algorithm these weights can be adjusted. In fact, some cellular constituents can be assigned a zero weight and, therefore, be effectively eliminated during the anneal thereby effectively reducing the number of cellular constituents used in subsequent steps. Other stochastic methods that can be used include, but are not limited to, genetic algorithms. See, for example, the stochastic methods in Chapter 7 of Duda et al., 2001, Pattern Classification, second edition, John Wiley & Sons, New York, which is hereby incorporated herein by reference in its entirety.

Step 5360. In some embodiments, the cellular constituents identified in previous steps are clustered in order to further identify subgroups within each phenotypic subpopulation. To perform such clustering, an expression vector is created for each cellular constituent under consideration. To create an expression vector for a respective cellular constituent, the levels measured for the respective cellular constituent in each of the phenotypically extreme organisms is used as an element in the vector. For example, consider the case in which an expression vector for a first cellular constituent 48-1 is to be constructed from organisms 46-1, 46-2, and 46-3. Levels 50-1-1, 50-2-1, and 50-3-1 would serve as the three elements of the expression vector that represents cellular constituent 48-1. Each of the expression vectors are then clustered using, for example, any of the clustering techniques described in Section 5.16. In one embodiment, k-means clustering (Section 5.16.2) is used.

A benefit of clustering is that it refines the trait under study into groups that are not distinguishable using gross observable phenotypic data (other than cellular constituent levels). As such, the optional clustering provides a way to refine the definition of the clinical trait under study by focusing on those cellular constituents that actually give rise to the clinical trait or well reflect the varied biochemical response to that trait. However, the refinement provided by clustering can be considered incomplete because it is based on only a select portion of the general population under study, those organisms that represent the phenotypic extremes. For this reason, pattern classification techniques are used in subsequent steps of the instant method to build a robust classifier that is capable of classifying the general population into subgroups in a manner that does not rely upon phenotypic levels.

Step 5364. Building a classifier. The set of cellular constituents identified as discriminators between phenotypic extremes (or principal components derived from such cellular constituents) are used to build a classifier. This set of cellular constituents actually refines the definition of the clinical phenotype under study. A number of pattern classification techniques can be used to accomplish this task, including, but not limited to, Bayesian decision theory, maximum-likelihood estimation, linear discriminant functions, multilayer neural networks, supervised learning, unsupervised learning, boosting and adaptive boosting.

In one embodiment, the set of cellular constituents that discriminate the phenotypically extreme organisms into phenotypic groups is used to train a neural network using, for example, a back-propagation algorithm. In this embodiment, the neural network serves as a classifier. First, the neural network is trained with a probability distribution derived from the set of cellular constituents that discriminate the phenotypically extreme organisms into phenotypic groups. For example, in some embodiments, the probability distribution comprises each cellular constituent t-value, p-value or other computed statistic. Once the neural network has been trained, it is used to classify the general population into phenotypic groups. In some embodiments the neural network that is trained is a multilayer neural network. In other embodiments, a projection pursuit regression, a generalized additive model, or a multivariate adaptive regression spline is used. See, for example, any of the techniques disclosed in Chapter 6 of Duda et al., 2001, Pattern Classification, second edition, John Wiley & Sons, Inc., New York, which is hereby incorporated herein by reference in its entirety.

In another embodiment, Bayesian decision theory can be used to build a classifier. Bayesian decision theory plays a role when there is some a priori information about the things to be classified. Here, a probability distribution derived from the set of cellular constituents that discriminate the phenotypically extreme organisms into phenotypic groups serves as the a priori information. For example, in some embodiments, this probability distribution comprises each cellular constituent p-value or other computed statistic. For more information on Bayesian decision theory, see for, example, any of the techniques disclosed in Chapters 2 and 3 of Duda et al., 2001, Pattern Classification, second edition, John Wiley & Sons, Inc., New York, which is hereby incorporated herein by reference in its entirety.

In still another embodiment, linear discriminate analysis (functions), linear programming algorithms, or support vector machines are used to create a classifier that is capable of classifying the general population of organisms into phenotypic groups. This classification is based on the cellular constituent data 50 for the cellular constituents 48 that refined the definition of the clinical phenotype (i.e., the cellular constituents selected in any of the preceding steps). For more information on this class of pattern classification functions, see for, example, any of the techniques disclosed in Chapter 5 of Duda et al., 2001, Pattern Classification, second edition, John Wiley & Sons, Inc., New York, which is hereby incorporated herein by reference in its entirety.

In preferred embodiments, boosting methods are used to create a classifier based upon the set of cellular constituents identified as discriminators between phenotypic extremes or based upon principal components derived from such cellular constituents. An exemplary boosting method that can be used in the present invention is described by Freund and Schapire, 1997, Journal of Computer and System Sciences 55, pp. 119-139, which is hereby incorporated herein by reference in its entirety. The technique is used as follows. Consider the case where there are two phenotypic extremes exhibited by the population under study, extreme phenotype 1 (e.g., obese), and extreme phenotype 2 (e.g., lean). Given a vector of predictor cellular constituents X identified using the techniques described above, a classifier G(X) produces a prediction taking one of type values in the two value set: {extreme phenotype 1, extreme phenotype 2}. The error rate on the training sample is

$$\overline{err} = \frac{1}{N} {\sum }_{i = 1}^{N} I ( {y}_{i} \neq G ( {x}_{i} ) )$$

where N is the number of organisms in the training set (the sum total of the organisms that have either extreme phenotype 1 or extreme phenotype 2). For example, if there are 49 obese and 72 lean organisms under study, N is 121.

A weak classifier is one whose error rate is only slightly better than random guessing. In the boosting algorithm, the weak classification algorithm is repeatedly applied to modified versions of the data, thereby producing a sequence of weak classifiers Gₘ(x), m,=1, 2, . . . , M. The predictions from all of the classifiers in this sequence are then combined through a weighted majority vote to produce the final prediction:

$$G ( x ) = sign ( {\sum }_{m = 1}^{M} {α}_{m} {G}_{m} ( x ) )$$

Here α₁, α₂, . . . , α_{M} are computed by the boosting algorithm and their purpose is to weigh the contribution of each respective Gₘ(x). Their effect is to give higher influence to the more accurate classifiers in the sequence.

The data modifications at each boosting step consist of applying weights w₁, w₂, . . . , wₙ to each of the training observations (xᵢ, yᵢ), i=1, 2, . . . , N. Initially all the weights are set to wᵢ=1/N, so that the first step simply trains the classifier on the data in the usual manner. For each successive iteration m=2, 3, . . . , M the observation weights are individually modified and the classification algorithm is reapplied to the weighted observations. At stem m, those observations that were misclassified by the classifier Gₘ₋₁(x) induced at the previous step have their weights increased, whereas the weights are decreased for those that were classified correctly. Thus as iterations proceed, observations that are difficult to correctly classify receive ever-increasing influence. Each successive classifier is thereby forced to concentrate on those training observations that are missed by previous ones in the sequence.

The exemplary boosting algorithm is summarized as follows:

1. Initialize the observation weights wᵢ=1/N, i=1, 2, . . . , N.

2. For m=1 to M:
(a) Fit a classifier Gₘ(x) to the training set using weights wᵢ.
(b) Compute

$${err}_{m} = \frac{{\sum }_{i = 1}^{N} {w}_{i} I ( {y}_{i} \neq {G}_{m} ( {x}_{i} ) )}{{\sum }_{i = 1}^{N} {w}_{i}}$$
(c) Compute αₘ=log((1−errₘ)/errₘ).
(d) Set wᵢ←eᵢ·exp[αₘ·I(yᵢ≠Gₘ(xᵢ))],i=1, 2, . . . , N.

3. Output G(x)=sign

$$⌊ {\sum }_{m = 1}^{M} {α}_{m} {G}_{m} ( x ) ⌋$$

In the algorithm, the current classifier Gₘ(x) is induced on the weighted observations at line 2a. The resulting weighted error rate is computed at line 2b. Line 2c calculates the weight αₘ given to Gₘ(x) in producing the final classifier G(x) (line 3). The individual weights of each of the observations are updated for the next iteration at line 2d. Observations misclassified by Gₘ(x) have their weights scaled by a factor exp(αₘ), increasing their relative influence for inducing the next classifier Gₘ₊₁(x) in the sequence. In some embodiments, modifications of the Freund and Schapire, 1997, Journal of Computer and System Sciences 55, pp. 119-139, boosting method are used, which is hereby incorporated herein by reference in its entirety. See, for example, Hasti et al., The Elements of Statistical Learning, 2001, Springer, N.Y., Chapter 10, which is hereby incorporated herein by reference in its entirety. In some embodiments, boosting or adaptive boosting methods are used.

An embodment of the present invention provides a method for identifying a quantitative trait locus for a trait that is exhibited by a plurality of organisms in a population. In the method, the population is divided into a plurality of sub-populations using a classification scheme that classifies each organism in the population into at least one of the subpopulations. The classification scheme is derived from a plurality of cellular constituent measurements for each of a plurality of respective cellular constituents that are obtained from each the organism. Furthermore, the classification scheme uses a classifier constructed using any of the boosting techniques described above. For at least one sub-population in the plurality of sub-populations, the method further comprises performing quantitative genetic analysis on the sub-population in order to identify the quantitative trait locus for the trait.

In some embodiments, modifications of Freund and Schapire, 1997, Journal of Computer and System Sciences 55, pp. 119-139, are used. For example, in some embodiments, feature preselection is performed using a technique such as the nonparametric scoring methods of Park et al., 2002, Pac. Symp. Biocomput. 6, 52-63. Feature preselection is a form of dimensionality reduction in which the genes that discriminate between classifications the best are selected for use in the classifier. Then, the LogitBoost procedure introduced by Friedman et al., 2000, Ann Stat 28, 337-407 is used rather than the boosting procedure of Freund and Schapire, which is hereby incorporated herein by reference in its entirety. In some embodiments, the boosting and other classification methods of Ben-Dor et al., 2000, Journal of Computational Biology 7, 559-583 are used in the present invention. In some embodiments, the boosting and other classification methods of Freund and Schapire, 1997, Journal of Computer and System Sciences 55, 119-139, are used. In some embodiments, the support vector machine classifaction methods of Furey et al., 2000, Bioinformatics 16, 906-914, is used, each of which is hereby incorporated herein by reference in its entirety.

Step 5366. Classifying the population. The classifier derived above is used to classify all or a substantial portion (e.g., more than 30%, more than 50%, more than 75%) of the population under study. Essentially, the classifier bins the remaining population (the portions of the population that do not include the phenotypic extremes) without taking their phenotype into consideration. The process of using the classifier to classify the general population produces phenotypic classifications (phenotypic subgroups). Phenotypic subgroups can be considered a refinement of the trait under study and subsequently used in analysis of the underlying biochemical process that differentiate the trait under study into groups using the techniques disclosed below.

Step 5368. Using the classifier. By way of summary, cellular constituents that are differentially expressed in phenotypically extreme organisms are identified. This set of cellular constituents is used to construct a classifier. The classifier classifies the trait under study into subgroups without consideration of phenotypic data. It is expected that these subgroups define subgroups of the trait under study and that each of the subgroups define a homogenous biochemical form of the trait under study. Regardless of its form, the classifier formed in the inventive methods serves to further refine the phenotypic subgroups. As such, the methods disclosed in this section can be used to refine a trait under study. At the outset, the trait under study is exhibited by some population of organisms 46. Observation of gross (visible, measurable) phenotypes (other than cellular constituent levels) related to the trait are used to divide the general population into two or more phenotypic groups. Optional clustering of select cellular constituents serves to refine a phenotypic group into subphenotypic groups. A benefit of the clustering is that it refines the trait under study into subgroups that are not distinguishable using gross observable phenotypic data (other than cellular constituent levels). As such, the clustering provides a way to refine the definition of the clinical trait under study by focusing on those cellular constituents that actually give rise to the clinical trait or well reflects the varied biochemical response to that trait. However, the refinement provided by the clustering is incomplete because it is based on only a select portion of the general population under study, those organisms that represent phenotypic extremes. Accordingly, a more robust classifier is built using the initial set of cellular constituents selected based upon phenotypic extremes organisms 46 as a starting point. This derived classifier derived classifies the trait under study into highly refined subgroups. Thus, although only gross categories were used to develop the classifier, the classifier will split the population into clusters that can fall within highly refined subgroups. Each of these highly refined subgroups serves to refine the trait under study. In other words, each of the highly refined subgroups is a more homogenous form of the overall trait under study.

The classifier developed using the methods described in this section serves to refine the definition of a trait of interest. Thus, each identified subgroup represents a more homogenous suppopulation with respect to the trait of interest. These homogenous subpopulation can then be studied using approaches such as quantitative genetic approaches.

### 5.1.1.3. Subdividing—More Formal Approaches

Sections 5.1.1.1 and 5.1.1.2 provide methods for identifying subgroups of a population. These subgroups are then tested to determine whether the relationship between cQTL for a trait of interest are stronger (have higher lod scores) in a subgroup than in the population as a whole. These methods make use of techniques such as clustering, building classifiers and the like. However, some embodiments of the present invention contemplate more formal mathematical methods for identifying subgroups involving specific mathematical modeling of the subgroup identification process and cQTL assessment process so that they are linked together. In other words, subdividing algorithms are contemplated that couple the magnitude of cQTL lod scores for the trait of interest with the subgroup identification process in such a way that such cQTL lod scores can actually be used to refine the subgroups. In some embodiments, Bayesian approaches, in which eQTL lod scores are used to refine subgroup populations, are used.

### 5.1.1.4. Subdividing Using Clustering

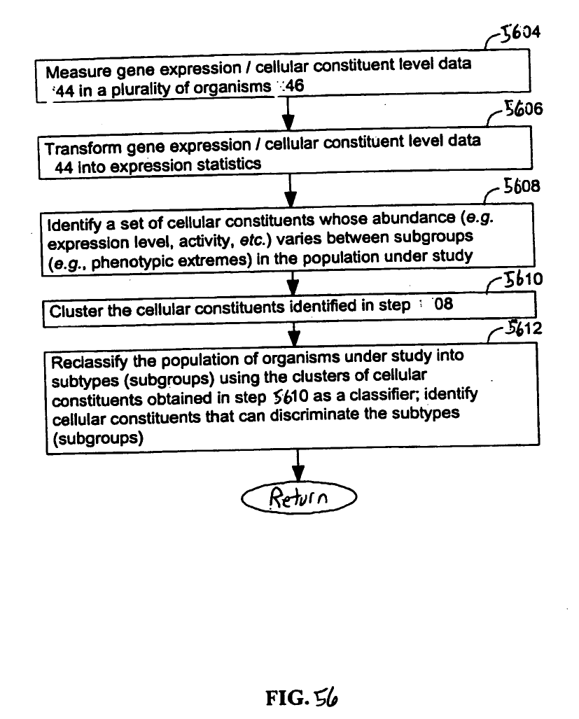

The following embodiment makes reference to FIG. 56. In the following method a species is studied. The species can be, for example, a plant, animal, human, or bacteria. In some embodiments, the species is human, cat, dog, mouse, rat, monkey, pigs, Drosophila, or corn. In some embodiments, a plurality of organisms representing the species is studied. The number of organisms in the species can be any number. In some embodiments, the plurality of organisms studied is between 5 and 100, between 50 and 200, between 100 and 500, or more than 500 organisms. In some embodiments, the plurality of organisms are an F₂ intercross, a Fₜ population (formed by randomly mating F₁s for t−1 generations), an F_{2:3} design (F₂ individuals are genotyped and then selfed), or a Design III (F₂ from two inbred lines are backcrossed to both parental lines). Thus, in some embodiments of the present invention, organisms 246 (FIG. 2) represent a population, such as an F₂ population, an Fₜ population, an F_{2:3} population or a Design III population.

In some embodiments, a portion of the organisms under study are subjected to a perturbation. The perturbation can be environmental or genetic. Examples of environmental perturbations include, but are not limited to, exposure of an organism to a test compound, an allergen, pain, and hot or cold temperatures. Additional examples of environmental perturbations include diet (e.g., a high fat diet or low fat diet), sleep deprivation, isolation, and quantifying natural environmental influences (e.g., smoking, diet, exercise). Examples of genetic perturbations include, but are not limited to, the use of gene knockouts, introduction of an inhibitor of a predetermined gene or gene product, N-Ethyl-N-nitrosourea (ENU) mutagenesis, siRNA knockdown of a gene, or quantifying a trait exhibited by a plurality of organisms of a species. Various siRNA knock-out techniques (also referred to as RNA interference or post-transcriptional gene silencing) are disclosed, for example, in Xia, et al., 2002, Nature Biotechnology 20, p. 1006; Hannon, 2002, Nature 418, p. 244; Carthew, 2001, Current Opinion in Cell Biology 13, p. 244; Paddison, 2002, Genes & Development 16, p. 948; Paddison & Hannon, 2002, Cancer Cell 2, p. 17; Jang et al., 2002, Proc. Natl. Acad. Sci. USA 99, p. 1984; Martinez et al., 2002, Proc. Natl. Acad. Sci. USA 99, p. 14849, each of which is hereby incorporated herein by reference in its entirety.

Step 5604. In step 5604 (FIG. 56), the levels of cellular constituents in tissue selected from the organism are measured from the plurality of organisms 46 in order to derive gene expression/cellular constituent data 44. In some embodiments cellular constituent data from only one tissue type is collected. In other embodiments, cellular constituent data from multiple tissue types are collected.

Generally, the plurality of organisms 46 exhibit a genetic variance with respect to some trait of interest. In some embodiments, the trait is quantifiable. For example, in instances where the trait is a disease, the trait can be quantified in a binary form (e.g., “1” if the organism has contracted the disease and “0” if the organism has not contracted the disease). In some embodiments, the trait can be quantified as a spectrum of values and the plurality of organisms 46 will represent several different values in such a spectrum. In some embodiments, the plurality of organisms 46 comprise an untreated (e.g., unexposed, wild type, etc.) population and a treated population (e.g., exposed, genetically altered, etc.). In some embodiments, for example, the untreated population is not subjected to a perturbation whereas the treated population is subjected to a perturbation. In some embodiments, the tissue that is measured in step 5604 is blood, white adipose tissue, or some other tissue that is easily obtained from organisms 46.

In varying embodiments, the levels of between 5 cellular constituents and 100 cellular constituents, between 50 cellular constituents and 100 cellular constituents, between 300 and 1000 cellular constituents, between 800 and 5000 cellular constituents, between 4000 and 15,000 cellular constituents, between 10,000 and 40,000 cellular constituents, or more than 40,000 cellular constituents are measured.

In one embodiment, gene expression/cellular constituent data comprises the processed microarray images for each individual (organism) in a population under study. In some embodiments, such data comprises, for each individual, quantity (intensity) information for each gene/cellular constituent represented on the microarray, optional background signal information, and associated annotation information describing the gene probe. In some embodiments, cellular constituent data is, in fact, protein expression levels for various proteins in a particular tissue in organisms under study.

In one aspect of the present invention, cellular constituent levels are determined in step 5604 by measuring an amount of the cellular constituent in a predetermined tissue of the organism. As used herein, the term “cellular constituent” comprises individual genes, proteins, mRNA, metabolites and/or any other cellular components that can affect the trait under study. The level of a cellular constituent other than a gene can be measured in a wide variety of methods. Cellular constituent levels, for example, can be amounts or concentrations in the organisms, their activities, their states of modification (e.g., phosphorylation), or other measurements relevant to the trait under study.

In one embodiment, step 5604 comprises measuring the transcriptional state of cellular constituents in one or more tissues of organisms. The transcriptional state includes the identities and abundances of the constituent RNA species, especially mRNAs. In this case, the cellular constituents are RNA, cRNA, cDNA, or the like. The transcriptional state of the cellular constituents can be measured by techniques of hybridization to arrays of nucleic acid or nucleic acid mimic probes, or by other gene expression technologies.

In another embodiment, step 5604 comprises measuring the translational state of cellular constituents in tissues. In this case, the cellular constituents are proteins. The translational state includes the identities and abundances of the proteins in the tissue. In one embodiment, whole genome monitoring of protein (e.g., the “proteome,” Goffeau et al., 1996, Science 274, p. 546, which is hereby incorporated herein by reference in its entirety) can be carried out by constructing a microarray in which binding sites comprise immobilized, preferably monoclonal, antibodies specific to a plurality of protein species. Preferably, antibodies are present for a substantial fraction (e.g. 30%, 40%, 50%, 60%, or more) of the encoded proteins. Methods for making monoclonal antibodies are well known. See, for example, Harlow and Lane, 1998, Antibodies: A Laboratory Manual, Cold Spring Harbor, N.Y. In one embodiment, monoclonal antibodies are raised against synthetic peptide fragments designed based on genomic sequences. With such an antibody array, proteins from the organisms are contacted with the array and their binding is assayed with assays known in the art. In some embodiments, antibody arrays for high-throughput screening of antibody-antigen interactions are used. See, for example, Wildt et al., Nature Biotechnology 18, p. 989.

Alternatively, large scale quantitative protein expression analysis can be performed using radioactive (e.g., Gygi et al., 1999, Mol. Cell. Biol 19, p. 1720, which is hereby incorporated herein by reference in its entirety) and/or stable iostope (¹⁵N) metabolic labeling (e.g., Oda et al. Proc. Natl. Acad. Sci. USA 96, p. 6591, which is hereby incorporated herein by reference in its entirety) followed by two-dimensional (2D) gel separation and quantitative analysis of separated proteins by scintillation counting or mass spectrometry. Two-dimensional gel electrophoresis is well-known in the art and typically involves focusing along a first dimension followed by SDS-PAGE electrophoresis along a second dimension. See, e.g., Hames et al., 1990, Gel Electrophoresis of Proteins: A Practical Approach, IRL Press, New York; Shevchenko et al., 1996, Proc Natl Acad. Sci. USA 93, p. 1440; Sagliocco et al., 1996, Yeast 12, p. 1519; Lander 1996, Science 274, p. 536; and Naaby-Haansen et al., 2001, TRENDS in Pharmacological Science 22, p. 376, each of which is hereby incorporated herein by reference in its entirety. Electropherograms can be analyzed by numerous techniques, including mass spectrometric techniques, western blotting and immunoblot analysis using polyclonal and monoclonal antibodies, and internal and N-terminal micro-sequencing. See, for example, Gygi, et al., 1999, Nature Biotechnology 17, p. 994, which is hereby incorporated herein by reference in its entirety. In some embodiments, fluorescence two-dimensional difference gel electrophoresis (DIGE) is used. See, for example, Beaumont et al., Life Science News 7, 2001. In some embodiments, quantities of proteins in tissues of organisms 246 are determined using isotope-coded affinity tags (ICATs) followed by tandem mass spectrometry. See, for example, Gygi et al., 1999, Nature Biotech 17, p. 994. Using such techniques, it is possible to identify a substantial fraction of the proteins expressed in a predetermined tissue in organisms 246.

In other embodiments, step 5604 comprises measuring the activity or post-translational modifications of the cellular constituents in predetermined tissues of the plurality of organisms 46. See for example, Zhu and Snyder, Curr. Opin. Chem. Biol 5, p. 40; Martzen et al., 1999, Science 286, p. 1153; Zhu et al., 2000, Nature Genet. 26, p. 283; and Caveman, 2000, J. Cell. Sci. 113, p. 3543, each of which is hereby incorporated herein by reference in its entirety. In some embodiments, measurement of the activity of the cellular constituents is facilitated using techniques such as protein microarrays. See, for example, MacBeath and Schreiber, 2000, Science 289, p. 1760; and Zhu et al., 2001, Science 293, p. 2101, each of which is hereby incorporated herein by reference in its entirety. In some embodiments, post-translational modifications or other aspects of the state of cellular constituents are analyzed using mass spectrometry. See, for example, Aebersold and Goodlett, 2001, Chem Rev 101: 269; Petricoin III, 2002, The Lancet 359: 572, each of which is hereby incorporated herein by reference in its entirety.

In some embodiments, the proteome of tissue from organisms 46 is analyzed in step 5604. The analysis of the proteome of cells in the organisms (e.g., the quantification of all proteins and the determination of their post-translational modifications) typically involves the use of high-throughput protein analysis methods such as microarray technology. See, for example, Templin et al., 2002, TRENDS in Biotechnology 20: 160; Albala and Humphrey-Smith, 1999, Curr. Opin. Mol. Ther. 1: 680; Cahill, 2000, Proteomics: A Trends Guide, p. 47-51; Emili and Cagney, 2000, Nat. Biotechnol., 18: 393; and Mitchell, Nature Biotechnology 20: 225, each of which is hereby incorporated herein by reference in its entirety.

In still other embodiments, “mixed” aspects of the amounts cellular constituents are measured in step 5604. In one example, the amounts or concentrations of one set of cellular constituents in tissues from organisms 46 are combined with measurements of the activities of certain other cellular constituents in such tissues in step 5604.

In some embodiments, different allelic forms of a cellular constituent in a given organism are detected and measured in step 5604. For example, in a diploid organism, there are two copies of any given gene, one descending from the “father” and the other from the “mother.” In some instances, it is possible that each copy of the given gene is expressed at different levels. This is of significant interest since this type of allelic differential expression could associate with the trait under study, particularly in instances where the trait under study is complex.

Step 5606. Once gene expression/cellular constituent data has been obtained, the data is transformed (FIG. 56, step 5606) into expression statistics. In some embodiments, cellular constituent data 44 (FIG. 1) comprises transcriptional data, translational data, activity data, and/or metabolite abundances for a plurality of cellular constituents. In one embodiment, the plurality of cellular constituents comprises at least five cellular constituents. In another embodiment, the plurality of cellular constituents comprises at least one hundred cellular constituents, at least one thousand cellular constituents, at least twenty thousand cellular constituents, or more than thirty thousand cellular constituents.

The expression statistics commonly used as quantitative traits in the analyses in one embodiment of the present invention include, but are not limited to, the mean log ratio, log intensity, and background-corrected intensity derived from transcriptional data. In other embodiments, other types of expression statistics are used as quantitative traits.

In one embodiment, the expression level of each of a plurality of genes in each organism under study is normalized. Any normalization routine can be used to accomplish this normalization. Representative normalization routines include, but are not limited to, Z-score of intensity, median intensity, log median intensity, Z-score standard deviation log of intensity, Z-score mean absolute deviation of log intensity calibration DNA gene set, user normalization gene set, ratio median intensity correction, and intensity background correction. Furthermore, combinations of normalization routines can be run.

Step 5608. In step 5608, patterns of cellular constituent levels (e.g., gene expression levels, protein abundance levels, etc.) are identified that associate with a trait under study and/or the perturbation that is optionally applied to the population prior to cellular constituent measurement. There are several ways that step 5608 can be carried out, and all such ways are included within the scope of the present invention. One such method first identifies those cellular constituents that discriminate the trait.

In one example, a perturbation is applied to the population prior to cellular constituent measurement in step 5604. The perturbation can be, for example, exposure of the organism to a compound. Exposure of the organism to a compound can be effected by a variety of means, including but not limited to, administration, injection, etc. In this example, the population of organisms is divided into two classes. Those organisms that have been exposed to the compound and those organisms that have not been exposed to the compound. In the example, those cellular constituents (e.g. genes, proteins, metabolites, etc.) whose levels (e.g., transcriptional state, translational state, activity state, post-translational modification state, etc.) in the organisms discriminate the treatment group (the group exposed to the organism) from the control group are identified using a statistical technique such as a paired t-test, an unpaired t-test, a Wilcoxon rank test, a signed rank test, or by computation of the correlation between the trait and gene expression values. In some instances, the perturbation optionally applied to the population comprises multiple treatments. In such instances, generalizations to the t-test and ranks tests, such as Anova or Kruskal-Wallis are used in this step.

In another embodiment, a perturbation is not applied to the population under study. In one case, the population under study is divided into those organisms that exhibit the trait and those organisms that do not exhibit the trait. Those cellular constituents (e.g. genes, proteins, metabolites, etc.) whose levels (e.g., transcriptional state, translational state, activity state, post-translational modification state, etc.) in the organisms discriminate the affected group from the unaffected group are identified using a statistical technique.

In still other embodiments, the population under study is divided into groups based on a function of the phenotype for the trait under study. Those cellular constituents whose levels in the organisms 46 discriminate between the various groups are identified using a statistical technique.

In another example, the population under study exhibits a broad spectrum of phenotypes for the trait. Those cellular constituents whose levels in the organism 246 that can differentiate at least some of these phenotypes are then identified using statistical techniques. Generally speaking, in this step, the population is divided into phenotypically distinct groups and cellular constituents that distinguish between these phenotypically distinct groups are identified using statistical tests such as a t-tests (for two groups) or ANOVA (for greater than two groups).

In various embodiments, the set of cellular constituents identified in step 5608 comprises between 5 and 100 cellular constituents, between 50 and 500 cellular constituents, between 400 and 1000 cellular constituents, between 800 and 4000 cellular constituents, between 3000 and 8000 cellular constituents, 8000 to 15000 cellular constituents, more 15000 cellular constituents, or less than 30000 cellular constituents.

In some embodiments, the phenotypic extremes within the population are identified. For example, in one case, the trait of interest is obesity. In such an example, very obese and very skinny organisms 246 are selected as the phenotypic extremes in this step. In one embodiment of the present invention, a phenotypic extreme is defined as the top or lowest 40^{th}, 30^{th}, 20^{th}, or 10^{th} percentile of the population with respect to a given phenotype exhibited by the population. In some embodiments, cellular constituent levels 250 (measured in phenotypically extreme organisms) for a given cellular constituent 246 are subjected to a t-test or some other test such as a multivariate test to determine whether the given cellular constituent 246 can discriminate between phenotypic groups identified (e.g., treated versus untreated) for the population under study. A cellular constituent 246 will discriminate between phenotypic groups when the cellular constituent is found at characteristically different levels in each of the phenotypic groups. For example, in the case where there are two phenotypic groups, a cellular constituent will discriminate between the two groups when levels 250 of the cellular constituent (measured in phenotypically extreme organisms) are found at a first level in the first phenotypic group and are found at a second level in the second phenotypic group, where the first and second level are distinctly different.

Step 5610. Once the set of cellular constituents that discriminate the trait or, optionally, the perturbation, have been identified (e.g., using organisms in the population that represent phenotypic extremes), they can be clustered. In one embodiment of the present invention, each cellular constituent in the set of cellular constituents that discriminates the trait (or the perturbation applied to the population prior to measurement in step 5604) between two or more classes (e.g., afflicted versus nonafflicted, perturbed versus nonperturbed) is treated as a cellular constituent vector. For example, the n^{th} cellular constituent in the set of cellular constituents that discriminates the perturbation (e.g., complex trait) between two or more classes is represented as:
Cₙ=(A₁ⁿ,A₂ⁿ, . . . ,Aₘⁿ)

where each A is the level (e.g., transcriptional state, translational state, activity, etc.) of cellular constituent n in a tissue of an organism 246 in the plurality of organisms under study, and m is the number of organisms considered. Cellular constituent vectors Cₙ can be clustered based on similarities in the values of corresponding levels A in each cellular constituent vector. Cellular constituent vector Cₙ will cluster into the same group (cellular constituent vector cluster) if the corresponding levels in such cellular constituent vectors are correlated. To illustrate, consider hypothetical cellular constituent vectors Cₙ that are obtained by measuring three different cellular constituents in five different organisms. Each cellular constituent vector will therefore have five values. Each of the five values will be a level (e.g., activity, transcriptional state, translational state, etc.) of the corresponding cellular constituent n in a tissue of one of the five organisms:

| | |
|---|---|
| Exemplary cellular constituent vector C₁: | {0, 5, 5.5, 0, 0} |
| Exemplary cellular constituent vector C₂: | {0, 4.9, 5.4, 0, 0} |
| Exemplary cellular constituent vector C₃: | {6, 0, 3, 3, 5} |

Thus, for vector C₁, there is a level of cellular constituent “C₁” of 0 arbitrary units in the first organism, 5 arbitrary units in the second organism, 5.5 arbitrary units in the third organism, and 0 arbitrary units in the fourth and fifth organisms. Clustering of exemplary cellular constituent vectors C₁, C₂, and C₃ will result in two clusters (cellular constituent vector clusters). The first cluster will include cellular constituent vectors C₁ and C₂ because there is a correlation in the levels within each vector (0 versus 0 in organism 246-1, 5 versus 4.9 in organism 246-2, 5.5 versus 5.4 in organism 246-3, 0 versus 0 in organism 246-4, and 0 versus 0 in organism 246-5). The second cluster will include exemplary cellular constituent vector C₃ because the pattern of levels in vector C₃ is not similar to the pattern of levels in C₁ and C₂. This illustration serves to describe certain aspects of clustering using hypothetical cellular constituent level data. However, in the present invention, the cellular constituents used in this step are selected because they discriminate trait extremes. Thus, unlike the hypothetical data shown above, the cellular constituent levels should reflect that they were selected over phenotypic extremes. When this is the case, the clustering in this step will help to identify subgroups of cellular constituents within the group of cellular constituents that discriminate trait extremes.

In one embodiment of the present invention, agglomerative hierarchical clustering is applied to the cellular constituent vectors in step 1510. In such clustering, similarity is determined using Pearson correlation coefficients between the cellular constituent vector pairs. In other embodiments, the clustering of the cellular constituent vectors comprises application of a hierarchical clustering technique, application of a k-means technique, application of a fuzzy k-means technique, application of a Jarvis-Patrick clustering technique, application of a self-organizing map or application of a neural network. In some embodiments, the hierarchical clustering technique is an agglomerative clustering procedure. In other embodiments, the agglomerative clustering procedure is a nearest-neighbor algorithm, a farthest-neighbor algorithm, an average linkage algorithm, a centroid algorithm, or a sum-of-squares algorithm. In still other embodiments, the hierarchical clustering technique is a divisive clustering procedure. In preferred embodiments, nonparametric clustering algorithms are applied to the cellular constituent vectors. In some embodiments, Spearman R, Kendall Tau, or Gamma coefficients are used to cluster the cellular constituent vectors.

Step 5612. In step 5612, the population is reclassified into subtypes using the clustering information from step 5610. The goal of step 5612 is to construct a classifier that comprises those cellular constituents that can distinguish between these subtypes. In one embodiment, a respective phenotypic vector is constructed for each organism in the population. Each phenotypic vector comprises the cellular constituent levels for all or a portion of the set of cellular constituents that were used in step 5610. In some embodiments, the order of the elements in the phenotypic vectors is determined by the clustering patterns achieved in step 5610.

The phenotypic vectors are clustered using any known clustering technique. In embodiments where the order of the elements in each phenotypic vector is determined based on the clustering in step 5610, the clustering in step 5612 produces a two-dimensional cluster. In one dimension, cellular constituents are clustered based on similarities in their abundance across the population of organisms. For example, two cellular constituents would cluster together if they are expressed at similar levels throughout the population. On the other dimension, organisms are clustered based on similarity across the set of cellular constituents. For example, two organisms will cluster together if corresponding cellular constituents in each organism express at comparable levels.

The present invention provides many alternative pattern classification techniques that can be used instead of the clustering techniques that are described in steps 5610 and 5612. These alternative pattern classification techniques can be used to build classifiers from discriminating cellular constituents. Such classifiers can then be used to differentiate the general population into distinct subgroups.

In essence, the clustering in steps 5610 and 5612 order the population into new subgroups (e.g., phenotypic clusters). Each subgroup (phenotypic cluster) is characterized by a distinctive cellular constituent expression (or level) pattern. To illustrate, consider the case in which the clustering performed in step 5610 produces three groups of cellular constituents, namely groups A, B and C. Next, in step 1512, a phenotypic vector is constructed for each organism in the population under study. The elements in the phenotypic vectors are the measured cellular constituent levels for the respective organisms arranged in the order specified by the cellular constituent clustering results of step 5610. For illustration, suppose there are ten cellular constituents, (1, 2, 3, 4, 5, 6, 7, 8, 9, and 10), where constituents 8-10 fall into group A, constituents 4-7 fall into group B, and constituents 1-3 fall into group C. In this instance, a phenotypic vector V_{M} for an organism M in the population could have the form:
V_{M}={8, 9, 10, 4, 5, 6, 7, 1, 2, 3}
   where each respective cellular constituent in the vector is represented by the level of the cellular constituent in the organism represented by the vector. Each vector V_{M} is clustered based on these levels. Consider the hypothetical vectors for four such organisms, where cellular constituent levels are merely represented as “+” for high level and “−” for low level:
V₁={+, −, +, +, +, −, −, −, −, −}
V₂{−, −, −, −, −, +, +, +, +, +}
V₃={+, +, +, +, +, −, −, −, −, −}
V₄={−, −, −, −, −, +, +, +, −, +}
   Clustering V₁ through V₄ will result in two groups (I and II):

Group I:
V₁={+, −, +, +, +, −, −, −, −, −}
V₃={+, +, +, +, +, −, −, −, −, −}

Group II:
V₂={−, −, −, −, −, +, +, +, −, +}
V₄={−, −, −, −, −, +, +, +, −, +}
   It is apparent that each organism in group I has a similar cellular constituent expression (or level) pattern. Further, this similar pattern distinguishes group I from group II. Likewise, each organism in group II has a similar cellular constituent (or level) pattern and this pattern distinguishes group II from group I. In this example, the ordered set of cellular constituents from step 5610 serves as a classifier that reclassifies the organisms into subtypes.

In some embodiments the clustering of step 5610 is not performed and only phenotypic vectors are clustered in order to identify such phenotypic clusters. However, it will be appreciated from the example above that the identification of cellular constituents that can discriminate the phenotypic clusters will be more easily identifiable in cases where the clustering of step 1510 is performed because the clustering of step 5610 will tend to group discriminating cellular constituents within each phenotypic vector.

It is noted that each of the subtypes (subgroups) obtained in this step are not obtained using classical phenotypic observations. Rather, each of the subtypes are identified using an ordered set of cellular constituents levels that discriminate between phenotypically distinguishable groups. As such, each of the subtypes identified in step 5612 may well represent distinct biochemical forms of the trait under study. For example, in the case where perturbations are applied in the preceding steps, each of the subtypes identified in this step could represent a different biochemical response associated with the trait.

In step 5612, the cellular constituents that can discriminate between the newly identified subgroups (subtypes) are determined. For example, consider the example above in which the following clusters were obtained:

Group I:
V₁={+, −, +, +, +, −, −, −, −, −}
V₃={+, +, +, +, +, −, −, −, −, −}

Group II:
V₂={−, −, −, −, −, +, +, +, +, +}
V₄={−, −, −, −, −, +, +, +, −, +}

where the order of the elements in each vector is

V_{M}={8, 9, 10, 4, 5, 6, 7, 1, 2, 3}

It can be seen that cellular constituents 8, 10, 4, 5, 6, 7, 1, and 3 discriminate between groups I and II whereas cellular constituents 9 and 2 do not discriminate. For example, cellular constituent 9 has the values (−/+) in group I and (−/−) in group II and cellular constituent 2 has the values (−/−) in group I and (+/−) in group II.

The set of cellular constituents that discriminate between subtypes (subgroups) identified in step 5612 serve as a classifier for the population under study. This classifier is capable of differentiating the general population into subtypes. While select organisms (e.g., phenotypically extreme organisms) were used in previous steps in order to identify and order the discriminating set of cellular constituents (the classifier), the cellular constituents identified in step 5612 are capable of classifying all the organisms in the general population into subgroups.

Return. Step 1512 serves to break a population down into subtypes. After step 1512, quantitative genetic methods are used to study the subpopulations.

### 5.2. Sources of Marker Data

Several forms of genetic markers that are used to construct marker map 78 are known in the art. A common genetic marker is single nucleotide polymorphisms (SNPs). SNPs occur approximately once every 600 base pairs in the genome. See, for example, Kruglyak and Nickerson, 2001, Nature Genetics 27, 235, which is hereby incorporated herein by reference in its entirety. The present invention contemplates the use of genotypic databases such as SNP databases as a source of genetic markers. Alleles making up blocks of such SNPs in close physical proximity are often correlated, resulting in reduced genetic variability and defining a limited number of “SNP haplotypes” each of which reflects descent from a single ancient ancestral chromosome. See Fullerton et al., 2000, Am. J. Hum. Genet. 67, 881, which is hereby incorporated herein by reference in its entirety. Such haplotype structure is useful in selecting appropriate genetic variants for analysis. Patil et al. found that a very dense set of SNPs is required to capture all the common haplotype information. Once common haplotype information is available, it can be used to identify much smaller subsets of SNPs useful for comprehensive whole-genome studies. See Patil et al., 2001, Science 294, 1719-1723, which is hereby incorporated herein by reference in its entirety.

Other suitable sources of genetic markers include databases that have various types of gene expression data from platform types such as spotted microarray (microarray), high-density oligonucleotide array (HDA), hybridization filter (filter) and serial analysis of gene expression (SAGE) data. Another example of a genetic database that can be used is a DNA methylation database. For details on a representative DNA methylation database, see Grunau et al., in press, MethDB—a public database for DNA methylation data, Nucleic Acids Research; or the URL: http://genome.imb-jena.de/public.html.

In one embodiment of the present invention, a set of genetic markers is derived from any type of genetic database that tracks variations in the genome of an organism of interest. Information that is typically represented in such databases is a collection of locus within the genome of the organism of interest. For each locus, strains for which genetic variation information is available are represented. For each represented strain, variation information is provided. Variation information is any type of genetic variation information. Representative genetic variation information includes, but is not limited to, single nucleotide polymorphisms, restriction fragment length polymorphisms, microsatellite markers, restriction fragment length polymorphisms, and short tandem repeats. Therefore, suitable genotypic databases include, but are not limited to:

| Genetic | |
|---|---|
| variation type | Uniform resource location |
| SNP | http://bioinfo.pal.roche.com/usuka_bioinformatics/ |
| | cgi-bin/msnp/msnp.pl |
| SNP | http://snp.cshl.org/ |
| SNP | http://www.ibc.wustl.edu/SNP/ |
| SNP | http://www-genome.wi.mit.edu/SNP/mouse/ |
| SNP | http://www.ncbi.nlm.nih.gov/SNP/ |
| Microsatellite | http://www.informatics.jax.org/searches/ |
| markers | polymorphism_form.shtml |
| Restriction fragment | http://www.informatics.jax.org/searches/ |
| length | polymorphism_form.shtml |
| polymorphisms | |
| Short tandem | http://www.cidr.jhmi.edu/mouse/mmset.html |
| repeats | |
| Sequence length | http://mcbio.med.buffalo.edu/mit.html |
| polymorphisms | |
| DNA methylation | http://genome.imb-jena.de/public.html |
| database | |
| Short tandem-repeat | Broman et al., 1998, Comprehensive human genetic |
| polymorphisms | maps: Individual and sex-specific variation in |
| | recombination, American Journal of Human |
| | Genetics 63: 861-869, which is hereby |
| | incorporated herein by reference in its |
| | entirety |
| Microsatellite | Kong et al., 2002, A high-resolution recombination |
| markers | map of the human genome, Nat Genet 31: 241-247, |
| | which is hereby incorporated herein by reference in |
| | its entirety |

In addition, the genetic variations used by the methods of the present invention may involve differences in the expression levels of genes rather than actual identified variations in the composition of the genome of the organism of interest. Therefore, genotypic databases within the scope of the present invention include a wide array of expression profile databases such as the one found at the URL: http://www.ncbi.nlm.nih.gov/geo/.

Another form of genetic marker that may be used to construct marker map 78 is restriction fragment length polymorphisms (RFLPs). RFLPs are the product of allelic differences between DNA restriction fragments caused by nucleotide sequence variability. As is well known to those of skill in the art, RFLPs are typically detected by extraction of genomic DNA and digestion with a restriction endonuclease. Generally, the resulting fragments are separated according to size and hybridized with a probe; single copy probes are preferred. As a result, restriction fragments from homologous chromosomes are revealed. Differences in fragment size among alleles represent an RFLP (see, for example, Helentjaris et al., 1985, Plant Mol. Bio. 5:109-118, and U.S. Pat. No. 5,324,631, each of which is hereby incorporated herein by reference in its entirety). Another form of genetic marker that may be used to construct marker map 78 is random amplified polymorphic DNA (RAPD). The phrase “random amplified polymorphic DNA” or “RAPD” refers to the amplification product of the distance between DNA sequences homologous to a single oligonucleotide primer appearing on different sites on opposite strands of DNA. Mutations or rearrangements at or between binding sites will result in polymorphisms as detected by the presence or absence of amplification product (see, for example, Welsh and McClelland, 1990, Nucleic Acids Res. 18:7213-7218; Hu and Quiros, 1991, Plant Cell Rep. 10:505-511, each of which is hereby incorporated herein by reference in its entirety). Yet another form of genetic marker map that may be used to construct marker map 78 is amplified fragment length polymorphisms (AFLP). AFLP technology refers to a process that is designed to generate large numbers of randomly distributed molecular markers (see, for example, European Patent Application No. 0534858 A1). Still another form of genetic marker map that may be used to construct marker map 78 is “simple sequence repeats” or “SSRs”. SSRs are di-, tri- or tetra-nucleotide tandem repeats within a genome. The repeat region may vary in length between genotypes while the DNA flanking the repeat is conserved such that the same primers will work in a plurality of genotypes. A polymorphism between two genotypes represents repeats of different lengths between the two flanking conserved DNA sequences (see, for example, Akagi et al., 1996, Theor. Appl. Genet. 93, 1071-1077; Bligh et al., 1995, Euphytica 86:83-85; Struss et al., 1998, Theor. Appl. Genet. 97, 308-315; Wu et al., 1993, Mol. Gen. Genet. 241, 225-235; and U.S. Pat. No. 5,075,217, each of which is hereby incorporated herein by reference in its entirety). SSR are also known as satellites or microsatellites.

As described above, many genetic markers suitable for use with the present invention are publicly available. Those skilled in the art can also readily prepare suitable markers. For molecular marker methods, see generally, The DNA Revolution by Andrew H. Paterson 1996 (Chapter 2) in: Genome Mapping in Plants (ed. Andrew H. Paterson) by Academic Press/R. G. Landis Company, Austin, Tex., 7-21, which is hereby incorporated herein by reference in its entirety.

### 5.3. Exemplary Normalization Routines

A number of different normalization protocols can be used by normalization module 72 to normalize cellular constituent abundance data 44. Some such normalization protocols are described in this section. Typically, the normalization comprises normalizing the expression level measurement of each gene in a plurality of genes that is expressed by an organism in a population of interest. Many of the normalization protocols described in this section are used to normalize microarray data. It will be appreciated that there are many other suitable normalization protocols that may be used in accordance with the present invention. All such protocols are within the scope of the present invention. Many of the normalization protocols found in this section are found in publicly available software, such as Microarray Explorer (Image Processing Section, Laboratory of Experimental and Computational Biology, National Cancer Institute, Frederick, Md. 21702, USA).

One normalization protocol is Z-score of intensity. In this protocol, raw expression intensities are normalized by the (mean intensity)/(standard deviation) of raw intensities for all spots in a sample. For microarray data, the Z-score of intensity method normalizes each hybridized sample by the mean and standard deviation of the raw intensities for all of the spots in that sample. The mean intensity mnI₁ and the standard deviation sdI₁ are computed for the raw intensity of control genes. It is useful for standardizing the mean (to 0.0) and the range of data between hybridized samples to about −3.0 to +3.0. When using the Z-score, the Z differences (Z_{diff}) are computed rather than ratios. The Z-score intensity (Z-scoreᵢⱼ) for intensity Iᵢⱼ for probe i (hybridization probe, protein, or other binding entity) and spot j is computed as:
Z-scoreᵢⱼ=(Iᵢⱼ−mnIᵢ)/sdIᵢ,
and
Zdiffⱼ(x,y)=Z-scoreₓⱼ−Z-score_{yj}

where x represents the x channel and y represents the y channel.

Another normalization protocol is the median intensity normalization protocol in which the raw intensities for all spots in each sample are normalized by the median of the raw intensities. For microarray data, the median intensity normalization method normalizes each hybridized sample by the median of the raw intensities of control genes (medianIᵢ) for all of the spots in that sample. Thus, upon normalization by the median intensity normalization method, the raw intensity Iᵢⱼ for probe i and spot j, has the value Imᵢⱼ where,
Imᵢⱼ=(Iᵢⱼ/medianIᵢ).

Another normalization protocol is the log median intensity protocol. In this protocol, raw expression intensities are normalized by the log of the median scaled raw intensities of representative spots for all spots in the sample. For microarray data, the log median intensity method normalizes each hybridized sample by the log of median scaled raw intensities of control genes (medianIᵢ) for all of the spots in that sample. As used herein, control genes are a set of genes that have reproducible accurately measured expression values. The value 1.0 is added to the intensity value to avoid taking the log(0.0) when intensity has zero value. Upon normalization by the median intensity normalization method, the raw intensity Iᵢⱼ for probe i and spot j, has the value Imᵢⱼ where,
Imᵢⱼ=log(1.0+(Iᵢⱼ/medianIᵢ)).

Yet another normalization protocol is the Z-score standard deviation log of intensity protocol. In this protocol, raw expression intensities are normalized by the mean log intensity (mnLIᵢ) and standard deviation log intensity (sdLIᵢ). For microarray data, the mean log intensity and the standard deviation log intensity is computed for the log of raw intensity of control genes. Then, the Z-score intensity ZlogSᵢⱼ for probe i and spot j is:
ZlogSᵢⱼ=(log(Iᵢⱼ)−mnLIᵢ)/sdLIᵢ.

Still another normalization protocol is the Z-score mean absolute deviation of log intensity protocol. In this protocol, raw expression intensities are normalized by the Z-score of the log intensity using the equation (log(intensity)-mean logarithm)/standard deviation logarithm. For microarray data, the Z-score mean absolute deviation of log intensity protocol normalizes each bound sample by the mean and mean absolute deviation of the logs of the raw intensities for all of the spots in the sample. The mean log intensity mnLIᵢ and the mean absolute deviation log intensity madLIᵢ are computed for the log of raw intensity of control genes. Then, the Z-score intensity ZlogAᵢⱼ for probe i and spot j is:
ZlogAᵢⱼ=(log(Iᵢⱼ)−mnLIᵢ)/madLIᵢ.

Another normalization protocol is the user normalization gene set protocol. In this protocol, raw expression intensities are normalized by the sum of the genes in a user defined gene set in each sample. This method is useful if a subset of genes has been determined to have relatively constant expression across a set of samples. Yet another normalization protocol is the calibration DNA gene set protocol in which each sample is normalized by the sum of calibration DNA genes. As used herein, calibration DNA genes are genes that produce reproducible expression values that are accurately measured. Such genes tend to have the same expression values on each of several different microarrays. The algorithm is the same as user normalization gene set protocol described above, but the set is predefined as the genes flagged as calibration DNA.

Yet another normalization protocol is the ratio median intensity correction protocol. This protocol is useful in embodiments in which a two-color fluorescence labeling and detection scheme is used. See, for example, section 5.8.1.5. In the case where the two fluors in a two-color fluorescence labeling and detection scheme are Cy3 and Cy5, measurements are normalized by multiplying the ratio (Cy3/Cy5) by medianCy5/medianCy3 intensities. If background correction is enabled, measurements are normalized by multiplying the ratio (Cy3/Cy5) by (medianCy5-medianBkgdCy5)/(medianCy3-medianBkgdCy3) where medianBkgd means median background levels.

In some embodiments, intensity background correction is used to normalize measurements. The background intensity data from a spot quantification programs may be used to correct spot intensity. Background may be specified as either a global value or on a per-spot basis. If the array images have low background, then intensity background correction may not be necessary.

### 5.4. Logarithm of the Odds Scores

Denoting the joint probability of inheriting all genotypes P(g), and the joint probability of all observed data x (trait and marker species) conditional on genotypes P(x|g), the likelihood L for a set of data is
L=ΣP(g)P(x|g)
where the summation is over all the possible joint genotypes g (trait and marker) for all pedigree members. What is unknown in this likelihood is the recombination fraction 0, on which P(g) depends.

The recombination fraction θ is the probability that two loci will recombine during meioses. The recombination fraction θ is correlated with the distance between two loci. By definition, the genetic distance is defined to be infinity between the loci on different chromosomes (nonsyntenic loci), and for such unlinked loci, θ=0.5. For linked loci on the same chromosome (syntenic loci), θ<0.5, and the genetic distance is a monotonic function of θ. See, e.g., Ott, 1985, Analysis of Human Genetic Linkage, first edition, Baltimore, Md., John Hopkins University Press, which is hereby incorporated herein by reference in its entirety. The essence of linkage analysis described in Section 5.13, is to estimate the recombination fraction θ and to test whether θ=0.5. When the position of one locus in the genome is known, genetic linkage can be exploited to obtain an estimate of the chromosomal position of a second locus relative to the first locus. In linkage analysis described in Section 5.2, linkage analysis is used to map the unknown location of genes predisposing to various quantitative phenotypes relative to a large number of marker loci in a genetic map. In the ideal situation, where recombinant and nonrecombinant meioses can be counted unambiguously, θ is estimated by the frequency of recombinant meioses in a large sample of meioses. If two loci are linked, then the number of nonrecombinant meioses N is expected to be larger than the number of recombinant meioses R. The recombination fraction between the new locus and each marker can be estimated as:

$${θ}^{⋒} = \frac{R}{N + R}$$

The likelihood of interest is:
L=ΣP(g|θ)P(x|g)
and inferences are based about a test recombination fraction θ on the likelihood ratio Λ=L(θ)/L(1/2) or, equivalently, its logarithm.

Thus, in a typical clinical genetics study, the likelihood of the trait and a single marker is computed over one or more relevant pedigrees. This likelihood function L(θ) is a function of the recombination fraction θ between the trait (e.g., classical trait or quantitative trait) and the marker locus. The standardized loglikelihood Z(θ)=log₁₀[L(θ)/L(1/2)] is referred to as a lod score. Here, “lod” is an abbreviation for “logarithm of the odds.” A lod score permits visualization of linkage evidence. As a rule of thumb, in human studies, geneticists provisionally accept linkage if
Z(\hat{θ})≧3
at its maximum θ on the interval [0,1/2], where \hat{θ} represents the maximum θ on the interval. Further, linkage is provisionally rejected at a particular θ if Z(\hat{θ})≦−2.
However, for complex traits, other rules have been suggested. See, for example, Lander and Kruglyak, 1995, Nature Genetics 11, p. 241.

Acceptance and rejection are treated asymmetrically because, with 22 pairs of human autosomes, it is unlikely that a random marker even falls on the same chromosome as a trait locus. See Lange, 1997, Mathematical and Statistical Methods for Genetic Analysis, Springer-Verlag, New York; Olson, 1999, Tutorial in Biostatistics: Genetic Mapping of Complex Traits, Statistics in Medicine 18, 2961-2981, each of which is hereby incorporated herein by reference in its entirety.

When the value of L is large, the null hypothesis of no linkage, L(1/2), to a marker locus of known location can be rejected, and the relative location of the locus corresponding to the quantitative trait can be estimated by \hat{θ}. Therefore, lod scores provide a method to calculate linkage distances as well as to estimate the probability that two genes (and/or QTLs) are linked.

Those of skill in the art will appreciate that lod score computation is species dependent. For example, methods for computing the lod score in mouse different from that described in this section. However, methods for computing lod scores are known in the art and the method described in this section is only by way of illustration and not by limitation.

### 5.5. Causality Test

This section provides more details on the causality test that is applied in step 718 of FIG. 7B. Let G be a gene expression trait for some gene g, and let T be a clinical trait. For the correlation between G and T, it is of interest to determine those genetic and environmental components driving the association, and it is of interest to determine whether an assessment can be made in a genetics context as to whether one trait drives the other. That is, does one of the relationships depicted in FIG. 13A hold.

It is not possible to look at these two traits in isolation and determine whether either one of the cases depicted in FIG. 13A holds. In the more classical graphical modeling context, where the aim is to reconstruct a complex network, different graphical structures are assessed and edges are weighted and directed in such structures using mutual information measures that examine all adjacent triplets (say, X, Y, and Z), where these variables represent any combination of QTL, expression trait or clinical trait in the graph where the topology of the graph is constrained a priori to satisfy certain mathematical conditions.

Without the genetic information described herein this network reconstruction problem is difficult because many of the different possibilities that are considered are not distinguishable. For instance, consider the three possible relationships among three traits of interest depicted in FIG. 13B. Cases (i) and (ii) are not distinguishable because they have the same dependency structure. This presents problems for reliable reconstruction of genetic networks given correlation data alone, since in many instances it will simply not be possible to direct edges (directing the edges in such graphs establishes the cause and effect relationships of interest to us in reconstructing pathways associated with disease).

The embodiment of the invention outlined in Section 5.1, above, and shown in FIG. 7, has the significant advantage in that gene expression data and clinical traits are linked to (correlated with) quantitative trait loci (QTL). The QTL information provides a powerful filter that allows for the rapid restriction of attention from all significantly correlated cellular constituents and trait values to those subsets of cellular constituents and traits that are under the control of a common set of QTL. The triplets described in FIG. 13B then become QTL and traits and it is possible to initially direct an edge between the QTL and a single trait by definition of a QTL, and then test all other traits pair wise as discussed below to determine how the trait pairs are positioned relative to one another. For instance, going back to the case of a clinical trait T linked to a QTL Q, the relationship between Q and T can be immediately fixed as illustrated in FIG. 13C. The relationship in FIG. 13C holds because Q is a QTL for T, and the QTL provides the direction of the relationship (T depends from Q) since Q is causal for T (e.g., variations in the DNA at the QTL location lead to variations in T). To position a given gene expression trait, G, that is correlated with T, all that is required is a test for mutual independence of Q and T given G. That is, if T and Q are independent given G, then the (Q, T, G) triplet has the form depicted in FIG. 13D. However, lack of independence given G indicates one of the alternative possibilities given by FIG. 13E.

The methods discussed below can be applied to determine which of the two structures (FIG. 13D versus FIG. 13E) is supported by the data.

More formally, a determination of whether T is correlated with the genotypes at Q, conditional on G is desired in order to assess if the following property holds:
P(T,Q|G)=P(T|G)P(Q|G).
This property is satisfied only if T and Q are conditionally dependent upon G. For formal theoretical support for this conditional dependence property, see Pearl, 1988, Probabilistic Reasoning In Intelligent Systems: Networks of Plausible Inference, Revised Second Printing, Morgan Kaufmann Publishers, Inc., San Francisco, Calif., Section 3.1.2. This conditional dependency property is related to the mutual information measure that is typically used in network reconstruction problems:

$$I ( T , Q \text{\vert} G ) = {\sum }_{T , Q , G} P ( T , Q , G ) log ( \frac{P ( T , Q \text{\vert} G )}{P ( T \text{\vert} G ) P ( Q \text{\vert} G )} ) ,$$

where the summation symbol indicates the continuous variables T and G have been discretized to allow for efficient computation over complicated graph structures, as is usually done in network reconstruction problems. The use of mutual information is the reduction in uncertainty about one variable due to the knowledge of the other variable. See, for example, Duda et al., 2001, Pattern Classification, John Wiley & Sons, Inc., New York, p 632.

While the mutual information measure is useful in more general network reconstruction problems, the problem addressed by the instant causality test is significantly more simple than the general case because of the novel requirement that T and G are both linked to Q. This novel requirement leads to a more robust and more powerful test for causality. The purpose of the causality test of the present invention is to position a cellular constituent on the causal or reactive side of a clinical trait of interest, which can be accomplished by testing for independence of T and Q, conditional on G, as discussed above.

In developing a test for independence, a few observations help clarify the specifics of such a test. First, it is assumed a priori that G and T are significantly correlated to Q. That is, these quantitative traits both have QTL at position Q that give rise to significant LOD scores. Second, it is noted that
P(T,Q|G)=P(T|Q,G)P(Q|G),
so that
P(T,Q|G)=P(T|G)P(Q|G),
if and only if
P(T|Q,G)=P(T|G),
whenever P(Q|G)>0.
These relationships follow from the conditional independence of T and Q given G. Therefore, the term P(Q|G) can be ignored and the focus can center on the single conditional probability. What this last equation implies is that if that portion of the correlation between T and Q that can be explained by the correlation between G and Q is conditioned out, then a determination can be made as to whether the remaining correlation between T and Q is still significant. If not, then it is expected that a significant QTL for T|Q and G|Q will arise, but that no significant QTL for T|Q, G will arise. By forming the loglikelihood ratio based on these two probability densities, the significance of the resulting LOD score can be used as the significance level for the test of independence.

Before forming the conditional likelihoods based on the conditional probability density functions discussed above, the likelihood for G and T for a single animal in an F₂ population are formed, where G and T are taken to be jointly normally distributed, allowing for dependency between G and T. Under the null hypothesis of no correlation between (T, G) and genotypes at location Q, the likelihood for animal i is:

$$l ( {θ}_{0} ; {t}_{i} , {g}_{i} ) = \frac{1}{2 {πσ}_{G} {σ}_{T} \sqrt{1 - {ρ}^{2}}} exp \{ - \frac{1}{2 ( 1 - {ρ}^{2} )} [ \frac{{( {t}_{i} - {μ}_{T} )}^{2}}{{σ}_{T}^{2}} - 2 ρ \frac{( {t}_{i} - {μ}_{T} ) ( {g}_{i} - {μ}_{G} )}{{σ}_{T} {σ}_{G}} + \frac{{( {g}_{i} - {μ}_{G} )}^{2}}{{σ}_{G}^{2}} ] \} ,$$

where θ₀=(μ_{T},μ_{G},σ_{T},σ_{G},ρ) is the parameter vector for the likelihood, and ρ is the correlation between G and T. Under the alternative hypothesis where G and T are correlated with Q, the likelihood is:

$$l ( {θ}_{A} ; {t}_{i} , {g}_{i} \vert Q ) = {\sum }_{j = 1}^{3} P ( {Q}_{j} ) [ \frac{1}{2 {πσ}_{G} {σ}_{T} \sqrt{1 - {ρ}^{2}}} exp ( - \frac{{q}_{{Q}_{j}}}{2} ) ] ,$$

where

$${q}_{{Q}_{j}} = \{ - \frac{1}{1 - {ρ}^{2}} [ \frac{{( {t}_{i} - {μ}_{{T}_{{Q}_{j}}} )}^{2}}{{σ}_{T}^{2}} - 2 ρ \frac{\begin{matrix}( {t}_{i} - {μ}_{{T}_{{Q}_{j}}} ) \\ ( {g}_{i} - {μ}_{{G}_{{Q}_{j}}} )\end{matrix}}{{σ}_{T} {σ}_{G}} + \frac{{( {g}_{i} - {μ}_{{G}_{{Q}_{j}}} )}^{2}}{{σ}_{G}^{2}} ] \} , \\ {θ}_{A} = ( {μ}_{{T}_{{Q}_{1}}} , {μ}_{{T}_{{Q}_{2}}} , {μ}_{{T}_{{Q}_{3}}} , {μ}_{{GQ}_{1}} , {μ}_{{GQ}_{2}} , {μ}_{{GQ}_{3}} , {σ}_{T} , {σ}_{G} , ρ ) ,$$

and P(Qⱼ) is the probability of genotype Qⱼ at locus Q. Given these likelihoods for the individual animals in an F₂ population, the full likelihood over all N animals for the null and alternative hypotheses, respectively, are:

$$L ( {θ}_{0} ; G , T ) = {\prod }_{i = 1}^{N} l ( {θ}_{0} ; {g}_{i} , {t}_{i} )$$

$$and$$

$$L ( {θ}_{A} ; G , T \vert Q ) = {\prod }_{i = 1}^{N} l ( {θ}_{A} ; {g}_{i} , {t}_{i} \vert Q ) .$$

For each likelihood defined above the maximum likelihood estimates for θ₀ and θ_{A}, \hat{θ}₀ and \hat{θ}_{A} are obtained. The likelihood ratio statistic is:

$$LR = - 2 ln ( \frac{L ( {\hat{θ}}_{0} ; G , T )}{L ( {\hat{θ}}_{A} ; G , T \vert Q )} ) ,$$

which is χ² distributed with 4 degrees of freedom.

With these maximum likelihood estimates in hand for the null and alternative hypotheses, it is possible to compute the conditional likelihoods that are needed to assess conditional independence of T and Q. The form of the conditional likelihood for T|G (the conditional likelihood under the null hypothesis) for a single animal is:

$${l}^{′} ( {θ}_{0} ; {t}_{i} \vert {g}_{i} ) = \frac{1}{\sqrt{2 π ( 1 - {ρ}^{2} )}} exp [ - \frac{( {t}_{i} - b )}{2 {σ}_{T}^{2} ( 1 - {ρ}^{2} )} ] ,$$

where

$$b = {μ}_{T} + ρ \frac{{σ}_{T}}{{σ}_{G}} ( {z}_{i} - {μ}_{G} ) .$$

The corresponding conditional likelihood under the alternative hypothesis is:

$${l}^{′} ( {θ}_{A} ; {t}_{i} \vert {g}_{i} , Q ) = {\sum }_{j = 1}^{3} P ( {Q}_{j} ) \frac{1}{\sqrt{2 π ( 1 - {ρ}^{2} )}} exp [ - \frac{( {t}_{i} - {b}_{{Q}_{j}} )}{2 {σ}_{T}^{2} ( 1 - {ρ}^{2} )} ] ,$$

where

$$b = {μ}_{{T}_{{Q}_{j}}} + ρ \frac{{σ}_{T}}{{σ}_{G}} ( {g}_{i} - {μ}_{{G}_{{Q}_{j}}} ) .$$

The full likelihoods are:

$${L}^{′} ( {θ}_{0} ; T \vert G ) = {\prod }_{i = 1}^{N} {l}^{′} ( {θ}_{0} ; {t}_{i} \vert {g}_{i} )$$

$$and$$

$${L}^{′} ( {θ}_{A} ; T \vert G , Q ) = {\prod }_{i = 1}^{N} {l}^{′} ( {θ}_{A} ; {t}_{i} \vert {g}_{i} , Q ) .$$

Finally, from this, the conditional likelihood ratio test statistic of interest is obtained:

$${LR}^{′} = - 2 ln ( \frac{{L}^{′} ( {\hat{θ}}_{0} ; T \vert G )}{{L}^{′} ( {\hat{θ}}_{A} ; T \vert G , Q )} ) ,$$

where \hat{θ}₀ and \hat{θ}_{A} are the maximum likelihood estimates obtained from L₀ and L_{A} defined above.

### 5.6. Multivariate Statistical Models

Using the methods of the present invention, candidate pathway groups are identified from the analysis of QTL interaction map data and gene expression cluster maps. Each candidate pathway group includes a number of genes. The methods of the present invention are advantageous because they filter the potentially thousands of genes in the genome of the population of interest into a few candidate pathway groups using clustering techniques. In a typical case, a candidate pathway group represents a group of genes that tightly cluster in a gene expression cluster map. The genes in a candidate pathway group may also cluster tightly in a QTL interaction map. The QTL interaction map serves as a complementary approach to defining the genes in a candidate pathway group. For example, consider the case in which genes A, B, and C cluster tightly in a gene expression cluster map. Furthermore, genes A, B, C and D cluster tightly in the corresponding QTL interaction map. In this example, analysis of the gene expression cluster map alone suggest that genes A, B, and C form a candidate pathway group. However, analysis of both the QTL interaction map and the gene expression cluster map suggest that the candidate pathway group comprises genes A, B, C, and D.

Once candidate pathway groups have been identified, multivariate statistical techniques can be used to determine whether each of the genes in the candidate pathway group affect a particular trait, such as a complex disease trait. The form of multivariate statistical analysis used in some embodiments of the present invention is dependent upon on the type of genotype and/or pedigree data that is available.

Typically, more pedigree data is available in cases where the population to be studied is plants or animals. In such instances, the multivariate statistical models such as those of Jiang and Zeng, 1995, Nature Genetics 140, pp. 1111-1127, as well as the techniques implemented in QTL Cartographer (Basten and Zeng, 1994, Zmap-a QTL cartographer, Proceedings of the 5th World Congress on Genetics Applied to Livestock Production: Computing Strategies and Software 22, Smith et al. eds., pp. 65-66, The Organizing Committee, 5th World Congress on Genetics Applied to Livestock Production, Guelph, Ontario, Canada; Basten et al., 2001, QTL Cartographer, Version 1.15, Department of Statistics, North Carolina State University, Raleigh, N.C., each of which is hereby incorporated herein by reference in its entirety. In addition, marker regression (joint mapping, marker-difference regression, MDR), interval mapping with marked cofactors, and composite interval mapping can be used. See, for example, Lynch & Walsh, 1998, Genetics and Analysis of Quantitative Traits, Sinauer Associates, Inc., Sunderland, Mass., which is hereby incorporated herein by reference in its entirety.

Jiang and Zeng have developed a multiple-trait extension to composite interval mapping (CIM). See, for example, Jiang and Zeng, 1995, Genetics 140, p. 1111, which is hereby incorporated herein by reference in its entirety. CIM refers to the general approach of adding marker cofactors to an otherwise standard interval analysis (e.g., QTL detection using linear models or via maximum likelihood). CIM handles multiple QTLs by incorporating multilocus marker information from organisms by modifying standard interval mapping to include additional markers as cofactors for analysis. See, for example, Jansen, 1993, Genetics 135, p. 205; Zeng, 1994, Genetics 136, p. 1457, each of which is hereby incorporated herein by reference in its entirety. The multiple-trait extension to CIM developed by Jiang and Zeng provides a framework for testing the candidate pathway groups that are constructed using the methods of the present invention in cases where the genes in these candidate pathway groups link to the same genetic region. The methods of Jiang and Zeng allow for the determination as to whether expression values (for the genes in the candidate pathway group) linking to the same region are controlled by a single gene pleiotropy) or by two closely linked genes. If the methods of Jiang and Zeng suggest that multiple genes are actually controlled by closely linked loci (closely linked genes), then there is not support that the genes linking to the same region are in the same pathway. Moreover, the components (hierarchy) of a pathway can be deduced by testing subsets of the pathway group to see which genes have an underlying pleiotropic relationship with respect to other genes. Further, the definition of the candidate pathway group can be refined by eliminating specific genes in the candidate pathway group that do not have a pleiotropic relationship with other genes in the candidate pathway group. The idea is to determine which of the genes linking to given region, have other genes linking to their physical location, indicating the order for hierarchy and control.

Presently, the practical limits are that no more than ten genes can be handled at once using multivariate methods such as the Jiang and Zeng methods. Theoretically, the number of genes is limited by the amount of data available to fit the model, but the particular limitation is that the optimization techniques are not effective for greater than 10 dimensions. However, in some embodiments, more than 10 genes can be handled at once by implementing dimensionality reductions techniques (like principal components).

For human genotype and pedigree data, methods described in Allison, 1998, Multiple Phenotype Modeling in Gene-Mapping Studies of Quantitative Traits: Power Advantages, Am J, Hum. Genetics 63, pp. 1190-1201, are used, including, but not limited to, those of Amos et al., 1990, Am J. Hum. Genetics 47, pp. 247-254, each of which is hereby incorporated herein by reference in its entirety.

In some embodiments, gene expression data 44 is collected for multiple tissue types. In such instances, multivariate analysis can be used to determine the true nature of a complex disease. Multivariate techniques used in this embodiment of the invention are described, in part, in Williams et al., 1999, Am J. Hum Genet 65(4): 1134-47; Amos et al., 1990, Am J. Hum Genet 47(2): 247-54, and Jiang and Zeng, 1995, Nature Genetics 140:1111-1127, each of which is hereby incorporated herein by reference in its entirety.

Asthma provides one example of a complex disease that can be studied using expression data from multiple tissue types. Asthma is expected to, in part, be influenced by immune system response not only in lungs but also in blood. By measuring expression of genes in the lung and in blood, the following model could be used to dissect the shared genetic effect in a model system, e.g. an F2 mouse cross:
yⱼ₁=α₁+b₁xⱼ+d₁zⱼ+eⱼ₁
yⱼ₂=α₂+b₂xⱼ+d₂zⱼ+eⱼ₂
•
•
•
yⱼₘ=αₘ+bₘxⱼ+dₘzⱼ+eⱼₘ

where, for individual j and a putative QTL:

yⱼ₁, . . . , yⱼₘ consists of asthma relevant phenotypes, expression data for gene expression in the lung and expression data for gene expression in blood;

xⱼ is the number of QTL alleles from a specific parental line;

zⱼ is 1 if the individual is heterozygous for the QTL and 0 otherwise;

αᵢ represents the mean for phenotype i;

bᵢ and dᵢ represent the additive and dominance effects of the QTL on phenotype i; and

eⱼᵢ is the residual error for individual j and phenotype i.

It is typically assumed that the residuals are uncorrelated between individuals, and the correlation between residuals within an individual are modeled as Cov(eⱼₖ, eⱼ₁)=ρₖ₁σₖ σ₁. Assuming a multivariate normal distribution for the residuals, likelihood analysis can be used to test for joint linkage of a QTL to the trait vector and to test for pleiotropic effects versus close linkage. With such information, it would be possible to detect a QTL that influences susceptibility to asthma through causing changes in gene expression for a set of genes expressed in blood and for a set of, potentially overlapping, genes expressed in lung. Such multivariate analyses in accordance with the present invention, combined with high quality phenotypic data that includes expression data across multiple tissues, allows for improved detection of those genes truly influencing susceptibility to complex diseases.

### 5.7. Analytic Kit Implementation

In one embodiment, the methods of this invention can be implemented by use of kits for determining genes that are causal for traits. Such kits contain microarrays, such as those described in Subsections below. The microarrays contained in such kits comprise a solid phase, e.g., a surface, to which probes are hybridized or bound at a known location of the solid phase. Preferably, these probes consist of nucleic acids of known, different sequence, with each nucleic acid being capable of hybridizing to an RNA species or to a cDNA species derived therefrom. In a particular embodiment, the probes contained in the kits of this invention are nucleic acids capable of hybridizing specifically to nucleic acid sequences derived from RNA species in cells collected from an organism of interest.

In a preferred embodiment, a kit of the invention also contains one or more databases described above and in FIG. 1, encoded on computer readable medium, and/or an access authorization to use the databases described above from a remote networked computer.

In another preferred embodiment, a kit of the invention further contains software capable of being loaded into the memory of a computer system such as the one described supra, and illustrated in FIG. 1. The software contained in the kit of this invention, is essentially identical to the software described above in conjunction with FIG. 1.

Alternative kits for implementing the analytic methods of this invention will be apparent to one of skill in the art and are intended to be comprehended within the accompanying claims.

### 5.8. Transcriptional State Measurements

This section provides some exemplary methods for measuring the expression level of genes, which are one type of cellular constituent. One of skill in the art will appreciate that this invention is not limited to the following specific methods for measuring the expression level of genes in each organism in a plurality of organisms.

### 5.8.1. Transcript Assay Using Microarrays

The techniques described in this section are particularly useful for the determination of the expression state or the transcriptional state of a cell or cell type or any other cell sample by monitoring expression profiles. These techniques include the provision of polynucleotide probe arrays that can be used to provide simultaneous determination of the expression levels of a plurality of genes. These technique further provide methods for designing and making such polynucleotide probe arrays.

The expression level of a nucleotide sequence in a gene can be measured by any high throughput techniques. However measured, the result is either the absolute or relative amounts of transcripts or response data, including but not limited to values representing abundances or abundance rations. Preferably, measurement of the expression profile is made by hybridization to transcript arrays, which are described in this subsection. In one embodiment, “transcript arrays” or “profiling arrays” are used. Transcript arrays can be employed for analyzing the expression profile in a cell sample and especially for measuring the expression profile of a cell sample of a particular tissue type or developmental state or exposed to a drug of interest.

In one embodiment, an expression profile is obtained by hybridizing detectably labeled polynucleotides representing the nucleotide sequences in mRNA transcripts present in a cell (e.g., fluorescently labeled cDNA synthesized from total cell mRNA) to a microarray. A microarray is an array of positionally-addressable binding (e.g., hybridization) sites on a support for representing many of the nucleotide sequences in the genome of a cell or organism, preferably most or almost all of the genes. Each of such binding sites consists of polynucleotide probes bound to the predetermined region on the support. Microarrays can be made in a number of ways, of which several are described herein below. However produced, microarrays share certain characteristics. The arrays are reproducible, allowing multiple copies of a given array to be produced and easily compared with each other. Preferably, the microarrays are made from materials that are stable under binding (e.g., nucleic acid hybridization) conditions. Microarrays are preferably small, e.g., between 1 cm² and 25 cm², preferably 1 to 3 cm². However, both larger and smaller arrays are also contemplated and may be preferable, e.g., for simultaneously evaluating a very large number or very small number of different probes.

Preferably, a given binding site or unique set of binding sites in the microarray will specifically bind (e.g., hybridize) to a nucleotide sequence in a single gene from a cell or organism (e.g., to exon of a specific mRNA or a specific cDNA derived therefrom).

The microarrays used can include one or more test probes, each of which has a polynucleotide sequence that is complementary to a subsequence of RNA or DNA to be detected. Each probe typically has a different nucleic acid sequence, and the position of each probe on the solid surface of the array is usually known. Indeed, the microarrays are preferably addressable arrays, more preferably positionally addressable arrays. Each probe of the array is preferably located at a known, predetermined position on the solid support so that the identity (i.e., the sequence) of each probe can be determined from its position on the array (i.e., on the support or surface). In some embodiments, the arrays are ordered arrays.

Preferably, the density of probes on a microarray or a set of microarrays is 100 different (i.e., non-identical) probes per 1 cm² or higher. More preferably, a microarray used in the methods of the invention will have at least 550 probes per 1 cm², at least 1,000 probes per 1 cm², at least 1,500 probes per 1 cm² or at least 2,000 probes per 1 cm². In a particularly preferred embodiment, the microarray is a high density array, preferably having a density of at least 2,500 different probes per 1 cm². The microarrays used in the invention therefore preferably contain at least 2,500, at least 5,000, at least 10,000, at least 15,000, at least 20,000, at least 25,000, at least 50,000 or at least 55,000 different (i.e., non-identical) probes.

In one embodiment, the microarray is an array (e.g., a matrix) in which each position represents a discrete binding site for a nucleotide sequence of a transcript encoded by a gene (e.g., for an exon of an mRNA or a cDNA derived therefrom). The collection of binding sites on a microarray contains sets of binding sites for a plurality of genes. For example, in various embodiments, the microarrays of the invention can comprise binding sites for products encoded by fewer than 50% of the genes in the genome of an organism. Alternatively, the microarrays of the invention can have binding sites for the products encoded by at least 50%, at least 75%, at least 85%, at least 90%, at least 95%, at least 99% or 100% of the genes in the genome of an organism. In other embodiments, the microarrays of the invention can having binding sites for products encoded by fewer than 50%, by at least 50%, by at least 75%, by at least 85%, by at least 90%, by at least 95%, by at least 99% or by 100% of the genes expressed by a cell of an organism. The binding site can be a DNA or DNA analog to which a particular RNA can specifically hybridize. The DNA or DNA analog can be, e.g., a synthetic oligomer or a gene fragment, e.g. corresponding to an exon.

In some embodiments of the present invention, a gene or an exon in a gene is represented in the profiling arrays by a set of binding sites comprising probes with different polynucleotides that are complementary to different sequence segments of the gene or the exon. Such polynucleotides are preferably of the length of 15 to 200 bases, more preferably of the length of 20 to 100 bases, most preferably 40-60 bases. Each probe sequence may also comprise linker sequences in addition to the sequence that is complementary to its target sequence. As used herein, a linker sequence is a sequence between the sequence that is complementary to its target sequence and the surface of support. For example, in preferred embodiments, the profiling arrays of the invention comprise one probe specific to each target gene or exon. However, if desired, the profiling arrays may contain at least 2, 5, 10, 100, or 1000 or more probes specific to some target genes or exons. For example, the array may contain probes tiled across the sequence of the longest mRNA isoform of a gene at single base steps.

In specific embodiments of the invention, when an exon has alternative spliced variants, a set of polynucleotide probes of successive overlapping sequences, i.e., tiled sequences, across the genomic region containing the longest variant of an exon can be included in the exon profiling arrays. The set of polynucleotide probes can comprise successive overlapping sequences at steps of a predetermined base intervals, e.g. at steps of 1, 5, or 10 base intervals, span, or are tiled across, the mRNA containing the longest variant. Such sets of probes therefore can be used to scan the genomic region containing all variants of an exon to determine the expressed variant or variants of the exon to determine the expressed variant or variants of the exon. Alternatively or additionally, a set of polynucleotide probes comprising exon specific probes and/or variant junction probes can be included in the exon profiling array. As used herein, a variant junction probe refers to a probe specific to the junction region of the particular exon variant and the neighboring exon. In some cases, the probe set contains variant junction probes specifically hybridizable to each of all different splice junction sequences of the exon. In other cases, the probe set contains exon specific probes specifically hybridizable to the common sequences in all different variants of the exon, and/or variant junction probes specifically hybridizable to the different splice junction sequences of the exon.

In some cases, an exon is represented in the exon profiling arrays by a probe comprising a polynucleotide that is complementary to the full length exon. In such instances, an exon is represented by a single binding site on the profiling arrays. In some preferred cases, an exon is represented by one or more binding sites on the profiling arrays, each of the binding sites comprising a probe with a polynucleotide sequence that is complementary to an RNA fragment that is a substantial portion of the target exon. The lengths of such probes are normally between 15-600 bases, preferably between 20-200 bases, more preferably between 30-100 bases, and most preferably between 40-80 bases. The average length of an exon is about 200 bases (see, e.g., Lewin, Genes V, Oxford University Press, Oxford, 1994, which is hereby incorporated herein by reference in its entirety). A probe of length of 40-80 allows more specific binding of the exon than a probe of shorter length, thereby increasing the specificity of the probe to the target exon. For certain genes, one or more targeted exons may have sequence lengths less than 40-80 bases. In such cases, if probes with sequences longer than the target exons are to be used, it may be desirable to design probes comprising sequences that include the entire target exon flanked by sequences from the adjacent constitutively splice exon or exons such that the probe sequences are complementary to the corresponding sequence segments in the mRNAs. Using flanking sequence from adjacent constitutively spliced exon or exons rather than the genomic flanking sequences, i.e., intron sequences, permits comparable hybridization stringency with other probes of the same length. Preferably the flanking sequence used are from the adjacent constitutively spliced exon or exons that are not involved in any alternative pathways. More preferably the flanking sequences used do not comprise a significant portion of the sequence of the adjacent exon or exons so that cross-hybridization can be minimized. In some embodiments, when a target exon that is shorter than the desired probe length is involved in alternative splicing, probes comprising flanking sequences in different alternatively spliced mRNAs are designed so that expression level of the exon expressed in different alternatively spliced mRNAs can be measured.

In some instances, when alternative splicing pathways and/or exon duplication in separate genes are to be distinguished, the DNA array or set of arrays can also comprise probes that are complementary to sequences spanning the junction regions of two adjacent exons. Preferably, such probes comprise sequences from the two exons which are not substantially overlapped with probes for each individual exons so that cross hybridization can be minimized. Probes that comprise sequences from more than one exons are useful in distinguishing alternative splicing pathways and/or expression of duplicated exons in separate genes if the exons occurs in one or more alternative spliced mRNAs and/or one or more separated genes that contain the duplicated exons but not in other alternatively spliced mRNAs and/or other genes that contain the duplicated exons. Alternatively, for duplicate exons in separate genes, if the exons from different genes show substantial difference in sequence homology, it is preferable to include probes that are different so that the exons from different genes can be distinguished.

It will be apparent to one skilled in the art that any of the probe schemes, supra, can be combined on the same profiling array and/or on different arrays within the same set of profiling arrays so that a more accurate determination of the expression profile for a plurality of genes can be accomplished. It will also be apparent to one skilled in the art that the different probe schemes can also be used for different levels of accuracies in profiling. For example, a profiling array or array set comprising a small set of probes for each exon may be used to determine the relevant genes and/or RNA splicing pathways under certain specific conditions. An array or array set comprising larger sets of probes for the exons that are of interest is then used to more accurately determine the exon expression profile under such specific conditions. Other DNA array strategies that allow more advantageous use of different probe schemes are also encompassed.

Preferably, the microarrays used in the invention have binding sites (i.e., probes) for sets of exons for one or more genes relevant to the action of a drug of interest or in a biological pathway of interest. As discussed above, a “gene” is identified as a portion of DNA that is transcribed by RNA polymerase, which may include a 5′ untranslated region (“UTR”), introns, exons and a 3′ UTR. The number of genes in a genome can be estimated from the number of mRNAs expressed by the cell or organism, or by extrapolation of a well characterized portion of the genome. When the genome of the organism of interest has been sequenced, the number of ORFs can be determined and mRNA coding regions identified by analysis of the DNA sequence. For example, the genome of Saccharomyces cerevisiae has been completely sequenced and is reported to have approximately 6275 ORFs encoding sequences longer the 99 amino acid residues in length. Analysis of these ORFs indicates that there are 5,885 ORFs that are likely to encode protein products (Goffeau et al., 1996, Science 274: 546-567, which is hereby incorporated herein by reference in its entirety). In contrast, the human genome is estimated to contain approximately 30,000 to 130,000 genes (see Crollius et al., 2000, Nature Genetics 25:235-238; Ewing et al., 2000, Nature Genetics 25:232-234, each of which is hereby incorporated herein by reference in its entirety). Genome sequences for other organisms, including but not limited to Drosophila, C. elegans, plants, e.g., rice and Arabidopsis, and mammals, e.g., mouse and human, are also completed or nearly completed. Thus, in preferred embodiments of the invention, an array set comprising in total probes for all known or predicted exons in the genome of an organism is provided. As a non-limiting example, the present invention provides an array set comprising one or two probes for each known or predicted exon in the human genome.

It will be appreciated that when cDNA complementary to the RNA of a cell is made and hybridized to a microarray under suitable hybridization conditions, the level of hybridization to the site in the array corresponding to an exon of any particular gene will reflect the prevalence in the cell of mRNA or mRNAs containing the exon transcribed from that gene. For example, when detectably labeled (e.g., with a fluorophore) cDNA complementary to the total cellular mRNA is hybridized to a microarray, the site on the array corresponding to an exon of a gene (i.e., capable of specifically binding the product or products of the gene expressing) that is not transcribed or is removed during RNA splicing in the cell will have little or no signal (e.g., fluorescent signal), and an exon of a gene for which the encoded mRNA expressing the exon is prevalent will have a relatively strong signal. The relative abundance of different mRNAs produced from the same gene by alternative splicing is then determined by the signal strength pattern across the whole set of exons monitored for the gene.

In one embodiment, cDNAs from cell samples from two different conditions are hybridized to the binding sites of the microarray using a two-color protocol. In the case of drug responses one cell sample is exposed to a drug and another cell sample of the same type is not exposed to the drug. In the case of pathway responses one cell is exposed to a pathway perturbation and another cell of the same type is not exposed to the pathway perturbation. The cDNA derived from each of the two cell types are differently labeled (e.g., with Cy3 and Cy5) so that they can be distinguished. In one embodiment, for example, cDNA from a cell treated with a drug (or exposed to a pathway perturbation) is synthesized using a fluorescein-labeled dNTP, and cDNA from a second cell, not drug-exposed, is synthesized using a rhodamine-labeled dNTP. When the two cDNAs are mixed and hybridized to the microarray, the relative intensity of signal from each cDNA set is determined for each site on the array, and any relative difference in abundance of a particular exon detected.

In the example described above, the cDNA from the drug-treated (or pathway perturbed) cell will fluoresce green when the fluorophore is stimulated and the cDNA from the untreated cell will fluoresce red. As a result, when the drug treatment has no effect, either directly or indirectly, on the transcription and/or post-transcriptional splicing of a particular gene in a cell, the exon expression patterns will be indistinguishable in both cells and, upon reverse transcription, red-labeled and green-labeled cDNA will be equally prevalent. When hybridized to the microarray, the binding site(s) for that species of RNA will emit wavelengths characteristic of both fluorophores. In contrast, when the drug-exposed cell is treated with a drug that, directly or indirectly, change the transcription and/or post-transcriptional splicing of a particular gene in the cell, the exon expression pattern as represented by ratio of green to red fluorescence for each exon binding site will change. When the drug increases the prevalence of an mRNA, the ratios for each exon expressed in the mRNA will increase, whereas when the drug decreases the prevalence of an mRNA, the ratio for each exons expressed in the mRNA will decrease.

The use of a two-color fluorescence labeling and detection scheme to define alterations in gene expression has been described in connection with detection of mRNAs, e.g., in Shena et al., 1995, Quantitative monitoring of gene expression patterns with a complementary DNA microarray, Science 270:467-470, which is incorporated by reference in its entirety for all purposes. The scheme is equally applicable to labeling and detection of exons. An advantage of using cDNA labeled with two different fluorophores is that a direct and internally controlled comparison of the mRNA or exon expression levels corresponding to each arrayed gene in two cell states can be made, and variations due to minor differences in experimental conditions (e.g., hybridization conditions) will not affect subsequent analyses. However, it will be recognized that it is also possible to use cDNA from a single cell, and compare, for example, the absolute amount of a particular exon in, e.g., a drug-treated or pathway-perturbed cell and an untreated cell. Furthermore, labeling with more than two colors is also contemplated in the present invention. In some embodiments of the invention, at least 5, 10, 20, or 100 dyes of different colors can be used for labeling. Such labeling permits simultaneous hybridizing of the distinguishably labeled cDNA populations to the same array, and thus measuring, and optionally comparing the expression levels of, mRNA molecules derived from more than two samples. Dyes that can be used include, but are not limited to, fluorescein and its derivatives, rhodamine and its derivatives, texas red, 5′carboxy-fluorescein (“FMA”), 2′,7′-dimethoxy-4′,5′-dichloro-6-carboxy-fluorescein (“JOE”), N,N,N′,N′-tetramethyl-6-carboxy-rhodamine (“TAMRA”), 6′carboxy-X-rhodamine (“ROX”), HEX, TET, IRD40, and IRD41, cyamine dyes, including but are not limited to Cy3, Cy3.5 and Cy5; BODIPY dyes including but are not limited to BODIPY-FL, BODIPY-TR, BODIPY-TMR, BODIPY-630/650, and BODIPY-650/670; and ALEXA dyes, including but are not limited to ALEXA-488, ALEXA-532, ALEXA-546, ALEXA-568, and ALEXA-594; as well as other fluorescent dyes which will be known to those who are skilled in the art.

In some embodiments of the invention, hybridization data are measured at a plurality of different hybridization times so that the evolution of hybridization levels to equilibrium can be determined. In such embodiments, hybridization levels are most preferably measured at hybridization times spanning the range from 0 to in excess of what is required for sampling of the bound polynucleotides (i.e., the probe or probes) by the labeled polynucleotides so that the mixture is close to or substantially reached equilibrium, and duplexes are at concentrations dependent on affinity and abundance rather than diffusion. However, the hybridization times are preferably short enough that irreversible binding interactions between the labeled polynucleotide and the probes and/or the surface do not occur, or are at least limited. For example, in embodiments wherein polynucleotide arrays are used to probe a complex mixture of fragmented polynucleotides, typical hybridization times may be approximately 0-72 hours. Appropriate hybridization times for other embodiments will depend on the particular polynucleotide sequences and probes used, and may be determined by those skilled in the art (see, e.g., Sambrook et al., Eds., 1989, Molecular Cloning: A Laboratory Manual, 2nd ed., Vol. 1-3, Cold Spring Harbor Laboratory, Cold Spring Harbor, N.Y., which is hereby incorporated herein by reference in its entirety).

In one embodiment, hybridization levels at different hybridization times are measured separately on different, identical microarrays. For each such measurement, at hybridization time when hybridization level is measured, the microarray is washed briefly, preferably in room temperature in an aqueous solution of high to moderate salt concentration (e.g., 0.5 to 3 M salt concentration) under conditions which retain all bound or hybridized polynucleotides while removing all unbound polynucleotides. The detectable label on the remaining, hybridized polynucleotide molecules on each probe is then measured by a method which is appropriate to the particular labeling method used. The resulted hybridization levels are then combined to form a hybridization curve. In another embodiment, hybridization levels are measured in real time using a single microarray. In this embodiment, the microarray is allowed to hybridize to the sample without interruption and the microarray is interrogated at each hybridization time in a non-invasive manner. In still another embodiment, one can use one array, hybridize for a short time, wash and measure the hybridization level, put back to the same sample, hybridize for another period of time, wash and measure again to get the hybridization time curve.

Preferably, at least two hybridization levels at two different hybridization times are measured, a first one at a hybridization time that is close to the time scale of cross-hybridization equilibrium and a second one measured at a hybridization time that is longer than the first one. The time scale of cross-hybridization equilibrium depends, inter alia, on sample composition and probe sequence and may be determined by one skilled in the art. In preferred embodiments, the first hybridization level is measured at between 1 to 10 hours, whereas the second hybridization time is measured at 2, 4, 6, 10, 12, 16, 18, 48 or 72 times as long as the first hybridization time.

### 5.8.1.1. Preparing Probes for Microarrays

As noted above, the “probe” to which a particular polynucleotide molecule, such as an exon, specifically hybridizes according to the invention is a complementary polynucleotide sequence. Preferably one or more probes are selected for each target exon. For example, when a minimum number of probes are to be used for the detection of an exon, the probes normally comprise nucleotide sequences greater than 40 bases in length. Alternatively, when a large set of redundant probes is to be used for an exon, the probes normally comprise nucleotide sequences of 40-60 bases. The probes can also comprise sequences complementary to full length exons. The lengths of exons can range from less than 50 bases to more than 200 bases. Therefore, when a probe length longer than exon is to be used, it is preferable to augment the exon sequence with adjacent constitutively spliced exon sequences such that the probe sequence is complementary to the continuous mRNA fragment that contains the target exon. This will allow comparable hybridization stringency among the probes of an exon profiling array. It will be understood that each probe sequence may also comprise linker sequences in addition to the sequence that is complementary to its target sequence.

The probes may comprise DNA or DNA “mimics” (e.g., derivatives and analogues) corresponding to a portion of each exon of each gene in an organism's genome. In one embodiment, the probes of the microarray are complementary RNA or RNA mimics. DNA mimics are polymers composed of subunits capable of specific, Watson-Crick-like hybridization with DNA, or of specific hybridization with RNA. The nucleic acids can be modified at the base moiety, at the sugar moiety, or at the phosphate backbone. Exemplary DNA mimics include, e.g., phosphorothioates. DNA can be obtained, e.g., by polymerase chain reaction (PCR) amplification of exon segments from genomic DNA, cDNA (e.g., by RT-PCR), or cloned sequences. PCR primers are preferably chosen based on known sequence of the exons or cDNA that result in amplification of unique fragments (i.e., fragments that do not share more than 10 bases of contiguous identical sequence with any other fragment on the microarray). Computer programs that are well known in the art are useful in the design of primers with the required specificity and optimal amplification properties, such as Oligo version 5.0 (National Biosciences). Typically each probe on the microarray will be between 20 bases and 600 bases, and usually between 30 and 200 bases in length. PCR methods are well known in the art, and are described, for example, in Innis et al., eds., 1990, PCR Protocols: A Guide to Methods and Applications, Academic Press Inc., San Diego, Calif., which is hereby incorporated herein by reference in its entirety. It will be apparent to one skilled in the art that controlled robotic systems are useful for isolating and amplifying nucleic acids.

An alternative, preferred means for generating the polynucleotide probes of the microarray is by synthesis of synthetic polynucleotides or oligonucleotides, e.g., using N-phosphonate or phosphoramidite chemistries (Froehler et al., 1986, Nucleic Acid Res. 14:5399-5407; McBride et al., 1983, Tetrahedron Lett. 24:246-248, each of which is hereby incorporated herein by reference in its entirety). Synthetic sequences are typically between 15 and 600 bases in length, more typically between 20 and 100 bases, most preferably between 40 and 70 bases in length. In some embodiments, synthetic nucleic acids include non-natural bases, such as, but by no means limited to, inosine. As noted above, nucleic acid analogues may be used as binding sites for hybridization. An example of a suitable nucleic acid analogue is peptide nucleic acid (see, e.g., Egholm et al., 1993, Nature 363:566-568; and U.S. Pat. No. 5,539,083, each of which is hereby incorporated herein by reference in its entirety).

In alternative embodiments, the hybridization sites (i.e., the probes) are made from plasmid or phage clones of genes, cDNAs (e.g., expressed sequence tags), or inserts therefrom (Nguyen et al., 1995, Genomics 29:207-209, which is hereby incorporated herein by reference in its entirety).

### 5.8.1.2. Attaching Nucleic Acids to the Solid Surface

Preformed polynucleotide probes can be deposited on a support to form the array. Alternatively, polynucleotide probes can be synthesized directly on the support to form the array. The probes are attached to a solid support or surface, which may be made, e.g., from glass, plastic (e.g., polypropylene, nylon), polyacrylamide, nitrocellulose, gel, or other porous or nonporous material.

A preferred method for attaching the nucleic acids to a surface is by printing on glass plates, as is described generally by Schena et al, 1995, Science 270:467-470. This method is especially useful for preparing microarrays of cDNA (See also, DeRisi et al, 1996, Nature Genetics 14:457-460; Shalon et al., 1996, Genome Res. 6:639-645; and Schena et al., 1995, Proc. Natl. Acad. Sci. U.S.A. 93:10539-11286, each of which is hereby incorporated herein by reference in its entirety).

A second preferred method for making microarrays is by making high-density polynucleotide arrays. Techniques are known for producing arrays containing thousands of oligonucleotides complementary to defined sequences, at defined locations on a surface using photolithographic techniques for synthesis in situ (see, Fodor et al., 1991, Science 251:767-773; Pease et al., 1994, Proc. Natl. Acad. Sci. U.S.A. 91:5022-5026; Lockhart et al., 1996, Nature Biotechnology 14:1675; U.S. Pat. Nos. 5,578,832; 5,556,752; and 5,510,270, each of which is hereby incorporated herein by reference in its entirety) or other methods for rapid synthesis and deposition of defined oligonucleotides (Blanchard et al., Biosensors & Bioelectronics 11:687-690, which is hereby incorporated herein by reference in its entirety). When these methods are used, oligonucleotides (e.g., 60-mers) of known sequence are synthesized directly on a surface such as a derivatized glass slide. The array produced can be redundant, with several polynucleotide molecules per exon.

Other methods for making microarrays, e.g., by masking (Maskos and Southern, 1992, Nucl. Acids. Res. 20:1679-1684, which is hereby incorporated herein by reference in its entirety), may also be used. In principle, and as noted supra, any type of array, for example, dot blots on a nylon hybridization membrane (see Sambrook et al., supra) could be used. However, as will be recognized by those skilled in the art, very small arrays will frequently be preferred because hybridization volumes will be smaller.

In a particularly preferred embodiment, microarrays of the invention are manufactured by means of an ink jet printing device for oligonucleotide synthesis, e.g., using the methods and systems described by Blanchard in International Patent Publication No. WO 98/41531, published Sep. 24, 1998; Blanchard et al., 1996, Biosensors and Bioelectronics 11:687-690; Blanchard, 1998, in Synthetic DNA Arrays in Genetic Engineering, Vol. 20, J. K. Setlow, Ed., Plenum Press, New York at pages 111-123; and U.S. Pat. No. 6,028,189 to Blanchard, each of which is hereby incorporated herein by reference in its entirety. Specifically, the polynucleotide probes in such microarrays are preferably synthesized in arrays, e.g., on a glass slide, by serially depositing individual nucleotide bases in “microdroplets” of a high surface tension solvent such as propylene carbonate. The microdroplets have small volumes (e.g., 100 pL or less, more preferably 50 pL or less) and are separated from each other on the microarray (e.g., by hydrophobic domains) to form circular surface tension wells which define the locations of the array elements (i.e., the different probes). Polynucleotide probes are normally attached to the surface covalently at the 3′ end of the polynucleotide. Alternatively, polynucleotide probes can be attached to the surface covalently at the 5′ end of the polynucleotide (see for example, Blanchard, 1998, in Synthetic DNA Arrays in Genetic Engineering, Vol. 20, J. K. Setlow, Ed., Plenum Press, New York at pages 111-123, which is hereby incorporated herein by reference in its entirety).

### 5.8.1.3. Target Polynucleotide Molecules

Target polynucleotides that can be analyzed by the methods and compositions of the invention include RNA molecules such as, but by no means limited to, messenger RNA (mRNA) molecules, ribosomal RNA (rRNA) molecules, cRNA molecules (i.e., RNA molecules prepared from cDNA molecules that are transcribed in vivo) and fragments thereof. Target polynucleotides which may also be analyzed by the methods and compositions of the present invention include, but are not limited to DNA molecules such as genomic DNA molecules, cDNA molecules, and fragments thereof including oligonucleotides, ESTs, STSs, etc.

The target polynucleotides can be from any source. For example, the target polynucleotide molecules may be naturally occurring nucleic acid molecules such as genomic or extragenomic DNA molecules isolated from an organism, or RNA molecules, such as mRNA molecules, isolated from an organism. Alternatively, the polynucleotide molecules may be synthesized, including, e.g., nucleic acid molecules synthesized enzymatically in vivo or in vitro, such as cDNA molecules, or polynucleotide molecules synthesized by PCR, RNA molecules synthesized by in vitro transcription, etc. The sample of target polynucleotides can comprise, e.g., molecules of DNA, RNA, or copolymers of DNA and RNA. In preferred embodiments, the target polynucleotides of the invention will correspond to particular genes or to particular gene transcripts (e.g., to particular mRNA sequences expressed in cells or to particular cDNA sequences derived from such mRNA sequences). However, in many embodiments, particularly those embodiments wherein the polynucleotide molecules are derived from mammalian cells, the target polynucleotides may correspond to particular fragments of a gene transcript. For example, the target polynucleotides may correspond to different exons of the same gene, e.g., so that different splice variants of that gene may be detected and/or analyzed.

In preferred embodiments, the target polynucleotides to be analyzed are prepared in vitro from nucleic acids extracted from cells. For example, in one embodiment, RNA is extracted from cells (e.g., total cellular RNA, poly(A)⁺ messenger RNA, fraction thereof) and messenger RNA is purified from the total extracted RNA. Methods for preparing total and poly(A)⁺ RNA are well known in the art, and are described generally, e.g., in Sambrook et al., supra. In one embodiment, RNA is extracted from cells of the various types of interest in this invention using guanidinium thiocyanate lysis followed by CsCl centrifugation and an oligo dT purification (Chirgwin et al., 1979, Biochemistry 18:5294-5299, which is hereby incorporated herein by reference in its entirety). In another embodiment, RNA is extracted from cells using guanidinium thiocyanate lysis followed by purification on RNeasy columns (Qiagen). cDNA is then synthesized from the purified mRNA using, e.g., oligo-dT or random primers. In preferred embodiments, the target polynucleotides are cRNA prepared from purified messenger RNA extracted from cells. As used herein, cRNA is defined here as RNA complementary to the source RNA. The extracted RNAs are amplified using a process in which doubled-stranded cDNAs are synthesized from the RNAs using a primer linked to an RNA polymerase promoter in a direction capable of directing transcription of anti-sense RNA. Anti-sense RNAs or cRNAs are then transcribed from the second strand of the double-stranded cDNAs using an RNA polymerase (see, e.g., U.S. Pat. Nos. 5,891,636, 5,716,785; 5,545,522 and 6,132,997; see also, U.S. Pat. No. 6,271,002, and U.S. Provisional Patent Application Ser. No. 60/253,641, filed on Nov. 28, 2000, by Ziman et al.). Both oligo-dT primers (U.S. Pat. Nos. 5,545,522 and 6,132,997, each of which is hereby incorporated herein by reference in its entirety) or random primers (U.S. Provisional Patent Application Ser. No. 60/253,641, filed on Nov. 28, 2000, by Ziman et al., which is hereby incorporated herein by reference in its entirety) that contain an RNA polymerase promoter or complement thereof can be used. Preferably, the target polynucleotides are short and/or fragmented polynucleotide molecules which are representative of the original nucleic acid population of the cell.

The target polynucleotides to be analyzed by the methods and compositions of the invention are preferably detectably labeled. For example, cDNA can be labeled directly, e.g., with nucleotide analogs, or indirectly, e.g., by making a second, labeled cDNA strand using the first strand as a template. Alternatively, the double-stranded cDNA can be transcribed into cRNA and labeled.

Preferably, the detectable label is a fluorescent label, e.g., by incorporation of nucleotide analogs. Other labels suitable for use in the present invention include, but are not limited to, biotin, imminobiotin, antigens, cofactors, dinitrophenol, lipoic acid, olefinic compounds, detectable polypeptides, electron rich molecules, enzymes capable of generating a detectable signal by action upon a substrate, and radioactive isotopes. Preferred radioactive isotopes include ³²P, ³⁵S, ¹⁴C, ¹⁵N and ¹²⁵I. Fluorescent molecules suitable for the present invention include, but are not limited to, fluorescein and its derivatives, rhodamine and its derivatives, texas red, 5′carboxy-fluorescein (“FMA”), 2′,7′-dimethoxy-4′,5′-dichloro-6-carboxy-fluorescein (“JOE”), N,N,N′,N′-tetramethyl-6-carboxy-rhodamine (“TAMRA”), 6′carboxy-X-rhodamine (“ROX”), HEX, TET, IRD40, and IRD41. Fluorescent molecules that are suitable for the invention further include: cyamine dyes, including by not limited to Cy3, Cy3.5 and Cy5; BODIPY dyes including but not limited to BODIPY-FL, BODIPY-TR, BODIPY-TMR, BODIPY-630/650, and BODIPY-650/670; and ALEXA dyes, including but not limited to ALEXA-488, ALEXA-532, ALEXA-546, ALEXA-568, and ALEXA-594; as well as other fluorescent dyes which will be known to those who are skilled in the art. Electron rich indicator molecules suitable for the present invention include, but are not limited to, ferritin, hemocyanin, and colloidal gold. Alternatively, in less preferred embodiments the target polynucleotides may be labeled by specifically complexing a first group to the polynucleotide. A second group, covalently linked to an indicator molecules and which has an affinity for the first group, can be used to indirectly detect the target polynucleotide. In such an embodiment, compounds suitable for use as a first group include, but are not limited to, biotin and iminobiotin. Compounds suitable for use as a second group include, but are not limited to, avidin and streptavidin.

### 5.8.1.4. Hybridization to Microarrays

As described supra, nucleic acid hybridization and wash conditions are chosen so that the polynucleotide molecules to be analyzed by the invention (referred to herein as the “target polynucleotide molecules) specifically bind or specifically hybridize to the complementary polynucleotide sequences of the array, preferably to a specific array site, wherein its complementary DNA is located.

Arrays containing double-stranded probe DNA situated thereon are preferably subjected to denaturing conditions to render the DNA single-stranded prior to contacting with the target polynucleotide molecules. Arrays containing single-stranded probe DNA (e.g., synthetic oligodeoxyribonucleic acids) may need to be denatured prior to contacting with the target polynucleotide molecules, e.g., to remove hairpins or dimers which form due to self complementary sequences.

Optimal hybridization conditions will depend on the length (e.g., oligomer versus polynucleotide greater than 200 bases) and type (e.g., RNA, or DNA) of probe and target nucleic acids. General parameters for specific (i.e., stringent) hybridization conditions for nucleic acids are described in Sambrook et al., (supra), and in Ausubel et al., 1987, Current Protocols in Molecular Biology, Greene Publishing and Wiley-Interscience, New York, which is hereby incorporated herein by reference in its entirety. When the cDNA microarrays of Schena et al. are used, typical hybridization conditions are hybridization in 5×SSC plus 0.2% SDS at 65° C. for four hours, followed by washes at 25° C. in low stringency wash buffer (1×SSC plus 0.2% SDS), followed by 10 minutes at 25° C. in higher stringency wash buffer (0.1×SSC plus 0.2% SDS) (Shena et al., 1996, Proc. Natl. Acad. Sci. U.S.A. 93:10614, which is hereby incorporated herein by reference in its entirety). Useful hybridization conditions are also provided in, e.g., Tijessen, 1993, Hybridization With Nucleic Acid Probes, Elsevier Science Publishers B.V. and Kricka, 1992, Nonisotopic DNA Probe Techniques, Academic Press, San Diego, Calif., each of which is hereby incorporated herein by reference in its entirety.

Particularly preferred hybridization conditions for use with the screening and/or signaling chips of the present invention include hybridization at a temperature at or near the mean melting temperature of the probes (e.g., within 5° C., or more preferably within 2° C.) in 1 M NaCl, 50 mM MES buffer (pH 6.5), 0.5% sodium Sarcosine and 30% formamide.

### 5.8.1.5. Signal Detection and Data Analysis

It will be appreciated that when target sequences, e.g., cDNA or cRNA, complementary to the RNA of a cell is made and hybridized to a microarray under suitable hybridization conditions, the level of hybridization to the site in the array corresponding to an exon of any particular gene will reflect the prevalence in the cell of mRNA or mRNAs containing the exon transcribed from that gene. For example, when detectably labeled (e.g., with a fluorophore) cDNA complementary to the total cellular mRNA is hybridized to a microarray, the site on the array corresponding to an exon of a gene (i.e., capable of specifically binding the product or products of the gene expressing) that is not transcribed or is removed during RNA splicing in the cell will have little or no signal (e.g., fluorescent signal), and an exon of a gene for which the encoded mRNA expressing the exon is prevalent will have a relatively strong signal. The relative abundance of different mRNAs produced from the same gene by alternative splicing is then determined by the signal strength pattern across the whole set of exons monitored for the gene.

In preferred embodiments, target sequences, e.g., cDNAs or cRNAs, from two different cells are hybridized to the binding sites of the microarray. In the case of drug responses one cell sample is exposed to a drug and another cell sample of the same type is not exposed to the drug. In the case of pathway responses one cell is exposed to a pathway perturbation and another cell of the same type is not exposed to the pathway perturbation. The cDNA or cRNA derived from each of the two cell types are differently labeled so that they can be distinguished. In one embodiment, for example, cDNA from a cell treated with a drug (or exposed to a pathway perturbation) is synthesized using a fluorescein-labeled dNTP, and cDNA from a second cell, not drug-exposed, is synthesized using a rhodamine-labeled dNTP. When the two cDNAs are mixed and hybridized to the microarray, the relative intensity of signal from each cDNA set is determined for each site on the array, and any relative difference in abundance of a particular exon detected.

In the example described above, the cDNA from the drug-treated (or pathway perturbed) cell will fluoresce green when the fluorophore is stimulated and the cDNA from the untreated cell will fluoresce red. As a result, when the drug treatment has no effect, either directly or indirectly, on the transcription and/or post-transcriptional splicing of a particular gene in a cell, the exon expression patterns will be indistinguishable in both cells and, upon reverse transcription, red-labeled and green-labeled cDNA will be equally prevalent. When hybridized to the microarray, the binding site(s) for that species of RNA will emit wavelengths characteristic of both fluorophores. In contrast, when the drug-exposed cell is treated with a drug that, directly or indirectly, changes the transcription and/or post-transcriptional splicing of a particular gene in the cell, the exon expression pattern as represented by ratio of green to red fluorescence for each exon binding site will change. When the drug increases the prevalence of an mRNA, the ratios for each exon expressed in the mRNA will increase, whereas when the drug decreases the prevalence of an mRNA, the ratio for each exons expressed in the mRNA will decrease.

The use of a two-color fluorescence labeling and detection scheme to define alterations in gene expression has been described in connection with detection of mRNAs, e.g., in Shena et al., 1995, Science 270:467-470, which is incorporated by reference in its entirety for all purposes. The scheme is equally applicable to labeling and detection of exons. An advantage of using target sequences, e.g., cDNAs or cRNAs, labeled with two different fluorophores is that a direct and internally controlled comparison of the mRNA or exon expression levels corresponding to each arrayed gene in two cell states can be made, and variations due to minor differences in experimental conditions (e.g., hybridization conditions) will not affect subsequent analyses. However, it will be recognized that it is also possible to use cDNA from a single cell, and compare, for example, the absolute amount of a particular exon in, e.g., a drug-treated or pathway-perturbed cell and an untreated cell.

When fluorescently labeled probes are used, the fluorescence emissions at each site of a transcript array can be, preferably, detected by scanning confocal laser microscopy. In one embodiment, a separate scan, using the appropriate excitation line, is carried out for each of the two fluorophores used. Alternatively, a laser can be used that allows simultaneous specimen illumination at wavelengths specific to the two fluorophores and emissions from the two fluorophores can be analyzed simultaneously (see Shalon et al., 1996, Genome Res. 6:639-645, which is hereby incorporated herein by reference in its entirety). In a preferred embodiment, the arrays are scanned with a laser fluorescence scanner with a computer controlled X-Y stage and a microscope objective. Sequential excitation of the two fluorophores is achieved with a multi-line, mixed gas laser, and the emitted light is split by wavelength and detected with two photomultiplier tubes. Such fluorescence laser scanning devices are described, e.g., in Schena et al., 1996, Genome Res. 6:639-645, which is hereby incorporated herein by reference in its entirety. Alternatively, the fiber-optic bundle described by Ferguson et al., 1996, Nature Biotech. 14:1681-1684, may be used to monitor mRNA abundance levels at a large number of sites simultaneously, which is also hereby incorporated herein by reference in its entirety.

Signals are recorded and, in a preferred embodiment, analyzed by computer, e.g., using a 12 bit analog to digital board. In one embodiment, the scanned image is despeckled using a graphics program (e.g., Hijaak Graphics Suite) and then analyzed using an image gridding program that creates a spreadsheet of the average hybridization at each wavelength at each site. If necessary, an experimentally determined correction for “cross talk” (or overlap) between the channels for the two fluors may be made. For any particular hybridization site on the transcript array, a ratio of the emission of the two fluorophores can be calculated. The ratio is independent of the absolute expression level of the cognate gene, but is useful for genes whose expression is significantly modulated by drug administration, gene deletion, or any other tested event.

According to the method of the invention, the relative abundance of an mRNA and/or an exon expressed in an mRNA in two cells or cell lines is scored as perturbed (i.e., the abundance is different in the two sources of mRNA tested) or as not perturbed (i.e., the relative abundance is the same). As used herein, a difference between the two sources of RNA of at least a factor of 25% (e.g., RNA is 25% more abundant in one source than in the other source), more usually 50%, even more often by a factor of 2 (e.g., twice as abundant), 3 (three times as abundant), or 5 (five times as abundant) is scored as a perturbation. Present detection methods allow reliable detection of differences of an order of 1.5 fold to 3-fold.

It is, however, also advantageous to determine the magnitude of the relative difference in abundances for an mRNA and/or an exon expressed in an mRNA in two cells or in two cell lines. This can be carried out, as noted above, by calculating the ratio of the emission of the two fluorophores used for differential labeling, or by analogous methods that will be readily apparent to those of skill in the art.

### 5.8.2. Other Methods of Transcriptional State Measurement

The transcriptional state of a cell can be measured by other gene expression technologies known in the art. Several such technologies produce pools of restriction fragments of limited complexity for electrophoretic analysis, such as methods combining double restriction enzyme digestion with phasing primers (see, e.g., European Patent O 534858 A1, filed Sep. 24, 1992, by Zabeau et al., each of which is hereby incorporated herein by reference in its entirety), or methods selecting restriction fragments with sites closest to a defined mRNA end (see, e.g., Prashar et al., 1996, Proc. Natl. Acad. Sci. U.S.A. 93:659-663, each of which is hereby incorporated herein by reference in its entirety). Other methods statistically sample cDNA pools, such as by sequencing sufficient bases (e.g., 20-50 bases) in each of multiple cDNAs to identify each cDNA, or by sequencing short tags (e.g., 9-10 bases) that are generated at known positions relative to a defined mRNA end (see, e.g., Velculescu, 1995, Science 270:484-487, each of which is hereby incorporated herein by reference in its entirety).

### 5.9. Measurement of Other Aspects of the Biological State

In various embodiments of the present invention, aspects of the biological state other than the transcriptional state, such as the translational state, the activity state, or mixed aspects can be measured. Thus, in such embodiments, gene expression data can include translational state measurements or even protein expression measurements. Details of embodiments in which aspects of the biological state other than the transcriptional state are described in this section.

### 5.9.1. Translational State Measurements

Measurement of the translational state can be performed according to several methods. For example, whole genome monitoring of protein (e.g., the “proteome,”) can be carried out by constructing a microarray in which binding sites comprise immobilized, preferably monoclonal, antibodies specific to a plurality of protein species encoded by the cell genome. Preferably, antibodies are present for a substantial fraction of the encoded proteins, or at least for those proteins relevant to the action of a drug of interest. Methods for making monoclonal antibodies are well known (see, e.g., Harlow and Lane, 1988, Antibodies: A Laboratory Manual, Cold Spring Harbor, N.Y., each of which is hereby incorporated herein by reference in its entirety). In one embodiment, monoclonal antibodies are raised against synthetic peptide fragments designed based on genomic sequence of the cell. With such an antibody array, proteins from the cell are contacted to the array and their binding is assayed with assays known in the art.

Alternatively, proteins can be separated by two-dimensional gel electrophoresis systems. Two-dimensional gel electrophoresis is well-known in the art and typically involves iso-electric focusing along a first dimension followed by SDS-PAGE electrophoresis along a second dimension. See, e.g., Hames et al., 1990, Gel Electrophoresis of Proteins: A Practical Approach, IRL Press, New York; Shevchenko et al., 1996, Proc. Natl. Acad. Sci. U.S.A. 93:1440-1445; Sagliocco et al., 1996, Yeast 12:1519-1533; and Lander, 1996, Science 274:536-539, each of which is hereby incorporated herein by reference in its entirety. The resulting electropherograms can be analyzed by numerous techniques, including mass spectrometric techniques, Western blotting and immunoblot analysis using polyclonal and monoclonal antibodies, and internal and N-terminal micro-sequencing. Using these techniques, it is possible to identify a substantial fraction of all the proteins produced under given physiological conditions, including in cells (e.g., in yeast) exposed to a drug, or in cells modified by, e.g., deletion or over-expression of a specific gene.

### 5.9.2. Other Types of Cellular Constituent Abundance Measurements

The methods of the invention are applicable to any cellular constituent that can be monitored. For example, where activities of proteins can be measured, embodiments of this invention can use such measurements. Activity measurements can be performed by any functional, biochemical, or physical means appropriate to the particular activity being characterized. Where the activity involves a chemical transformation, the cellular protein can be contacted with the natural substrate(s), and the rate of transformation measured. Where the activity involves association in multimeric units, for example association of an activated DNA binding complex with DNA, the amount of associated protein or secondary consequences of the association, such as amounts of mRNA transcribed, can be measured. Also, where only a functional activity is known, for example, as in cell cycle control, performance of the function can be observed. However known and measured, the changes in protein activities form the response data analyzed by the foregoing methods of this invention.

In some embodiments of the present invention, cellular constituent measurements are derived from cellular phenotypic techniques. One such cellular phenotypic technique uses cell respiration as a universal reporter. In one embodiment, 96-well microtiter plate, in which each well contains its own unique chemistry is provided. Each unique chemistry is designed to test a particular phenotype. Cells from the organism of interest are pipetted into each well. If the cells exhibits the appropriate phenotype, they will respire and actively reduce a tetrazolium dye, forming a strong purple color. A weak phenotype results in a lighter color. No color means that the cells don't have the specific phenotype. Color changes can be recorded as often as several times each hour. During one incubation, more than 5,000 phenotypes can be tested. See, for example, Bochner et al., 2001, Genome Research 11, p. 1246, each of which is hereby incorporated herein by reference in its entirety.

In some embodiments of the present invention, cellular constituent measurements are derived from cellular phenotypic techniques. One such cellular phenotypic technique uses cell respiration as a universal reporter. In one embodiment, 96-well microtiter plates, in which each well contains its own unique chemistry is provided. Each unique chemistry is designed to test a particular phenotype. Cells from the organism 46 (FIG. 1) of interest are pipetted into each well. If the cells exhibit the appropriate phenotype, they will respire and actively reduce a tetrazolium dye, forming a strong purple color. A weak phenotype results in a lighter color. No color means that the cells don't have the specific phenotype. Color changes may be recorded as often as several times each hour. During one incubation, more than 5,000 phenotypes can be tested. See, for example, Bochner et al., 2001, Genome Research 11, 1246-55, each of which is hereby incorporated herein by reference in its entirety.

In some embodiments of the present invention, the cellular constituents that are measured are metabolites. Metabolites include, but are not limited to, amino acids, metals, soluble sugars, sugar phosphates, and complex carbohydrates. Such metabolites can be measured, for example, at the whole-cell level using methods such as pyrolysis mass spectrometry (Irwin, 1982, Analytical Pyrolysis: A Comprehensive Guide, Marcel Dekker, New York; Meuzelaar et al., 1982, Pyrolysis Mass Spectrometry of Recent and Fossil Biomaterials, Elsevier, Amsterdam), fourier-transform infrared spectrometry (Griffiths and de Haseth, 1986, Fourier transform infrared spectrometry, John Wiley, New York; Helm et al., 1991, J. Gen. Microbiol. 137, 69-79; Naumann et al., 1991, Nature 351, 81-82; Naumann et al., 1991, each of which is hereby incorporated herein by reference in its entirety, In: Modern techniques for rapid microbiological analysis, 43-96, Nelson, W. H., ed., VCH Publishers, New York), Raman spectrometry, gas chromatography-mass spectroscopy (GC-MS) (Fiehn et al., 2000, Nature Biotechnology 18, 1157-1161, which is hereby incorporated herein by reference in its entirety), capillary electrophoresis (CE)/MS, high pressure liquid chromatography/mass spectroscopy (HPLC/MS), as well as liquid chromatography (LC)-Electrospray and cap-LC-tandem-electrospray mass spectrometries. Such methods can be combined with established chemometric methods that make use of artificial neural networks and genetic programming in order to discriminate between closely related samples.

### 5.10. Target Validation

The methods of the present invention can be used to associate a cellular constituent with a complex trait. This section discloses techniques that can be used to validate such cellular constituents identified using the techniques of the present invention. In some embodiments, gene knock-out/knock-in mice or transgenic mice are employed for such validation. In some embodiments, in vivo siRNA is used to validate such genes. See, for example, Cohen et al., 1997, J. Clin. Invest. 99, p. 1906; Xia, et al., 2002, Nature Biotechnology 20, p. 1006; Hannon, 2002, Nature 418, p. 244; Carthew, 2001, Current Opinion in Cell Biology 13, p. 244; Paddison, 2002, Genes & Development 16, p. 948; Paddison & Hannon, 2002, Cancer Cell 2, p. 17; Jang et al., 2002, Proc. Natl. Acad. Sci. U.S.A. 99, p. 1984; and Martinez et al., 2002, Proc. Natl. Acad. Sci. U.S.A. 99, p. 14849, each of which is hereby incorporated herein by reference in its entirety.

In some embodiments, before a putative target cellular constituent is biologically validated in mice, association studies can be carried out in human populations to provide a source of validation in humans. Associating a gene in a human population with a clinical trait, where the gene in mouse 1) was physically co-localized with a cQTL for the corresponding clinical trait in a segregating mouse population, 2) gave rise to a cis-acting QTL with respect to its transcription, and 3) was significantly genetically interacting with the clinical trait QTL, is itself a very powerful validation of a gene's role in the complex trait of interest. See, also, U.S. Provisional Patent Application 60/436,684 filed Dec. 27, 2002, which is hereby incorporated herein by reference in its entirety. The combined validation in mouse and human provides all that is necessary to move a target forward in a discovery program. Even in cases where the causal gene is not itself druggable, druggable targets driven by the causal gene can be identified by examining those targets that have eQTL that co-localize and are interacting with eQTL for the causative gene. This speaks to the more general use of the combined genetics/gene expression approach to reconstruct genetic networks.

### 5.11. Complex Traits

In some embodiments of the present invention, the term “complex trait” refers to any clinical trait T that does not exhibit classic Mendelian inheritance. In some embodiments, the term “complex trait” refers to a trait that is affected by two or more gene loci. In some embodiments, the term “complex trait” refers to a trait that is affected by two or more gene loci in addition to one or more factors including, but not limited to, age, sex, habits, and environment. See, for example, Lander and Schork, 1994, Science 265: 2037, which is hereby incorporated herein by reference in its entirety. Such “complex” traits include, but are not limited to, susceptibilities to heart disease, hypertension, diabetes, obesity, cancer, and infection. Complex traits arise when the simple correspondence between genotype and phenotype breaks down, either because the same genotype can result in different phenotypes (due to the effect of chance, environment, or interaction with other genes) or different genotypes can result in the same phenotype.

In some embodiments, a complex trait is one in which there exists no genetic marker that shows perfect cosegregation with the trait due to incomplete penetrance, phenocopy, and/or nongenetic factors (e.g., age, sex, environment, and affect or other genes). Incomplete penetrance means that some individuals who inherit a predisposing allele may not manifest the disease. Phenocopy means that some individuals who inherit no predisposing allele can nonetheless get the disease as a result of environmental or random causes. Thus, the genotype at a given locus may affect the probability of disease, but not fully determine the outcome. The penetrance function ƒ(G), specifying the probability of disease for each genotype G, may also depend on nongenetic factors such as age, sex, environment, and other genes. For example, the risk of breast cancer by ages 40, 55, and 80 is 37%, 66%, and 85% in a woman carrying a mutation at the BCRA1 locus as compared with 0.4%, 3%, and 8% in a noncarrier (Easton et al., 1993, Cancer Surv. 18: 1995; Ford et al., 1994, Lancet 343: 692, each of which is hereby incorporated herein by reference in its entirety). In such cases, genetic mapping is hampered by the fact that a predisposing allele may be present in some unaffected individuals or absent in some affected individuals.

In some embodiments a complex trait arises because any one of several genes may result in identical phenotypes (genetic heterogeneity). In cases where there is genetic heterogeneity, it may be difficult to determine whether two patients suffer from the same disease for different genetic reasons until the genes are mapped. Examples of complex diseases that arise due to genetic heterogeneity in humans include polycystic kidney disease (Reeders et al., 1987, Human Genetics 76: 348, which is hereby incorporated herein by reference in its entirety), early-onset Alzheimer's disease (George-Hyslop et al., 1990, Nature 347: 194, which is hereby incorporated herein by reference in its entirety), maturity-onset diabetes of the young (Barbosa et al., 1976, Diabete Metab. 2: 160, which is hereby incorporated herein by reference in its entirety), hereditary nonpolyposis colon cancer (Fishel et al., 1993, Cell 75: 1027, which is hereby incorporated herein by reference in its entirety) ataxia telangiectasia (Jaspers and Bootsma, 1982, Proc. Natl. Acad. Sci. U.S.A. 79: 2641, which is hereby incorporated herein by reference in its entirety), obesity, nonalcoholic steatohepatitis (NASH) (James & Day, 1998, J. Hepatol. 29: 495-501, which is hereby incorporated herein by reference in its entirety), nonalcoholic fatty liver (NAFL) (Younossi, et al., 2002, Hepatology 35, 746-752, which is hereby incorporated herein by reference in its entirety), and xeroderma pigmentosum (De Weerd-Kastelein, Nat. New Biol. 238: 80, which is hereby incorporated herein by reference in its entirety). Genetic heterogeneity hampers genetic mapping, because a chromosomal region may cosegregate with a disease in some families but not in others.

In still other embodiments, a complex trait arises due to the phenomenon of polygenic inheritance. Polygenic inheritance arises when a trait requires the simultaneous presence of mutations in multiple genes. An example of polygenic inheritance in humans is one form of retinitis pigmentosa, which requires the presence of heterozygous mutations at the perpherin/RDS and ROM1 genes (Kajiwara et al., 1994, Science 264: 1604, which is hereby incorporated herein by reference in its entirety). It is believed that the proteins coded by RDS and ROM1 are thought to interact in the photoreceptor outer pigment disc membranes. Polygenic inheritance complicates genetic mapping, because no single locus is strictly required to produce a discrete trait or a high value of a quantitative trait.

In yet other embodiments, a complex trait arises due to a high frequency of disease-causing allele “D”. A high frequency of disease-causing allele will cause difficulties in mapping even a simple trait if the disease-causing allele occurs at high frequency in the population. That is because the expected Mendelian inheritance pattern of disease will be confounded by the problem that multiple independent copies of D may be segregating in the pedigree and that some individuals may be homozygous for D, in which case one will not observe linkage between D and a specific allele at a nearby genetic marker, because either of the two homologous chromosomes could be passed to an affected offspring. Late-onset Alzheimer's disease provides one example of the problems raised by high frequency disease-causing alleles. Initial linkage studies found weak evidence of linkage to chromosome 19q, but they were dismissed by many observers because the lod score (logarithm of the likelihood ratio for linkage) remained relatively low, and it was difficult to pinpoint the linkage with any precision (Pericak-Vance et al., 1991, Am J. Hum. Genet. 48: 1034, which is hereby incorporated herein by reference in its entirety). The confusion was finally resolved with the discovery that the apolipoprotein E type 4 allele appears to be the major causative factor on chromosome 19. The high frequency of the allele (about 16% in most populations) had interfered with the traditional linkage analysis (Corder et al., 1993, Science 261: 921, which is hereby incorporated herein by reference in its entirety). High frequency of disease-causing alleles becomes an even greater problem if genetic heterogeneity is present.

### 5.12. Exemplary Diseases

As discussed supra, the present invention provides an apparatus and method for associating a gene with a trait exhibited by one or more organisms in a plurality of organisms of a single species. In some instances, the gene is associated with the trait by identifying a biological pathway in which the gene product participates. In some embodiments of the present invention, the trait of interest is a complex trait, such as a disease, e.g., a human disease. Exemplary diseases include asthma, ataxia telangiectasia (Jaspers and Bootsma, 1982, Proc. Natl. Acad. Sci. U.S.A. 79: 2641, which is hereby incorporated herein by reference in its entirety), bipolar disorder, common cancers, common late-onset Alzheimer's disease, diabetes, heart disease, hereditary early-onset Alzheimer's disease (George-Hyslop et al., 1990, Nature 347: 194, which is hereby incorporated herein by reference in its entirety), hereditary nonpolyposis colon cancer, hypertension, infection, maturity-onset diabetes of the young (Barbosa et al., 1976, Diabete Metab. 2: 160, which is hereby incorporated herein by reference in its entirety), mellitus, migraine, nonalcoholic fatty liver (NAFL) (Younossi, et al., 2002, Hepatology 35, 746-752, which is hereby incorporated herein by reference in its entirety), nonalcoholic steatohepatitis (NASH) (James & Day, 1998, J. Hepatol. 29: 495-501, which is hereby incorporated herein by reference in its entirety), non-insulin-dependent diabetes mellitus, obesity, polycystic kidney disease (Reeders et al., 1987, Human Genetics 76: 348, which is hereby incorporated herein by reference in its entirety), psoriases, schizophrenia, steatohepatitis and xeroderma pigmentosum (De Weerd-Kastelein, Nat. New Biol. 238: 80, which is hereby incorporated herein by reference in its entirety). Genetic heterogeneity hampers genetic mapping, because a chromosomal region may cosegregate with a disease in some families but not in others.

### 5.13. Linkage Analysis

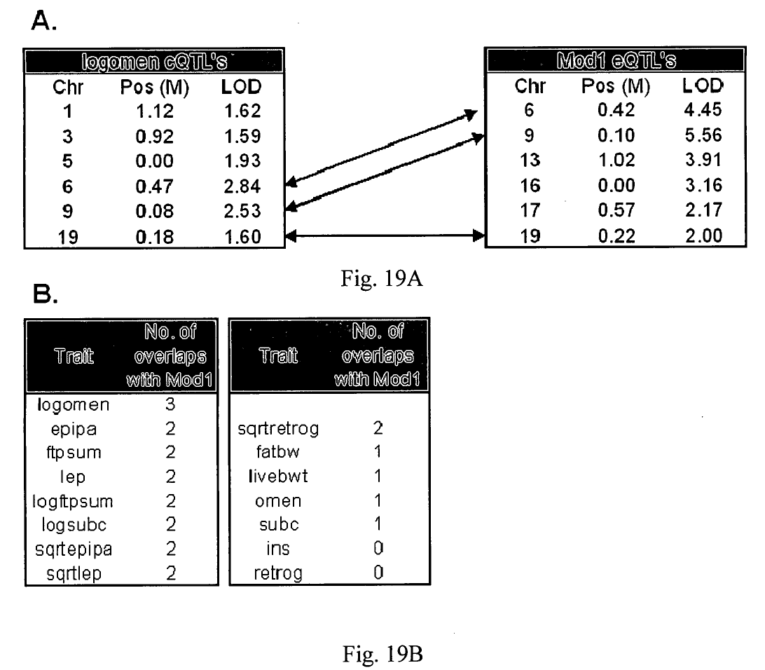

This section describes a number of standard quantitative trait locus (QTL) linkage analysis algorithms that can be used in various embodiments of processing step 210 (FIG. 2) and/or processing step 1910 (FIG. 19). Such linkage analysis is also sometimes referred to as QTL analysis. See, for example, Lynch and Walsch, 1998, Genetics and Analysis of Quantitative Traits, Sinauer Associates, Sunderland, Mass., each of which is hereby incorporated herein by reference in its entirety. The primary aim of linkage analysis is to determine whether there exist pieces of the genome that are passed down through each of several families with multiple afflicted organisms in a pattern that is consistent with a particular inheritance model and that is unlikely to occur by chance alone. In other words, the purpose of these algorithms is to identify a locus (e.g., a QTL) for a phenotypic trait exhibited by one or more organisms. A QTL is a region of a genome of a species that is responsible for a percentage of variation in a phenotypic trait in the species under study.

The recombination fraction can be denoted by θ and is bounded between 0 and 0.5. If θ=0.5 for two loci, then alleles at the two loci are transmitted independently with half of the gametes being recombinant, for the two loci, and half parental. In this case, the loci are unlinked. If θ<0.5, then alleles are not transmitted independently, and the two loci are linked. The extreme scenario is when θ=0, so that the two loci are completely linked, and there will be no recombination between the two loci during meiosis, i.e. all gametes are parental. Linkage analysis tests whether a marker locus, of known location, is linked to a locus of unknown location, that influences the phenotype under study. In other words, a QTL is identified by comparing genotypes of organisms in a group to a phenotype exhibited by the group using pedigree data. The genotype of each organism at each marker in a plurality of markers in a genetic map produced by marker genotypic data is compared to a given phenotype of each organism. The genetic map is created by placing genetic markers in genetic (linear) map order so that the positional relationships between markers are understood. The information gained from knowing the relationships between markers that is provided by a marker map provides the setting for addressing the relationship between QTL effect and QTL location.

In some embodiments of the present invention, linkage analysis is based on any of the QTL detection methods disclosed or referenced in Lynch and Walsch, 1998, Genetics and Analyis of Quantitative Traits, Sinauer Associates, Inc., Sunderland, Mass.

### 5.13.1. Phenotypic Data Used

It will be appreciated that the present invention provides no limitation on the type of phenotypic data that can be used. The phenotypic data can, for example, represent a series of measurements for a quantifiable phenotypic trait in a collection of organisms. Such quantifiable phenotypic traits can include, for example, tail length, life span, eye color, size and weight. Alternatively, the phenotypic data can be in a binary form that tracks the absence or presence of some phenotypic trait. As an example, a “1” can indicate that a particular species of the organism of interest possesses a given phenotypic trait and a “0” can indicate that a particular species of the organism of interest lacks the phenotypic trait. The phenotypic trait can be any form of biological data that is representative of the phenotype of each organism in the population under study. In some embodiments, the phenotypic traits are quantified and are often referred to as quantitative phenotypes.

### 5.13.2. Genotypic Data Used

In order to provide the necessary genotypic data for linkage analysis, the genotype of each marker in the genetic marker map is determined for each organism in a population under study. Genotypic information is obtained from polymorphisms at each marker in the genetic map. Such polymorphisms include, but are not limited to, single nucleotide polymorphisms, microsatellite markers, restriction fragment length polymorphisms, short tandem repeats, sequence length polymorphisms, and DNA methylation patterns.

Linkage analyses use the genetic map derived from marker genotypic data as the framework for location of QTL for any given quantitative trait. In some embodiments, the intervals that are defined by ordered pairs of markers are searched in increments (for example, 2 cM), and statistical methods are used to test whether a QTL is likely to be present at the location within the interval. In one embodiment, linkage analysis statistically tests for a single QTL at each increment across the ordered markers in a genetic map. The results of the tests are expressed as lod scores, which compares the evaluation of the likelihood function under a null hypothesis (no QTL) with the alternative hypothesis (QTL at the testing position) for the purpose of locating probable QTL. More details on lod scores are found in Section 5.4, as well as in Lander and Schork, 1994, Science 265, p. 2037-2048. Interval mapping searches through the ordered genetic markers in a systematic, linear (one-dimensional) fashion, testing the same null hypothesis and using the same form of likelihood at each increment.

### 5.13.3. Pedigree Data Used

Linkage analysis requires pedigree data for organisms in the population under study in order to statistically model the segregation of markers. The various forms of linkage analysis can be categorized by the type of population used to generate the pedigree data (inbred versus outbred).

Some forms of linkage analysis use pedigree data for populations that originate from inbred parental lines. The resulting F₁ lines will tend to be heterozygous at all markers and QTL. From the F₁ population, crosses are made. Exemplary crosses include backcrosses, F₂ intercrosses, Fₜ populations (formed by randomly mating F₁s for t−1 generations), F_{2:3} design (F₂ individuals are genotyped and then selfed), Design III (F₂ from two inbred lines are backcrossed to both parental lines). Thus, in some embodiments of the present invention, organisms represent a population, such as an F₂ population, and pedigree data for the F₂ population is known. This pedigree data is used to compute logarithm of the odds (lod) scores, as discussed in further detail below.

For many organisms, including humans, manipulatable inbred lines are not available and outbred populations must be used to perform linkage analysis. Linkage analysis using outbred populations detect QTLs responsible for within-population variation whereas linkage analysis using inbred populations detect QTLs responsible for fixed differences between lines, or even different species. Using within-population variation (outbred population), as opposed to fixed differences between populations (inbred population) results in decreased power in QTL detection. With inbred lines, all F₁ parents have identical genotypes (including the same linkage phase), so all individuals are informative, and linkage disequilibrium is maximized. As with inbred lines, a variety of designs have been proposed for obtaining samples with linkage disequilibrium required for linkage analysis. Typically, collections of relatives are relied upon.

The major difference between QTL analysis using inbred-line crosses versus outbred populations is that while the parents in the former are genetically uniform, parents in the latter are genetically variable. This distinction has several consequences. First, only a fraction of the parents from an outbred population are informative. For a parent to provide linkage information, it must be heterozygous at both a marker and a linked QTL, as only in this situation can a marker-trait association be generated in the progeny. Only a fraction of random parents from an outbred population are such double heterozygotes. With inbred lines, F₁'s are heterozygous at all loci that differ between the crossed lines, so that all parents are fully informative. Second, there are only two alleles segregating at any locus in an inbred-line cross design, while outbred populations can be segregating any number of alleles. Finally, in an outbred population, individuals can differ in marker-QTL linkage phase, so that an M-bearing gamete might by associated with QTL allele Q in one parent, and with q in another. Thus, with outbred populations, marker-trait associations might be examined separately for each parent. With inbred-line crosses, all F₁ parents have identical genotypes (including linkage phase), so one can average marker-trait associations over all off-spring, regardless of their parents. See Lynch and Walsh, Genetics and Analysis of Quantitative Traits, Sinauer Associates, Sunderland, Mass.

### 5.13.4. Model Free Versus Model Based Linkage Analysis

Linkage analyses can generally be divided into two classes: model-based linkage analysis and model-free linkage analysis. Model-based linkage analysis assumes a model for the mode of inheritance whereas model-free linkage analysis does not assume a mode of inheritance. Model-free linkage analyses are also known as allele-sharing methods and non-parametric linkage methods. Model-based linkage analyses are also known as “maximum likelihood” and “lod score” methods. Either form of linkage analysis can be used in the present invention.

Model-based linkage analysis is most often used for dichotomous traits and requires assumptions for the trait model. These assumptions include the disease allele frequency and penetrance function. For a disease trait, particularly those of interest to public health, the true underlying model is complex and unknown, so that these procedures are not applicable. The other form of linkage analysis (model-free linkage analysis) makes use of allele-sharing. Allele-sharing methods rely on the idea that relatives with similar phenotypes should have similar genotypes at a marker locus if and only if the marker is linked to the locus of interest. Linkage analyses are able to localize the locus of interest to a specific region of a chromosome, and the scope of resolution is typically limited to no less than 5 cM or roughly 5000 kb. For more information on model-based and model-free linkage analysis, see Olson et al., 1999, Statistics in Medicine 18, p. 2961-2981; Lander and Schork 1994, Science 265, p. 2037; and Elston, 1998, Genetic Epidemiology 15, p. 565, as well as the sections below, each of which is hereby incorporated herein by reference in its entirety.

### 5.13.5. Known Programs for Performing Linkage Analysis

Many known programs can be used to perform linkage analysis in accordance with this aspect of the invention. One such program is MapMaker/QTL, which is the companion program to MapMaker and is the original QTL mapping software. MapMaker/QTL analyzes F₂ or backcross data using standard interval mapping. Another such program is QTL Cartographer, which performs single-marker regression, interval mapping (Lander and Botstein, Id.), multiple interval mapping and composite interval mapping (Zeng, 1993, Proc. Natl. Acad. Sci. U.S.A. 90: 10972-10976; and Zeng, 1994, Genetics 136: 1457-1468, each of which is hereby incorporated herein by reference in its entirety). QTL Cartographer permits analysis from F₂ or backcross populations. QTL Cartographer is available from http://statgen.ncsu.edu/qtlcart/cartographer.html (North Carolina State University). Another program that can be used by processing step 114 is Qgene, which performs QTL mapping by either single-marker regression or interval regression (Martinez and Curnow 1994 Heredity 73:198-206, each of which is hereby incorporated herein by reference in its entirety). Using Qgene, eleven different population types (all derived from inbreeding) can be analyzed. Qgene is available from http://www.qgene.org/. Yet another program is MapQTL, which conducts standard interval mapping (Lander and Botstein, Id.), multiple QTL mapping (MQM) (Jansen, 1993, Genetics 135: 205-211; Jansen, 1994, Genetics 138: 871-881, each of which is hereby incorporated herein by reference in its entirety), and nonparametric mapping (Kruskal-Wallis rank sum test). MapQTL can analyze a variety of pedigree types including outbred pedigrees (cross pollinators). MapQTL is available from Plant Research International, Plant Research International, P.O. Box 16, 6700 AA Wageningen, The Netherlands; Zttp://www.plant.wageningen-ur.nl/default.asp?section=products). Yet another program that may be used in some embodiments of processing step 210 is Map Manager QT, which is a QTL mapping program (Manly and Olson, 1999, Mammalian Genome 10: 327-334, which is hereby incorporated herein by reference in its entirety). Map Manager QT conducts single-marker regression analysis, regression-based simple interval mapping (Haley and Knott, 1992, Heredity 69, 315-324, which is hereby incorporated herein by reference in its entirety), composite interval mapping (Zeng 1993, Proc. Natl. Acad. Sci. U.S.A. 90: 10972-10976, which is hereby incorporated herein by reference in its entirety), and permutation tests. A description of Map Manager QT is provided by the reference Manly and Olson, 1999, Overview of QTL mapping software and introduction to Map Manager QT, Mammalian Genome 10: 327-334, each of which is hereby incorporated herein by reference in its entirety.

Yet another program that may be used to perform linkage analysis is MultiCross QTL, which maps QTL from crosses originating from inbred lines. MultiCross QTL uses a linear regression-model approach and handles different methods such as interval mapping, all-marker mapping, and multiple QTL mapping with cofactors. The program can handle a wide variety of simple mapping populations for inbred and outbred species. MultiCross QTL is available from Unite de Biometrie et Intelligence Artificielle, INRA, 31326 Castanet Tolosan, France.

Still another program that can be used to perform linkage analysis is QTL Café. The program can analyze most populations derived from pure line crosses such as F₂ crosses, backcrosses, recombinant inbred lines, and doubled haploid lines. QTL Café incorporates a Java implementation of Haley & Knotts' flanking marker regression as well as Marker regression, and can handle multiple QTLs. The program allows three types of QTL analysis single marker ANOVA, marker regression (Kearsey and Hyne, 1994, Theor. Appl. Genet., 89: 698-702, which is hereby incorporated herein by reference in its entirety), and interval mapping by regression, (Haley and Knott, 1992, Heredity 69: 315-324, which is hereby incorporated herein by reference in its entirety). QTL Café is available from http://web.bham.ac.uk/g.g.seaton/.

Yet another program that can be used to perform linkage analysis is MAPL, which performs QTL analysis by either interval mapping (Hayashi and Ukai, 1994, Theor. Appl. Genet. 87:1021-1027, which is hereby incorporated herein by reference in its entirety) or analysis of variance. Different population types including F₂, back-cross, recombinant inbreds derived from F₂ or back-cross after a given generations of selfing can be analyzed. Automatic grouping and ordering of numerous markers by metric multidimensional scaling is possible. MAPL is available from the Institute of Statistical Genetics on Internet (ISGI), Yasuo, UKAI, http://web.bham.ac.uk/g.g.seaton/.

Another program that can be used for linkage analysis is R/qtl. This program provides an interactive environment for mapping QTLs in experimental crosses. R/qtl makes uses of the hidden Markov model (HMM) technology for dealing with missing genotype data. R/qtl has implemented many HMM algorithms, with allowance for the presence of genotyping errors, for backcrosses, intercrosses, and phase-known four-way crosses. R/qtl includes facilities for estimating genetic maps, identifying genotyping errors, and performing single-QTL genome scans and two-QTL, two-dimensional genome scans, by interval mapping with Haley-Knott regression, and multiple imputation. R/qtl is available from Karl W. Broman, Johns Hopkins University, http://biosun01.biostatjhsph.edu/˜kbroman/qtl/.

Those of skill in the art will appreciate that there are several other programs and algorithms that can be used in the steps of the methods of the present invention where quantitative genetic analysis is needed, and all such programs and algorithms are within the scope of the present invention.

### 5.13.6. Model-Based Parametric Linkage Analysis

In model-based linkage analysis, (also termed “lod score” methods or parametric methods), the details of a traits mode of inheritance is being modeled. Typically, particular values of the allele frequencies and the penetrance function are specified.

### 5.13.6.1 Interval Mapping Via Maximum Likelihood/Inbred Population

In one embodiment of the present invention, linkage analysis comprises QTL interval mapping in accordance with algorithms derived from those first proposed by Lander and Botstein, 1989, “Mapping Mendelian factors underlying quantitative traits using RFLP linkage maps,” Genetics 121: 185-199, which is hereby incorporated herein by reference in its entirety. The principle behind interval mapping is to test a model for the presence of a QTL at many positions between two mapped marker loci. The model is fit, and its goodness is tested using a technique such as the maximum likelihood method. Maximum likelihood theory assumes that when a QTL is located between two biallelic markers, the genotypes (i.e., AABB, AAbb, aaBB, aabb for doubled haploid progeny) each contain mixtures of quantitative trait locus (QTL) genotypes. Maximum likelihood involves searching for QTL parameters that give the best approximation for quantitative trait distributions that are observed for each marker class. Models are evaluated by computing the likelihood of the observed distributions with and without fitting a QTL effect.

In some embodiments of the present invention, linkage analysis is performed using the algorithm of Lander, as implemented in programs such as GeneHunter. See, for example, Kruglyak et al., 1996, Parametric and Nonparametric Linkage Analysis: A Unified Multipoint Approach, American Journal of Human Genetics 58:1347-1363, Kruglyak and Lander, 1998, Journal of Computational Biology 5:1-7; Kruglyak, 1996, American Journal of Human Genetics 58, 1347-1363, each of which is hereby incorporated herein by reference in its entirety. In such embodiments, unlimited markers may be used but pedigree size is constrained due to computational limitations. In other embodiments, the MENDEL software package is used. (See http://bimas.dcrt.nih.gov/linkage/ltools.html). In such embodiments, the size of the pedigree can be unlimited but the number of markers that can be used in constrained due to computational limitations. The techniques described in this Section typically require an inbred population.

### 5.13.6.2 Interval Mapping Using Linear Regression/Inbred Population

In some embodiments of the present invention, interval mapping is based on regression methodology and gives estimates of QTL position and effect that are similar to those given by the maximum likelihood method. Since the QTL genotypes are unknown in mapping based on regression methodology, genotypes are replaced by probabilities estimated using genotypes at the nearest flanking markers or for all linked markers. See, e.g., Haley and Knott, 1992, Heredity 69, 315-324; and Jiang and Zeng, 1997, Genetica 101:47-58, each of which is hereby incorporated herein by reference in its entirety. The techniques described in this Section typically require an inbred population.

### 5.13.7. Model-Free Nonparametric Linkage Analysis

Model-based linkage analysis (classical linkage analysis) calculates a lod score that represents the chance that a given locus in the genome is genetically linked to a trait, assuming a specific mode of inheritance for the trait. Namely the allele frequencies and penetrance values are included as parameters and are subsequently estimated. In the case of complex diseases, it is often difficult to model with any certainty all the causes of familial aggregation. In other words, when the trait exhibits non-Mendelian segregation it can be difficult to obtain reliable estimates of penetrance values, including phenocopy risks, and the allele frequency of the disease mutation. Indeed it can be the case that different mutations at different loci have different kinds of effect on susceptibility, some major and some minor, some dominant and some recessive. If different modes of transmission are operative in different families, or if different loci interact in the same family, then no one transmission model may be appropriate. It is conceivable that if the transmission model for a linkage analysis is specified incorrectly the results produced from it will not be valid nor interpretable.

As a result of the difficulties described above, a variety of methods have been developed to test for linkage without the need to specify values for the parameters defining the transmission model, and these methods are termed model-free linkage analyses (meaning that they can be applied without regard to the true transmission model). Such methods are based on the premise that relatives who are similar with respect to the phenotype of interest will be similar at a marker locus, sharing identical marker alleles, only if a locus underlying the phenotype is linked to the marker.

Model-free linkage analyses (allele-sharing methods) are not based on constructing a model, but rather on rejecting a model. Specifically, one tries to prove that the inheritance pattern of a chromosomal region is not consistent with random Mendelian segregation by showing that affected relatives inherit identical copies of the region more often then expected by chance. Affected relatives should show excess allele sharing in regions linked to the QTL even in the presence of incomplete penetrance, phenocopy, genetic heterogeneity, and high-frequency disease alleles.

### 5.13.7.1. Identical by Descent—Affected Pedigree Member (IBD-APM) Analysis/Outbred Population

In one embodiment, nonparametric linkage analysis involves studying affected relatives 246 (FIG. 1) in a pedigree 310 to see how often a particular copy of a chromosomal region is shared identical-by descent (IBD), that is, is inherited from a common ancestor within the pedigree. The frequency of IBD sharing at a locus can then be compared with random expectation. An identity-by-descent affected-pedigree-member (IBD-APM) statistic can be defined as:

$$T ( s ) = {\sum }_{i , j} {x}_{ij} ( s ) .$$

where xᵢⱼ(s) is the number of copies shared IBD at position s along a chromosome, and where the sum is taken over all distinct pairs (i,j) of affected relatives 246 in a pedigree 310. The results from multiple families can be combined in a weighted sum T(s). Assuming random segregation, T(s) tends to a normal distribution with a mean μ and a variance σ that can be calculated on the basis of the kinship coefficients of the relatives compared. See, for example, Blackwelder and Elston, 1985, Genet. Epidemiol. 2, p. 85; Whittemore and Halpern, 1994, Biometrics 50, p. 118; Weeks and Lange, 1988, Am. J. Hum. Genet. 42, p. 315; and Elston, 1998, Genetic Epidemiology 15, p. 565, each of which is hereby incorporated herein by reference in its entirety. Deviation from random segregation is detected when the statistic (T−μ)/σ exceeds a critical threshold. The techniques in this section typically use an outbred population.

### 5.13.7.2. Affected Sib Pair Analysis/Outbred Population

Affected sib pair analysis is one form of IBD-APM analysis (Section 5.13.7.1). For example, two sibs can show IBD sharing for zero, one, or two copies of any locus (with a 25%-50%-25% distribution expected under random segregation). If both parents are available, the data can be partitioned into separate IBD sharing for the maternal and paternal chromosome (zero or one copy, with a 50%-50% distribution expected under random segregation). In either case, excess allele sharing can be measured with χ² test. In the ASP approach, a large number of small pedigrees (affected siblings and their parents) are used. DNA samples are collected from each organism and genotyped using a large collection of markers (e.g., microsatellites, SNPs). Then a check for functional polymorphism is performed. See, for example, Suarez et al., 1978, Ann. Hum. Genet. 42, p. 87; Weitkamp, 1981, N. Engl. J. Med. 305, p. 1301; Knapp et al., 1994, Hum. Hered. 44, p. 37; Holmans, 1993, Am. J. Hum. Genet. 52, p. 362; Rich et al., 1991, Diabetologica 34, p. 350; Owerbach and Gabbay, 1994, Am. J. Hum. Genet. 54, p. 909; and Berrettini et al., Proc. Natl. Acad. Sci. USA. 91, p. 5918, each of which is hereby incorporated herein by reference in its entirety. For more information on Sib pair analysis, see Hamer et al., 1993, Science 261, p. 321, which is hereby incorporated herein by reference in its entirety.

In some embodiments, ASP statistics that test whether affected siblings pairs have a mean proportion of marker genes identical-by-descent that is >0.50 were computed. See, for example, Blackwelder and Elston, 1985, Genet. Epidemiol. 2: 85, which is hereby incorporated herein by reference in its entirety. In some embodiments, such statistics are computed using the SIBPAL program of the SAGE package. See, for example, Tran et al. 1991, (SIB-PAL) Sib-pair linkage program (Elston, New Orleans), Version 2.5, which is hereby incorporated herein by reference in its entirety. These statistics are computed on all possible affected pairs. In some embodiments the number of degrees of freedom of the t test is set at the number of independent affected pairs (defined per sibship as the number of affected individuals minus 1) in the sample instead of the number of all possible pairs. See, for example, Suarez and Eerdewegh, 1984, Am. J. Med. Genet. 18: 135, which is hereby incorporated herein by reference in its entirety. The techniques in this section typically use an outbred population.

### 5.13.7.3. Identical by State—Affected Pedigree Member (IBS-APM) Analysis/Outbred Population

In some instances, it is not possible to tell whether two relatives inherited a chromosomal region IBD, but only whether they have the same alleles at genetic markers in the region, that is, are identical by state (IBS). IBD can be inferred from IBS when a dense collection of highly polymorphic markers has been examined, but the early stages of genetic analysis can involve sparser maps with less informative markers so that IBD status can not be determined exactly. Various methods are available to handle situations in which IBD cannot be inferred from IBS. One method infers IBD sharing on the basis of the marker data (expected identity by descent affected-pedigree-member; IBD-APM). See, for example, Suarez et al., 1978, Ann. Hum. Genet. 42, p. 87; and Amos et al., 1990, Am J. Hum. Genet. 47, p. 842, each of which is hereby incorporated herein by reference in its entirety. Another method uses a statistic that is based explicitly on IBS sharing (an IBS-APM method). See, for example, Weeks and Lange, 1988, Am J. Hum. Genet. 42, p. 315; Lange, 1986, Am. J. Hum. Genet. 39, p. 148; Jeunemaitre et al., 1992, Cell 71, p. 169; and Pericak-Vance et al., 1991, Am. J. Hum. Genet. 48, p. 1034, each of which is hereby incorporated herein by reference in its entirety.

In one embodiment the IBS-APM techniques of Weeks and Lange, 1988, Am J. Hum. Genet. 42, p. 315; and Weeks and Lange, 1992, Am. J. Hum. Genet. 50, p. 859 are used, each of which is hereby incorporated herein by reference in its entirety. Such techniques use marker information of affected individuals to test whether the affected persons within a pedigree are more similar to each other at the marker locus than would be expected by chance. In some embodiments, the marker similarity is measured in terms of identity by state. In some embodiments, the APM method uses a marker allele frequency weighting function, ƒ(p), where p is the allele frequency, and the APM test statistics are presented separately for each of three different weighting functions, ƒ(p)=1, ƒ(p)=1/\sqrt{p}, and ƒ(p)=1/p. Whereas the second and third functions render the sharing of a rare allele among affected persons a more significant event, the first weighting function uses the allele frequencies only in calculation of the expected degree of marker allele sharing. The third function, ƒ(p)=1/p, can lead (more frequently than the first two) to a non-normal distribution of the test statistic. The second function is a reasonable compromise for generating a normal distribution of the test statistic while incorporating an allele frequency function. In some instances, the APM test statistics are sensitive to marker locus and allele frequency misspecification. See, for example, Babron, et al, 1993, Genet. Epidemiol. 10, p. 389, each of which is hereby incorporated herein by reference in its entirety. In some embodiments, allele frequencies are estimated from the pedigree data using the method of Boehnke, 1991, Am J. Hum. Genet. 48, p. 22, or by studying alleles. See, also, for example, Berrettini et al., 1994, Proc. Natl. Acad. Sci. U.S.A. 91, p. 5918, each of which is hereby incorporated herein by reference in its entirety.

In some embodiments, the significance of the APM test statistics is calculated from the theoretical (normal) distribution of the statistic. In addition, numerous replicates (e.g., 10,000) of these data, assuming independent inheritance of marker alleles and disease (i.e., no linkage), are simulated to assess the probability of observing the actual results (or a more extreme statistic) by chance. This probability is the empirical P value. Each replicate is generated by simulating an unlinked marker segregating through the actual pedigrees. An APM statistic is generated by analyzing the simulated data set exactly as the actual data set is analyzed. The rank of the observed statistic in the distribution of the simulated statistics determines the empirical P value. The techniques in this section typically use an outbred population.

### 5.13.7.4. Quantitative Traits

Model-free linkage analysis can also be applied to quantitative traits. An approach proposed by Haseman and Elston, 1972, Behav. Genet. 2, p. 3, is based on the notion that the phenotypic similarity between two relatives should be correlated with the number of alleles shared at a trait-causing locus. Formally, one performs regression analysis of the squared difference Δ² in a trait between two relatives and the number x of alleles shared IBD at a locus. The approach can be suitably generalized to other relatives (Blackwelder and Elston, 1982, Commun. Stat. Theor. Methods 11, p. 449, which is hereby incorporated herein by reference in its entirety) and multivariate phenotypes (See e.g., Amos et al., 1986, Genet. Epidemiol. 3, p. 255, which is hereby incorporated herein by reference in its entirety). See also, Marsh et al., 1994, Science 264, p. 1152, and Morrison et al., 1994, Nature 367, p. 284; Amos, 1994, Am. J. Hum Genet. 54, p. 535; and Elston, Am J. Hum. Genet. 63, p. 931, each of which is hereby incorporated herein by reference in its entirety.

### 5.14. Association Analysis

This section describes a number of association tests that can be used in the present invention. Association studies can be done with samples of pedigrees or samples of unrelated individuals. Further, association studies can be done for a dichotomous trait (e.g., disease) or a quantitative trait. See, for example, Nepom and Ehrlich, 1991, Annu. Rev. Immunol. 9, p. 493; Strittmatter and Roses, 1996, Annu. Rev. Neurosci. 19, p. 53; Vooberg et al., 1994, Lancet 343, p. 1535; Zoller et al., Lancet 343, p. 1536; Bennet et al., 1995, Nature Genet. 9, p. 284; Grant et al., 1996, Nature Genet. 14, p. 205; and Smith et al., 1997, Science 277, p. 959, each of which is hereby incorporated herein by reference in its entirety. As such, association studies test whether a disease and an allele show correlated occurrence across the population, whereas linkage studies determine whether there is correlated transmission within pedigrees.

Whereas linkage analysis involves the pattern of transmission of gametes from one generation to the next, association is a property of the population of gametes. Association exists between alleles at two loci if the frequency, with which they occur within the same gamete, is different from the product of the allele frequencies. If this association occurs between two linked loci, then utilizing the association will allow for fine localization, since the strength of association is in large part due to historical recombinations rather than recombination within a few generations of a family. In the simplest scenario, association arises when a mutation, which causes disease, occurs at a locus at some time, to. At that time, the disease mutation occurs on a specific genetic background composed of the alleles at all other loci; thus, the disease mutation is completely associated with the alleles of this background. As time progresses, recombination occurs between the disease locus and all other loci, causing the association to diminish. Loci that are closer to the disease locus will generally have higher levels of association, with association rapidly dropping off for markers further away. The reliance of association on evolutionary history can provide localization to a region as small as 50-75 kb. Association is also called linkage disequilibrium. Association (linkage disequilibrium) can exist between alleles at two loci without the loci being linked.

Two forms of association analysis are discussed in the sections below, population based association analysis and family based association analysis. More generally, those of skill in the art with appreciate that there are several different forms of association analysis, and all such forms of association analysis can be used in steps of the present invention that require the use of quantitative genetic analysis.

In some embodiments, whole genome association studies are performed in accordance with the present invention. Two methods can be used to perform whole-genome association studies, the “direct-study” approach and the “indirect-study” approach. In the direct-study approach, all common functional variants of a given gene are catalogued and tested directly to determine whether there is an increased prevalence (association) of a particular functional variant in affected individuals within the coding region of the given gene. The “indirect-study” approach uses a very dense marker map that is arrayed across both coding and noncoding regions. A dense panel of polymorphisms (e.g., SNPs) from such a map can be tested in controls to identify associations that narrowly locate the neighborhood of a susceptibility or resistance gene. This strategy is based on the hypothesis that each sequence variant that causes disease must have arisen in a particular individual at some time in the past, so the specific alleles for polymorphisms (haplotype) in the neighborhood of the altered gene in that individual can be inherited in all of his or her descendants. The presence of a recognizable ancestral haplotype therefore becomes an indicator of the disease-associated polymorphism. In actuality, some of the alleles will be in association while others will not due to recombination occurring between the mutation and other polymorphisms.

In the case where the testing is by association analysis, a genetic map is not required because the association test takes place between a single marker (or a number of markers that are physically very close to one another, e.g., a haplotype) and the trait of interest. In such a case, knowledge about the markers positions relative to others in the genome is not required because each marker is tested by itself. While it may be true that haplotypes are more easily formed with pedigree data, such information is not necessary (it can be computationally derived by examining the extent of linkage disequilibrium in an outbred population, or it can be formed directly by special resequencing assays that can track phase).

### 5.14.1. Population-based (model-free) association analysis

In population-based (model-free) association studies, allele frequencies in afflicted organisms are contrasted with allele frequencies in control organisms in order to determine if there is an association between a particular allele and a complex trait. Population-based association studies for dichotomous traits are also referred to as case-control studies. A case-control study is based on the comparison of unrelated affected and unaffected individuals from a population. An allele A at a gene of interest is said to be associated with the phenotype if it occurs at significantly higher frequency among affected compared with control individuals. Statistical significance can be tested by a number a methods, including, but not limited to, logistic regression. Association studies are discussed in Lander, 1996, Science 274, 536; Lander and Schork, 1994, Science 265, 2037; Risch and Merikangas, 1996, Science 273, 1516; and Collins et al., 1997, Science 278, 1533, each of which is hereby incorporated herein by reference in its entirety.

As is true for case-control studies generally, confounding is a problem for inferring a causal relationship between a disease and a measured risk factor using population-based association analysis. One approach to deal with confounding is the matched case-control design, where individual controls are matched to cases on potential confounding factors (for example, age and sex) and the matched pairs are then examined individually for the risk factor to see if it occurs more frequently in the case than in its matched control. In some embodiments, cases and controls are ethnically comparable. In other words, homogeneous and randomly mating populations are used in the association analysis. In some embodiments, the family-based association studies described below are used to minimize the effects of confounding due to genetically heterogeneous populations. See, for example, Risch, 2000, Nature 405, p. 847, which is hereby incorporated herein by reference in its entirety.

### 5.14.2. Family-Based Association Analysis

Family-based association analysis is used in some embodiments of the invention. In some embodiments, each affected organism is matched with one or more unaffected siblings (see, for example, Curtis, 1997, Ann. Hum. Genet. 61, p. 319, which is hereby incorporated herein by reference in its entirety) or cousins (see, for example, Witte, et al., 1999, Am. J. Epidemiol. 149, p. 693, which is hereby incorporated herein by reference in its entirety) and analytical techniques for matched case-control studies is used to estimate effects and to test a hypotheses. See, for example, Breslow and Day, 1989, Statistical methods in cancer research I, The analysis of case-control studies 32, Lyon: IARC Scientific Publications, which is hereby incorporated herein by reference in its entirety. The following subsections describe some forms of family-based association studies. Those of skill in the art will recognize that there are numerous forms of family-based association studies and all such methodologies can be used in the present invention.

### 5.14.2.1. Haplotype Relative Risk Test

In some embodiments, the haplotype relative risk test is used. In the haplotype relative risk method, all marker alleles compared arise from the same person. The marker alleles that parents transmit to an affected offspring (case alleles) are compared with those that they do not transmit to such an offspring (control alleles). One can also compare transmitted and nontransmitted genotypes. Consider the 2n parents of n affected persons. This population can be classified into a fourfold table according to whether the transmitted allele is a marker allele (M) or some other allele \overline{M} and according to whether the nontransmitted allele is similarly M or \overline{M}:

| | Nontransmitted allele | | |
|---|---|---|---|
| Transmitted allele | M | \overline{M} | Total |
| M | A | b | a + b |
| M | c | d | c + d |
| | a + c | b + d | 2n = a + b + c + d |

To test for association, a determination is made as to whether the proportion of M alleles that are transmitted, a/(a+b), differs significantly from the proportion of M alleles that are nontransmitted, a/(a+c). One appropriate statistical test for this determination is comparison of (b−c)²/(b+c) to a chi-square distribution with one degree of freedom when the sample is large.

The row totals for the table above are the numbers of transmitted alleles that are M and \overline{M}, while the column totals are the numbers of nontransmitted alleles that are M and \overline{M}. These four totals can be put into a fourfold table that classifies the 4n parental alleles, rather than the 2n parents:

| Marker allele | Transmitted | Non-transmitted | Total |
|---|---|---|---|
| M | a + b | a + c | 2a + b + c |
| M | c + d | b + d | b + c + 2d |
| Total | 2n | 2n | 4n |

The haplotype relative risk ratio is defined as (a+b)(c+d)/(a+c)(c+d). A chi-square distribution using one degree of freedom can be used to determine whether the haplotype relative risk ratio differs significantly from one. See, for example, Rudorfer, et al., 1984, Br. J. Clin. Pharmacol. 17, 433; Mueller and Young, 1997, Emery's Elements of Medical Genetics, Kalow ed., p. 169-175, Churchill Livingstone, Edinburgh; and Roses, 2000, Nature 405, p. 857, Elson, 1998, Genetic Epidemilogy, 15, p. 565, each of which is hereby incorporated herein by reference in its entirety.

### 5.14.2.2. Transmission Equilibrium Test

In some embodiments, the transmission equilibrium test (TDT) is used. TDT considers parents who are heterozygous for an allele and evaluates the frequency with which that allele is transmitted to affected offspring. By restriction to heterozygous parents, the TDT differs from other model-free tests for association between specific alleles of a polymorphic marker and a disease locus. The parameters of that locus, genotypes of sampled individuals, linkage phase, and recombination frequency are not specified. Nevertheless, by considering only heterozygous parents, the TDT is specific for association between linked loci.

TDT is a test of linkage and association that is valid in heterogeneous populations. It was originally proposed for data consisting of families ascertained due to the presence of a diseased child. The genetic data consists of the marker genotypes for the parents and child. The TDT is based on transmissions, to the diseased child, from heterozygous parents, or parents whose genotypes consist of different alleles. In particular, consider a biallelic marker with alleles M₁ and M₂. The TDT counts the number of times, n₁₂, that M₁M₂ parents transmit marker allele M₁ to the diseased child and the number of times, n₂₁, that M₂ is transmitted. If the marker is not linked to (correlated with) the disease locus, i.e. θ=0.5, or if there is no association between M₁ and the disease mutation, then conditional on the number of heterozygous parents, and in the absence of segregation distortion, n₁₂ is distributed binomially: B(n₁₂+n₂₁, 0.5). The null hypothesis of no linkage or no association can be tested with the statistic

$${T}_{TDT} = \frac{{( {n}_{12} - {n}_{21} )}^{2}}{{n}_{12} + {n}_{21}}$$

with statistical significance level approximated using the χ² distribution with one df or computed exactly with the binomial distribution. When transmissions from more than one diseased child per family are included in the TDT statistic, the test is valid only as a test of linkage.

Several extensions of the TDT test have been proposed and all such extensions are within the scope of the present invention. See, for example, Mortin and Collins, 1998, Proc. Natl. Acad. Sci. U.S.A. 95, p. 11389; Terwilliger, 1995, Am. J. Hum. Genet. 56, p. 777. See also, for example, Mueller and Young, 1997, Emery 's Elements of Medical Genetics, Kalow ed., p. 169-175, Churchill Livingstone, Edinburgh; Zhao et al., 1998, Am. J. Hum. Genet. 63, p. 225; Roses, 2000, Nature 405, p. 857; Spielman et al., 1993, Am. J. Hum. Genet. 52, p. 506; and Ewens and Spielman; Am. J. Hum. Genet. 57, p. 455, each of which is hereby incorporated herein by reference in its entirety.

### 5.14.2.3. Sibship-Based Test

In some embodiments, the sibship-based test is used. See, for example, Wiley, 1998, Cur. Pharmaceut. Des. 4, p. 417; Blackstock and Weir, 1999, Trends Biotechnol. 17, p. 121; Kozian and Kirschbaum, 1999, Trends Biotechnol. 17, p. 73; Rockett et al., Xenobiotica 29, p. 655; Roses, 1994, J. Neuropathol. Exp. Neurol 53, p. 429; and Roses, 2000, Nature 405, p. 857, each of which is hereby incorporated herein by reference in its entirety.

### 5.15. Obesity Related Genes and Obesity Related Gene Products

In Tables 4 through 6 of Section 6 below, a number of genes were identified as being associated with and, in many instances, causal for the omental fat pad mass trait. Each of the genes identified in Table 6 are causal for omental fad pad mass in mice. As such, each of the genes in Table 6 (and their homologs) are potential therapuetic targets for obesity and related diseases. Section 5.15.1 provides additional evidence that inhibition of the malic enzyme Mod1, (ranked eighth in Table 6) could be an effective treatment for obesity.

### 5.15.1. Treatment of Obesity by Inhibition of Mod1

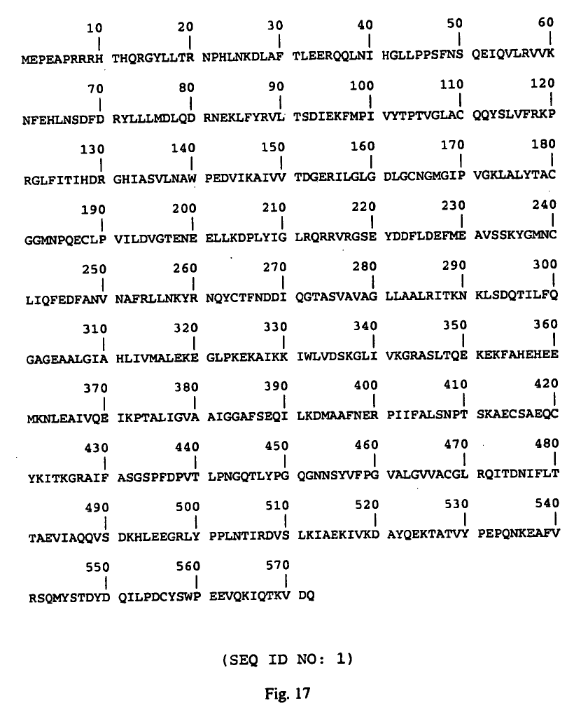

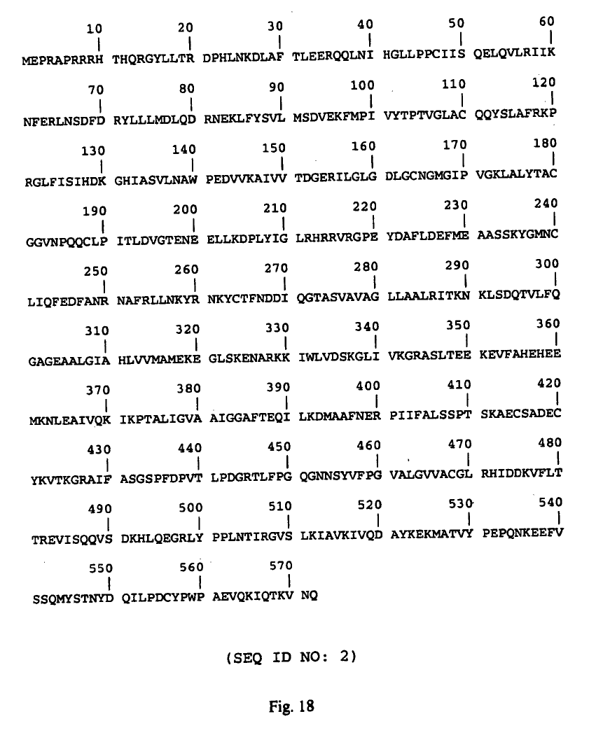

Malic enzyme 1, ME1 (SEQ ID NO: 1, FIG. 17; Swiss protein entry P48163) in humans (Strausberg, 2002, Proc. Natl. Acad. Sci. U.S.A. 99:16899-16903; EC 1.1.1.40, which is hereby incorporated herein by reference in its entirety), Mod1 (SEQ ID NO: 2, FIG. 18; Swiss protein entry P06801) in mouse (Bagchi et al., 1987, J. Biol. Chem. 262:1558-1565, which is hereby incorporated herein by reference in its entirety) is a well known cytoplasmic protein involved in the citrate-pyruvate shuttle and associated with lipogenesis. As discussed in Section 6 below, Mod1 (SEQ ID NO: 2) has been identified as one of a number of genes that test as causative for omental fat pad mass (OFPM) in a mouse cross. Mod1 (SEQ ID NO: 2) was ranked eighth in Table 6 of Section 6 and accounts for approximately 52 percent of the genetic variation in OFPM as judged by the causality test of the present invention. Three of six of Mod1's (SEQ ID NO: 2) eQTLs overlap with three of five cQTLs for omental fat pad mass (log of omental FPM). Mod1 (SEQ ID NO: 2) sits at the center of key pathways in intermediate metabolism and is regulated in liver by thyroid hormone, insulin, glucagon, androgens, fasting, high carbohydrates, low fatty acids and thiazolidinediones. Mod1 (SEQ ID NO: 2) activity closely follows lipogenesis and mRNA levels are positively correlated with OFPM and a number of other measures of adiposity. Mod1 is reported to be non-essential in mouse. See for example Johnson et al., 1981, J. Hered. 72, 134-136; and Lee et al. 1980, Mol. Cell. Biochem. 30, 143-149, each of which is hereby incorporated herein by reference in its entirety. Here the roles of Mod1 (SEQ ID NO: 2) in low and high energy states are discussed and a model of how inhibition of Mod1 activity may be an effective treatment for obesity is proposed.

As discussed in previous sections, the present invention provides methods to identify genes in the genetic network that are causative for individual traits. Briefly, this is done by selecting genes whose expression is correlated with the trait of interest and identifying amongst those that have overlapping genetics (Quantitative Trait Loci, or QTL). These are then further assessed using a causality test as described to distinguish between reactive and causative changes with respect to the clinical trait. As discussed in Section 6 below, this analysis was completed using omental fat pad mass (OFPM) of F₂ mice from a cross of C57bl6J and DBA (BxD cross), and resulted in a short list of genes (Section 6, Table 6) that, by these criteria, appear to be causative for that clinical trait. Here we focus on one gene from the list that is intimately involved in key metabolic pathways, and propose that the cytosolic malic enzyme, may be an excellent target for the treatment of obesity and its co-morbidities, such as, diabetes, coronary artery disease, dyslipidemias (e.g., hyperlipidemia), stroke, chronic venous abnormalities, orthopedic problems, sleep apnea disorders, esophageal reflux disease, hypertension, arthritis and some forms of cancer (e.g., colorectal cancer, breast cancer, diabetes, heart disease).

### 5.15.1.1. Mod1 (SEQ ID NO: 2) is Causative for OFPM

Using standard analyses it was found that the log of omental fat pad mass (logomen) is under the genetic control of 6 discreet loci in the genome of the mice in the BxD cross (see FIG. 19).

In particular, FIG. 19A shows the quantitative trait loci (QTLs) that control genetic variation in OFPM (log of OFPM or logomen, left panel) and Mod1 (SEQ ID NO: 2) (right panel). The column legends for the left panel are (Chr—chromosome, Pos(M)—position on the chromosome in Morgans from the left end, LOD—calculated Lod score). Also shown are three overlapping QTLs indicated by arrows. Using the causality test, the matches at chromosomes 6 and 19 tested as causal and chromosome 9 was inconclusive. FIG. 19B lists various traits and the number of overlapping QTLs they have with Mod1 (SEQ ID No: 2). The traits are omen—omental fat pad mass; epipa—epididymal fat pad mass; retrog—retroperitoneal fat pad mass; subc—subcutaneous fat pad mass; lep—leptin protein levels; ins, insulin protein levels, livebwt—total body weight at sacrifice, ftpsum—sum of all fat pad masses; fatbw—adiposity (ftpsum as a percentage of livebwt). Also, some of the traits are converted to the log of the values (prefix “log”) or the square root of the values (prefix “sqrt”). The values are sorted by the number of overlaps with Mod1 (SEQ ID NO: 2) QTLs.

The livers from the mice in the BxD cross were profiled and 444 genes were found to be correlated with the OFPM trait (Pearson correlation coefficient p-values less than 0.0001), as discussed in Section 6 below. QTLs for these genes were derived followed by a test of causality as described in Section 6 below. This resulted in a list of 40 genes with two or more QTL's that are coincident with OFPM QTLs, and two or more of which tested as causal for that trait. This list of genes can be ranked by the estimated proportion of the genetically controlled variation that can be accounted for by each gene. Here the eighth member of that list Mod1 (SEQ ID NO: 2) is discussed.

There are six regions of the genome that control Mod1 (SEQ ID NO: 2) expression in the BxD cross and three of these are coincident with OFPM QTLs (see FIG. 19A). As discussed in Section 6, below, two of these overlaps are assessed to be causal using the causality test and Mod1 (SEQ ID NO: 2) can account for up to 52 percent of the genetically controlled variation in the OFPM trait. Based on this data it is proposed that the variation in Mod1 expression controls a significant portion of the variation in OFPM.

### 5.15.1.2. Mod1 (SEQ ID NO: 2) is Correlated with OFPM and Other Measures of Adiposity

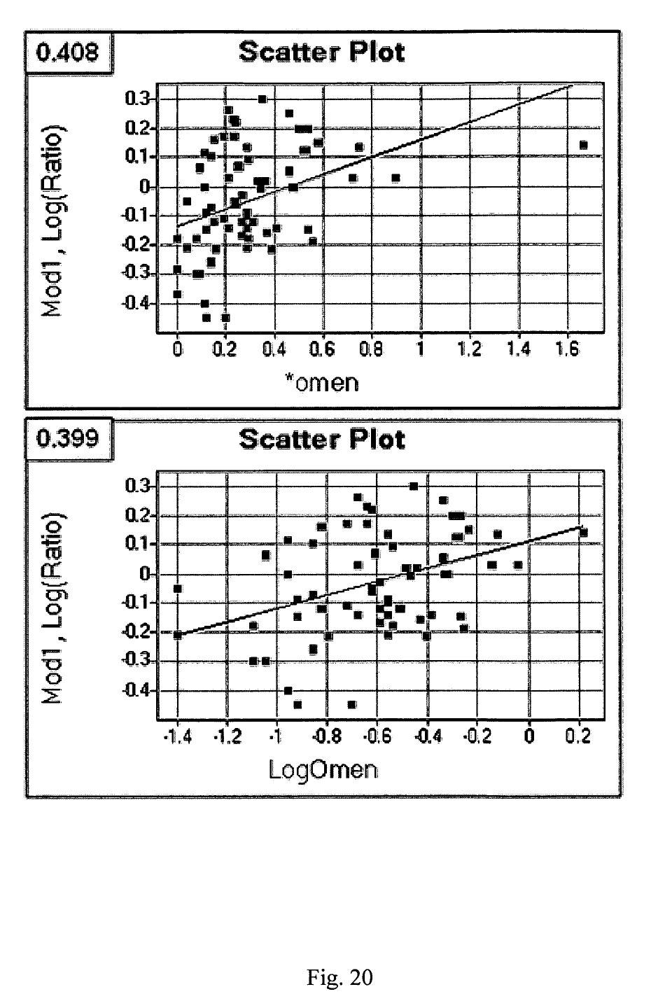

As described above, Mod1 (SEQ ID NO: 2) is correlated with OFPM and log of OFPM (see FIG. 20, top and bottom panels respectively) with coefficients of 0.408 and 0.399, respectively. In particular, the top panel of FIG. 20 shows a scatter gram of the OFPM values in grams (X axis) versus Mod1 (SEQ ID NO: 2) mRNA levels as mlratio's (Y axis). The lower panel shows a comparison of Mod1 to the log of the OFPM values (LogOmen).

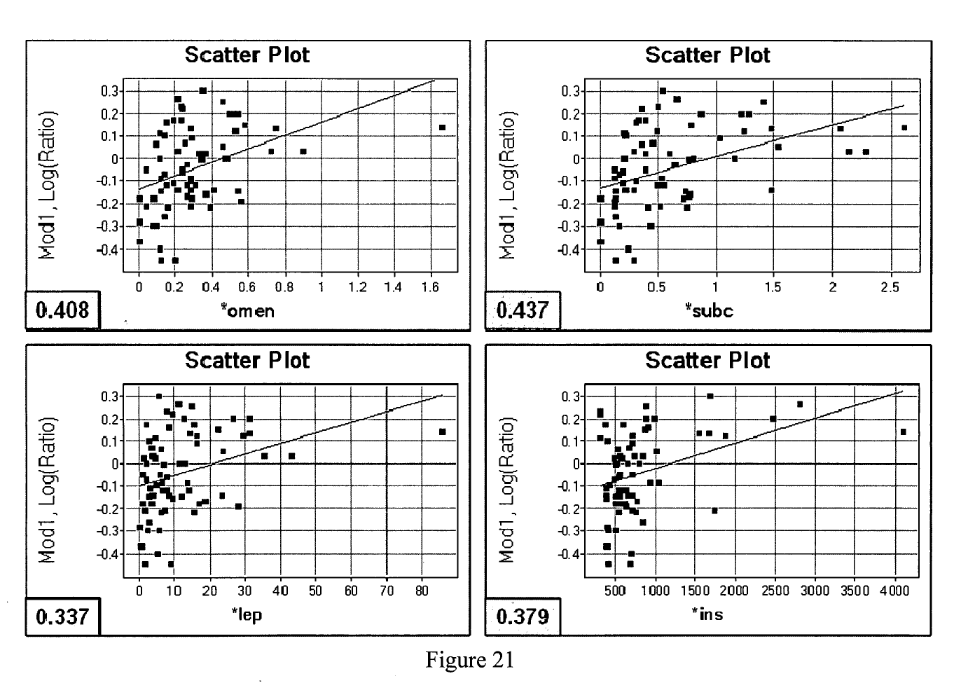

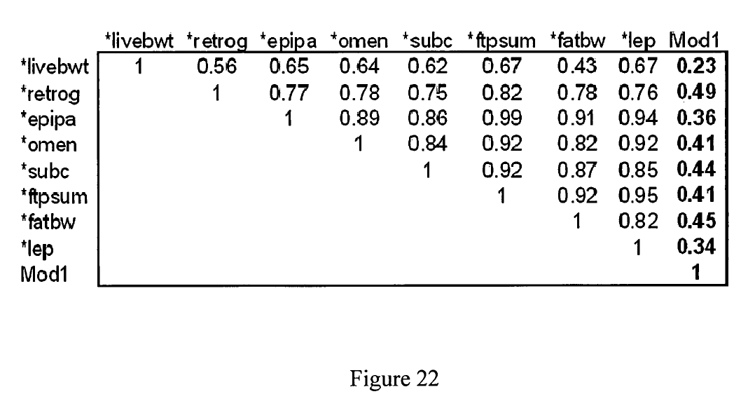

The positive correlation and causality implies that increasing Mod1 levels results in increased OFPM and therefore an inhibitor of Mod1 (SEQ ID NO: 2) activity may decrease OFPM. Similarly, data indicates that Mod1 (SEQ ID NO: 2) levels in the liver are correlated with subcutaneous fat pad mass, leptin and insulin levels (see FIG. 21) and has coincident QTLs with, and is correlated to a number of obesity and obesity related traits (see FIG. 19B, and FIG. 22). This is consistent with Mod1 (SEQ ID NO: 2) levels and/or activity being a determining factor in a range of obesity phenotypes. In more detail, FIG. 21 illustrates scatter grams comparing Mod1 (SEQ ID NO: 2) ml ratios (Y axes) to OFPM (top left), subcutaneous fat pat mass (top right), leptin protein levels (bottom left) and insulin protein levels (bottom right) all X axis. The correlation coefficients are as shown in the bottom left of each panel. FIG. 22 illustrates the correlation coefficients of various measures of fat pad masses and adiposity and Mod1 (SEQ ID NO: 2) mRNA levels. Figure legends for FIG. 22 are the same as for FIG. 19.

### 5.15.1.3. Mod1 (SEQ ID NO: 2) is an NADP(+) Dependent Enzyme

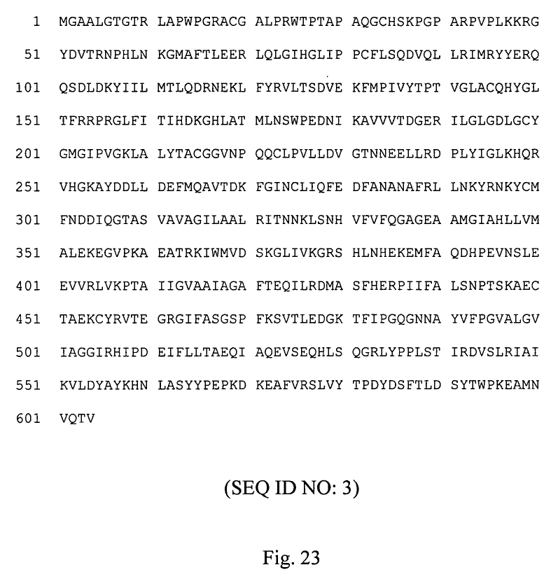

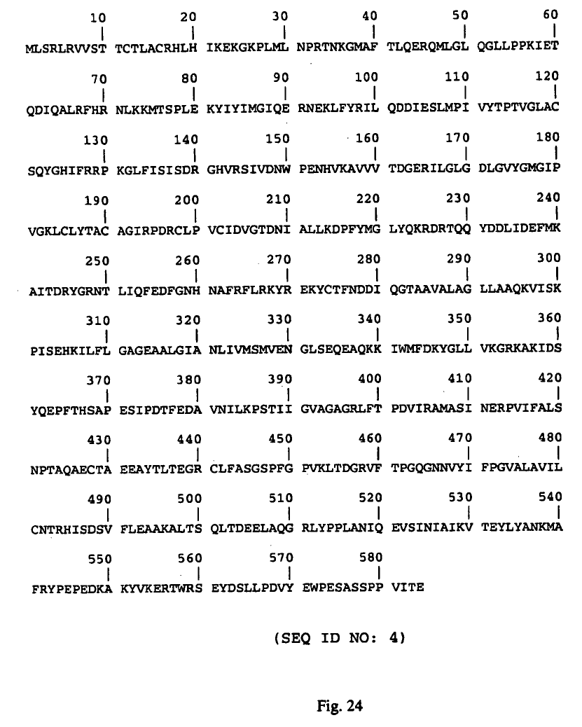

Mod1 (SEQ ID NO: 2) catalyzes the reversible oxidative decarboxylation of malate and is a link between the citric acid cycle, fatty acid synthesis and the glycolytic pathway. For instance, see Povey et al., 1975, Ann. Hum. Genet. 39, 203-212; Yang et al., 2002, Protein Science 11, 332-341. The reaction is L-malate plus NADP(+) to form pyruvate, CO(2), and NADPH. There are two types of NADP(+)-dependent malic enzymes, a cytosolic form (ME1) (SEQ ID NO: 1) and a mitochondrial form (ME3) (Swiss Prot accession number Q16798; SEQ ID NO: 3; FIG. 23; Loeber et al., 1994, Biochem. J. 304: 687-692; which is hereby incorporated herein by reference in its entirety). These enzymes are also called NADP(+)-dependent malate dehydrogenases. ME2 (EC 1.1.1.39) (SEQ ID NO: 4; FIG. 24; Swiss Prot accession number P23368), which is NAD(+)dependent, is a third type of malic enzyme. See, Loeber et al., 1991, Biol. Chem. 266:3016-3021, which is hereby incorporated herein by reference in its entirety, Mod1/ME1 (SEQ ID NO: 2 and SEQ ID NO: 1) and ME3 are 72 percent identical and 87 percent similar.

The crystal structure of pigeon Mod1 has been solved and the reaction catalyzed by the malic enzymes has been extensively studied. These studies include the characterization of a number of substrate and transition state inhibitors, including D-malate, tartronate, ketomalonate and oxalate. See Yang et al., 2002, Protein Science 11, pp. 332-341, which is hereby incorporated herein by reference in its entirety. Further, the crystal structure of residues 21-573 of human mitochondrial NAD(P)+-dependent malic enzyme (m-NAD-ME2) (SEQ ID NO: 4, FIG. 24) has been reported. See Xu et al., 1999, Structure 7, 877-889; Yang et al. 2000, Nat. Struct. Biol. 7, 251-257; Yang and Tong, 2000, Protein Pept. Lett. 7, 287-296, each of which is hereby incorporated herein by reference in its entirety).

The crystal structures of Mod1 indicates that a number of regions of Mod1 can be mutated without interrupting the catalytic activity of the enzyme. The present invention contemplates the use of such mutants in screening assays in order to identify and develop compounds to treat diseases such as obesity. The crystal structures reveals that the malic enzyme is a tetramer of 60 kD monomers, termed domain A (residues 23-130), domain B (131-277 and 467-538), domain C (residues 278-466), and domain D (residues 539-573). See Yang et al., Nature Structural Biology 2000, 7, 251-257, which is hereby incorporated herein by reference in its entirety. Domains A and D are involved in dimer and tetramer formation, whereas domains B and C and several residues from domain A are responsible for catalysis of the enzyme.

### 5.15.1.4. Mod1 (SEQ ID NO: 2) Expression and Regulation

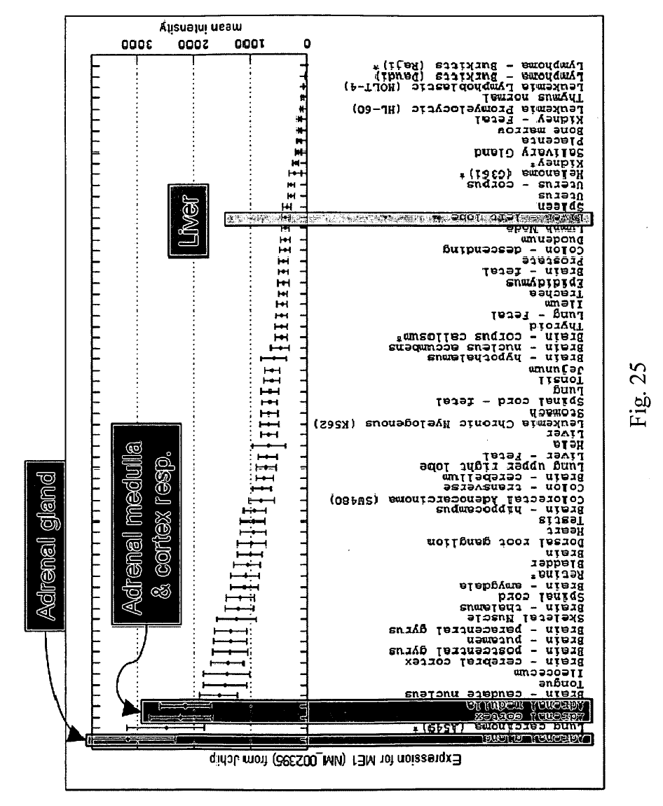

Mod1 (SEQ ID No: 2) is broadly expressed in monkeys with highest expression in the adrenals. For example, FIG. 25 illustrates the relative levels of expression of the cytoslic Malic enzyme Mod1 (SEQ ID NO: 2)) in various tissues of monkeys. Highest expression of Mod1 is in the adrenal gland, and expression in liver is somewhat lower. Most studies have concentrated on Mod1 (SEQ ID NO: 2) expression in the liver and its key role in intermediate metabolism. Mod1 (SEQ ID NO: 2) protein levels are primarily controlled by the rate of its synthesis, and this is up-regulated by high carbohydrates, low fats, insulin, thyroid hormone and androgens in vivo. See Casazza et al., 1986, J. Nutr. 116, p. 304-310; and Li et al., 1975, J. Biol. Chem 250, 141-148, which is hereby incorporated herein by reference in its entirety. The effect of thyroid hormone (T3) is via increased mRNA expression whereas carbohydrate alters mRNA degradation (the effect of carbohydrate is reported to be liver specific, Dozin et al. 1986, J. Biol. Chem. 261, 10290-10292; and Dozin et al. 1986, Proc. Natl. Acad. Sci. U.S.A. 83, 4705-4709, which is hereby incorporated herein by reference in its entirety. In tissue cultures, Mod1 (SEQ ID NO: 2) expression is repressed by the absence of thyroid hormone, starvation and glucagon via increased cAMP levels. Mod1 (SEQ ID NO: 2) is also induced by thiazolidinediones. See Hauner 2002, Diabetes Metab. Res. Rev. 18 Suppl 2, S10-15, which is hereby incorporated herein by reference in its entirety.

### 5.15.1.5. Mod1 (SEQ ID NO: 2) and Fatty Acid Synthesis

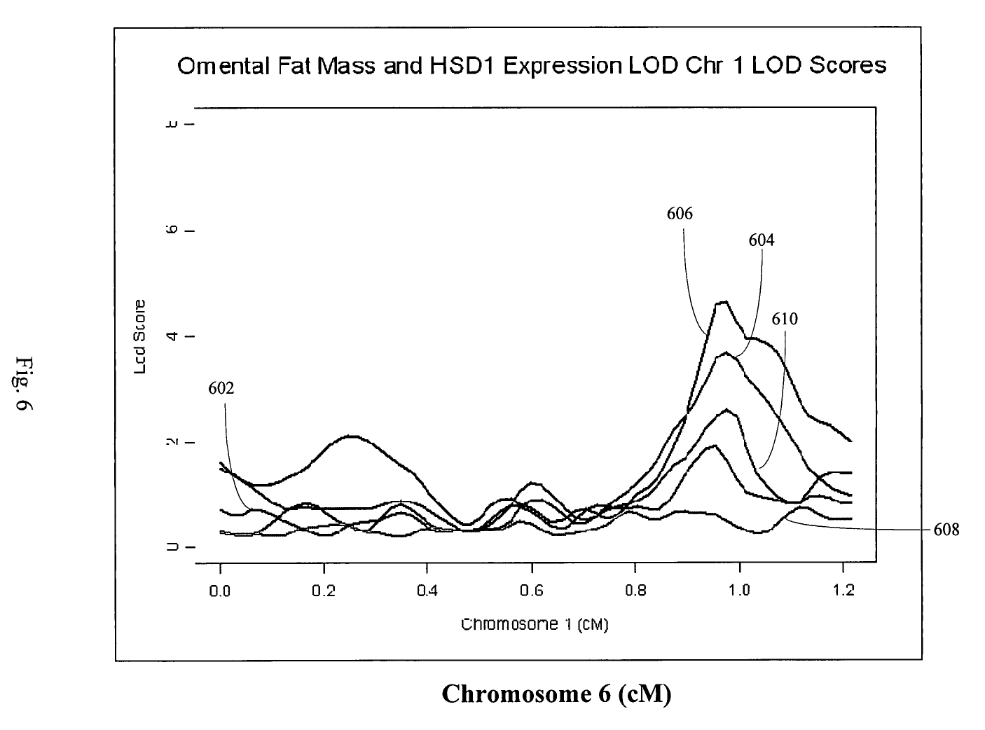

As described above, Mod1 (SEQ ID NO: 2) expression is highly regulated by high and low energy states. This regulation of Mod1 (SEQ ID NO: 2) closely parallels the response of intermediate metabolic pathways to conditions energy surplus. The following changes occur under high energy conditions (see FIG. 6):
The mitochondrion in high energy state has high levels of ATP and NADH, H+. This reduces the flow of metabolites through the TCA cycle by inhibiting isocitrate dehydrogenase.
Consequently isocitrate and citrate accumulate. Citrate diffuses into the cytosol via the tricarboxylate carrier, leading to 3 effects:
   Citrate and ATP inhibit phosphofructokinase (PFK), thereby reducing the flux through glycolysis and redirecting flow into the pentose phosphate pathway.
   Citrate is processed to form the precursor (acetyl CoA) of fatty acid synthesis, and to oxaloacetate, which is processed to malate and then to pyruvate. Production of pyruvate is accompanied by NADPH, H+ (a product of the Mod1 reaction) which is required for steps in fatty acid synthesis.
   Citrate activates the key regulatory enzyme in fatty acid synthesis: acetyl CoA carboxylase (ACC).
Activation of fatty acid synthesis is further helped by the pentose phosphate pathway producing NADPH, H+, which is required for fatty acid synthase (FAS) activity, and by feeding back into glycolysis via glyceraldehyde-3-phosphate, thereby maintaining citrate levels.

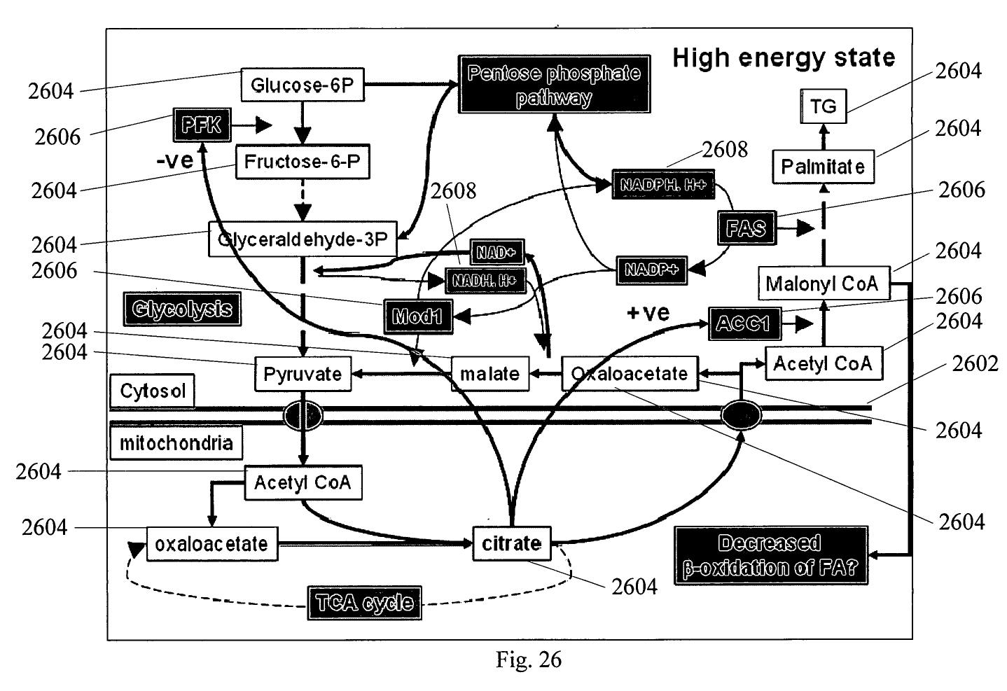

FIG. 26 provides the position of Mod1 (SEQ ID NO: 2) in a schematic representation of intermediate metabolism. Above line 2602 is cytosol, below line 2602 is mitochondria. Boxes 2604 show various metabolites, boxes 2606 show selected enzymes (PFK—phosphofructokinase, FAS—fatty acid synthase, ACC1—acetyl coenzyme A carboxylase, Mod1—cytosolic malic enzyme). Lines show the various pathways and connections and the thickness represent the relative flux through those pathways. The usage and production of NAD+/NADH, H+ and NADP+/NADPH, H+ are shown in the boxes 2608. Under “high energy” conditions citrate accumulates, is transported to the cytosol, and represses PFK and activates ACC1 (indicated by red lines). This results in increased fatty acid synthesis and decreased β-oxidation of fatty acids.

### 5.15.1.6. The Involvement of Mod1 (SEQ ID NO: 2) in Regulation of Energy Metabolism

Mod1 (SEQ ID NO: 2) links the citric acid cycle and fatty acid synthesis to glycolysis and is regulated by conditions of low and high energy state (thyroid hormone, insulin, glucagon, carbohydrates, fasting). Despite this, Mod1 (SEQ ID NO: 2) activity has not been implicated as the rate limiting or controlling step for fatty acid synthesis. The identification of Mod1 (SEQ ID NO: 2) as causative for OFPM levels suggests that this should be considered. The present invention proposes the following model whereby reduced malic enzyme activity results in decreased lipogenesis and potentially increased β-oxidation of fatty acid. First, decreasing levels of Mod1 (SEQ ID NO: 2) reduces the recycling of oxaloacetate in the cytosol to citrate in the mitochondrion (see FIG. 26). Second, reduced malic enzyme level also reduces the upstream reaction: oxaloacetate to malate which produces NAD+. NAD+ is required for a step in glycolysis (glyceraldehydes-3-phosphate to 1,3-bisphosphoglycerate. This further reduces the production of citrate (and ATP). Reduced citrate has three effects. It decreases inhibition of PFK which results in down-regulation of the pentose phosphate pathway (reducing production of NADPH, H+ which is required for FAS). It reduces precursor for fatty acid synthesis (acetyl CoA) and NADPH, H+. For example, it is estimated that 40 percent of the NADPH, H+ required by fatty acid synthesis is supplied by the malic enzyme reaction under glucose supported lipogenesis, the remaining 60 percent comes from the pentose phosphate pathway. It also reduces activation of acetyl CoA carboxylase, the highly regulated step in fatty acid synthesis. For example, reduced acetyl CoA carboxylase activity should also lower malonyl CoA. This could increase fatty acid oxidation since malonyl CoA inhibits fatty acid transport into the mitochondrion for β-oxidation. All of these effects will result in decreased fatty acid synthesis and a switch to a “low energy like state.”

### 5.15.1.7. The Role of Mod1 (SEQ ID NO: 2) in Obesity

Given the central position of Mod1, a number of researchers have asked if it could explain the variation in fatty acid synthesis under various conditions. The consensus is that while Mod1 activity closely tracks with lipogenesis it may not be the rate limiting step. See, for instance, Katsurada et al., 1986, Biochim Biophys Acta 878, 1986, 200-208, which is hereby incorporated herein by reference in its entirety. However, all of these experiments are based on the dietary manipulation of metabolism and in no case has Mod1 level or activity been directly altered. The genetics data described above suggests that Mod1 levels may in fact be a key determinant factor in intermediate metabolism and obesity, and a case can be made to support this hypothesis. As discussed in Section 6, analysis of a cross of mice has identified a short list of genes that appear to be causative for variation in omental fat pad mass. Mod1 is the eighth gene on this list and could account for 52 percent of the genetically determined variation in OFPM. Mod1, or the cytosolic malic enzyme, connects the citric acid cycle and fatty acid synthesis to glycolysis, and is regulated by high and low energy states (including insulin, glucagon, thyroid hormone, low fatty acids, high carbohydrates and fasting). Despite this high degree of regulation, Mod1 has not, until now, been implicated as a key regulatory step in intermediate metabolism. Mice lacking cytosolic malic enzyme activity have been reported, suggesting that it is not essential. See, for example, Johnson et al., 1981, J. Hered. 72, pp. 134-136; and Lee, 1980, Mol Cell Biochem 30, pp. 143-149, each of which is hereby incorporated herein by reference in its entirety. Mod1 mRNA levels are positively correlated with OFPM and other measures of obesity and the Mod1 enzyme catalyses a well characterized reaction for which many inhibitors have been identified. All of this is consistent with Mod1 being a druggable and safe target and that inhibitors of it may be effective anti-obesity agents.

### 5.15.2. Malic Enzymes

As discussed in Section 5.15.1, using the techniques of the present invention, it has been discovered that inhibition of the malic enzyme, which catalyzes the oxidative decarboxylation of L-malate to pyruvate with the concomitant reduction of the cofactor NAD⁺ or NADP⁺, could provide an effective therapy in the treatment of obesity. While specific malic enzymes have been discussed in Section 5.15.1, the present invention is not limited to such examples. Indeed, a number of orthologs of the malic enzyme are known and any and all such orthologs can be screened in order to develop inhibitors of malic enzyme. Such orthologs can be used in a primary screen that is designed to identify inhibitors of the malic enzyme. Alternatively, such orthologs can be used in secondary screens that are designed to test the selectivity of potential malic enzyme inhibitors. Such orthologs include, but are not limited to rattus norvegicus (rat) Mod1 (Swiss Prot accession number P13697; Nikodem et al., 1989, Endocr. Res. 15:547-564, which is hereby incorporated herein by reference in its entirety), Mesembryanthemum crystallinum (Common ice plant) Mod1 (Swiss Prot accession number P37223; Cushman, 1992, Eur. J. Biochem. 208:259-266, which is hereby incorporated herein by reference in its entirety), Zea mays (maize) Mod1 (Swiss Prot accession number P16243; Rothermel and Nelson, 1989, J. Biol. Chem. 264:19587-19592, which is hereby incorporated herein by reference in its entirety), Flayeria trinervia (Clustered yellowtops) Mod1 (Swiss Prot accession number P22178; Boersch and Westhoff, 1990, FEBS Lett. 273:111-115, which is hereby incorporated herein by reference in its entirety), Escherichia coli Mod1 (Swiss Prot accession number P76558; Blattner et al., 1997, Science 277:1453-1474, which is hereby incorporated herein by reference in its entirety), Haemophilus influenzae Mod1 (Swiss Prot accession number P43837; Fleischmann et al., 1995, Science 269, pp. 496-512, which is hereby incorporated herein by reference in its entirety), Rhizobium meliloti Mod1 (Swiss Prot accession number O30808; Mitsch, 1998, J. Biol. Chem. 273:9330-9336), Rickettsia prowazekii Mod1 (Swiss Prot accession number Q9ZFV8; Andersson et al., 1998, Nature 396:133-140, which is hereby incorporated herein by reference in its entirety), Salmonella typhimurium Mod1 (Swiss Prot accession number Q9ZFV8; McClelland et al., Nature, 2001, 413:852-856, which is hereby incorporated herein by reference in its entirety), Flayeria pringlei Mod1 (Swiss Prot accession number P36444; Lipka et al., 1994, Plant Mol. Biol. 26:1775-1783, which is hereby incorporated herein by reference in its entirety), Oryza sativa Mod1 (Swiss Prot accession number P43279; Fushimi et al., 1994, Plant Mol. Biol. 24:965-967, which is hereby incorporated herein by reference in its entirety), Anas platyrhynchos Mod1 (Swiss Prot accession number P28227; Hsu et al., 1992, Biochem. J. 284:869-876), Gallus gallus (chicken) Mod1 (Swiss Prot accession number Q92060; Hodnett et al., 1996, Arch. Biochem. Biophys. 334:309-324, which is hereby incorporated herein by reference in its entirety), columba livia (domestic pigeon) Mod1 (Swiss Prot accession number P40927; Chou et al., 1994, Arch. Biochem. Biophys. 310:158-166, which is hereby incorporated herein by reference in its entirety), Mus musculus (mouse) Mod1 (Swiss Prot accession number P06801; Bagchi, 1986, Ann. N.Y. Acad. Sci. 478:77-92), Phaseolus vulgaris (kidney bean) Mod1 (Swiss Prot accession number P12628; Walter et al., 1988, Proc. Natl. Acad. Sci. U.S.A. 85:5546-5550, which is hereby incorporated herein by reference in its entirety), Populus trichocarpa (Western balsam poplar) Mod1 (Swiss Prot accession number P34105; van Doorsselaere et al., 1991, Plant Physiol. 96:1385-1386), and Vitis vinifera (grape) Mod1 (Swiss Prot accession number P51615; Franke et al., 1995, Plant Physiol. 107:1009-1010, which is hereby incorporated herein by reference in its entirety).

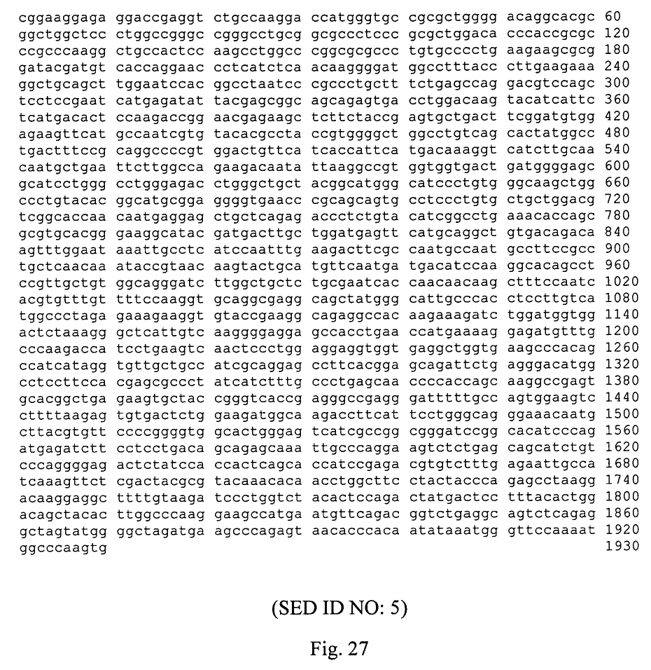

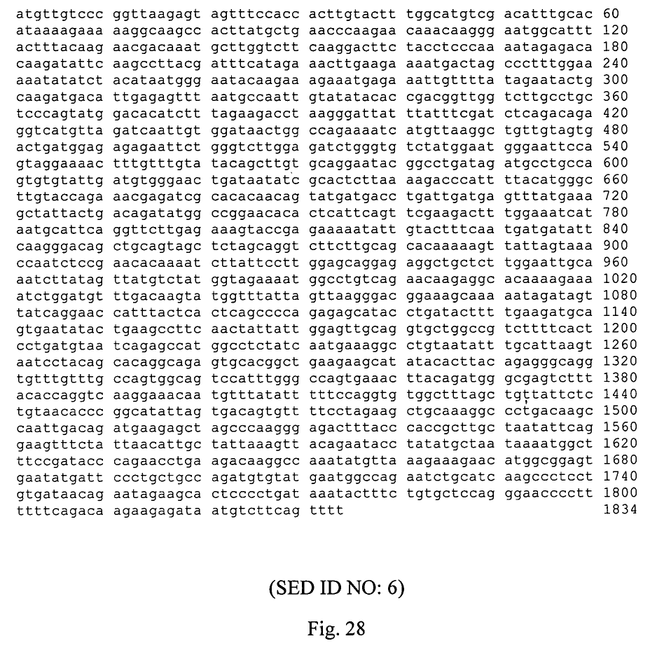

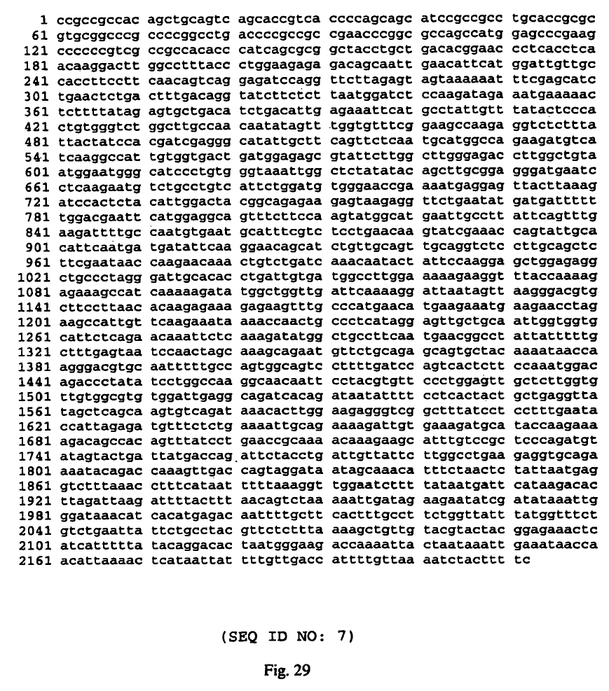

Malic enzymes include cDNAs or other nucleic acids that encode a malic enzyme. Such cDNAs can include, but are not limited to, all or a portion of homo sapiens mitochondrial NADP(+)-dependent malic enzyme 3 (NCBI accession number X79440; SEQ ID NO: 5; FIG. 27), all or a portion of homo sapiens mitochondrial NAD-dependent malic enzyme 2 (NCBI accession number M55905; SEQ ID NO: 6; FIG. 28); and all or a portion of homo sapiens cytosolic malic enzyme 1 (SEQ ID NO: 7; FIG. 29; Gonzalez-Manchon et al., 1997, DNA Cell Biol. 16, 533-544, which is hereby incorporated herein by reference in its entirety).

The term “malic enzyme” includes amino acid macromolecules that include a sequence as substantially set forth in any one of SEQ ID NO: 1, SEQ ID NO: 2, SEQ ID NO: 3, and SEQ ID NO: 4. The invention further relates to fragments and derivatives thereof. Antibodies to malic enzymes and derivatives of such antibodies (e.g., the binding domain of such antibodies) are further provided by the present invention.

### 5.15.3. Additional Genes and Proteins that are Causal for Obesity-Related Traits

Section 5.15.2 describes malic enzymes and Table 6 of Section 6 describes a number of genes and proteins (SEQ ID NO: 8 through SEQ ID NO: 34) that are causal for an obesity-related trait in mice. This invention further relates to modulation of these genes and proteins, their orthologs, their paralogs, and fragments and derivatives thereof. The present invention further relates to therapeutic and diagnostic methods and compositions based on such nucleic acid sequences and/or gene products as well as antibodies that bind to such gene products.

Animal models, diagnostic methods and screening methods for predisposition to obesity are also provided by the invention. The invention further provides methods of treatment of obesity and obesity related diseases such as anorexia nervosa, bulimia nervosa, and cachexia using modulators of genes and gene products referenced in this section. Modulators, e.g., inhibitors and agonists, of such genes and gene products can be identified by any method known in the art. In particular, molecules can be assayed for their ability to promote or inhibit (modulate) the expression of the such genes. Once modulators are identified, they can be assayed for therapeutic efficacy using any assay available in the art for obesity.

Modulators can be identified by screening for molecules that bind to gene products referenced in this section. Molecules that bind such gene products can be identified in many ways that are well known and routine in the art. For example, but not by way of limitation, by overexpressing such gene products (e.g., SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, SEQ ID NO: 26, SEQ ID NO: 28, SEQ ID NO: 30, and SEQ ID NO: 34 or their orthologs) in a cell line that endogenously expresses little or none of the gene product and assaying for molecules that bind to the cells overexpressing the gene product (or cell extract from such overexpressing cells) and that do not bind to the cells not overexpressing the gene product (or cell extract from such cells) or by conjugating the gene product to a solid support (e.g., a chromatography resin) contacting the conjugated gene product to a solid support with a molecule of interest, isolating the solid support and determining whether the molecule of interest bound to the gene product. Other methods include screening phage display libraries, combinatorial chemical libraries and the like for binding to one or more of the gene products are described below.

In specific aspects, nucleic acids are provided that comprise a sequence complementary to at least 10, 25, 50, 100, or 200 nucleotides or the entire coding region of a gene encoding SEQ ID NO: 5, SEQ ID NO: 6, SEQ ID NO: 7, SEQ ID NO: 8, SEQ ID NO: 9, SEQ ID NO: 1, SEQ ID NO: 12, SEQ ID NO: 14, SEQ ID NO: 16, SEQ ID NO: 18, SEQ ID NO: 20, SEQ ID NO: 21, SEQ ID NO: 23, SEQ ID NO: 25, SEQ ID NO: 27, SEQ ID NO: 29, or SEQ ID NO: 31.

### 5.15.4. Screening for Gene Agonists and Antagonists

The genes and gene products referenced in Section 5.15.3 can be used to prepare protein for screening by methods that are routine and well known in the art (see, e.g., Sambrook et al., 2001, Molecular Cloning: A Laboratory Manual, Third Edition, Cold Spring Harbor Laboratory Press, N.Y.; and Ausubel et al., 1989, Current Protocols in Molecular Biology, Green Publishing Associates and Wiley Interscience, N.Y., both of which are hereby incorporated by reference in their entireties).

For example, using any of the gene sequences referenced in Section 5.15.3 (e.g., SEQ ID NO: 5, SEQ ID NO: 6, SEQ ID NO: 7, SEQ ID NO: 8, SEQ ID NO: 9, SEQ ID NO: 1, SEQ ID NO: 12, SEQ ID NO: 14, SEQ ID NO: 16, SEQ ID NO: 18, SEQ ID NO: 20, SEQ ID NO: 21, SEQ ID NO: 23, SEQ ID NO: 25, SEQ ID NO: 27, SEQ ID NO: 29, and SEQ ID NO: 31) oligonucleotide primers for PCR amplification can be designed. PCR amplification is then used to amplify specifically the obesity related protein coding sequence, which can be cloned into an appropriate expression vector using routine techniques. That vector can then be introduced into bacterial or cultured eukaryotic cells (e.g., cultured mammalian cells, insect cells, etc.) such that the gene product is expressed in the bacterial or cultured cell. The gene product can then be isolated from the bacterial or eukaryotic cell culture.

By way of example, diversity libraries, such as random or combinatorial peptide or nonpeptide libraries, can be screened for molecules that specifically bind to and/or modulate the function of the gene product. Many libraries are known in the art that can be used, e.g., chemically synthesized libraries, recombinant (e.g., phage display libraries), and in vitro translation-based libraries.

Examples of chemically synthesized libraries are described in Fodor et al., 1991, Science 251:767-773; Houghten et al., 1991, Nature 354:84-86; Lam et al., 1991, Nature 354:82-84; Medynski, 1994, Bio/Technology 12:709-710; Gallop et al., 1994, J. Medicinal Chemistry 37:1233-1251; Ohlmeyer et al., 1993, Proc. Natl. Acad. Sci. U.S.A. 90:10922-10926; Erb et al., 1994, Proc. Natl. Acad. Sci. USA 91:11422-11426; Houghten et al., 1992, Biotechniques 13:412; Jayawickreme et al., 1994, Proc. Natl. Acad. Sci. U.S.A. 91:1614-1618; Salmon et al., 1993, Proc. Natl. Acad. Sci. U.S.A. 90:11708-11712; PCT Publication No. WO 93/20242; and Brenner and Lerner, 1992, Proc. Natl. Acad. Sci. U.S.A. 89:5381-5383, each of which is hereby incorporated herein by reference in its entirety.

Examples of phage display libraries are described in Scott and Smith, 1990, Science 249:386-390; Devlin et al., 1990, Science, 249:404-406; Christian, R. B., et al., 1992, J. Mol. Biol. 227:711-718; Lenstra, 1992, J. Immunol. Meth. 152:149-157; Kay et al., 1993, Gene 128:59-65; and PCT Publication No. WO 94/18318 dated Aug. 18, 1994, each of which is hereby incorporated herein by reference in its entirety. In vitro translation-based libraries include but are not limited to those described in PCT Publication No. WO 91/05058 dated Apr. 18, 1991; and Mattheakis et al., 1994, Proc. Natl. Acad. Sci. U.S.A. 91:9022-9026, each of which is hereby incorporated herein by reference in its entirety.

By way of examples of nonpeptide libraries, a benzodiazepine library (see e.g., Bunin et al., 1994, Proc. Natl. Acad. Sci. U.S.A. 91:4708-4712, which is hereby incorporated herein by reference in its entirety) can be adapted for use. Peptoid libraries (Simon et al., 1992, Proc. Natl. Acad. Sci. U.S.A. 89:9367-9371, which is hereby incorporated herein by reference in its entirety) can also be used. Another example of a library that can be used, in which the amide functionalities in peptides have been permethylated to generate a chemically transformed combinatorial library, is described by Ostresh et al. (1994, Proc. Natl. Acad. Sci. U.S.A. 91:11138-11142, which is hereby incorporated herein by reference in its entirety).

Screening the libraries can be accomplished by any of a variety of commonly known methods. See, e.g., the following references, which disclose screening of peptide libraries: Parmley and Smith, 1989, Adv. Exp. Med. Biol. 251:215-218; Scott and Smith, 1990, Science 249:386-390; Fowlkes et al., 1992; BioTechniques 13:422-427; Oldenburg et al., 1992, Proc. Natl. Acad. Sci. U.S.A. 89:5393-5397; Yu et al., 1994, Cell 76:933-945; Staudt et al., 1988, Science 241:577-580; Bock et al., 1992, Nature 355:564-566; Tuerk et al., 1992, Proc. Natl. Acad. Sci. U.S.A. 89:6988-6992; Ellington et al., 1992, Nature 355:850-852; U.S. Pat. No. 5,096,815, U.S. Pat. No. 5,223,409, and U.S. Pat. No. 5,198,346, all to Ladner et al.; Rebar and Pabo, 1993, Science 263:671-673; and PCT Publication No. WO 94/18318, each of which is hereby incorporated herein by reference in its entirety.

In a specific embodiments, screening can be carried out by contacting the library members with an obesity related gene product referenced in Section 5.15.3 (or nucleic acid or derivative) immobilized on a solid phase and harvesting those library members that bind to the protein (or nucleic acid or derivative). Examples of such screening methods, termed “panning” techniques, are described by way of example in Parmley and Smith, 1988, Gene 73:305-318; Fowlkes et al., 1992, BioTechniques 13:422-427; PCT Publication No. WO 94/18318; and in references cited hereinabove.

In another embodiment, the two-hybrid system for selecting interacting proteins in yeast (Fields and Song, 1989, Nature 340:245-246; Chien et al., 1991, Proc. Natl. Acad. Sci. U.S.A. 88:9578-9582, each of which is hereby incorporated herein by reference in its entirety) can be used to identify molecules that specifically bind to a gene product referenced in Section 5.15.3 or a derivative of such gene product.

### 5.15.5. Low Stringency Conditions

The invention also relates to nucleic acids hybridizable to or complementary to all or a portion of the nucleic acid sequences referenced in Section 5.15.3 under conditions of low stringency. By way of example and not limitation, procedures using such conditions of low stringency are as follows (see also Shilo and Weinberg, 1981, Proc. Natl. Acad. Sci. U.S.A. 78:6789-6792, each of which is hereby incorporated herein by reference in its entirety): filters containing DNA are pretreated for 6 hours at 40° C. in a solution containing 35% formamide, 5×SSC, 50 mM Tris-HCl (pH 7.5), 5 mM EDTA, 0.1% PVP, 0.1% Ficoll, 1% BSA, and 500 mg/ml denatured salmon sperm DNA. Hybridizations are carried out in the same solution with the following modifications: 0.02% PVP, 0.02% Ficoll, 0.2% BSA, 100 mg g/ml salmon sperm DNA, 10% (wt/vol) dextran sulfate, and 5-20×106 cpm 32P-labeled probe is used. Filters are incubated in hybridization mixture for 18-20 hours at 40° C., and then washed for 1.5 hours at 55° C. in a solution containing 2×SSC, 25 mM Tris-HCl (pH 7.4), 5 mM EDTA, and 0.1% SDS. The wash solution is replaced with fresh solution and incubated an additional 1.5 hours at 60° C. Filters are blotted dry and exposed for autoradiography. If necessary, filters are washed for a third time at 65-68° C. and reexposed to film. Other conditions of low stringency that can be used are well known in the art (e.g., as employed for cross-species hybridizations).

### 5.15.6. High Stringency Conditions

The invention also relates to nucleic acids hybridizable to or complementary to all or a portion of the nucleic acid sequences referenced in Section 5.15.3 under conditions of high stringency. By way of example and not limitation, procedures using such conditions of high stringency are as follows: prehybridization of filters containing DNA is carried out for 8 hours to overnight at 65° C. in buffer composed of 6×SSC, 50 mM Tris-HCl (pH 7.5), 1 mM EDTA, 0.02% PVP, 0.02% Ficoll, 0.02% BSA, and 500 mg/ml denatured salmon sperm DNA. Filters are hybridized for 48 hours at 65° C. in prehybridization mixture containing 100 mg/ml denatured salmon sperm DNA and 5-20×106 cpm of ³²P-labeled probe. Washing of filters is done at 37° C. for one hour in a solution containing 2×SSC, 0.01% PVP, 0.01% Ficoll, and 0.01% BSA. This is followed by a wash in 0.1×SSC at 50° C. for 45 minutes before autoradiography. Other conditions of high stringency that may be used are well known in the art.

### 5.15.7. Moderate Stringency Conditions

In another specific embodiment, the invention relates to nucleic acids hybridizable to or complementary to all or a portion of the nucleic acid sequences referenced in Section 5.15.3 under conditions of moderate stringency. As used herein, conditions of moderate stringency, as known to those having ordinary skill in the art, and as defined by Sambrook et al., Molecular Cloning: A Laboratory Manual, 2^{nd} Ed. Vol. 1, pp. 1.101-104, Cold Spring Harbor Laboratory Press, 1989), include use of a prewashing solution for the nitrocellulose filters 5×SSC, 0.5% SDS, 1.0 mM EDTA (pH 8.0), hybridization conditions of 50 percent formamide, 6×SSC at 42° C. (or other similar hybridization solution, or Stark's solution, in 50% formamide at 42° C.), and washing conditions of about 60° C., 0.5×SSC, 0.1% SDS. See also, Ausubel et al., eds., in the Current Protocols in Molecular Biology series of laboratory technique manuals, © 1987-1997, Current Protocols, © 1994-1997, John Wiley and Sons, Inc., which is hereby incorporated herein by reference in its entirety). The skilled artisan will recognize that the temperature, salt concentration, and chaotrope composition of hybridization and wash solutions can be adjusted as necessary according to factors such as the length and nucleotide base composition of the probe.

### 5.15.8. Derivatives and Antisense Nucleic Acids

Nucleic acids encoding derivatives of gene sequences referenced in Section 5.15.3 (e.g., SEQ ID NO: 5, SEQ ID NO: 6, SEQ ID NO: 7, SEQ ID NO: 8, SEQ ID NO: 9, SEQ ID NO: 1, SEQ ID NO: 12, SEQ ID NO: 14, SEQ ID NO: 16, SEQ ID NO: 18, SEQ ID NO: 20, SEQ ID NO: 21, SEQ ID NO: 23, SEQ ID NO: 25, SEQ ID NO: 27, SEQ ID NO: 29, and SEQ ID NO: 31) and antisense nucleic acids to such sequence are additionally provided. As is readily apparent, as used herein, a nucleic acid encoding a fragment or portion of a given nucleic acid sequence (e.g., a fragment of SEQ ID NO: 5) shall be construed as referring to a nucleic acid encoding only the recited fragment or portion of the specific nucleic acid and not the other contiguous portions of the nucleic acid as a continuous sequence.

### 5.15.9. Gene Product Antibody Production

The antibodies of the invention or fragments thereof can be produced by any method known in the art for the synthesis of antibodies, in particular, by chemical synthesis or preferably, by recombinant expression techniques.

Polyclonal antibodies can be produced by various procedures well known in the art. For example, a gene product of the present invention, as referenced in Section 5.15.3, or an immunogenic or antigenic fragment thereof can be administered to various host animals including, but not limited to, rabbits, mice, rats, etc. to induce the production of sera containing polyclonal antibodies specific for the obesity related gene product. Various adjuvants can be used to increase the immunological response, depending on the host species, and include but are not limited to, Freund's (complete and incomplete), mineral gels such as aluminum hydroxide, surface active substances such as lysolecithin, pluronic polyols, polyanions, peptides, oil emulsions, keyhole limpet hemocyanins, dinitrophenol, and potentially useful human adjuvants such as BCG (bacille Calmette-Guerin) and corynebacterium parvum. Such adjuvants are also well known in the art.

Monoclonal antibodies can be prepared using a wide variety of techniques known in the art including the use of hybridoma, recombinant, and phage display technologies, or a combination thereof. For example, monoclonal antibodies can be produced using hybridoma techniques including those known in the art and taught, for example, in Harlow et al., Antibodies: A Laboratory Manual, (Cold Spring Harbor Laboratory Press, 2^{nd} ed. 1988); Hammerling, et al., in: Monoclonal Antibodies and T-Cell Hybridomas 563-681 (Elsevier, N.Y., 1981) (said references incorporated by reference in their entireties). The term “monoclonal antibody” as used herein is not limited to antibodies produced through hybridoma technology. The term “monoclonal antibody” refers to an antibody that is derived from a single clone, including any eukaryotic, prokaryotic, or phage clone, and not the method by which it is produced.

Methods for producing and screening for specific antibodies using hybridoma technology are routine and well known in the art. Briefly, mice can be immunized with osteopontin or an immunogenic or antigenic fragment thereof and once an immune response is detected, e.g., antibodies specific for osteopontin are detected in the mouse serum, the mouse spleen is harvested and splenocytes isolated. The splenocytes are then fused by well known techniques to any suitable myeloma cells, for example cells from cell line SP20 available from the ATCC. Hybridomas are selected and cloned by limited dilution. The hybridoma clones are then assayed by methods known in the art for cells that secrete antibodies capable of binding the obesity related gene products of the present invention. Ascites fluid, which generally contains high levels of antibodies, can be generated by immunizing mice with positive hybridoma clones.

Accordingly, the present invention provides methods of generating monoclonal antibodies as well as antibodies produced by the method comprising culturing a hybridoma cell secreting an antibody of the invention wherein, preferably, the hybridoma is generated by fusing splenocytes isolated from a mouse immunized with a gene product referenced in Section 5.15.3 or an immunogenic or antigenic fragment thereof with myeloma cells and then screening the hybridomas resulting from the fusion for hybridoma clones that secrete an antibody able to bind to the subject gene product referenced in Section 5.15.3.

Antibody fragments that recognize specific epitopes can be generated by any technique known to those of skill in the art. For example, Fab and F(ab′)2 fragments of the invention can be produced by proteolytic cleavage of immunoglobulin molecules, using enzymes such as papain (to produce Fab fragments) or pepsin (to produce F(ab′)2 fragments). F(ab′)2 fragments contain the variable region, the light chain constant region and the CH1 domain of the heavy chain. Further, the antibodies of the present invention can also be generated using various phage display methods known in the art.

In phage display methods, functional antibody domains are displayed on the surface of phage particles that carry the polynucleotide sequences encoding them. In particular, DNA sequences encoding VH and VL domains are amplified from animal cDNA libraries (e.g., human or murine cDNA libraries of lymphoid tissues). The DNA encoding the VH and VL domains are recombined together with a scFv linker by PCR and cloned into a phagemid vector (e.g., p CANTAB 6 or pComb 3 HSS). The vector is electroporated in E. coli and the E. coli is infected with helper phage. Phage used in these methods are typically filamentous phage including fd and M13 and the VH and VL domains are usually recombinantly fused to either the phage gene III or gene VIII. Phage expressing an antigen binding domain that binds to an antigen of interest can be selected or identified with antigen, e.g., using labeled antigen or antigen bound or captured to a solid surface or bead. Examples of phage display methods that can be used to make the antibodies of the present invention include those disclosed in Brinkman et al., 1995, J. Immunol Methods 182:41-50; Ames et al., 1995, J. Immunol. Methods 184:177-186; Kettleborough et al., 1994, Eur. J. Immunol. 24:952-958; Persic et al., 1997, Gene 187:9-18; Burton et al., 1994, Advances in Immunology 57:191-280; PCT application No. PCT/GB91/O1 134; PCT publications WO 90/02809; WO 91/10737; WO 92/01047; WO 92/18619; WO 93/1 1236; WO 95/15982; WO 95/20401; WO97/13844; and U.S. Pat. Nos. 5,698,426; 5,223,409; 5,403,484; 5,580,717; 5,427,908; 5,750,753; 5,821,047; 5,571,698; 5,427,908; 5,516,637; 5,780,225; 5,658,727; 5,733,743 and 5,969,108; each of which is incorporated herein by reference in its entirety.

As described in the above references, after phage selection, the antibody coding regions from the phage can be isolated and used to generate whole antibodies, including human antibodies, or any other desired antigen binding fragment, and expressed in any desired host, including mammalian cells, insect cells, plant cells, yeast, and bacteria, e.g., as described below. Techniques to recombinantly produce Fab, Fab′ and F(ab′)2 fragments can also be employed using methods known in the art such as those disclosed in PCT publication WO 92/22324; Mullinax et al., 1992, BioTechniques 12(6):864-869; and Sawai et al., 1995, AJRI 34:26-34; and Better et al., 1988, Science 240:1041-1043, each of which is hereby incorporated herein by reference in its entirety.

To generate whole antibodies, PCR primers including VH or VL nucleotide sequences, a restriction site, and a flanking sequence to protect the restriction site can be used to amplify the VH or VL sequences in scFv clones. Utilizing cloning techniques known to those of skill in the art, the PCR amplified VH domains can be cloned into vectors expressing a VH constant region, e.g., the human gamma 4 constant region, and the PCR amplified VL domains can be cloned into vectors expressing a VL constant region, e.g., human kappa or lamba constant regions. Preferably, the vectors for expressing the VH or VL domains comprise an EF-1α promoter, a secretion signal, a cloning site for the variable domain, constant domains, and a selection marker such as neomycin. The VH and VL domains can also cloned into one vector expressing the necessary constant regions. The heavy chain conversion vectors and light chain conversion vectors are then co-transfected into cell lines to generate stable or transient cell lines that express full-length antibodies, e.g., IgG, using techniques known to those of skill in the art.

For some uses, including in vivo use of antibodies in humans and in vitro detection assays, it can be preferable to use human or chimeric antibodies. Completely human antibodies are particularly desirable for therapeutic treatment of human subjects. Human antibodies can be made by a variety of methods known in the art including phage display methods described above using antibody libraries derived from human immunoglobulin sequences. See also U.S. Pat. Nos. 4,444,887 and 4,716,111; and PCT publications WO 98/46645, WO 98/50433, WO 98/24893, WO98/16654, WO 96/34096, WO 96/33735, and WO 91/10741; each of which is incorporated herein by reference in its entirety.

Human antibodies can also be produced using transgenic mice that are incapable of expressing functional endogenous immunoglobulins, but which can express human immunoglobulin genes. For example, the human heavy and light chain immunoglobulin gene complexes can be introduced randomly or by homologous recombination into mouse embryonic stem cells. Alternatively, the human variable region, constant region, and diversity region can be introduced into mouse embryonic stem cells in addition to the human heavy and light chain genes. The mouse heavy and light chain immunoglobulin genes can be rendered non-functional separately or simultaneously with the introduction of human immunoglobulin loci by homologous recombination. In particular, homozygous deletion of the JH region prevents endogenous antibody production. The modified embryonic stem cells are expanded and microinjected into blastocysts to produce chimeric mice. The chimeric mice are then bred to produce homozygous offspring that express human antibodies. The transgenic mice are immunized in the normal fashion with a selected antigen, e.g., all or a portion of a polypeptide of interest. Monoclonal antibodies directed against the antigen can be obtained from the immunized transgenic mice using conventional hybridoma technology. The human immunoglobulin transgenes harbored by the transgenic mice rearrange during B cell differentiation, and subsequently undergo class switching and somatic mutation. Thus, using such a technique, it is possible to produce therapeutically useful IgG, IgA, IgM and IgE antibodies. For an overview of this technology for producing human antibodies, see Lonberg and Huszar (1995, Int. Rev. Immunol. 13:65-93). For a detailed discussion of this technology for producing human antibodies and human monoclonal antibodies and protocols for producing such antibodies, see, e.g., PCT publications WO 98/24893; WO 96/34096; WO 96/33735; U.S. Pat. Nos. 5,413,923; 5,625,126; 5,633,425; 5,569,825; 5,661,016; 5,545,806; 5,814,318; and 5,939,598, which are incorporated by reference herein in their entirety. In addition, companies such as Abgenix, Inc. (Freemont, Calif.) and Genpharm (San Jose, Calif.) can be engaged to provide human antibodies directed against a selected antigen using technology similar to that described above.

A chimeric antibody is a molecule in which different portions of the antibody are derived from different immunoglobulin molecules such as antibodies having a variable region derived from a human antibody and a non-human immunoglobulin constant region. Methods for producing chimeric antibodies are known in the art. See e.g., Morrison, 1985, Science 229:1202; Oi et al., 1986, BioTechniques 4:214; Gillies et al., 1989, J. Immunol. Methods 125:191-202; U.S. Pat. Nos. 5,807,715; 4,816,567; and 4,816,397, which are incorporated herein by reference in their entirety. Chimeric antibodies comprising one or more CDRs from human species and framework regions from a non-human immunoglobulin molecule can be produced using a variety of techniques known in the art including, for example, CDR-grafting (EP 239,400; PCT publication WO 91/09967; U.S. Pat. Nos. 5,225,539; 5,530,101; and 5,585,089), veneering or resurfacing (EP 592,106; EP 519,596; Padlan, 1991, Molecular Immunology 28(4/5):489-498; Studnicka et al., 1994, Protein Engineering 7(6):805-814; Roguska et al., 1994, PNAS 91:969-973), and chain shuffling (U.S. Pat. No. 5,565,332), each of which is hereby incorporated herein by reference in its entirety.

Further, the antibodies of the invention can, in turn, be utilized to generate anti-idiotype antibodies that “mimic” one or more of the obesity related gene products of the present invention using techniques well known to those skilled in the art. (See, e.g., Greenspan & Bona, 1989, FASEB J. 7:437-444; and Nissinoff, 1991, J. Immunol. 147:2429-2438, which is hereby incorporated herein by reference in its entirety).

### 5.15.10. Polynucleotides Encoding an Obesity Related Gene Product Antibody

The invention provides polynucleotides comprising a nucleotide sequence encoding an antibody of the invention or a fragment thereof. The invention also encompasses polynucleotides that hybridize under high stringency, intermediate or lower stringency hybridization conditions, e.g., as defined supra, to polynucleotides that encode an antibody of the invention.

The polynucleotides can be obtained, and the nucleotide sequence of the polynucleotides determined, by any method known in the art. Nucleotide sequences encoding these antibodies can be determined using any nucleic acid sequencing method known in the art. Such a polynucleotide encoding the antibody can be assembled from chemically synthesized oligonucleotides (e.g., as described in Kutmeier et al., 1994, BioTechniques 17:242), which, briefly, involves the synthesis of overlapping oligonucleotides containing portions of the sequence encoding the antibody, annealing and ligating of those oligonucleotides, and then amplification of the ligated oligonucleotides by PCR.

Alternatively, a polynucleotide encoding an antibody can be generated from nucleic acid from a suitable source. If a clone containing a nucleic acid encoding a particular antibody is not available, but the sequence of the antibody molecule is known, a nucleic acid encoding the immunoglobulin can be chemically synthesized or obtained from a suitable source (e.g., an antibody cDNA library, or a cDNA library generated from, or nucleic acid, preferably poly A+ RNA, isolated from, any tissue or cells expressing the antibody, such as hybridoma cells selected to express an antibody of the invention) by PCR amplification using synthetic primers hybridizable to the 3′ and 5′ ends of the sequence or by cloning using an oligonucleotide probe specific for the particular gene sequence to identify, e.g., a cDNA clone from a cDNA library that encodes the antibody. Amplified nucleic acids generated by PCR can then be cloned into replicable cloning vectors using any method well known in the art.

Once the nucleotide sequence of the antibody is determined, the nucleotide sequence of the antibody can be manipulated using methods well known in the art for the manipulation of nucleotide sequences, e.g., recombinant DNA techniques, site directed mutagenesis, PCR, etc. (see, for example, the techniques described in Sambrook et al., 1990, Molecular Cloning, A Laboratory Manual, 2^{nd} Ed., Cold Spring Harbor Laboratory, Cold Spring Harbor, N.Y. and Ausubel et al., eds., 1998, Current Protocols in Molecular Biology, John Wiley & Sons, NY, which are both incorporated by reference herein in their entireties), to generate antibodies having a different amino acid sequence, for example to create amino acid substitutions, deletions, and/or insertions.

### 5.15.11. Recombinant Expression of an Antibody to a Gene Product of Interest

Recombinant expression of an antibody of the invention, derivative or analog thereof, (e.g., a heavy or light chain of an antibody of the invention or a portion thereof or a single chain antibody of the invention), requires construction of an expression vector containing a polynucleotide that encodes the antibody. Once a polynucleotide encoding an antibody molecule or a heavy or light chain of an antibody, or portion thereof (preferably, but not necessarily, containing the heavy or light chain variable domain), of the invention has been obtained, the vector for the production of the antibody molecule can be produced by recombinant DNA technology using techniques well known in the art. Thus, methods for preparing a protein by expressing a polynucleotide containing an antibody encoding nucleotide sequences are described herein. Methods that are well known to those skilled in the art can be used to construct expression vectors containing antibody coding sequences and appropriate transcriptional and translational control signals. These methods include, for example, in vitro recombinant DNA techniques, synthetic techniques, and in vivo genetic recombination. The invention, thus, provides replicable vectors comprising a nucleotide sequence encoding an antibody molecule of the invention, a heavy or light chain of an antibody, a heavy or light chain variable domain of an antibody or a portion thereof, or a heavy or light chain CDR, operably linked to a promoter. Such vectors can include the nucleotide sequence encoding the constant region of the antibody molecule (see, e.g., PCT Publication WO 86/05807; PCT Publication WO 89/01036; and U.S. Pat. No. 5,122,464, each of which is hereby incorporated herein by reference in its entirety) and the variable domain of the antibody can be cloned into such a vector for expression of the entire heavy, the entire light chain, or both the entire heavy and light chains.

The expression vector is transferred to a host cell by conventional techniques and the transfected cells are then cultured by conventional techniques to produce an antibody of the invention. Thus, the invention includes host cells containing a polynucleotide encoding an antibody of the invention or fragments thereof, or a heavy or light chain thereof, or portion thereof, or a single chain antibody of the invention, operably linked to a heterologous promoter. In preferred embodiments for the expression of double-chained antibodies, vectors encoding both the heavy and light chains may be co-expressed in the host cell for expression of the entire immunoglobulin molecule, as detailed below.

A variety of host-expression vector systems can be utilized to express the antibody molecules of the invention. Such host-expression systems represent vehicles by which the coding sequences of interest can be produced and subsequently purified, but also represent cells that may, when transformed or transfected with the appropriate nucleotide coding sequences, express an antibody molecule of the invention in situ. These include but are not limited to microorganisms such as bacteria (e.g., E. coli, B. subtilis) transformed with recombinant bacteriophage DNA, plasmid DNA or cosmid DNA expression vectors containing antibody coding sequences; yeast (e.g., Saccharomyces, Pichia) transformed with recombinant yeast expression vectors containing antibody coding sequences; insect cell systems infected with recombinant virus expression vectors (e.g., baculovirus) containing antibody coding sequences; plant cell systems infected with recombinant virus expression vectors (e.g., cauliflower mosaic virus, CaMV; tobacco mosaic virus, TMV) or transformed with recombinant plasmid expression vectors (e.g., Ti plasmid) containing antibody coding sequences; or mammalian cell systems (e.g., COS, CHO, BHK, 293, 3T3 cells) harboring recombinant expression constructs containing promoters derived from the genome of mammalian cells (e.g., metallothionein promoter) or from mammalian viruses (e.g., the adenovirus late promoter; the vaccinia virus 7.5K promoter). Preferably, bacterial cells such as Escherichia coli, and more preferably, eukaryotic cells, especially for the expression of whole recombinant antibody molecule, are used for the expression of a recombinant antibody molecule. For example, mammalian cells such as Chinese hamster ovary cells (CHO), in conjunction with a vector such as the major intermediate early gene promoter element from human cytomegalovirus is an effective expression system for antibodies (Foecking et al., 1986, Gene 45:101; Cockett et al., 1990, Bio/Technology 8:2, each of which is hereby incorporated herein by reference in its entirety).

In bacterial systems, a number of expression vectors can be advantageously selected depending upon the use intended for the antibody molecule being expressed. For example, when a large quantity of such a protein is to be produced, for the generation of pharmaceutical compositions of an antibody molecule, vectors that direct the expression of high levels of fusion protein products that are readily purified can be desirable. Such vectors include, but are not limited to, the E. coli expression vector pUR278 (Ruther et al., 1983, EMBO J. 12:1791), in which the antibody coding sequence can be ligated individually into the vector in frame with the lac Z coding region so that a fusion protein is produced; pIN vectors (Inouye & Inouye, 1985, Nucleic Acids Res. 13:3101-3109; Van Heeke & Schuster, 1989, J. Biol. Chem. 24:5503-5509, each of which is hereby incorporated herein by reference in its entirety); and the like. pGEX vectors can also be used to express foreign polypeptides as fusion proteins with glutathione 5-transferase (GST). In general, such fusion proteins are soluble and can easily be purified from lysed cells by adsorption and binding to matrix glutathione agarose beads followed by elution in the presence of free glutathione. The pGEX vectors are designed to include thrombin or factor Xa protease cleavage sites so that the cloned target gene product can be released from the GST moiety.

In an insect system, Autographa californica nuclear polyhedrosis virus (AcNPV) is used as a vector to express foreign genes in some instances. The virus grows in Spodoptera frugiperda cells. The antibody coding sequence can be cloned individually into non-essential regions (for example the polyhedrin gene) of the virus and placed under control of an AcNPV promoter (for example the polyhedrin promoter).

In mammalian host cells, a number of viral-based expression systems can be utilized. In cases where an adenovirus is used as an expression vector, the antibody coding sequence of interest can be ligated to an adenovirus transcription/translation control complex, e.g., the late promoter and tripartite leader sequence. This chimeric gene can then be inserted in the adenovirus genome by in vitro or in vivo recombination. Insertion in a non-essential region of the viral genome (e.g., region E1 or E3) will result in a recombinant virus that is viable and capable of expressing the antibody molecule in infected hosts (e.g., see Logan & Shenk, 1984, Proc. Natl. Acad. Sci. U.S.A. 81:355-359, each of which is hereby incorporated herein by reference in its entirety). Specific initiation signals may also be required for efficient translation of inserted antibody coding sequences. These signals include the ATG initiation codon and adjacent sequences. Furthermore, the initiation codon must be in phase with the reading frame of the desired coding sequence to ensure translation of the entire insert. These exogenous translational control signals and initiation codons can be of a variety of origins, both natural and synthetic. The efficiency of expression can be enhanced by the inclusion of appropriate transcription enhancer elements, transcription terminators, etc. (see, e.g., Bittner et al., 1987, Methods in Enzymol. 153:51-544).

In addition, a host cell strain can be chosen that modulates the expression of the inserted sequences, or modifies and processes the gene product in the specific fashion desired. Such modifications (e.g., glycosylation) and processing (e.g., cleavage) of protein products can be important for the function of the protein. Different host cells have characteristic and specific mechanisms for the post-translational processing and modification of proteins and gene products. Appropriate cell lines or host systems can be chosen to ensure the correct modification and processing of the foreign protein expressed. To this end, eukaryotic host cells that possess the cellular machinery for proper processing of the primary transcript, glycosylation, and phosphorylation of the gene product can be used. Such mammalian host cells include but are not limited to CHO, VERY, BHK, Hela, COS, MDCK, 293, 3T3, W138, and in particular, breast cancer cell lines such as, for example, BT483, Hs578T, HTB2, BT2O and T47D, and normal mammary gland cell line such as, for example, CRL7O3O and HsS78Bst.

For long-term, high-yield production of recombinant proteins, stable expression is preferred. For example, cell lines that stably express the antibody molecule can be engineered. Rather than using expression vectors that contain viral origins of replication, host cells can be transformed with DNA controlled by appropriate expression control elements (e.g., promoter, enhancer, sequences, transcription terminators, polyadenylation sites, etc.), and a selectable marker. Following the introduction of the foreign DNA, engineered cells can be allowed to grow for 1-2 days in an enriched media, and then are switched to a selective media. The selectable marker in the recombinant plasmid confers resistance to the selection and allows cells to stably integrate the plasmid into their chromosomes and grow to form foci which in turn can be cloned and expanded into cell lines. This method can advantageously be used to engineer cell lines that express the antibody molecule. Such engineered cell lines can be particularly useful in screening and evaluation of compositions that interact directly or indirectly with the antibody molecule.

A number of selection systems can be used including, but not limited to, the herpes simplex virus thymidine kinase (Wigler et al., 1977, Cell 11:223, which is hereby incorporated herein by reference in its entirety), hypoxanthineguanine phosphoribosyltransferase (Szybalska & Szybalski, 1992, Proc. Natl. Acad. Sci. U.S.A. 48:202), and adenine phosphoribosyltransferase (Lowy et al., 1980, Cell 22:8-17) genes can be employed in tk−, hgprt− or aprt− cells, respectively. Also, antimetabolite resistance can be used as the basis of selection for the following genes: dhfr, which confers resistance to methotrexate (Wigler et al., 1980, Natl. Acad. Sci. U.S.A. 77:357; O'Hare et al., 1981, Proc. Natl. Acad. Sci. U.S.A. 78:1527, each of which is hereby incorporated herein by reference in its entirety); gpt, which confers resistance to mycophenolic acid (Mulligan & Berg, 1981, Proc. Natl. Acad. Sci. U.S.A. 78:2072, which is hereby incorporated herein by reference in its entirety); neo, which confers resistance to the aminoglycoside G-418 (Wu and Wu, 1991, Biotherapy 3:87-95; Tolstoshev, 1993, Ann. Rev. Pharmacol. Toxicol. 32:573-596; Mulligan, 1993, Science 260:926-932; and Morgan and Anderson, 1993, Ann. Rev. Biochem. 62: 191-217; May, 1993, TIB TECH 11:155, each of which is hereby incorporated herein by reference in its entirety); and hygro, which confers resistance to hygromycin (Santerre et al., 1984, Gene 30:147, which is hereby incorporated herein by reference in its entirety). Methods commonly known in the art of recombinant DNA technology may be routinely applied to select the desired recombinant clone, and such methods are described, for example, in Ausubel et al. (eds.), Current Protocols in Molecular Biology, John Wiley & Sons, NY (1993); Kriegler, Gene Transfer and Expression, A Laboratory Manual, Stockton Press, NY (1990); and in Chapters 12 and 13, Dracopoli et al. (eds), Current Protocols in Human Genetics, John Wiley & Sons, NY (1994); Colberre-Garapin et al., 1981, J. Mol. Biol. 150:1, which are incorporated by reference herein in their entireties.

The expression levels of an antibody molecule can be increased by vector amplification (for a review, see Bebbington and Hentschel, The use of vectors based on gene amplification for the expression of cloned genes in mammalian cells in DNA cloning, Vol. 3. (Academic Press, New York, 1987)). When a marker in the vector system expressing antibody is amplifiable, increase in the level of inhibitor present in culture of host cell will increase the number of copies of the marker gene. Since the amplified region is associated with the antibody gene, production of the antibody will also increase. See, for example, Crouse et al., 1983, Mol. Cell. Biol. 3:257, each of which is hereby incorporated herein by reference in its entirety.

The host cell can be co-transfected with two expression vectors of the invention, the first vector encoding a heavy chain derived polypeptide and the second vector encoding a light chain derived polypeptide. The two vectors can contain identical selectable markers that enable equal expression of heavy and light chain polypeptides. Alternatively, a single vector may be used that encodes, and is capable of expressing, both heavy and light chain polypeptides. In such situations, the light chain should be placed before the heavy chain to avoid an excess of toxic free heavy chain (Proudfoot, 1986, Nature 322:52; and Kohler, 1980, Proc. Natl. Acad. Sci. U.S.A. 77:2 197, each of which is hereby incorporated herein by reference in its entirety). The coding sequences for the heavy and light chains may comprise cDNA or genomic DNA.

Once an antibody molecule of the invention has been produced by recombinant expression, it may be purified by any method known in the art for purification of an immunoglobulin molecule, for example, by chromatography (e.g., ion exchange, affinity, particularly by affinity for the specific antigen after Protein A, and sizing column chromatography), centrifugation, differential solubility, or by any other standard technique for the purification of proteins. Further, the antibodies of the present invention or fragments thereof may be fused to heterologous polypeptide sequences described herein or otherwise known in the art to facilitate purification.

### 5.15.12. Anti-Sense Nucleic Acids

The function of the genes referenced in Section 5.15.3 can be inhibited by use of antisense nucleic acids. The present invention provides the therapeutic or prophylactic use of nucleic acids of at least six nucleotides in length that are antisense to a gene or cDNA encoding an obesity related gene product referenced in Section 5.15.3, or portions thereof. An “antisense” nucleic acid as used herein refers to a nucleic acid capable of hybridizing to a portion of a nucleic acid referenced in Section 5.15.3 (preferably mRNA, e.g., the sequence of SEQ ID NO: 5, SEQ ID NO: 6, SEQ ID NO: 7, SEQ ID NO: 8, SEQ ID NO: 9, SEQ ID NO: 11, SEQ ID NO: 12, SEQ ID NO: 14, SEQ ID NO: 16, SEQ ID NO: 18, SEQ ID NO: 20, SEQ ID NO: 21, SEQ ID NO: 23, SEQ ID NO: 25, SEQ ID NO: 27, SEQ ID NO: 29, or SEQ ID NO: 31) by virtue of some sequence complementarity. The antisense nucleic acid can be complementary to a coding and/or noncoding region of an obesity related mRNA.

The antisense nucleic acids can be oligonucleotides that are double-stranded or single-stranded RNA or DNA or a modification or derivative thereof, which can be directly administered to a cell, or which can be produced intracellularly by transcription of exogenous, introduced sequences.

The antisense nucleic acids are of at least six nucleotides and are preferably oligonucleotides (ranging from 6 to about 200 oligonucleotides). In specific aspects, the oligonucleotide is at least 10 nucleotides, at least 15 nucleotides, at least 100 nucleotides, or at least 200 nucleotides. The oligonucleotides can be DNA or RNA or chimeric mixtures or derivatives or modified versions thereof, single-stranded or double-stranded. The oligonucleotide can be modified at the base moiety, sugar moiety, or phosphate backbone. The oligonucleotide can include other appending groups such as peptides, or agents facilitating transport across the cell membrane (see, e.g., Letsinger et al., 1989, Proc. Natl. Acad. Sci. U.S.A. 86: 6553-6556; Lemaitre et al., 1987, Proc. Natl. Acad. Sci. U.S.A. 84: 648-652; PCT Publication No. WO 88/09810, published Dec. 15, 1988, each of which is hereby incorporated herein by reference in its entirety) or blood-brain barrier (see, e.g., PCT Publication No. WO 89/10134, published Apr. 25, 1988), hybridization-triggered cleavage agents (see, e.g., Krol et al., 1988, BioTechniques 6: 958-976) or intercalating agents (see, e.g., Zon, 1988, Pharm. Res. 5: 539-549, each of which is hereby incorporated herein by reference in its entirety).

In a preferred aspect of the invention, the antisense oligonucleotide is provided, preferably as single-stranded DNA. The oligonucleotide can be modified at any position on its structure with constituents generally known in the art. The antisense oligonucleotides can comprise at least one modified base moiety that is selected from the group including, but not limited to, 5-fluorouracil, 5-bromouracil, 5-chlorouracil, 5-iodouracil, hypoxanthine, xanthine, 4-acetylcytosine, 5-(carboxyhydroxylmethyl) uracil, 5-carboxymethylaminomethyl-2-thiouridine, 5-carboxymethylaminomethyluracil, dihydrouracil, beta-D-galactosylqueosine, inosine, N6-isopentenyladenine, 1-methylguanine, 1-methylinosine, 2,2-dimethylguanine, 2-methyladenine, 2-methylguanine, 3-methylcytosine, 5-methylcytosine, N6-adenine, 7-methylguanine, 5-methylaminomethyluracil, 5-methoxyaminomethyl-2-thiouracil, beta-D-mannosylqueosine, 5′-methoxycarboxymethyluracil, 5-methoxyuracil, 2-methylthio-N-6-isopentenyladenine, uracil-5-oxyacetic acid (v), wybutoxosine, pseudouracil, queosine, 2-thiocytosine, 5-methyl-2-thiouracil, 2-thiouracil, 4-thiouracil, 5-methyluracil, uracil-5-oxyacetic acid methylester, uracil-5-oxyacetic acid (v), 5-methyl-2-thiouracil, 3-(3-amino-3-N-2-carboxypropyl) uracil, and 2,6-diaminopurine.

In another embodiment, the oligonucleotide comprises at least one modified sugar moiety selected from the group including, but not limited to, arabinose, 2-fluoroarabinose, xylulose, and hexose.

In yet another embodiment, the oligonucleotide comprises at least one modified phosphate backbone selected from the group consisting of a phosphorothioate, a phosphorodithioate, a phosphoramidothioate, a phosphoramidate, a phosphordiamidate, a methylphosphonate, an alkyl phosphotriester, a formacetal, or analogs thereof.

In yet another embodiment, the oligonucleotide is an α-anomeric oligonucleotide. An α-anomeric oligonucleotide forms specific double-stranded hybrids with complementary RNA in which, contrary to the usual β-units, the strands run parallel to each other (Gautier et al., 1987, Nucl. Acids Res. 15: 6625-6641, which is hereby incorporated herein by reference in its entirety).

The oligonucleotide can be conjugated to another molecule, e.g., a peptide, hybridization triggered cross-linking agent, transport agent, hybridization-triggered cleavage agent, etc.

Oligonucleotides may be synthesized by standard methods known in the art, e.g. by use of an automated DNA synthesizer (such as are commercially available from Biosearch, Applied Biosystems, etc.). As examples, phosphorothioate oligonucleotides can be synthesized by the method of Stein et al. (1988, Nucl. Acids Res. 16: 3209, which is hereby incorporated herein by reference in its entirety), methylphosphonate oligonucleotides can be prepared by use of controlled pore glass polymer supports (Sarin et al., 1988, Proc. Natl. Acad. Sci. U.S.A. 85: 7448-7451, which is hereby incorporated herein by reference in its entirety), etc.

In a specific embodiment, the antisense oligonucleotides comprise catalytic RNAs, or ribozymes (see, e.g., PCT International Publication WO 90/11364, published Oct. 4, 1990; Sarver et al., 1990, Science 247: 1222-1225, each of which is hereby incorporated herein by reference in its entirety). In another embodiment, the oligonucleotide is a 2′-0-methylribonucleotide (Inoue et al., 1987, Nucl. Acids Res. 15: 6131-6148), or a chimeric RNA-DNA analog (Inoue et al., 1987, FEBS Lett. 215: 327-330), each of which is hereby incorporated herein by reference in its entirety.

In an alternative embodiment, antisense nucleic acids are produced intracellularly by transcription from an exogenous sequence. For example, a vector can be introduced in vivo such that it is taken up by a cell, within which cell the vector or a portion thereof is transcribed, producing an antisense nucleic acid (RNA) of the invention. Such a vector would contain a sequence encoding an antisense nucleic acid. Such a vector can remain episomal or become chromosomally integrated, as long as it can be transcribed to produce the desired antisense RNA. Such vectors can be constructed by recombinant DNA technology methods standard in the art. Vectors can be plasmid, viral, or others known in the art, used for replication and expression in mammalian cells. Expression of the sequences encoding the antisense RNAs can be by any promoter known in the art to act in mammalian, preferably human, cells. Such promoters can be inducible or constitutive. Such promoters include, but are not limited to, the SV40 early promoter region (Bemoist and Chambon, 1981, Nature 290: 304-310, which is hereby incorporated herein by reference in its entirety), the promoter contained in the 3′ long terminal repeat of Rous sarcoma virus (Yamamoto et al., 1980, Cell 22: 787-797), the herpes thymidine kinase promoter (Wagner et al., 1981, Proc. Natl. Acad. Sci. U.S. 78: 1441-1445), the regulatory sequences of the metallothionein gene (Brinster et al., 1982, Nature 296: 39-42), etc., each of which is hereby incorporated herein by reference in its entirety The antisense nucleic acids of the invention comprise a sequence complementary to at least a portion of an RNA transcript of a gene referenced in Section 5.15.3. However, absolute complementarity, although preferred, is not required. A sequence “complementary to at least a portion of an RNA,” as referred to herein, means a sequence having sufficient complementarity to be able to hybridize with the RNA, forming a stable duplex; in the case of double-stranded antisense nucleic acids, a single strand of the duplex DNA can thus be tested, or triplex formation can be assayed. The ability to hybridize will depend on both the degree of complementarity and the length of the antisense nucleic acid.

Generally, the longer the hybridizing nucleic acid, the more base mismatches with an obesity related RNA (target RNA) it may contain and still form a stable duplex (or triplex, as the case may be). One skilled in the art can ascertain a tolerable degree of mismatch by use of standard procedures to determine the melting point of the hybridized complex.

Pharmaceutical compositions of the invention, comprising an effective amount of an antisense nucleic acid in a pharmaceutically acceptable carrier can be administered in therapeutic methods of the invention. The amount of antisense nucleic acid that will be effective in the treatment of a particular disorder or condition will depend on the nature of the disorder or condition, and can be determined by standard clinical techniques. Where possible, it is desirable to determine the antisense cytotoxicity in vitro, and then in useful animal model systems prior to testing and use in humans.

In a specific embodiment, pharmaceutical compositions comprising antisense nucleic acids are administered via liposomes, microparticles, or microcapsules. In various embodiments of the invention, it may be useful to use such compositions to achieve sustained release of antisense nucleic acids. In a specific embodiment, it can be desirable to utilize liposomes targeted via antibodies to specific identifiable central nervous system cell types (Leonetti et al., 1990, Proc. Natl. Acad. Sci. U.S.A. 87: 2448-2451; Renneisen et al., 1990, J. Biol. Chem. 265: 16337-16342, each of which is hereby incorporated herein by reference in its entirety).

### 5.15.13. Gene Product Analogs, Derivatives and Fragments

The invention further provides methods of modulating the genes referenced in Section 5.15.3 using agonists and promoters of such genes. Agonists include, but are not limited to, active fragments thereof (wherein a fragment is at least 10, 15, 20, 30, 50, 75, 100, or 150 amino acid portion of an obesity related gene product disclosed in Section 6.7.5) and analogs and derivatives thereof, and nucleic acids encoding any of the foregoing.

For recombinant expression of gene products, and fragments, derivatives and analogs thereof, the nucleic acid containing all or a portion of the nucleotide sequence encoding the protein can be inserted into an appropriate expression vector, e.g., a vector that contains the necessary elements for the transcription and translation of the inserted protein coding sequence. In a preferred embodiment, the regulatory elements (e.g., promoter) are heterologous (i.e., not the native gene promoter). Promoters which may be used include but are not limited to the SV40 early promoter (Bernoist and Chambon, 1981, Nature 290: 304-310), the promoter contained in the 3′ long terminal repeat of Rous sarcoma virus (Yamamoto et al., 1980, Cell 22: 787-797, which is hereby incorporated herein by reference in its entirety), the herpes thymidine kinase promoter (Wagner et al., 1981, Proc. Natl. Acad. Sci. U.S.A. 78: 1441-1445, which is hereby incorporated herein by reference in its entirety), the regulatory sequences of the metallothionein gene (Brinster et al., 1982, Nature 296: 39-42, which is hereby incorporated herein by reference in its entirety); prokaryotic expression vectors such as the β-lactamase promoter (Villa-Kamaroff et al., 1978, Proc. Natl. Acad. Sci. U.S.A. 75: 3727-3731) or the tac promoter (DeBoer et al., 1983, Proc. Natl. Acad. Sci. U.S.A. 80: 21-25; see also “Useful Proteins from Recombinant Bacteria”: in Scientific American 1980, 242:79-94); plant expression vectors comprising the nopaline synthetase promoter (Herrar-Estrella et al., 1984, Nature 303: 209-213) or the cauliflower mosaic virus ³⁵S RNA promoter (Garder et al., 1981, Nucleic Acids Res. 9:2871), and the promoter of the photosynthetic enzyme ribulose bisphosphate carboxylase (Herrera-Estrella et al., 1984, Nature 310: 115-120); promoter elements from yeast and other fungi such as the Gal4 promoter, the alcohol dehydrogenase promoter, the phosphoglycerol kinase promoter, the alkaline phosphatase promoter, and the following animal transcriptional control regions that exhibit tissue specificity and have been utilized in transgenic animals: elastase I gene control region which is active in pancreatic acinar cells (Swift et al., 1984, Cell 38: 639-646; Omitz et al., 1986, Cold Spring Harbor Symp. Quant. Biol. 50: 399-409; MacDonald 1987, Hepatology 7: 425-515); insulin gene control region which is active in pancreatic beta cells (Hanahan et al., 1985, Nature 315: 115-122), immunoglobulin gene control region which is active in lymphoid cells (Grosschedl et al., 1984, Cell 38: 647-658; Adams et al., 1985, Nature 318: 533-538; Alexander et al., 1987, Mol. Cell Biol. 7: 1436-1444), mouse mammary tumor virus control region which is active in testicular, breast, lymphoid and mast cells (Leder et al., 1986, Cell 45: 485-495), albumin gene control region which is active in liver (Pinckert et al., 1987, Genes and Devel. 1: 268-276), alpha-fetoprotein gene control region which is active in liver (Krumlauf et al., 1985, Mol. Cell. Biol. 5: 1639-1648; Hammer et al., 1987, Science 235: 53-58), alpha-1 antitrypsin gene control region which is active in liver (Kelsey et al., 1987, Genes and Devel. 1: 161-171), beta globin gene control region which is active in myeloid cells (Mogram et al., 1985, Nature 315: 338-340; Kollias et al., 1986, Cell 46: 89-94), myelin basic protein gene control region which is active in oligodendrocyte cells of the brain (Readhead et al., 1987, Cell 48: 703-712), myosin light chain-2 gene control region which is active in skeletal muscle (Sani 1985, Nature 314: 283-286), and gonadotrophic releasing hormone gene control region which is active in gonadotrophs of the hypothalamus (Mason et al., 1986, Science 234: 1372-1378), each of which is hereby incorporated herein by reference in its entirety.

A variety of host-vector systems can be utilized to express the protein coding sequence. These include, but are not limited to, mammalian cell systems infected with virus (e.g., vaccinia virus, adenovirus, etc.); insect cell systems infected with virus (e.g. baculovirus); microorganisms such as yeast containing yeast vectors; or bacteria transformed with bacteriophage, DNA, plasmid DNA, or cosmid DNA. The expression elements of vectors vary in their strengths and specificities. Depending on the host-vector system utilized, any one of a number of suitable transcription and translation elements can be used.

Once a gene product disclosed in Section 5.15.3, or fragment, derivative or analog thereof has been recombinantly expressed, it can be isolated and purified by standard methods including chromatography (e.g., ion exchange, affinity, and sizing column chromatography), centrifugation, differential solubility, or by any other standard technique for the purification of proteins. An obesity related gene product can also be purified by any standard purification method from natural sources.

Alternatively, an obesity related gene product, analog or derivative thereof of the present invention can be synthesized by standard chemical methods known in the art (e.g., see Hunkapiller et al., 1984, Nature 310:105-111, which is hereby incorporated herein by reference in its entirety).

Standard techniques known to those of skill in the art can be used to introduce mutations in the nucleotide sequence encoding a molecule of the invention, including, for example, site-directed mutagenesis and PCR-mediated mutagenesis that results in amino acid substitutions. Preferably, the derivatives include less than 25 amino acid substitutions, less than 20 amino acid substitutions, less than 15 amino acid substitutions, less than 10 amino acid substitutions, less than 5 amino acid substitutions, less than 4 amino acid substitutions, less than 3 amino acid substitutions, or less than 2 amino acid substitutions relative to the original molecule. In a preferred embodiment, the derivatives have conservative amino acid substitutions are made at one or more predicted non-essential amino acid residues. A “conservative amino acid substitution” is one in which the amino acid residue is replaced with an amino acid residue having a side chain with a similar charge. Families of amino acid residues having side chains with similar charges have been defined in the art. These families include amino acids with basic side chains (e.g., lysine, arginine, histidine), acidic side chains (e.g., aspartic acid, glutamic acid), uncharged polar side chains (e.g., glycine, asparagine, glutamine, serine, threonine, tyrosine, cysteine), nonpolar side chains (e.g., alanine, valine, leucine, isoleucine, proline, phenylalanine, methionine, tryptophan), beta-branched side chains (e.g., threonine, valine, isoleucine) and aromatic side chains (e.g., tyrosine, phenylalanine, tryptophan, histidine). Alternatively, mutations can be introduced randomly along all or part of the coding sequence, such as by saturation mutagenesis, and the resultant mutants can be screened for biological activity to identify mutants that retain activity. Following mutagenesis, the encoded protein can be expressed and the activity of the protein can be determined.

In a specific embodiment, the gene analog, derivative or fragment thereof is encoded by a nucleotide sequence that hybridizes to the nucleotide sequence of SEQ ID NO: 5, SEQ ID NO: 6, SEQ ID NO: 7, SEQ ID NO: 8, SEQ ID NO: 9, SEQ ID NO: 11, SEQ ID NO: 12, SEQ ID NO: 14, SEQ ID NO: 16, SEQ ID NO: 18, SEQ ID NO: 20, SEQ ID NO: 21, SEQ ID NO: 23, SEQ ID NO: 25, SEQ ID NO: 27, SEQ ID NO: 29, or SEQ ID NO: 31 under stringent conditions, e.g., hybridization to filter-bound DNA in 6× sodium chloride/sodium citrate (SSC) at about 45° C. followed by one or more washes in 0.2×SSC/0.1% SDS at about 50-65° C., under highly stringent conditions, e.g., hybridization to filter-bound nucleic acid in 6×SSC at about 45° C. followed by one or more washes in 0.1×SSC/0.2% SDS at about 68° C., or under other stringent hybridization conditions that are known to those of skill in the art (see, for example, Ausubel, F. M. et al., eds., 1989, Current Protocols in Molecular Biology, Vol. I, Green Publishing Associates, Inc. and John Wiley & Sons, Inc., New York at pages 6.3.1-6.3.6 and 2.10.3, which is hereby incorporated herein by reference in its entirety).

In another embodiment, the analog, derivative or fragment comprises an amino acid sequence that is at least 35%, at least 40%, at least 45%, at least 50%, at least 55%, at least 60%, at least 65%, at least 70%, at least 75%, at least 80%, at least 85%, at least 90%, at least 95%, or at least 99% identical to the amino acid sequence of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, SEQ ID NO: 26, SEQ ID NO: 28, SEQ ID NO: 30, and SEQ ID NO: 32. Additionally, the nucleic acid sequence can be mutated in vitro or in vivo, to create and/or destroy translation, initiation, and/or termination sequences, or to create variations in coding regions and/or form new restriction endonuclease sites or destroy preexisting ones, to facilitate further in vitro modification. Any technique for mutagenesis known in the art can be used, including, but not limited to, chemical mutagenesis, in vitro site-directed mutagenesis (Hutchinson, C., et al., 1978, J. Biol. Chem. 253:6551, which is hereby incorporated herein by reference in its entirety), use of TAB® linkers (Pharmacia), etc.

Manipulations of the sequence can also be made at the protein level. Included within the scope of the invention are protein fragments or other derivatives or analogs that are differentially modified during or after translation, e.g., by glycosylation, acetylation, phosphorylation, amidation, derivatization by known protecting/blocking groups, proteolytic cleavage, linkage to an antibody molecule or other cellular ligand, etc. Any of numerous chemical modifications can be carried out by known techniques including, but not limited to, specific chemical cleavage by cyanogen bromide, trypsin, chymotrypsin, papain, V8 protease, NaBH₄, acetylation, formylation, oxidation, reduction; metabolic synthesis in the presence of tunicamycin, etc.

In addition, analogs and derivatives of the gene products referenced in Section 5.15.3 can be chemically synthesized. Furthermore, if desired, nonclassical amino acids or chemical amino acid analogs can be introduced as a substitution or addition into such sequences. Non-classical amino acids include but are not limited to the D-isomers of the common amino acids, α-amino isobutyric acid, 4-aminobutyric acid, Abu, 2-amino butyric acid, γ-Abu, ε-Ahx, 6-amino hexanoic acid, Aib, 2-amino isobutyric acid, 3-amino propionic acid, ornithine, norleucine, norvaline, hydroxyproline, sarcosine, citrulline, cysteic acid, t-butylglycine, t-butylalanine, phenylglycine, cyclohexylalanine, β-alanine, fluoro-amino acids, designer amino acids such as β-methyl amino acids, Cα-methyl amino acids, Nα-methyl amino acids, and amino acid analogs in general. Furthermore, the amino acids used to make the analogs and derivatives can be D (dextrorotary), L (levorotary), or some combination of D and L.

In a specific embodiment, the derivative is a chimeric (or fusion) protein comprising a gene product referenced in Section 5.15.3 or fragment thereof (preferably consisting of at least one protein domain or protein structural motif, or at least 15, preferably 20, amino acids of the obesity related protein) joined at its amino- or carboxy-terminus via a peptide bond to an amino acid sequence of a different protein. In one embodiment, such a chimeric protein is produced by recombinant expression of a nucleic acid encoding the protein (comprising an obesity related protein-coding sequence joined in-frame to a coding sequence for a different protein). Such a chimeric product can be made by ligating the appropriate nucleic acid sequences encoding the desired amino acid sequences to each other by methods known in the art, in the proper coding frame, and expressing the chimeric product by methods commonly known in the art. Alternatively, such a chimeric product may be made by protein synthetic techniques, e.g., by use of a peptide synthesizer. Chimeric genes comprising portions of a gene product referenced in Section 5.15.3 (e.g., SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, SEQ ID NO: 26, SEQ ID NO: 28, SEQ ID NO: 30, and SEQ ID NO: 32) fused to any heterologous protein-encoding sequences can be constructed.

### 5.15.14. Pharmaceutical Compositions and Methods of Administration

The invention provides methods of treatment, prophylaxis, and amelioration of one or more symptoms associated with obesity by administrating to a subject an effective amount of a modulater of a gene referenced in Section 5.15.3. (e.g., SEQ ID NO: 5, SEQ ID NO: 6, SEQ ID NO: 7, SEQ ID NO: 8, SEQ ID NO: 9, SEQ ID NO: 11, SEQ ID NO: 12, SEQ ID NO: 14, SEQ ID NO: 16, SEQ ID NO: 18, SEQ ID NO: 20, SEQ ID NO: 21, SEQ ID NO: 23, SEQ ID NO: 25, SEQ ID NO: 27, SEQ ID NO: 29, or SEQ ID NO: 31), or a pharmaceutical composition comprising an obesity related gene modulator. In a preferred aspect, the obesity related gene modulator is substantially purified (e.g., substantially free from substances that limit its effect or produce undesired side-effects). The subject is preferably a mammal such as non-primate (e.g., cows, pigs, horses, cats, dogs, rats etc.) and a primate (e.g., monkeys or humans). In a preferred embodiment, the subject is a human.

### 5.15.14.1. Delivery Systems

Various delivery systems are known and can be used to administer modulators of the invention or fragment thereof, e.g., encapsulation in liposomes, microparticles, microcapsules, recombinant cells capable of expressing a protein or antibody modulator, receptor-mediated endocytosis (see, e.g., Wu and Wu, 1987, J. Biol. Chem. 262:4429-4432, which is hereby incorporated herein by reference in its entirety), construction of a nucleic acid as part of a retroviral or other vector, etc. Methods of administering a modulator, or pharmaceutical composition include, but are not limited to, parenteral administration (e.g., intradermal, intramuscular, intraperitoneal, intravenous and subcutaneous), epidural, and mucosal (e.g., intranasal and oral routes). In a specific embodiment, modulators of the present invention or fragments thereof, or pharmaceutical compositions are administered intramuscularly, intravenously, or subcutaneously. The compositions can be administered by any convenient route, for example by infusion or bolus injection, by absorption through epithelial or mucocutaneous linings (e.g., oral mucosa, rectal and intestinal mucosa, etc.) and can be administered together with other biologically active agents. Administration can be systemic or local. In addition, pulmonary administration can also be employed, e.g., by use of an inhaler or nebulizer, and formulation with an aerosolizing agent. See, e.g., U.S. Pat. Nos. 6,019,968, 5,985,309, 5,934,272, 5,874,064, 5,290,540, and 4,880,078, and PCT Publication No. WO 92/19244, each of which is hereby incorporated herein by reference in its entirety. In a preferred embodiment, the pharmaceutical composition is delivered locally to the site of neural tissue damage, e.g., using osmotic or other types of pumps.

### 5.15.14.2. Pharmaceutical Compositions

The invention also provides that the pharmaceutical composition is packaged in a hermetically sealed container such as an ampule or sachette indicating the quantity of modulator. In one embodiment, the modulator is supplied as a dry sterilized lyophilized powder or water free concentrate in a hermetically sealed container and can be reconstituted, e.g., with water or saline to the appropriate concentration for administration to a subject. Preferably, the modulator is supplied as a dry sterile lyophilized powder in a hermetically sealed container at a unit dosage of at least 5 mg, more preferably at least 10 mg, at least 15 mg, at least 25 mg, at least 35 mg, at least 45 mg, at least 50 mg, or at least 75 mg. Preferably, the liquid form is supplied in a hermetically sealed container at least 1 mg/ml, more preferably at least 2.5 mg/ml, at least 5 mg/ml, at least 8 mg/ml, at least 10 mg/ml, or at least 25 mg/ml.

In a specific embodiment, it can be desirable to administer the pharmaceutical compositions of the invention locally to the area in need of treatment; this can be achieved by, for example, and not by way of limitation, local infusion, by injection, or by means of an implant, said implant being of a porous, non-porous, or gelatinous material, including membranes, such as sialastic membranes, or fibers. A particularly useful application involves coating, imbedding or derivatizing fibers, such as collagen fibers, protein polymers, etc. with a modulator of the invention. Other useful approaches are described in Otto et at., 1989, J. Neuroscience Research 22, 83-91 and Otto and Unsicker, 1990, J. Neuroscience 10, 1912-1921, both of which are incorporated herein in their entireties. Preferably, when administering the modulator, care must be taken to use materials to which the modulator does not absorb.

In another embodiment, the composition can be delivered in a vesicle, in particular a liposome (see Langer, 1990, Science 249:1527-1533 1990); Treat et al., 1989, in Liposomes in the Therapy of Infectious Disease and Cancer, Lopez-Berestein and Fidler (eds.), Liss, New York, pp. 353-365; and Lopez-Berestein, ibid., pp. 3 17-327; see generally ibid, each of which is hereby incorporated herein by reference in its entirety.).

In yet another embodiment, the composition can be delivered in a controlled release system. In one embodiment, a pump may be used (see Langer, supra; Sefton, 1987, CRC Crit. Ref Biomed. Eng. 14:20; Buchwald et al., 1980, Surgery 88:507; Saudek et al., 1989, N. Engl. J. Med. 321:574). In another embodiment, polymeric materials can be used (see e.g., Medical Applications of Controlled Release, Langer and Wise (eds.), CRC Pres., Boca Raton, Fla. (1974); Controlled Drug Bioavailability, Drug Product Design and Performance, Smolen and Ball (eds.), Wiley, New York (1984); Ranger and Peppas, 1983, J. Macromol. Sci. Rev. Macromol. Chem. 23:61; see also Levy et al., 1985, Science 228:190; During et al., 1989, Ann. Neurol. 25:351; Howard et al., 1989, J. Neurosurg. 7 1:105); U.S. Pat. No. 5,679,377; U.S. Pat. No. 5,916,597; U.S. Pat. No. 5,912,015; U.S. Pat. No. 5,989,463; U.S. Pat. No. 5,128,326; PCT Publication No. WO 99/15154; and PCT Publication No. WO 99/20253, each of which is hereby incorporated herein by reference in its entirety. In yet another embodiment, a controlled release system can be placed in proximity of the therapeutic target, i.e., nervous tissue (see, e.g., Goodson, 1984, in Medical Applications of Controlled Release, supra, vol. 2, pp. 115-138, which is hereby incorporated herein by reference in its entirety). Other controlled release systems are discussed in the review by Langer, 1990, Science 249:1527-1533, which is hereby incorporated herein by reference in its entirety.

In a specific embodiment, where the composition of the invention is a nucleic acid encoding modulator, the nucleic acid can be administered in vivo to promote expression of its encoded modulator by constructing it as part of an appropriate nucleic acid expression vector and administering it so that it becomes intracellular, e.g., by use of a retroviral vector (see U.S. Pat. No. 4,980,286), or by direct injection, or by use of microparticle bombardment (e.g., a gene gun; Biolistic, Dupont), or coating with lipids or cell-surface receptors or transfecting agents, or by administering it in linkage to a homeobox-like peptide which is known to enter the nucleus (see e.g., Joliot et al., 1991, Proc. Natl. Acad. Sci. USA. 88:1864-1868), etc., each of which is hereby incorporated herein by reference in its entirety Alternatively, a nucleic acid can be introduced intracellularly and incorporated within host cell DNA for expression by homologous recombination.

The pharmaceutical compositions of the invention comprise a prophylactically or therapeutically effective amount of an obesity related gene modulator, and a pharmaceutically acceptable carrier. In a specific embodiment, the term “pharmaceutically acceptable” means approved by a regulatory agency of the Federal or a state government or listed in the U.S. Pharmacopeia or other generally recognized pharmacopeia for use in animals, and more particularly in humans. The term “carrier” refers to a diluent, adjuvant (e.g., Freund's adjuvant (complete and incomplete)), excipient, or vehicle with which the therapeutic is administered. Such pharmaceutical carriers can be sterile liquids, such as water and oils, including those of petroleum, animal, vegetable or synthetic origin, such as peanut oil, soybean oil, mineral oil, sesame oil and the like. Water is a preferred carrier when the pharmaceutical composition is administered intravenously. Saline solutions and aqueous dextrose and glycerol solutions can also be employed as liquid carriers, particularly for injectable solutions. Suitable pharmaceutical excipients include starch, glucose, lactose, sucrose, gelatin, malt, rice, flour, chalk, silica gel, sodium stearate, glycerol monostearate, talc, sodium chloride, dried skim milk, glycerol, propylene, glycol, water, ethanol and the like. The composition, if desired, can also contain minor amounts of wetting or emulsifying agents, or pH buffering agents. These compositions can take the form of solutions, suspensions, emulsion, tablets, pills, capsules, powders, sustained-release formulations and the like. Oral formulation can include standard carriers such as pharmaceutical grades of mannitol, lactose, starch, magnesium stearate, sodium saccharine, cellulose, magnesium carbonate, etc. Examples of suitable pharmaceutical carriers are described in “Remington's Pharmaceutical Sciences” by E. W. Martin. Such compositions will contain a prophylactically or therapeutically effective amount of the antibody or fragment thereof, preferably in purified form, together with a suitable amount of carrier so as to provide the form for proper administration to the patient. The formulation should suit the mode of administration.

In a preferred embodiment, the composition is formulated in accordance with routine procedures as a pharmaceutical composition adapted for intravenous administration to human beings. Typically, compositions for intravenous administration are solutions in sterile isotonic aqueous buffer. Where necessary, the composition can also include a solubilizing agent and a local anesthetic such as lignocamne to ease pain at the site of the injection.

Generally, the ingredients of compositions of the invention are supplied either separately or mixed together in unit dosage form, for example, as a dry lyophilized powder or water free concentrate in a hermetically sealed container such as an ampoule or sachette indicating the quantity of active agent. Where the composition is to be administered by infusion, it can be dispensed with an infusion bottle containing sterile pharmaceutical grade water or saline. Where the composition is administered by injection, an ampoule of sterile water for injection or saline can be provided so that the ingredients can be mixed prior to administration.

The compositions of the invention can be formulated as neutral or salt forms. Pharmaceutically acceptable salts include those formed with anions such as those derived from hydrochloric, phosphoric, acetic, oxalic, tartaric acids, etc., and those formed with cations such as those derived from sodium, potassium, ammonium, calcium, ferric hydroxides, isopropylamine, triethylamine, 2-ethylamino ethanol, histidine, procaine, etc.

The amount of the composition delivered is that amount that will be effective in the methods of treatment of the invention.

### 5.15.14.3. Gene Therapy

In some embodiments, the compositions are delivered by gene therapy. Gene therapy refers to therapy performed by the administration to a subject of an expressed or expressible nucleic acid. In this embodiment of the invention, the nucleic acids produce their encoded modulator that mediates a therapeutic effect. Any of the methods for gene therapy available in the art can be used according to the present invention. Exemplary methods are described below.

For general reviews of the methods of gene therapy, see Goldspiel et al., 1993, Clinical Pharmacy 12:488-505; Wu and Wu, 1991, Biotherapy 3:87-95; Tolstoshev, 1993, Ann. Rev. Pharmacol. Toxicol. 32:573-596; Mulligan, 1993, Science 260:926-932; and Morgan and Anderson, 1993, Ann. Rev. Biochem. 62:191-217; May, 1993, TIBTECH 11:155-215. Methods commonly known in the art of recombinant DNA technology which can be used are described in Ausubel et al. (eds.), Current Protocols in Molecular Biology, John Wiley & Sons, NY (1993); and Kriegler, Gene Transfer and Expression, A Laboratory Manual, Stockton Press, NY (1990), each of which is hereby incorporated herein by reference in its entirety.

In a preferred aspect, a composition of the invention comprises nucleic acids encoding a modulator. These nucleic acids are part of an expression vector that expresses the modulator in a suitable host. In particular, such nucleic acids have promoters, preferably heterologous promoters, operably linked to the antibody coding region, the promoter being inducible or constitutive and, optionally, tissue-specific. In another particular embodiment, nucleic acid molecules are used in which the modulator coding sequences and any other desired sequences are flanked by regions that promote homologous recombination at a desired site in the genome, thus providing for intrachromosomal expression of the modulator encoding nucleic acids (Koller and Smithies, 1989, Proc. Natl. Acad. Sci. U.S.A. 86:8932-8935; Zijlstra et al., 1989, Nature 342:435-438), each of which is hereby incorporated herein by reference in its entirety. In specific embodiments, where the modulator is an antibody, the expressed antibody molecule is a single chain antibody. Alternatively, the nucleic acid sequences include sequences encoding both the heavy and light chains, or fragments thereof, of the antibody.

Delivery of the nucleic acids into a subject can be either direct, in which case the subject is directly exposed to the nucleic acid or nucleic acid-carrying vectors, or indirect, in which case cells are first transformed with the nucleic acids in vitro, then transplanted into the subject. These two approaches are known, respectively, as in vivo or ex vivo gene therapy.

In a specific embodiment, the nucleic acid sequences are directly administered in vivo, where it is expressed to produce the encoded product. This can be accomplished by any of numerous methods known in the art, e.g., by constructing them as part of an appropriate nucleic acid expression vector and administering it so that they become intracellular, e.g., by infection using defective or attenuated retrovirals or other viral vectors (see U.S. Pat. No. 4,980,286), or by direct injection of naked DNA, or by use of microparticle bombardment (e.g., a gene gun; Biolistic, Dupont), or coating with lipids or cell-surface receptors or transfecting agents, encapsulation in liposomes, microparticles, or microcapsules, or by administering them in linkage to a peptide which is known to enter the nucleus, by administering it in linkage to a ligand subject to receptor-mediated endocytosis (see, e.g., Wu and Wu, 1987, J. Biol. Chem. 262:4429-4432, which is hereby incorporated herein by reference in its entirety) (which can be used to target cell types specifically expressing the receptors), etc. In another embodiment, nucleic acid-ligand complexes can be formed in which the ligand comprises a fusogenic viral peptide to disrupt endosomes, allowing the nucleic acid to avoid lysosomal degradation. In yet another embodiment, the nucleic acid can be targeted in vivo for cell specific uptake and expression, by targeting a specific receptor (see, e.g., PCT Publications WO 92/06180; WO 92/22635; WO92/203 16; WO93/14188, WO 93/20221). Alternatively, the nucleic acid can be introduced intracellularly and incorporated within host cell DNA for expression, by homologous recombination (Koller and Smithies, 1989, Proc. Natl. Acad. Sci. U.S.A. 86:8932-8935; and Zijlstra et al., 1989, Nature 342:435-438, each of which is hereby incorporated herein by reference in its entirety).

In a specific embodiment, viral vectors that contains nucleic acid sequences encoding an antibody of the invention or fragments thereof are used. For example, a retroviral vector can be used (see Miller et al., 1993, Meth. Enzymol. 217:581-599). These retroviral vectors contain the components necessary for the correct packaging of the viral genome and integration into the host cell DNA. The nucleic acid sequences encoding the antibody to be used in gene therapy are cloned into one or more vectors, which facilitates delivery of the gene into a subject. More detail about retroviral vectors can be found in Boesen et al., 1994, Biotherapy 6:291-302, which describes the use of a retroviral vector to deliver the mdr 1 gene to hematopoietic stem cells in order to make the stem cells more resistant to chemotherapy. Other references illustrating the use of retroviral vectors in gene therapy are Clowes et al., 1994, J. Clin. Invest. 93:644-651; Klein et al., 1994, Blood 83:1467-1473; Salmons and Gunzberg, 1993, Human Gene Therapy 4:129-141; and Grossman and Wilson, 1993, Curr. Opin. in Genetics and Devel. 3:110-114, each of which is hereby incorporated herein by reference in its entirety.

Adenoviruses are other viral vectors that can be used in gene therapy and can be targeted to the central nervous system. Adenoviruses have the advantage of being capable of infecting non-dividing cells. Kozarsky and Wilson, 1993, Current Opinion in Genetics and Development 3:499-503 present a review of adenovirus-based gene therapy. Other instances of the use of adenoviruses in gene therapy can be found in Rosenfeld et al., 1991, Science 252:431-434; Rosenfeld et al., 1992, Cell 68:143-155; Mastrangeli et al., 1993, J. Clin. Invest. 91:225-234; PCT Publication WO94/12649; and Wang et al., 1995, Gene Therapy 2:775-783, each of which is hereby incorporated herein by reference in its entirety. Adeno-associated virus (AAV) has also been proposed for use in gene therapy (Walsh et al., 1993, Proc. Soc. Exp. Biol. Med 204:289-300; and U.S. Pat. No. 5,436,146, each of which is hereby incorporated herein by reference in its entirety).

Another approach to gene therapy involves transferring a gene to cells in tissue culture by such methods as electroporation, lipofection, calcium phosphate mediated transfection, or viral infection. Usually, the method of transfer includes the transfer of a selectable marker to the cells. The cells are then placed under selection to isolate those cells that have taken up and are expressing the transferred gene. Those cells are then delivered to a subject.

In this embodiment, the nucleic acid is introduced into a cell prior to administration in vivo of the resulting recombinant cell. Such introduction can be carried out by any method known in the art, including but not limited to transfection, electroporation, microinjection, infection with a viral or bacteriophage vector containing the nucleic acid sequences, cell fusion, chromosome-mediated gene transfer, microcellmediated gene transfer, spheroplast fusion, etc. Numerous techniques are known in the art for the introduction of foreign genes into cells (see, e.g., Loeffler and Behr, 1993, Meth. Enzymol. 217:599-618; and Cohen et al., 1993, Meth. Enzymol. 217:618-644, each of which is hereby incorporated herein by reference in its entirety) and may be used in accordance with the present invention, provided that the necessary developmental and physiological functions of the recipient cells are not disrupted. The technique should provide for the stable transfer of the nucleic acid to the cell, so that the nucleic acid is expressible by the cell and preferably heritable and expressible by its cell progeny.

The resulting recombinant cells can be delivered to a subject by various methods known in the art. Recombinant blood cells (e.g., hematopoietic stem or progenitor cells) are preferably administered intravenously. The amount of cells envisioned for use depends on the desired effect, patient state, etc., and can be determined by one skilled in the art.

Cells into which a nucleic acid can be introduced for purposes of gene therapy encompass any desired, available cell type, and include but are not limited to epithelial cells, endothelial cells, keratinocytes, fibroblasts, muscle cells, hepatocytes; blood cells such as T lymphocytes, B lymphocytes, monocytes, macrophages, neutrophils, eosinophils, megakaryocytes, granulocytes; various stem or progenitor cells, in particular hematopoietic stem or progenitor cells, e.g., as obtained from bone marrow, umbilical cord blood, peripheral blood, fetal liver, etc. In a preferred embodiment, the cell is a neural cell. In a preferred embodiment, the cell used for gene therapy is autologous to the subject.

In an embodiment in which recombinant cells are used in gene therapy, nucleic acid sequences encoding a modulator are introduced into the cells such that they are expressible by the cells or their progeny, and the recombinant cells are then administered in vivo for therapeutic effect. In a specific embodiment, stem or progenitor cells are used. Any stem and/or progenitor cells that can be isolated and maintained in vitro can potentially be used in accordance with this embodiment of the present invention (see e.g., PCT Publication WO 94/08598; Stemple and Anderson, 1992, Cell 7 1:973-985; Rheinwald, 1980, Meth. Cell Bio. 21A:229; and Pittelkow and Scott, 1986, Mayo Clinic Proc. 61:771, each of which is hereby incorporated herein by reference in its entirety). In a specific embodiment, the nucleic acid to be introduced for purposes of gene therapy comprises an inducible promoter operably linked to the coding region, such that expression of the nucleic acid is controllable by controlling the presence or absence of the appropriate inducer of transcription.

### 5.15.15. Demonstration of Therapeutic Utility

The modulators of the invention can be assayed by any method well known in the art. The modulators of the invention or fragments thereof are preferably tested in vitro, and then in vivo for the desired therapeutic or prophylactic activity, prior to use in humans. For example, in vitro assays that can be used to determine whether administration of a specific composition of the present invention is indicated, include in vitro cell culture assays in which a subject tissue sample is grown in culture, and exposed to or otherwise administered a composition of the present invention, and the effect of such a composition of the present invention upon the tissue sample is observed. The following subsections describe various assays that can be used to determine the efficacy of the modulators of the invention.

### 5.15.15.1. Single Dose Effects on Food and Water Intake and Body Weight Gain in Fasted Rats

Subjects. Male Sprague-Dawley rats (Sasco, St. Louis, Mo.) weighing 210-300 g at the beginning of the experiment were used. Animals are triple-housed in stainless steel hanging cages in a temperature (22° C.) and humidity (40-70% RH) controlled animal facility with a 12:12 hour light-dark cycle. Food (Standard Rat Chow, PMI Feeds Inc., #5012) and water were available ad libitum.

Apparatus. Consumption data is collected while the animals were housed in Nalgene Metabolic cages (Model #650-0100). Each cage comprises subassemblies made of clear polymethlypentene (PMP), polycarbonate (PC), or stainless steel (SS). The entire cylinder-shaped plastic and SS cage rests on a SS stand and houses one animal. The animal were contained in the round Upper Chamber (PC) assembly (12 cm high and 20 cm in diameter) and rests on a SS floor. Two subassemblies were attached to the Upper Chamber. The first assembly consisted of a SS feeding chamber (10 cm long, 5 cm high and 5 cm wide) with a PC feeding drawer attached to the bottom. The feeding drawer had two compartments: a food storage compartment with the capacity for approximately 50 g of pulverized rat chow, and a food spillage compartment. The animals were allowed access to the pulverized chow by an opening in the SS floor of the feeding chamber. The floor of the feeding chamber does not allow access to the food dropped into the spillage compartment.

The second assembly included a water bottle support, a PC water bottle (100 ml capacity) and a graduated water spillage collection tube. The water bottle supported funnels any spilled water into the water spillage collection tube. The lower chamber consisted of a PMP separating cone, PMP collection funnel, PMP fluid (urine) collection tube, and a PMP solid (feces) collection tube. The separating cone was attached to the top of the collection funnel, which in turn was attached to the bottom of the Upper Chamber. The urine ran off the separating cone onto the walls of the collection funnel and into the urine collection tube. The separating cone also separated the feces and funnels it into the feces collection tube.

Food consumption, water consumption, and body weight were measured with an Ohaus Portable Advanced scale (±0.1 gram accuracy).

Procedure. Prior to the day of testing, animals were habituated to the testing apparatus by placing each animal in a Metabolic cage for one hour. On the day of the experiment, animals that were food deprived the previous night were weighed and assigned to treatment groups. Assignments were made using a quasi-random method utilizing the body weights to assure that the treatment groups have similar average body weight. Animals were then administered either vehicle (generally 0.5% methyl cellulose, MC) or test compound. At that time, the feeding drawer was filled with pulverized chow, and the filled water bottle, the empty urine and feces collection tubes were weighed. Two hours after test compound treatment, each animal was weighed and placed in a Metabolic Cage. Following a one hour test session, animals were removed and body weight obtained. The food and water containers were then weighed and the data recorded.

Test Compound. Test Compound was administered orally (0.1-50 mg/kg for oral (PO) dosing) using a gavage tube connected to a 3 or 5 ml syringe at a volume of 10 ml/kg. In some instances test compound was administered by a systemic route (e.g., by intravenous injection 0.1-20 mg/kg for i.v. dosing). Test compound for oral dosing was made into a homogenous suspension by stirring and ultrasonicating for at least one hour prior to dosing.

Statistical Analyses. The means and standard errors of the mean (SEM) for food consumption, water consumption, and body weight change were calculated. One-way analysis of variance using Sytat (5.2.1) was used to test for group differences. A significant effect was defined as having a p value of <0.05.

The following parameters were defined: Body weight change was the difference between the body weight of the animal immediately prior to placement in the metabolic cage and its body weight at the end of the one hour test session. Food consumption was the difference in the weight of the food drawer prior to testing and the weight following the one hour test session. Water consumption was the difference in the weight of the water bottle prior to testing and the weight following the one hour test session.

### 5.15.15.2. Overnight Food Intake

Subjects. Male Sprague-Dawley rats (Sasco, St. Louis, Mo.) weighing 210-300 g at the beginning of the experiment were used. Animals were pair or triple-housed in stainless steel hanging cages in a temperature (22° C.) and humidity (40-70% RH) controlled animal facility with a 12:12 hour light-dark cycle. Food (Standard Rat Chow, PMI Feeds Inc., #5012) and water were available ad libitum.

Apparatus. Consumption and elimination data were obtained while the animals were housed in Nalgene Metabolic cages (Model #650-0100). Each cage was comprised of subassemblies made of clear polymethlypentene (PMP), polycarbonate (PC), or stainless steel (SS). All parts disassemble for quick and accurate data collection and for cleaning. The entire cylinder-shaped plastic and SS cage rests on a SS stand and housed one animal.

The animals were contained in the round Upper Chamber (PC) assembly (12 cm high and 20 cm in diameter) that rests on a SS floor. Two subassemblies were attached to the Upper Chamber. The first assembly consisted of a SS feeding chamber (10 cm long, 5 cm high and 5 cm wide) with a PC feeding drawer attached to the bottom. The feeding drawer had two compartments: a food storage compartment with the capacity for approximately 50 grams of pulverized rat chow, and a food spillage compartment. The animals were allowed access to the pulverized chow by an opening in the SS floor of the feeding chamber. The floor of the feeding chamber did not allow access to the food dropped into the spillage compartment. The second assembly included a water bottle support, a PC water bottle (100 ml capacity) and a graduated water spillage collection tube. The water bottle support funneled any spilled water into the water spillage colllecton tube.

The lower chamber consists of a PMP separating cone, PMP collection funnel, PMP fluid (urine) collection tube, and a PMP solid (feces) collection tube. The separating cone was attached to the top of the collection funnel, which in turn was attached to the bottom of the Upper Chamber. The urine ran off the separating cone onto the walls of the collection funnel and into the urine collection tube. The separating cone also separated the feces and funnels it into the feces collection tube.

Food consumption, water consumption, urine excretion, feces excretion, and body weight were measured with an Ohaus Portable Advanced scale (+0.1 gram accuracy).

Procedure. On the day of the experiment, animals were weighed and assigned to treatment groups. Assignments were made using a quasi-random method utilizing the body weights to assure that the treatment groups had similar average body weight. Two hours prior to lights off (1830 hours), animals were administered either vehicle (0.5% methyl cellulose, MC) or test compound. At that time, the feeding drawer filled with pulverized chow, the filled water bottle, and the empty urine and feces collection tubes were weighed. Following dosing, each animal was weighed and placed in the Metabolic Cage. Animals were removed from the Metabolic Chamber the following morning (0800 hours) and body weight obtained. The food and water containers, and the feces and urine collection tubes, were weighed and the data recorded.

Test Compound. Test compound was administered orally (PO) using a gavage tube connected to a 3 or 5 ml syringe at a volume of 10 mVkg. Test compound was made into a homogenous suspension by stirring and ultrasonicating for at least one hour prior to dosing. In some experiments, animals were tested for more than one night. In these studies, animals were administered, on subsequent nights, the same treatment (test compound or 0.5% MC) they had received the first night.

Statistical Analyses. The means and standard errors of the mean (SEM) for food consumption, water consumption, urine excretion, feces excretion, and body weight change were calculated. One-way analysis of variance using Sytat (5.2.1) was used to test for group differences. A significant effect was defined as having a p value of <0.05.

The following parameters are defined: body weight change was the difference between the body weight of the animal immediately prior to placement in the metabolic cage (1630 hours) and its body weight the following morning (0800 hours). Food consumption was the difference in the weight of the food drawer at 1630 and the weight at 0800. Water consumption was the difference in the weight of the water bottle at 1630 and the weight at 0800. Fecal excretion was the difference in the weight of the empty fecal collection tube at 1630 and the weight at 0800. Urinary excretion was the difference in the weight of the empty urine collection tube at 1630 and the weight at 0800.

### 5.15.16. Methods for Detecting Changes in Gene Expression or Protein Expression

This invention provides several methods for detecting changes in gene expression or protein expression, including but not limited to the expression of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, SEQ ID NO: 26, SEQ ID NO: 28, SEQ ID NO: 30, and SEQ ID NO: 32, homologs of each of the foregoing, and marker genes operably linked to each of the forgoing. Assays for changes in gene expression are well known in the art (see, e.g., PCT Publication No. WO 96/34099, published Oct. 31, 1996, which is incorporated by reference herein in its entirety). Such assays can be performed in vitro using transformed cell lines, immortalized cell lines, or recombinant cell lines.

The RNA expression or protein expression of an open reading frame (which may be of a marker gene or may be of a gene referenced in Section 5.15.3), regulated by a promoter native to the gene referenced in Section 5.15.3 can be measured by measuring the amount or abundance of the RNA (as RNA or cDNA) or protein. In particular, the assays may detect the presence of increased or decreased expression of a gene referenced in Section 5.15.3 (e.g., SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, SEQ ID NO: 26, SEQ ID NO: 28, SEQ ID NO: 30, and SEQ ID NO: 32) on the basis of increased or decreased mRNA expression (using, e.g., nucleic acid probes), increased or decreased levels of protein products (using, e.g., antibodies thereto), or increased or decreased levels of expression of a marker gene (e.g., green fluorescent protein “GFP”) operably linked to the 5′ promoter region in a recombinant construct.

The present invention envisions monitoring changes in gene expression (e.g., a gene referenced in Section 5.15.3) or marker gene expression by any expression analysis technique known to one of skill in the art, including but not limited to, differential display, serial analysis of gene expression (SAGE), nucleic acid array technology, oligonucleotide array technology, GeneChip expression analysis, dot blot hybridization, northern blot hybridization, subtractive hybridization, protein chip arrays, Western blot, immunoprecipitation followed by SDS PAGE, immunocytochemistry, proteome analysis and mass-spectrometry of two-dimensional protein gels.

Methods of gene expression profiling to measure changes in gene expression are well-known in the art, as exemplified by the following references describing subtractive hybridization (Wang and Brown, 1991, Proc. Natl. Acad. Sci. U.S.A. 88:11505-11509), differential display (Liang and Pardee, 1992, Science 257:967-971), SAGE (Velculescu et al., 1995, Science 270:484-487), proteome analysis (Humphery-Smith et al., 1997, Electrophoresis 18:1217-1242; Dainese et al., 1997, Electrophoresis 18:432-442), and hybridization-based methods employing nucleic acid arrays (Heller et al., 1997, Proc. Natl. Acad. Sci. U.S.A. 94:2150-2155; Lashkari et al., 1997, Proc. Natl. Acad. Sci. U.S.A. 94:13057-13062; Wodicka et al., 1997, Nature Biotechnol. 15:1259-1267, each of which is hereby incorporated herein by reference in its entirety). Microarray technology is described in more detail below.

In one series of embodiments, various expression analysis techniques can be used to identify molecules that affect expression of a gene referenced in Section 5.15.3 or marker gene expression, by comparing a cell line expressing a gene disclosed in Section 5.15.3 (e.g., SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, SEQ ID NO: 26, SEQ ID NO: 28, SEQ ID NO: 30, and SEQ ID NO: 32) or a marker gene under the control of a gene promoter sequence in the absence of a test molecule to a cell line expressing the same gene or marker gene under the control of the same promoter sequence in the presence of the test molecule. In a preferred embodiment, expression analysis techniques are used to identify a molecule that upregulates a gene referenced in Section 5.15.3 or upregulates marker gene expression upon treatment of a cell with the molecule.

### 5.15.17. Methods for Monitoring Reporter Gene Expression of a Gene of the Present Invention

### 5.15.17.1. Heterologous Reporter Gene Construct

In a preferred embodiment, the cell being assayed for reporter gene expression contains a fusion construct of at least one transcriptional promoter region for a gene disclosed in Section 5.15.3 (e.g., SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, SEQ ID NO: 26, SEQ ID NO: 28, SEQ ID NO: 30, and SEQ ID: 32) (also referred to herein as the test gene), or homologs of the foregoing, each operably linked to a marker gene expressing a detectable and/or selectable product. Increased expression of a marker gene operably linked to a gene promoter indicates increased expression of the test gene.

The marker gene is a sequence encoding a detectable or selectable marker, the expression of which is regulated by at least one gene promoter region in the heterologous construct used in the present invention. Preferably, the assay is carried out in the absence of background levels of marker gene expression (e.g., in a cell that is mutant or otherwise lacking in the marker gene). If not already lacking in endogenous marker gene activity, cells mutant in the marker gene may be selected by known methods, or the cells can be made mutant in the marker gene by known gene-disruption methods prior to introducing the marker gene (Rothstein, 1983, Meth. Enzymol. 101:202-211).

A marker gene of the invention can be any gene that encodes a detectable and/or selectable product. The detectable marker can be any molecule that can give rise to a detectable signal, e.g., a fluorescent protein or a protein that can be readily visualized or that is recognizable by a specific antibody or that gives rise enzymatically to a signal. The selectable marker can be any molecule that can be selected for its expression, e.g., which gives cells a selective advantage over cells not having the selectable marker under appropriate (selective) conditions. In preferred aspects, the selectable marker is an essential nutrient in which the cell in which the interaction assay occurs is mutant or otherwise lacks or is deficient, and the selection medium lacks such nutrient. In one embodiment, one type of marker gene is used to detect gene expression. In another embodiment, more than one type of marker gene is used to detect gene expression.

Preferred marker genes include but are not limited to, green fluorescent protein (GFP) (Cubitt et al., 1995, Trends Biochem. Sci. 20:448-455), red fluorescent protein, blue fluorescent protein, luciferase, LEU2, LYS2, ADE2, TRP1, CAN1, CYH2, GUS, CUP1 or chloramphenicol acetyl transferase (CAT). Other marker genes include, but are not limited to, URA3, HIS3 and/or the lacZ genes (see e.g., Rose and Botstein, 1983, Meth. Enzymol. 101: 167-180, which is hereby incorporated herein by reference in its entirety) operably linked to GAL4 DNA-binding domain recognition elements. Alam and Cook disclose non-limiting examples of detectable marker genes that can be operably linked to a glucan synthase pathway reporter gene promoter region (Alam and Cook, 1990, Anal. Biochem. 188:245-254, which is hereby incorporated herein by reference in its entirety).

In a preferred embodiment, more than one different marker gene is used to detect transcriptional activation, e.g., one encoding a detectable marker, and one or more encoding one or more different selectable marker(s), or e.g., different detectable markers. Expression of the marker genes can be detected and/or selected for by techniques known in the art (see e.g. U.S. Pat. Nos. 6,057,101 and 6,083,693, each of which is hereby incorporated herein by reference in its entirety).

Methods to construct a suitable reporter construct are disclosed herein by way of illustration and not limitation and any other methods known in the art can also be used. In a preferred embodiment, the reporter gene construct is a chimeric reporter construct comprising a marker gene that is transcribed under the control of a gene promoter sequence comprising all or a portion of a promoter region of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, and SEQ ID NO: 24, SEQ ID NO: 26, SEQ ID NO: 28, SEQ ID NO: 30, SEQ ID: 32, and SEQ ID NO: 34. If not already a part of the DNA sequence, the translation initiation codon, ATG, is provided in the correct reading frame upstream of the DNA sequence.

Vectors comprising all or portions of the gene sequences of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, or SEQ ID NO: 24, SEQ ID NO: 26, SEQ ID NO: 28, SEQ ID NO: 30, SEQ ID NO: 32, and SEQ ID NO: 34 useful in the construction of recombinant reporter gene constructs and cells are provided. The vectors of this invention also include those vectors comprising DNA sequences that hybridize under stringent conditions to SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, or SEQ ID NO: 24, SEQ ID NO: 26, SEQ ID NO: 28, SEQ ID NO: 30, SEQ ID NO: 32, and SEQ ID NO: 34 gene sequences, and conservatively modified variations thereof.

The vectors of this invention may be present in transformed or transfected cells, cell lysates, or in partially purified or substantially pure forms. DNA vectors may contain a means for amplifying the copy number of the gene of interest, stabilizing sequences, or alternatively may be designed to favor directed or non-directed integration into the host cell genome.

Given the strategies described herein, one of skill in the art can construct a variety of vectors and nucleic acid molecules comprising functionally equivalent nucleic acids. DNA cloning and sequencing methods are well known to those of skill in the art and are described in an assortment of laboratory manuals, including Sambrook et al., 1989, supra; and Ausubel et al., 2002 Supplement which is hereby incorporated herein as reference in its entirety.

Transformation and other methods of introducing nucleic acids into a host cell (e.g., transfection, electroporation, liposome delivery, membrane fusion techniques, high velocity DNA-coated pellets, viral infection and protoplast fusion) can be accomplished by a variety of methods that are well known in the art (see, for instance, Ausubel, supra, and Sambrook, supra). S. cerevisiae cells of the invention can be transformed or transfected with an expression vector, such as a plasmid, a cosmid, or the like, wherein the expression vector comprises the DNA of interest. Alternatively, the cells can be infected by a viral expression vector comprising the DNA or RNA of interest.

Particular details of the transfection and expression of nucleic acid sequences are well documented and are understood by those of skill in the art. Further details on the various technical aspects of each of the steps used in recombinant production of foreign genes in expression systems can be found in a number of texts and laboratory manuals in the art (see, e.g., Ausubel et al., 2002, herein incorporated by reference).

### 5.15.17.2. Other Methods for Monitoring Reporter Gene Expression

In accordance with the present invention, reporter gene expression can be monitored at the RNA or the protein level. In a specific embodiment, molecules that affect reporter gene expression can be identified by detecting differences in the level of marker protein expressed by cells contacted with a test molecule versus the level of marker protein expressed by cells in the absence of the test molecule.

Protein expression can be monitored using a variety of methods that are well known to those of skill in the art. For example, protein chips or protein microarrays (e.g., ProteinChip™, Ciphergen Biosystem) and two-dimensional electrophoresis (see, e.g., U.S. Pat. No. 6,064,754, which is hereby incorporated herein by reference in its entirety) can be utilized to monitor protein expression levels. As used herein “two-dimensional electrophoresis”) (2D-electrophoresis) means a technique comprising isoelectric focusing, followed by denaturing electrophoresis, generating a two-dimensional gel (2D-gel) containing a plurality of proteins. Any protocol for 2D-electrophoresis known to one of ordinary skill in the art can be used to analyze protein expression by the reporter genes of the invention. For example, 2D electrophoresis can be performed according to the methods described in O'Farrell, 1975, J. Biol. Chem. 250: 4007-4021, which is hereby incorporated herein by reference in its entirety.

Liquid High Throughput-Like Assay. In a preferred embodiment, a liquid high throughput-like assay is used to determine the protein expression level of a reporter gene. The following exemplary, but not limiting, assay may be used:

A reporter construct is transformed into a cell strain. Cultures from solid media plates are used to innoculate liquid cultures in Casamino Acids media or an equivalent media. This liquid culture is grown and then diluted in Casamino Acids media or an equivalent media.

A test molecule is selected for the assay, preferably but not necessarily along with a negative control molecule. The test molecule and negative control molecule are separately added to an assay plate containing multiple wells and serially diluted (e.g., 1 to 2) into Casamino Acids media plus DMSO in sequential columns, so that each plate contains a range of concentrations of each drug. If a negative control is being used, one column of each plate may be used as a “no drug” control, containing only Casamino Acids media plus DMSO. The skilled artisan will note that different assay plates can be used, such as those with 96, 384 or 1536 well format.

An aliquot of liquid reporter strain is added to each well of the serial dilution plates from above and mixed. The assay plates are then incubated. After incubation the assay plates are analyzed for detectable marker gene product. In a preferred embodiment, the assay plates are imaged in a Molecular Dynamics Fluorimager SI to measure the fluorescence from the GFP reporters.

The results are then analyzed, as described above. If the drug is an inhibitor of the gene product (e.g., an inhibitor of e.g. SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, SEQ ID NO: 26, SEQ ID NO: 28, SEQ ID NO: 30, SEQ ID: 32, and SEQ ID NO: 34) the reporter will show increases in fluorescence for the higher drug concentrations versus the lower drug concentrations and/or the no drug controls.

### 5.15.17.3. Specific Embodiments

One embodiment of the present invention provides a method for determining whether a candidate molecule affects a body weight disorder associated with an organism. In step (a) of the method, a cell from the organism is contacted with the candidate molecule. Alternatively, the candidate molecule is recombinantly expressed within the cell. In step (b) of the method, a determination is made as to whether the RNA expression or protein expression in the cell of at least one open reading frame is changed in step (a) relative to the expression of the open reading frame in the absence of the candidate molecule, where each open reading frame is regulated by a promoter native to a nucleic acid sequence selected from the group consisting of SEQ ID NO: 5, SEQ ID NO: 6, SEQ ID NO: 7, SEQ ID NO: 8, SEQ ID NO: 9, SEQ ID NO: 1, SEQ ID NO: 12, SEQ ID NO: 14, SEQ ID NO: 16, SEQ ID NO: 18, SEQ ID NO: 20, SEQ ID NO: 21, or SEQ ID NO: 23, SEQ ID NO: 25, SEQ ID NO: 27, SEQ ID NO: 29, SEQ ID NO: 31, and SEQ ID NO: 33 homologs (e.g., orthologs, and paralogs) of each of the foregoing.

The candidate molecule affects a body weight disorder associated with the organism when the RNA expression or protein expression of the at least one open reading frame is changed. The candidate molecule does not affect a body weight disorder associated with the organism when the RNA expression or protein expression of the at least one open reading frame is unchanged. In some embodiments, the body weight disorder is obesity, anorexia nervosa, bulimia nervosa or cachexia.

In some embodiments, the candidate molecule affects a body weight disorder associated with the organism when a cell from the organism that is contacted with the candidate molecule exhibits a lower expression level of a protein sequence in the group consisting of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, SEQ ID NO: 26, SEQ ID NO: 28, SEQ ID NO: 30, SEQ ID: 32, and SEQ ID NO: 34 relative to a cell from the organism that is not contacted with the candidate molecule.

In some embodiments step (b) comprises determining whether RNA expression is changed. In some embodiments, step (b) comprises determining whether protein expression is changed. In some embodiments, step (b) comprises determining whether RNA or protein expression of at least two of the open reading frames is changed. In some embodiments, step (a) comprises contacting the cell with the candidate molecule and step (a) is carried out in a liquid high throughput-like assay.

In some embodiments, the cell comprises a promoter region of at least one gene selected from the group consisting of SEQ ID NO: 5, SEQ ID NO: 6, SEQ ID NO: 7, SEQ ID NO: 8, SEQ ID NO: 9, SEQ ID NO: 1, SEQ ID NO: 12, SEQ ID NO: 14, SEQ ID NO: 16, SEQ ID NO: 18, SEQ ID NO: 20, SEQ ID NO: 21, or SEQ ID NO: 23, SEQ ID NO: 25, SEQ ID NO: 27, SEQ ID NO: 29, SEQ ID NO: 31, and SEQ ID NO: 33 and homologs of each of the foregoing, each promoter region being operably linked to a marker gene. Further, in such embodiments, step (b) comprises determining whether the RNA expression or protein expression of the marker gene(s) is changed in step (a) relative to the expression of the marker gene in the absence of the candidate molecule. In some embodiments, the marker gene is selected from the group consisting of green fluorescent protein, red fluorescent protein, blue fluorescent protein, luciferase, LEU2, LYS2, ADE2, TRP1, CAN1, CYH2, GUS, CUP1 and chloramphenicol acetyl transferase.

Another aspect of the invention provides a method of identifying a molecule that specifically binds to a ligand selected from the group consisting of (i) a protein encoded by a gene selected from the group consisting of SEQ ID NO: 5, SEQ ID NO: 6, SEQ ID NO: 7, SEQ ID NO: 8, SEQ ID NO: 9, SEQ ID NO: 11, SEQ ID NO: 12, SEQ ID NO: 14, SEQ ID NO: 16, SEQ ID NO: 18, SEQ ID NO: 20, SEQ ID NO: 21, or SEQ ID NO: 23, SEQ ID NO: 25, SEQ ID NO: 27, SEQ ID NO: 29, SEQ ID NO: 31, and SEQ ID NO: 33 and homologs of each of the foregoing, and (ii) a biologically active fragment of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, and SEQ ID NO: 24, SEQ ID NO: 26, SEQ ID NO: 28, SEQ ID NO: 30, SEQ ID NO: 32, and SEQ ID NO: 34. The method comprises (a) contacting the ligand with one or more candidate molecules under conditions conducive to binding between the ligand and the candidate molecules; and (b) identifying a molecule within the one or more candidate molecules that binds to the ligand.

Another aspect of the invention provides a method for determining whether a candidate molecule affects a body weight disorder associated with an organism. The method consists of contacting a cell from the organism with a candidate molecule, or recombinantly expressing the candidate molecule within the cell from the organism. The method also consists of determining whether the RNA expression or protein expression in the cell of at least one open reading frame is changed in the previous step relative to the expression of the open reading frame in the absence of the candidate molecule. Each open reading frame that is regulated by a promoter native to a nucleic acid sequence is selected from the group consisting of SEQ ID NO: 25, SEQ ID NO: 27, SEQ ID NO: 29, SEQ ID NO: 31, and SEQ ID NO: 33 and homologs of each of the foregoing. The method further consists of determining either that the candidate molecule affects a body weight disorder associated with the organism when the RNA expression or protein expression of at least one open reading frame is changed, or determining that the candidate molecule does not affect a body weight disorder associated with the organism when the RNA expression or protein expression of at least one of the open reading frames is unchanged.

Another aspect of the invention provides a method for treating or preventing a body weight disorder. The method comprises administering to a subject in which treatment is desired a therapeutically effective amount of a compound. Specifically, the compound antagonizes in the subject a protein comprising a sequence selected from the group consisting of SEQ ID NO: 26, SEQ ID NO: 28, SEQ ID NO 30, SEQ ID NO: 32, and SEQ ID NO: 34, and homologs of each of the foregoing. In some embodiments, the compound inhibits a function of one or more of the group consisting of SEQ ID NO: 26, SEQ ID NO: 28, SEQ ID 30, SEQ ID: 32, and homologs of each of the foregoing. In some embodiments in accordance with the present invention, the compound is selected from the group consisting of an antibody that binds to one of SEQ ID NO: 26, SEQ ID NO: 28, SEQ ID 30, SEQ ID: 32, SEQ ID NO: 34, and homologs of each of the foregoing, or a fragment or derivative therefore containing the binding region thereof. Alternatively, in other embodiments in accordance with the present invention, the compound is selected from the group consisting of a nucleic acid complementary to the RNA produced by transcription of a gene encoding one of SEQ ID NO: 26, SEQ ID NO: 28, SEQ ID 30, SEQ ID: 32, and SEQ ID NO: 34, and homologs of each of the foregoing.

Another aspect of the invention provides a method for treating or preventing a body weight disorder comprising administering to a subject a therapeutically effective amount of a compound. More specifically, the compound enhances a function of one or more of the group consisting of SEQ ID NO: 26, SEQ ID NO: 28, SEQ ID 30, SEQ ID: 32, and SEQ ID NO: 34, and homologs of each of the foregoing.

Another aspect of the invention provides a method for diagnosing a disease or disorder or the predisposition to the disease or disorder. The disease or disorder is characterized by an aberrant level of one of SEQ ID NOs: 1-7, SEQ ID NOs 9-10, and SEQ ID NO: 25 through SEQ ID NO: 34, or a homolog thereof, in a subject. In some embodiments in accordance with the present invention, the method comprises measuring the level of any one of SEQ ID NO: 1 through SEQ ID NO: 34, or a homolog thereof, in a sample derived from the subject. An increase or decrease in the level of one of SEQ ID NOs: 1-7, SEQ ID NOs 9-10, and SEQ ID NO: 25 through SEQ ID NO: 34, or a homolog thereof, in the sample is recorded and compared to the level of a corresponding one of SEQ ID NOs: 1-7, SEQ ID NOs 9-10, and SEQ ID NO: 25 through SEQ ID NO: 34, or a homolog thereof, found in an analogous sample not having the disease or disorder. The difference between the levels indicates the presence of the disease or disorder in the subject.

Yet, another aspect of the invention provides a method for diagnosing or screening for the presence of or predisposition for developing a disease or disorder involving a body weight disorder in a subject. The method comprises detecting one or more mutations in at least one of SEQ ID NOs: 1-7, SEQ ID NOs 9-10, and SEQ ID NO: 25 through SEQ ID NO: 34, or a homolog thereof, in a sample derived from the subject. In some embodiments in accordance with the present invention, the presence of one or more mutations indicates the presence of the disease or disorder or a predisposition for developing the disease or disorder.

### 5.15.18. Method of Treating or Preventing Body Weight Disorders

One aspect of the invention provides a method of treating or preventing a body weight disorder. The method comprises administering to a subject in which treatment is desired a therapeutically effective amount of a molecule that inhibits a function of one or more of the group consisting of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, SEQ ID NO: 26, SEQ ID NO: 28, SEQ ID NO: 30, and SEQ ID NO: 34 and homologs (e.g., orthologs and paralogs) thereof.

In some embodiments, the subject is human. In some embodiments, the molecule that inhibits a function of one or more of the group consisting of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, SEQ ID NO: 26, SEQ ID NO: 28, SEQ ID NO: 30, SEQ ID NO: 32, SEQ ID NO: 34 and homologs (e.g., orthologs and paralogs) thereof, is selected from the group consisting of an antibody that binds to one of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, SEQ ID NO: 26, SEQ ID NO: 28, SEQ ID NO: 30, SEQ ID NO: 32, SEQ ID NO: 34 and homologs thereof, or a fragment or derivative therefof.

Another aspect of the invention provides a method of treating or preventing a body weight disorder. The method comprises administering to a subject in which treatment is desired a therapeutically effective amount of a molecule that enhances a function of one or more of the group consisting of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, SEQ ID NO: 26, SEQ ID NO: 28, SEQ ID NO: 30, SEQ ID NO: 32, SEQ ID NO: 34 and homologs thereof. In some embodiments, the subject is human.

Yet another aspect of the invention provides a method of diagnosing a disease or disorder or the predisposition to the disease or disorder, where the disease or disorder is characterized by an aberrant level of one of SEQ ID NO: 1 through SEQ ID NO: 34 (or homologs thereof) in a subject. The method comprises measuring the level of any one of SEQ ID NO: 1 through SEQ ID NO: 34 (or homologs thereof) in a sample derived from the subject, in which an increase or decrease in the level of one of SEQ ID NO: 1 through SEQ ID NO: 34 (or homologs thereof) in the sample, relative to the level of one of said SEQ ID NO: 1 through SEQ ID NO: 34 (or homologs thereof) found in an analogous sample not having the disease or disorder, indicates the presence of the disease or disorder in the subject. In some embodiments, the disease or disorder is a body weight disorder, such as obesity, anorexia nervosa, bulimia nervosa, or cachexia.

Still another aspect of the invention provides a method of diagnosing or screening for the presence of or predisposition for developing a disease or disorder involving a body weight disorder in a subject comprising detecting one or more mutations in at least one of SEQ ID NO: 1 through SEQ ID NO: 34 (or homologs thereof) in a sample derived from the subject, in which the presence of the one or more mutations indicates the presence of the disease or disorder or a predisposition for developing the disease or disorder.

### 5.15.19. Transgenic Animals

The invention also provides animal models. Transgenic animals that have incorporated and express a constitutively-functional obesity related gene have use as animal models of obesity related diseases and disorders. Such animals can be used to screen for or test molecules for the ability to prevent such obesity related diseases and disorders. In one embodiment, animal models for obesity related diseases and disorders is provided. Such animals can be initially produced by promoting homologous recombination between an obesity related gene (e.g., SEQ ID NO: 5, SEQ ID NO: 6, SEQ ID NO: 7, SEQ ID NO: 8, SEQ ID NO: 9, SEQ ID NO: 1, SEQ ID NO: 12, SEQ ID NO: 14, SEQ ID NO: 16, SEQ ID NO: 18, SEQ ID NO: 20, SEQ ID NO: 21, or SEQ ID NO: 23, SEQ ID NO: 25, SEQ ID NO: 27, SEQ ID NO: 29, SEQ ID NO: 31, SEQ ID NO: 33 and homologs thereof) in its chromosome and an exogenous obesity related gene that has been rendered biologically inactive. Preferably the sequence inserted is a heterologous sequence, e.g., an antibiotic resistance gene. In a preferred aspect, this homologous recombination is carried out by transforming embryo-derived stem (ES) cells with a vector containing an insertionally inactivated gene, where the active gene encodes a particular obesity related gene, such that homologous recombination occurs; the ES cells are then injected into a blastocyst, and the blastocyst is implanted into a foster mother, followed by the birth of the chimeric animal, also called a “knockout animal,” in which an obesity related gene has been inactivated (see Capecchi, 1989, Science 244: 1288-1292). The chimeric animal can be bred to produce additional knockout animals. Chimeric animals can be and are preferably non-human mammals such as mice, hamsters, sheep, pigs, cattle, etc. In a specific embodiment, a knockout mouse is produced.

Such knockout animals are expected to develop or be predisposed to developing diseases or disorders involving obesity and thus can have use as animal models of such diseases and disorders, e.g., to screen for or test molecules for the ability to promote activation or proliferation and thus treat or prevent such diseases or disorders.

In a different embodiment of the invention, transgenic animals that have incorporated and express a constitutively-functional obesity related gene have use as animal models of diseases and disorders involving in T-cell overactivation, or in which T cell activation is desired.

In particular, each transgenic line expressing a particular key gene under the control of the regulatory sequences of a characterizing gene is created by the introduction, for example by pronuclear injection, of a vector containing the transgene into a founder animal, such that the transgene is transmitted to offspring in the line. The transgene preferably randomly integrates into the genome of the founder but in specific embodiments can be introduced by directed homologous recombination. In a preferred embodiment, the transgene is present at a location on the chromosome other than the site of the endogenous characterizing gene. In a preferred embodiment, homologous recombination in bacteria is used for target-directed insertion of the key gene sequence into the genomic DNA for all or a portion of the characterizing gene, including sufficient characterizing gene regulatory sequences to promote expression of the characterizing gene in its endogenous expression pattern. In a preferred embodiment, the characterizing gene sequences are on a bacterial artificial chromosome (BAC). In specific embodiments, the key gene coding sequences are inserted as a 5′ fusion with the characterizing gene coding sequence such that the key gene coding sequences are inserted in frame and directly 3′ from the initiation codon for the characterizing gene coding sequences. In another embodiment, the key gene coding sequences are inserted into the 3′ untranslated region (UTR) of the characterizing gene and, preferably, have their own internal ribosome entry sequence (IRES).

The vector (preferably a BAC) comprising the key gene coding sequences and characterizing gene sequences is then introduced into the genome of a potential founder animal to generate a line of transgenic animals. Potential founder animals can be screened for the selective expression of the key gene sequence in the population of cells characterized by expression of the endogenous characterizing gene. Transgenic animals that exhibit appropriate expression (e.g., detectable expression of the key gene product having the same expression pattern within the animal as the endogenous characterizing gene) are selected as founders for a line of transgenic animals.

One aspect of the invention provides a recombinant non-human animal that is the product of a process comprising introducing a nucleic acid encoding at least a domain of one of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, and SEQ ID NO: 24, SEQ ID NO: 26, SEQ ID NO: 28, SEQ ID NO: 30, and SEQ ID NO: 32, and SEQ ID NO: 34 (or homologs thereof) into the non-human animal.

### 5.16. Clustering Techniques

The subsections below describe exemplary methods for clustering. Such techniques may be used to cluster QTL vectors in order to form QTL interaction maps. The same techniques can be applied to gene expression vectors in order to form gene expression cluster maps. Further, these techniques can be used to perform unsupervised or supervised classification. In these techniques, QTL vectors, gene expression vectors, or sets of cellular constituent measurements from different organisms in a population are clustered based on the strength of interaction between the data (e.g., QTL vectors, gene expression vectors, or sets of cellular constituents). More information on clustering techniques can be found in Kaufman and Rousseeuw, 1990, Finding Groups in Data: An Introduction to Cluster Analysis, Wiley, New York, N.Y.; Everitt, 1993, Cluster analysis (3d ed.), Wiley, New York, N.Y.; Backer, 1995, Computer-Assisted Reasoning in Cluster Analysis, Prentice Hall, Upper Saddle River, N.J.; and Duda et al., 2001, Pattern Classification, John Wiley & Sons, New York, N.Y.

### 5.16.1. Hierarchical Clustering Techniques

Hierarchical cluster analysis is a statistical method for finding relatively homogenous clusters of elements based on measured characteristics. Consider a sequence of partitions of n samples into c clusters. The first of these is a partition into n clusters, each cluster containing exactly one sample. The next is a partition into n−1 clusters, the next is a partition into n−2, and so on until the n^{th}, in which all the samples form one cluster. Level k in the sequence of partitions occurs when c=n−k+1. Thus, level one corresponds to n clusters and level n corresponds to one cluster. Given any two samples x and x*, at some level they will be grouped together in the same cluster. If the sequence has the property that whenever two samples are in the same cluster at level k they remain together at all higher levels, then the sequence is said to be a hierarchical clustering. Duda et al., 2001, Pattern Classification, John Wiley & Sons, New York, 2001: 551.

### 5.16.1.1. Agglomerative Clustering

In some embodiments, the hierarchical clustering technique used to cluster gene analysis vectors is an agglomerative clustering procedure. Agglomerative (bottom-up clustering) procedures start with n singleton clusters and form a sequence of partitions by successively merging clusters. The major steps in agglomerative clustering are contained in the following procedure, where c is the desired number of final clusters, Dᵢ and Dⱼ are clusters, xᵢ is a gene analysis vector, and there are n such vectors:

1 begin initialize c, ĉ [symbol] n, Dᵢ [symbol] {xᵢ}, i = 1, ..., n
2 do ĉ [symbol] ĉ −1
3 find nearest clusters, say, Dᵢ and Dⱼ
4 merge Dᵢ and Dⱼ
5 until c = ĉ
6 return c clusters
7 end

In this algorithm, the terminology a←b assigns to variable a the new value b. As described, the procedure terminates when the specified number of clusters has been obtained and returns the clusters as a set of points. A key point in this algorithm is how to measure the distance between two clusters Dᵢ and Dⱼ. The method used to define the distance between clusters Dᵢ and Dⱼ defines the type of agglomerative clustering technique used. Representative techniques include the nearest-neighbor algorithm, farthest-neighbor algorithm, the average linkage algorithm, the centroid algorithm, and the sum-of-squares algorithm.

Nearest-neighbor algorithm. The nearest-neighbor algorithm uses the following equation to measure the distances between clusters:

$$d min ( Di , Dj ) = {{min}_{x ∈ Di}}_{{x}^{′} ∈ Dj} ‖ x - {x}^{′} ‖ .$$

This algorithm is also known as the minimum algorithm. Furthermore, if the algorithm is terminated when the distance between nearest clusters exceeds an arbitrary threshold, it is called the single-linkage algorithm. Consider the case in which the data points are nodes of a graph, with edges forming a path between the nodes in the same subset Dᵢ. When dmin( ) is used to measure the distance between subsets, the nearest neighbor nodes determine the nearest subsets. The merging of Dᵢ and Dⱼ corresponds to adding an edge between the nearest pair of nodes in Dᵢ and Dⱼ. Because edges linking clusters always go between distinct clusters, the resulting graph never has any closed loops or circuits; in the terminology of graph theory, this procedure generates a tree. If it is allowed to continue until all of the subsets are linked, the result is a spanning tree. A spanning tree is a tree with a path from any node to any other node. Moreover, it can be shown that the sum of the edge lengths of the resulting tree will not exceed the sum of the edge lengths for any other spanning tree for that set of samples. Thus, with the use of dmin( ) as the distance measure, the agglomerative clustering procedure becomes an algorithm for generating a minimal spanning tree. See Duda et al., id, pp. 553-554.

Farthest-neighbor algorithm. The farthest-neighbor algorithm uses the following equation to measure the distances between clusters:

$$d max ( Di , Dj ) = {{max}_{x ∈ Di}}_{{x}^{′} ∈ Dj} ‖ x - {x}^{′} ‖ .$$

This algorithm is also known as the maximum algorithm. If the clustering is terminated when the distance between the nearest clusters exceeds an arbitrary threshold, it is called the complete-linkage algorithm. The farthest-neighbor algorithm discourages the growth of elongated clusters. Application of this procedure can be thought of as producing a graph in which the edges connect all of the nodes in a cluster. In the terminology of graph theory, every cluster contains a complete subgraph. The distance between two clusters is terminated by the most distant nodes in the two clusters. When the nearest clusters are merged, the graph is changed by adding edges between every pair of nodes in the two clusters.

Average linkage algorithm. Another agglomerative clustering technique is the average linkage algorithm. The average linkage algorithm uses the following equation to measure the distances between clusters:

$${d}_{avg} ( Di , Dj ) = \frac{1}{{n}_{i} {n}_{j}} {\sum }_{x ∈ Di} {\sum }_{{x}^{′} ∈ Dj} ‖ x - {x}^{′} ‖ .$$

Hierarchical cluster analysis begins by making a pair-wise comparison of all gene analysis vectors in a set of such vectors. After evaluating similarities from all pairs of elements in the set, a distance matrix is constructed. In the distance matrix, a pair of vectors with the shortest distance (i.e. most similar values) is selected. Then, when the average linkage algorithm is used, a “node” (“cluster”) is constructed by averaging the two vectors. The similarity matrix is updated with the new “node” (“cluster”) replacing the two joined elements, and the process is repeated n−1 times until only a single element remains. Consider six elements, A-F having the values:
A{4.9}, B{8.2}, C{3.0}, D{5.2}, E{8.3}, F{2.3}.
   In the first partition, using the average linkage algorithm, one matrix (sol. 1) that could be computed is:

(sol. 1) A {4.9}, B-E{8.25}, C{3.0}, D{5.2}, F{2.3}.

Alternatively, the first partition using the average linkage algorithm could yield the matrix:

(sol. 2) A {4.9}, C{3.0}, D{5.2}, E-B{8.25}, F{2.3}.

Assuming that solution 1 was identified in the first partition, the second partition using the average linkage algorithm will yield:

(sol. 1-1) A-D{5.05}, B-E{8.25}, C{3.0}, F{2.3}

or

(sol. 1-2) B-E{8.25}, C{3.0}, D-A{5.05}, F{2.3}.

Assuming that solution 2 was identified in the first partition, the second partition of the average linkage algorithm will yield:

(sol. 2-1) A-D{5.05}, C{3.0}, E-B{8.25}, F{2.3}

or

(sol. 2-2) C{3.0}, D-A{5.05}, E-B{8.25}, F{2.3}.

Thus, after just two partitions in the average linkage algorithm, there are already four matrices. See Duda et al., 2001, Pattern Classification, John Wiley & Sons, New York, p. 551.

### 5.16.1.2. Clustering with Pearson Correlation Coefficients

In one embodiment of the present invention, QTL vectors and/or gene expression vectors are clustered using agglomerative hierarchical clustering with Pearson correlation coefficients. In this form of clustering, similarity is determined using Pearson correlation coefficients between the QTL vectors pairs, gene expression pairs, or sets of cellular constituent measurements. Other metrics that can be used, in addition to the Pearson correlation coefficient, include but are not limited to, a Euclidean distance, a squared Euclidean distance, a Euclidean sum of squares, a Manhattan metric, and a squared Pearson correlation coefficient. Such metrics may be computed using SAS (Statistics Analysis Systems Institute, Cary, N.C.) or S-Plus (Statistical Sciences, Inc., Seattle, Wash.).

### 5.16.1.3. Divisive Clustering

In some embodiments, the hierarchical clustering technique used to cluster QTL vectors and/or gene expression vectors is a divisive clustering procedure. Divisive (top-down clustering) procedures start with all of the samples in one cluster and form the sequence by successfully splitting clusters. Divisive clustering techniques are classified as either a polythetic or a monthetic method. A polythetic approach divides clusters into arbitrary subsets.

### 5.16.2. K-Means Clustering

In k-means clustering, sets of QTL vectors, gene expression vectors, or sets of cellular constituent measurements are randomly assigned to K user specified clusters. The centroid of each cluster is computed by averaging the value of the vectors in each cluster. Then, for each i=1, . . . , N, the distance between vector xᵢ and each of the cluster centroids is computed. Each vector xᵢ is then reassigned to the cluster with the closest centroid. Next, the centroid of each affected cluster is recalculated. The process iterates until no more reassignments are made. See Duda et al., 2001, Pattern Classification, John Wiley & Sons, New York, N.Y., pp. 526-528. A related approach is the fuzzy k-means clustering algorithm, which is also known as the fuzzy c-means algorithm. In the fuzzy k-means clustering algorithm, the assumption that every QTL vector, gene expression vector, or set of cellular constituent measurements is in exactly one cluster at any given time is relaxed so that every vector (or set) has some graded or “fuzzy” membership in a cluster. See Duda et al., 2001, Pattern Classification, John Wiley & Sons, New York, N.Y., pp. 528-530.

### 5.16.3. Jarvis-Patrick Clustering

Jarvis-Patrick clustering is a nearest-neighbor non-hierarchical clustering method in which a set of objects is partitioned into clusters on the basis of the number of shared nearest-neighbors. In the standard implementation advocated by Jarvis and Patrick, 1973, IEEE Trans. Comput., C-22:1025-1034, a preprocessing stage identifies the K nearest-neighbors of each object in the dataset. In the subsequent clustering stage, two objects i and j join the same cluster if (i) i is one of the K nearest-neighbors of j, (ii) j is one of the K nearest-neighbors of i, and (iii) i and j have at least kₘᵢₙ of their K nearest-neighbors in common, where K and kₘᵢₙ are user-defined parameters. The method has been widely applied to clustering chemical structures on the basis of fragment descriptors and has the advantage of being much less computationally demanding than hierarchical methods, and thus more suitable for large databases. Jarvis-Patrick clustering may be performed using the Jarvis-Patrick Clustering Package 3.0 (Barnard Chemical Information, Ltd., Sheffield, United Kingdom).

### 5.16.4. Neural Networks

A neural network has a layered structure that includes a layer of input units (and the bias) connected by a layer of weights to a layer of output units. In multilayer neural networks, there are input units, hidden units, and output units. In fact, any function from input to output can be implemented as a three-layer network. In such networks, the weights are set based on training patterns and the desired output. One method for supervised training of multilayer neural networks is back-propagation. Back-propagation allows for the calculation of an effective error for each hidden unit, and thus derivation of a learning rule for the input-to-hidden weights of the neural network.

The basic approach to the use of neural networks is to start with an untrained network, present a training pattern to the input layer, and pass signals through the net and determine the output at the output layer. These outputs are then compared to the target values; any difference corresponds to an error. This error or criterion function is some scalar function of the weights and is minimized when the network outputs match the desired outputs. Thus, the weights are adjusted to reduce this measure of error. Three commonly used training protocols are stochastic, batch, and on-line. In stochastic training, patterns are chosen randomly from the training set and the network weights are updated for each pattern presentation. Multilayer nonlinear networks trained by gradient descent methods such as stochastic back-propagation perform a maximum-likelihood estimation of the weight values in the model defined by the network topology. In batch training, all patterns are presented to the network before learning takes place. Typically, in batch training, several passes are made through the training data. In online training, each pattern is presented once and only once to the net.

### 5.16.5. Self-Organizing Maps

A self-organizing map is a neural-network that is based on a divisive clustering approach. The aim is to assign genes to a series of partitions on the basis of the similarity of their expression vectors to reference vectors that are defined for each partition. Consider the case in which there are two microarrays from two different experiments. It is possible to build up a two-dimensional construct where every spot corresponds to the expression levels of any given gene in the two experiments. A two-dimensional grid is built, resulting in several partitions of the two-dimensional construct. Next, a gene is randomly picked and the identify of the reference vector (node) closest to the gene picked is determined based on a distance matrix. The reference vector is then adjusted so that it is more similar to the vector of the assigned gene. That means the reference vector is moved one distance unit on the x axis and y-axis and becomes closer to the assigned gene. The other nodes are all adjusted to the assigned gene, but only are moved one half or one-fourth distance unit. This cycle is repeated hundreds of thousands times to converge the reference vector to fixed value and where the grid is stable. At that time, every reference vector is the center of a group of genes. Finally, the genes are mapped to the relevant partitions depending on the reference vector to which they are most similar.

### 6. EXAMPLES

The following examples are presented by way of illustration of the invention and are not limiting. The methods outlined in Section 5.1 as well as FIG. 7 were applied to the data derived from the F₂ mouse population described by Schadt et al., 2003, Nature 422, 297 and Drake et al., 2001, Physiol. Genomics 5:205.

Steps 702 and 704.

Parental mice were purchased from the Jackson Laboratories (Bar Harbor, Me.). Females of strain C57BL/6J (B6) were mated with DBA/2J (DBA) males. F1 progeny were then intercrossed to produce F₂ intercross progeny. The female F₂ population (111 mice) was on a high-fat, atherogenic diet for 16 weeks, starting at 12 months of age, before omental fat pad masses (OFPM) were measured and livers were extracted for gene expression profiling (step 706 below). The mice were genotyped at 139 microsatellite markers uniformly distributed over the mouse genome to allow for the genetic mapping of the gene expression and disease traits. In particular, a complete linkage map for all chromosomes in Z. mays was constructed at an average density of 12 cM using the microsatellite markers using MapMaker QTL (Lincoln, et al., 1993, MAPMAKER/QTL User's Manual, Whitehead Institute for Biomedical Research, Cambridge, Mass.).

The OFPM trait was served as a quantitative trait in a QTL analysis using the program QTL Cartographer. Basten et al., 1999, QTL Cartographer User's Manual, Department of Statistics, North Carolina State University, Raleigh. OFPM had a total of four QTL with LOD scores over 2.0 located on chromosomes 1 at 95 cM, 6 at 43 cM, 9 at 8 cM, and 19 at 28 cM, with LOD scores 2.10, 2.84, 2.53, and 1.92, respectively.

Step 706.

Expression profiling was carried out on the extracted liver tissues from the F₂ population as described by Schadt et al., 2003, Nature 422:297 using a standard 23,000 plus gene microarray manufactured by Agilent Technologies. In particular, array images were scanned using the Agilent Dual Laser Microarray scanner (Agilent Technologies) and processed as described in Hughes, 2000, Cell 102:109, to obtain background noise, single-channel intensity and associated measurement error estimates. The mouse microarray contained 23,574 non-control oligonucleotide probes for mouse genes as described in Schadt et al., 2003, Nature 422:297-302. The hybridization protocol for the microarray data and the subsequent lower-level microarray analysis was carried out as described in Schadt et al., 2003, Nature 422:297-302. The single trait QTL analysis for the gene expression and OFPM trait described in this example was also carried out as described in Schadt et al., 2003, Nature 422:297-302. The multiple interval mapping described in this example was carried out using the MImapqtl program, Zeng et al., 1999, Genet. Res. 74:279-289.

Step 708.

In step 708, the cellular constituents whose abundance levels across the population significantly associate with the trait of interest were identified using the Pearson correlation coefficients between the OFPM trait and the genes that were significantly differentially expressed in at least ten percent of the samples profiled. Of the transcripts that were significantly differentially expressed in at least 10% of the samples, 438 of these transcripts had Pearson correlation coefficient p-values less than 0.001 (fewer than 5 would be expected by chance). This set of 438 transcripts was selected as the association set D for the OFPM trait. This set of genes represents targets for an obesity (or related disease) drug discovery program. This set of genes is provided in Table 4, below. Of these, those genes that include a druggable binding domain are preferred. In Table 4, column 1 gives the accession number for the gene, column 2 gives the p-value for the strength of correlation between OFPM and the gene expression trait, column 3 gives the official symbol associated with the gene (may be null), column 4 gives the official gene name (may be null), and the final column is non-null if a druggable domain was identified in the coding part of the gene, in which case the name of the druggable domain is indicated.

TABLE 4
Genes associated with the OFPM trait.

| Accession | Association Set | Official | | Druggable |
|---|---|---|---|---|
| Number | P-value | Symbol | Official Gene Name | Domain |
| AA986766 | 6.21E−05 | AA986766 | expressed sequence | |
| | | | AA986766 | |
| AB026997 | 4.61E−08 | Cast | calpastatin | |
| AB031959 | 1.15E−06 | Slc21a10 | solute carrier family 21 | |
| | | | (organic anion | |
| | | | transporter), member 10 | |
| AB041554 | 3.40E−06 | 1700041K21Rik | RIKEN cDNA | |
| | | | 1700041K21 gene | |
| AB041561 | 6.48E−05 | Gfer | growth factor, erv1 (S. cerevisiae)- | |
| | | | like | |
| | | | (augmenter of liver | |
| | | | regeneration) | |
| AB045323 | 1.63E−07 | D8Ertd594e | DNA segment, Chr 8, | |
| | | | ERATO Doi 594, | |
| | | | expressed | |
| AF047725 | 0.000215284 | Cyp2c38 | cytochrome P450, family | Cytochrome |
| | | | 2, subfamily c, | P450 |
| | | | polypeptide 38 | |
| AF085220 | 3.43E−06 | 4930414C22Rik | RIKEN cDNA | |
| | | | 4930414C22 gene | |
| AF135494 | 7.91E−05 | Birc1f | baculoviral IAP repeat- | |
| | | | containing 1f | |
| AF149291 | 7.56E−05 | Tagln2 | transgelin 2 | |
| AF163315 | 1.25E−05 | Cml2 | camello-like 2 | |
| AF168680 | 2.36E−05 | Crim1 | cysteine-rich motor | |
| | | | neuron 1 | |
| AF188613 | 1.10E−06 | Prss8 | protease, serine, 8 | Serine |
| | | | (prostasin) | protease, |
| | | | | trypsin |
| | | | | family |
| AF225910 | 2.87E−07 | Dazap1 | DAZ associated protein 1 | |
| AF231406 | 1.61E−05 | Ly6i | lymphocyte antigen 6 | |
| | | | complex, locus I | |
| AF240002 | 3.34E−05 | Slc25a4 | solute carrier family 25 | Adenine |
| | | | (mitochondrial carrier; | nucleotide |
| | | | adenine nucleotide | translocator 1 |
| | | | translocator), member 4 | |
| AF277718 | 2.45E−06 | AI195443 | expressed sequence | |
| | | | AI195443 | |
| AF296075 | 2.41E−05 | Wdr10 | WD repeat domain 10 | |
| AF297860 | 5.71E−06 | Aldh6a1 | aldehyde dehydrogenase | Aldehyde |
| | | | family 6, subfamily A1 | dehydrogenase |
| AI196437 | 1.31E−06 | | | |
| AI255955 | 1.48E−06 | | | |
| AI266962 | 3.37E−05 | | | |
| AI326203 | 2.17E−07 | | | |
| AI449163 | 0.000283344 | | | |
| AI461749 | 3.29E−06 | | | |
| AI503986 | 0.000143195 | | | |
| AI506234 | 1.94E−07 | | | |
| AI663818 | 2.77E−06 | AI663818 | expressed sequence | |
| | | | AI663818 | |
| AI746547 | 7.04E−06 | | | |
| AI874739 | 2.10E−05 | | | |
| AI875925 | 1.14E−06 | | | Cytochrome |
| | | | | P450 |
| AJ001379 | 5.50E−05 | Tspy-ps | testis specific protein-Y | |
| | | | encoded, pseudogene | |
| AK002247 | 4.33E−05 | 0610006H10Rik | RIKEN cDNA | |
| | | | 0610006H10 gene | |
| AK002251 | 0.00015 | Cd9 | CD9 antigen | |
| AK002327 | 6.47E−07 | 2310075M17Rik | RIKEN cDNA | |
| | | | 2310075M17 gene | |
| AK002535 | 6.50E−05 | 0610011F06Rik | RIKEN cDNA | |
| | | | 0610011F06 gene | |
| AK002545 | 1.75E−06 | Ifi1 | interferon inducible | |
| | | | protein 1 | |
| AK002549 | 1.85E−05 | Dio1 | deiodinase, | Iodothyronine |
| | | | iodothyronine, type I | deiodinase |
| AK002636 | 6.14E−06 | | | |
| AK002639 | 4.25E−07 | 0610016J10Rik | RIKEN cDNA | |
| | | | 0610016J10 gene | |
| AK002641 | 4.93E−05 | 0610016O18Rik | RIKEN cDNA | |
| | | | 0610016O18 gene | |
| AK002691 | 7.97E−06 | Dhrs4 | dehydrogenase/reductase | Short-chain |
| | | | (SDR family) member 4 | dehydrogenase/ |
| | | | | reductase |
| | | | | SDR |
| AK002705 | 8.17E−12 | Akr1b7 | aldo-keto reductase | Aldo/keto |
| | | | family 1, member B7 | reductase |
| AK002723 | 9.97E−07 | 0610031G08Rik | RIKEN cDNA | |
| | | | 0610031G08 gene | |
| AK002736 | 2.60E−05 | 0610033E06Rik | RIKEN cDNA | |
| | | | 0610033E06 gene | |
| AK002772 | 2.51E−05 | 1500036F01Rik | RIKEN cDNA | |
| | | | 1500036F01 gene | |
| AK002859 | 2.58E−05 | Aspa | aspartoacylase | |
| | | | (aminoacylase) 2 | |
| AK003112 | 2.76E−05 | Sepr | selenoprotein R | |
| AK003140 | 4.30E−05 | 1010001P06Rik | RIKEN cDNA | |
| | | | 1010001P06 gene | |
| AK003165 | 8.46E−07 | G0s2 | G0/G1 switch gene 2 | |
| AK003256 | 8.53E−06 | 1110001N06Rik | RIKEN cDNA | |
| | | | 1110001N06 gene | |
| AK003278 | 3.20E−07 | D11Ertd18e | DNA segment, Chr 11, | |
| | | | ERATO Doi 18, | |
| | | | expressed | |
| AK003375 | 2.00E−06 | Ly6g6c | lymphocyte antigen 6 | |
| | | | complex, locus G6C | |
| AK003394 | 7.98E−05 | 1110003P13Rik | RIKEN cDNA | |
| | | | 1110003P13 gene | |
| AK003554 | 4.99E−09 | D14Ertd449e | DNA segment, Chr 14, | |
| | | | ERATO Doi 449, | |
| | | | expressed | |
| AK003567 | 3.56E−07 | 1110008E19Rik | RIKEN cDNA | |
| | | | 1110008E19 gene | |
| AK003597 | 0.000144718 | 1110008P08Rik | RIKEN cDNA | |
| | | | 1110008P08 gene | |
| AK003665 | 5.99E−06 | D12Ertd647e | DNA segment, Chr 12, | |
| | | | ERATO Doi 647, | |
| | | | expressed | |
| AK003671 | 3.74E−11 | Car3 | carbonic anhydrase 3 | Carbonic |
| | | | | anhydrase, |
| | | | | eukaryotic |
| AK003708 | 6.73E−05 | 2310075G12Rik | RIKEN cDNA | |
| | | | 2310075G12 gene | |
| AK003768 | 9.91E−08 | 1110018D06Rik | RIKEN cDNA | |
| | | | 1110018D06 gene | |
| AK003861 | 4.92E−06 | Tgfbr2 | transforming growth | Serine/Threonine |
| | | | factor, beta receptor II | protein |
| | | | | kinase |
| AK003861 | 4.92E−06 | Tgfbr2 | transforming growth | Tyrosine |
| | | | factor, beta receptor II | protein |
| | | | | kinase |
| AK003892 | 1.34E−06 | Dnajc8 | DnaJ (Hsp40) homolog, | |
| | | | subfamily C, member 8 | |
| AK003996 | 1.04E−06 | 1110030O19Rik | RIKEN cDNA | Serine |
| | | | 1110030O19 gene | protease, |
| | | | | trypsin |
| | | | | family |
| AK004285 | 3.53E−07 | 1110057K04Rik | RIKEN cDNA | |
| | | | 1110057K04 gene | |
| AK004307 | 4.62E−05 | Grhpr | glyoxylate | |
| | | | reductase/hydroxypyruvate | |
| | | | reductase | |
| AK004338 | 5.72E−05 | 4930555L11Rik | RIKEN cDNA | |
| | | | 4930555L11 gene | |
| AK004544 | 1.79E−05 | Fbxo3 | F-box only protein 3 | |
| AK004546 | 7.08E−05 | G1-pending | grey lethal osteroperosis | |
| AK004550 | 0.000548243 | Tere1- | transitional epithelia | |
| | | pending | response protein | |
| AK004567 | 9.34E−06 | Crot | carnitine O- | Acyltransferase |
| | | | octanoyltransferase | ChoActase/ |
| | | | | COT/CPT |
| AK004623 | 5.32E−08 | Catna1 | catenin alpha 1 | |
| AK004724 | 2.50E−05 | Cyp4v3 | cytochrome P450, family | Serine |
| | | | 4, subfamily v, | protease, |
| | | | polypeptide 3 | trypsin |
| | | | | family |
| AK004743 | 1.80E−05 | Myolc | myosin IC | |
| AK004847 | 4.40E−06 | 1300002C13Rik | RIKEN cDNA | |
| | | | 1300002C13 gene | |
| AK004865 | 1.78E−06 | Hmgcs2 | 3-hydroxy-3- | Hydroxymethylglutaryl- |
| | | | methylglutaryl- | coenzyme |
| | | | Coenzyme A synthase 2 | A synthase |
| AK004889 | 2.28E−06 | Acadsb | acyl-Coenzyme A | |
| | | | dehydrogenase, | |
| | | | short/branched chain | |
| AK004924 | 5.84E−06 | Nudt7 | nudix (nucleoside | |
| | | | diphosphate linked | |
| | | | moiety X)-type motif 7 | |
| AK004933 | 9.43E−06 | 1300007K12Rik | RIKEN cDNA | Cytochrome |
| | | | 1300007K12 gene | P450 |
| AK004942 | 0.000146733 | Gpx3 | glutathione peroxidase 3 | |
| AK004971 | 1.02E−06 | 1300012D20Rik | RIKEN cDNA | |
| | | | 1300012D20 gene | |
| AK004980 | 2.61E−05 | Mod1 | malic enzyme, | |
| | | | supernatant | |
| AK004984 | 1.18E−06 | 1300013D18Rik | RIKEN cDNA | Cytochrome |
| | | | 1300013D18 gene | P450 |
| AK004987 | 0.000113144 | Mkks | McKusick-Kaufman | |
| | | | syndrome protein | |
| AK005141 | 1.19E−05 | 1500004A08Rik | RIKEN cDNA | |
| | | | 1500004A08 gene | |
| AK005157 | 0.000132248 | 5730403B10Rik | RIKEN cDNA | |
| | | | 5730403B10 gene | |
| AK005166 | 1.06E−05 | 1500005N04Rik | RIKEN cDNA | |
| | | | 1500005N04 gene | |
| AK0O05191 | 2.46E−06 | Hist1h2bc | histone 1, H2bc | |
| AK005210 | 2.55E−05 | Pla2g7 | phospholipase A2, group | |
| | | | VII (platelet-activating | |
| | | | factor acetylhydrolase, | |
| | | | plasma) | |
| AK005314 | 3.16E−05 | Rab4b | RAB4B, member RAS | |
| | | | oncogene family | |
| AK005641 | 1.37E−06 | 1700003H21Rik | RIKEN cDNA | |
| | | | 1700003H21 gene | |
| AK005804 | 5.60E−06 | 1700009P17Rik | RIKEN cDNA | |
| | | | 1700009P17 gene | |
| AK005950 | 0.000212334 | 1700013G20Rik | RIKEN cDNA | |
| | | | 1700013G20 gene | |
| AK005962 | 1.65E−05 | 1700013L23Rik | RIKEN cDNA | |
| | | | 1700013L23 gene | |
| AK006159 | 1.09E−07 | 1700020G04Rik | RIKEN cDNA | |
| | | | 1700020G04 gene | |
| AK006419 | 2.26E−07 | | | |
| AK006803 | 2.28E−07 | 1700055N04Rik | RIKEN cDNA | Aldehyde |
| | | | 1700055N04 gene | dehydrogenase |
| AK006906 | 4.96E−06 | 1700066M21Rik | RIKEN cDNA | |
| | | | 1700066M21 gene | |
| AK006955 | 0.000141838 | 1700080G11Rik | RIKEN cDNA | |
| | | | 1700080G11 gene | |
| AK007026 | 2.30E−06 | 1700087I21Rik | RIKEN cDNA | |
| | | | 1700087I21 gene | |
| AK007038 | 1.37E−05 | 1700092C10Rik | RIKEN cDNA | |
| | | | 1700092C10 gene | |
| AK007299 | 1.81E−08 | 1700015L13Rik | RIKEN cDNA | |
| | | | 1700015L13 gene | |
| AK007384 | 3.83E−08 | Sult1c1 | sulfotransferase family, | |
| | | | cytosolic, 1C, member 1 | |
| AK007458 | 2.30E−05 | Snap25bp | synaptosomal-associated | |
| | | | protein 25 binding | |
| | | | protein | |
| AK007574 | 2.17E−05 | Fgf21 | fibroblast growth factor | |
| | | | 21 | |
| AK007617 | 3.30E−06 | 1810027I20Rik | RIKEN cDNA | |
| | | | 1810027I20 gene | |
| AK007644 | 2.62E−05 | Dexi | dexamethasone-induced | |
| | | | transcript | |
| AK007681 | 1.72E−05 | Mrpl39 | mitochondrial ribosomal | |
| | | | protein L39 | |
| AK007707 | 9.42E−08 | 1810036I24Rik | RIKEN cDNA | |
| | | | 1810036I24 gene | |
| AK007857 | 2.77E−09 | Sdro- | orphan short chain | Short-chain |
| | | pending | dehydrogenase/reductase | dehydrogenase/ |
| | | | | reductase |
| | | | | SDR |
| AK007895 | 3.92E−05 | 1810058I24Rik | RIKEN cDNA | |
| | | | 1810058I24 gene | |
| AK007964 | 2.07E−05 | Chpt1 | choline | |
| | | | phosphotransferase 1 | |
| AK008035 | 1.38E−05 | 2010002E04Rik | RIKEN cDNA | |
| | | | 2010002E04 gene | |
| AK008127 | 1.59E−07 | Stat1 | signal transducer and | |
| | | | activator of transcription 1 | |
| AK008788 | 3.63E−06 | Ndufab1 | NADH dehydrogenase | |
| | | | (ubiquinone) 1, | |
| | | | alpha/beta subcomplex, 1 | |
| AK008852 | 1.36E−05 | 2210408E11Rik | RIKEN cDNA | |
| | | | 2210408E11 gene | |
| AK008884 | 3.14E−07 | 2210410E06Rik | RIKEN cDNA | |
| | | | 2210410E06 gene | |
| AK008976 | 0.000754307 | N4wbp4- | Nedd4 WW binding | |
| | | pending | protein 4 | |
| AK009034 | 4.80E−05 | 2300006M17Rik | RIKEN cDNA | |
| | | | 2300006M17 gene | |
| AK009137 | 4.66E−06 | 2310032D16Rik | RIKEN cDNA | |
| | | | 2310032D16 gene | |
| AK009249 | 5.49E−05 | 2310009E04Rik | RIKEN cDNA | |
| | | | 2310009E04 gene | |
| AK009269 | 4.25E−05 | 2310010G13Rik | RIKEN cDNA | |
| | | | 2310010G13 gene | |
| AK009321 | 7.24E−06 | Map3k7ip1 | mitogen-activated protein | |
| | | | kinase kinase kinase 7 | |
| | | | interacting protein 1 | |
| AK009450 | 0.000139828 | 2310021M12Rik | RIKEN cDNA | |
| | | | 2310021M12 gene | |
| AK009517 | 4.50E−05 | 2310026P19Rik | RIKEN cDNA | |
| | | | 2310026P19 gene | |
| AK009550 | 1.88E−05 | 2310031A18Rik | RIKEN cDNA | |
| | | | 2310031A18 gene | |
| AK009563 | 5.57E−06 | 2310032D16Rik | RIKEN cDNA | |
| | | | 2310032D16 gene | |
| AK009569 | 2.77E−05 | no_official_symbol | no_official_gene_name | |
| AK009622 | 4.04E−06 | 2310034O05Rik | RIKEN cDNA | |
| | | | 2310034O05 gene | |
| AK009685 | 0.000205788 | 2310038P10Rik | RIKEN cDNA | |
| | | | 2310038P10 gene | |
| AK009753 | 2.51E−05 | 2310042I22Rik | RIKEN cDNA | |
| | | | 2310042I22 gene | |
| AK009768 | 3.04E−05 | DXImx50e | DNA segment, Chr X, | |
| | | | Immunex 50, expressed | |
| AK009815 | 3.58E−05 | Gbe1 | glucan (1,4-alpha-), | |
| | | | branching enzyme 1 | |
| AK009821 | 7.45E−05 | 2810037C14Rik | RIKEN cDNA | |
| | | | 2810037C14 gene | |
| AK009885 | 3.33E−05 | Glcci1 | glucocorticoid induced | |
| | | | transcript 1 | |
| AK009957 | 6.81E−05 | 2310057G13Rik | RIKEN cDNA | |
| | | | 2310057G13 gene | |
| AK009964 | 0.00012628 | 2310057K14Rik | RIKEN cDNA | |
| | | | 2310057K14 gene | |
| AK010328 | 1.24E−06 | Ndufaf1 | NADH dehydrogenase | |
| | | | (ubiquinone) 1 alpha | |
| | | | subcomplex, assembly | |
| | | | factor 1 | |
| AK010477 | 3.59E−06 | 2410012M21Rik | RIKEN cDNA | |
| | | | 2410012M21 gene | |
| AK010677 | 2.00E−06 | Atp1b1 | ATPase, Na+/K+ | |
| | | | transporting, beta 1 | |
| | | | polypeptide | |
| AK010892 | 1.70E−06 | 2610034N03Rik | RIKEN cDNA | |
| | | | 2610034N03 gene | |
| AK011143 | 2.29E−08 | Hnrpdl | heterogeneous nuclear | |
| | | | ribonucleoprotein D-like | |
| AK011417 | 3.84E−05 | Pov1 | prostate cancer | |
| | | | overexpressed gene 1 | |
| AK011679 | 6.50E−08 | 2610034P21Rik | RIKEN cDNA | |
| | | | 2610034P21 gene | |
| AK011847 | 8.72E−06 | Rufy2 | RUN and FYVE domain- | |
| | | | containing 2 | |
| AK011867 | 4.80E−07 | 2610203E10Rik | RIKEN cDNA | |
| | | | 2610203E10 gene | |
| AK011994 | 5.65E−06 | D5Ertd249e | DNA segment, Chr 5, | |
| | | | ERATO Doi 249, | |
| | | | expressed | |
| AK012103 | 1.23E−05 | Hsd17b12 | hydroxysteroid (17-beta) | Short-chain |
| | | | dehydrogenase 12 | dehydrogenase/ |
| | | | | reductase |
| | | | | SDR |
| AK012120 | 6.05E−05 | 4833420E20Rik | RIKEN cDNA | |
| | | | 4833420E20 gene | |
| AK012162 | 8.89E−08 | Akr1c20 | aldo-keto reductase | Aldo/keto |
| | | | family 1, member C20 | reductase |
| AK012352 | 5.93E−05 | Nxn | nucleoredoxin | |
| AK012404 | 9.55E−05 | Bid | BH3 interacting domain | |
| | | | death agonist | |
| AK012685 | 2.94E−07 | 2810007J24Rik | RIKEN cDNA | |
| | | | 2810007J24 gene | |
| AK012725 | 0.000159 | 2810012G08Rik | RIKEN cDNA | Serine/Threonine |
| | | | 2810012G08 gene | protein |
| | | | | kinase |
| AK012941 | 2.83E−10 | 2810051A14Rik | RIKEN cDNA | |
| | | | 2810051A14 gene | |
| AK012954 | 3.64E−06 | 2810055F11Rik | RIKEN cDNA | |
| | | | 2810055F11 gene | |
| AK012958 | 7.64E−06 | 2810401C16Rik | RIKEN cDNA | FAD- |
| | | | 2810401C16 gene | dependent |
| | | | | pyridine |
| | | | | nucleotide- |
| | | | | disulphide |
| | | | | oxidoreductase |
| AK013507 | 1.45E−07 | 2900009J20Rik | RIKEN cDNA | |
| | | | 2900009J20 gene | |
| AK013715 | 3.72E−06 | 2900057D21Rik | RIKEN cDNA | |
| | | | 2900057D21 gene | |
| AK013979 | 2.18E−05 | 2400010D15Rik | RIKEN cDNA | |
| | | | 2400010D15 gene | |
| AK013995 | 0.000230933 | 3110004O18Rik | RIKEN cDNA | Insulinase- |
| | | | 3110004O18 gene | like |
| | | | | peptidase, |
| | | | | family M16 |
| AK014100 | 6.20E−05 | 2310016E22Rik | RIKEN cDNA | Short-chain |
| | | | 2310016E22 gene | dehydrogenase/ |
| | | | | reductase |
| | | | | SDR |
| AK014203 | 1.93E−08 | 3110052D19Rik | RIKEN cDNA | |
| | | | 3110052D19 gene | |
| AK014252 | 1.49E−07 | 3110073H01Rik | RIKEN cDNA | |
| | | | 3110073H01 gene | |
| AK014254 | 0.000175533 | Rnf11 | ring finger protein 11 | |
| AK014514 | 9.16E−10 | 4631408O11Rik | RIKEN cDNA | |
| | | | 4631408O11 gene | |
| AK014728 | 5.17E−05 | Arhgap18 | Rho GTPase activating | |
| | | | protein 18 | |
| AK015100 | 2.30E−08 | 4930405M20Rik | RIKEN cDNA | |
| | | | 4930405M20 gene | |
| AK015544 | 6.44E−06 | 4930471A21Rik | RIKEN cDNA | |
| | | | 4930471A21 gene | |
| AK016221 | 3.20E−06 | Ppid | peptidylprolyl isomerase | |
| | | | D (cyclophilin D) | |
| AK016470 | 1.50E−06 | D6Wsu176e | DNA segment, Chr 6, | |
| | | | Wayne State University | |
| | | | 176, expressed | |
| AK016624 | 1.44E−05 | 4933402L21Rik | RIKEN cDNA | |
| | | | 4933402L21 gene | |
| AK017049 | 1.04E−07 | 4933433P14Rik | RIKEN cDNA | |
| | | | 4933433P14 gene | |
| AK017144 | 7.51E−08 | 5031434O11Rik | RIKEN cDNA | |
| | | | 5031434O11 gene | |
| AK017436 | 1.40E−05 | 5530401J07Rik | RIKEN cDNA | |
| | | | 5530401J07 gene | |
| AK017457 | 4.01E−06 | 5530600P05Rik | RIKEN cDNA | |
| | | | 5530600P05 gene | |
| AK017491 | 0.000247529 | Mipep | mitochondrial | |
| | | | intermediate peptidase | |
| AK017818 | 7.63E−05 | D4Ertd174e | DNA segment, Chr 4, | |
| | | | ERATO Doi 174, | |
| | | | expressed | |
| AK017974 | 6.55E−05 | Tfam | transcription factor A, | |
| | | | mitochondrial | |
| AK018146 | 4.44E−09 | Miz1 | Msx-interacting-zinc | |
| | | | finger | |
| AK018242 | 2.51E−06 | Abca6 | ATP-binding cassette, | |
| | | | sub-family A (ABC1), | |
| | | | member 6 | |
| AK018280 | 2.55E−07 | Cyfip2 | cytoplasmic FMR1 | |
| | | | interacting protein 2 | |
| AK018294 | 3.38E−06 | 6430701C03Rik | RIKEN cDNA | G-protein |
| | | | 6430701C03 gene | coupled |
| | | | | receptors |
| | | | | family 3 |
| | | | | (Metabotropic |
| | | | | glutamate |
| | | | | receptor- |
| | | | | like) |
| AK018544 | 9.57E−05 | Stat1 | signal transducer and | |
| | | | activator of transcription 1 | |
| AK018584 | 3.13E−06 | 9130001M19Rik | RIKEN cDNA | |
| | | | 9130001M19 gene | |
| AK018631 | 2.45E−07 | 9130016M20Rik | RIKEN cDNA | |
| | | | 9130016M20 gene | |
| AK018666 | 2.60E−05 | Crim1 | cysteine-rich motor | |
| | | | neuron 1 | |
| AK018684 | 3.13E−07 | Hao3 | hydroxyacid oxidase | |
| | | | (glycolate oxidase) 3 | |
| AK018691 | 1.44E−05 | 9130427A09Rik | RIKEN cDNA | |
| | | | 9130427A09 gene | |
| AK018739 | 6.18E−05 | 0610011B16Rik | RIKEN cDNA | |
| | | | 0610011B16 gene | |
| AK018744 | 7.88E−05 | Grn | granulin | |
| AK018755 | 5.60E−06 | Zdhhc3 | zinc finger, DHHC | |
| | | | domain containing 3 | |
| AK019190 | 4.72E−05 | 2610510H03Rik | RIKEN cDNA | |
| | | | 2610510H03 gene | |
| AK019381 | 7.75E−05 | Pxmp4 | peroxisomal membrane | |
| | | | protein 4 | |
| AK019969 | 1.07E−06 | 5730504C04Rik | RIKEN cDNA | |
| | | | 5730504C04 gene | |
| AK020032 | 5.52E−07 | 5930416L09Rik | RIKEN cDNA | |
| | | | 5930416L09 gene | |
| AK020147 | 1.40E−07 | Gemin6 | gem (nuclear organelle) | |
| | | | associated protein 6 | |
| AK020256 | 5.18E−05 | 9030616G12Rik | RIKEN cDNA | |
| | | | 9030616G12 gene | |
| AK020335 | 5.18E−05 | 9230111I22Rik | RIKEN cDNA | |
| | | | 9230111I22 gene | |
| AK020362 | 3.38E−05 | | | |
| AK020564 | 0.000540367 | 9530019N15Rik | RIKEN cDNA | |
| | | | 9530019N15 gene | |
| AK020578 | 4.17E−05 | 9530027K23Rik | RIKEN cDNA | |
| | | | 9530027K23 gene | |
| AK020912 | 2.54E−05 | A930031F18Rik | RIKEN cDNA | |
| | | | A930031F18 gene | |
| AV115349 | 1.64E−06 | | | Oxidoreductase |
| | | | | FAD/NAD |
| | | | | (P)-binding |
| AV278128 | 3.04E−08 | | | |
| AV302058 | 2.37E−05 | | | |
| AV346241 | 6.81E−06 | | | |
| AW208668 | 1.17E−06 | | | |
| AW489251 | 2.03E−05 | | | |
| AW494458 | 5.63E−09 | | | |
| AY027436 | 0.000203727 | Copeb | core promoter element | |
| | | | binding protein | |
| BB219550 | 0.000142304 | | | |
| BC002131 | 2.39E−06 | Arl2bp | ADP-ribosylation-like 2 | |
| | | | binding protein | |
| BC003794 | 7.29E−08 | Stip1 | stress-induced | |
| | | | phosphoprotein 1 | |
| BC003808 | 2.28E−06 | | | |
| BC003843 | 1.01E−05 | 3110002K08Rik | RIKEN cDNA | |
| | | | 3110002K08 gene | |
| BC003914 | 7.57E−06 | 6430402H10Rik | RIKEN cDNA | |
| | | | 6430402H10 gene | |
| BC003945 | 6.04E−06 | BC003945 | cDNA sequence | |
| | | | BC003945 | |
| BC004749 | 0.000119692 | Hagh | hydroxyacyl glutathione | |
| | | | hydrolase | |
| BC005580 | 5.26E−05 | Polr2g | polymerase (RNA) II | |
| | | | (DNA directed) | |
| | | | polypeptide G | |
| BC005709 | 4.23E−05 | Pet112l | PET112-like (yeast) | |
| BE851910 | 4.62E−05 | | | |
| BF322562 | 7.74E−06 | | | |
| BF682171 | 1.07E−06 | | | |
| D11441 | 2.39E−05 | Mbl1 | mannose binding lectin, | |
| | | | liver (A) | |
| L11333 | 3.58E−06 | Es31 | esterase 31 | Carboxylesterase, |
| | | | | type B |
| L27439 | 5.65E−06 | Pros1 | protein S (alpha) | |
| L31783 | 1.66E−10 | Umpk | uridine monophosphate | |
| | | | kinase | |
| L41631 | 1.07E−05 | Gck | glucokinase | |
| M11310 | 2.02E−14 | Aprt | adenine phosphoribosyltransferase | Phosphoribosyltransferase |
| M16360 | 5.36E−05 | Mup5 | major urinary protein 5 | |
| NM_007382 | 5.96E−05 | Acadm | acetyl-Coenzyme A | |
| | | | dehydrogenase, medium | |
| | | | chain | |
| NM_007437 | 3.32E−08 | Aldh3a2 | aldehyde dehydrogenase | |
| | | | family 3, subfamily A2 | |
| NM_007471 | 1.90E−05 | App | amyloid beta (A4) | |
| | | | precursor protein | |
| NM_007700 | 5.85E−06 | Chuk | conserved helix-loop- | Serine/Threonine |
| | | | helix ubiquitous kinase | protein |
| | | | | kinase |
| NM_007700 | 5.85E−06 | Chuk | conserved helix-loop- | Tyrosine |
| | | | helix ubiquitous kinase | protein |
| | | | | kinase |
| NM_007705 | 6.07E−06 | Cirbp | cold inducible RNA | |
| | | | binding protein | |
| NM_007754 | 5.23E−05 | Cpd | carboxypeptidase D | Zinc |
| | | | | carboxypeptidase A |
| | | | | metalloprotease |
| | | | | (M14) |
| NM_007757 | 8.73E−05 | Cpo | coproporphyrinogen | |
| | | | oxidase | |
| NM_007799 | 1.68E−07 | Ctse | cathepsin E | |
| NM_007813 | 2.01E−06 | Cyp2b13 | cytochrome P450, family | Cytochrome |
| | | | 2, subfamily b, | P450 |
| | | | polypeptide 13 | |
| NM_007815 | 0.001277741 | Cyp2c29 | cytochrome P450, family | Cytochrome |
| | | | 2, subfamily c, | P450 |
| | | | polypeptide 29 | |
| NM_007817 | 0.000206 | Cyp2f2 | cytochrome P450, family | Cytochrome |
| | | | 2, subfamily f, | P450 |
| | | | polypeptide 2 | |
| NM_007825 | 0.000136498 | Cyp7b1 | cytochrome P450, family | Cytochrome |
| | | | 7, subfamily b, | P450 |
| | | | polypeptide 1 | |
| NM_007898 | 3.31E−05 | Ebp | phenylalkylamine Ca2+ | |
| | | | antagonist (emopamil) | |
| | | | binding protein | |
| NM_007934 | 0.000138527 | Enpep | glutamyl aminopeptidase | |
| NM_007980 | 4.18E−05 | Fabp2 | fatty acid binding protein | |
| | | | 2, intestinal | |
| NM_007987 | 2.71E−06 | Tnfrsf6 | tumor necrosis factor | |
| | | | receptor superfamily, | |
| | | | member 6 | |
| NM_007992 | 8.17E−05 | Fbln2 | fibulin 2 | |
| NM_008046 | 7.30E−05 | Fst | follistatin | |
| NM_008163 | 7.35E−05 | Grb2 | growth factor receptor | |
| | | | bound protein 2 | |
| NM_008194 | 2.53E−07 | Gyk | glycerol kinase | |
| NM_008254 | 0.000303408 | Hmgcl | 3-hydroxy-3- | |
| | | | methylglutaryl- | |
| | | | Coenzyme A lyase | |
| NM_008288 | 7.03E−06 | Hsd11b1 | hydroxysteroid 11-beta | Short-chain |
| | | | dehydrogenase 1 | dehydrogenase/ |
| | | | | reductase |
| | | | | SDR |
| NM_008298 | 6.78E−05 | Dnaja1 | DnaJ (Hsp40) homolog, | |
| | | | subfamily A, member 1 | |
| NM_008341 | 0.00025355 | Igfbp1 | insulin-like growth factor | |
| | | | binding protein 1 | |
| NM_008382 | 4.76E−07 | Inhbe | inhibin beta E | |
| NM_008490 | 4.53E−05 | Lcat | lecithin cholesterol | |
| | | | acyltransferase | |
| NM_008508 | 1.32E−06 | Lor | loricrin | |
| NM_008509 | 3.46E−06 | Lpl | lipoprotein lipase | Lipase |
| NM_008594 | 5.86E−05 | Mfge8 | milk fat globule-EGF | |
| | | | factor 8 protein | |
| NM_008599 | 8.13E−06 | Cxcl9 | chemokine (C—X—C | |
| | | | motif) ligand 9 | |
| NM_008648 | 5.29E−05 | Mup4 | major urinary protein 4 | |
| NM_008673 | 0.000190592 | Nat1 | N-acetyltransferase 1 | |
| | | | (arylamine N- | |
| | | | acetyltransferase) | |
| NM_008769 | 8.39E−06 | Otc | ornithine | |
| | | | transcarbamylase | |
| NM_008889 | 1.56E−07 | Ppp1r14b | protein phosphatase 1, | |
| | | | regulatory (inhibitor) | |
| | | | subunit 14B | |
| NM_008898 | 3.64E−07 | Por | P450 (cytochrome) | Oxidoreductase |
| | | | oxidoreductase | FAD/NAD |
| | | | | (P)-binding |
| NM_008904 | 2.44E−05 | Ppargc1 | peroxisome proliferative | |
| | | | activated receptor, | |
| | | | gamma, coactivator 1 | |
| NM_008916 | 8.87E−06 | Pps | putative phosphatase | Inositol |
| | | | | polyphosphate |
| | | | | related |
| | | | | phosphatase |
| | | | | family |
| NM_008961 | 4.46E−05 | Pter | phosphotriesterase | |
| | | | related | |
| NM_009041 | 2.09E−06 | Rdx | radixin | |
| NM_009052 | 4.46E−05 | Rex3 | reduced expression 3 | |
| NM_009060 | 6.82E−07 | Rgn | regucalcin | |
| NM_009175 | 6.57E−06 | | | |
| NM_009191 | 3.47E−05 | Skd3 | suppressor of K+ | |
| | | | transport defect 3 | |
| NM_009198 | 5.74E−07 | Slc17a1 | solute carrier family 17 | |
| | | | (sodium phosphate), | |
| | | | member 1 | |
| NM_009202 | 1.65E−07 | Slc22a1 | solute carrier family 22 | |
| | | | (organic cation | |
| | | | transporter), member 1 | |
| NM_009320 | 2.41E−06 | Slc6a6 | solute carrier family 6 | Sodium:neurotransmitter |
| | | | (neurotransmitter | symporter |
| | | | transporter, taurine), | |
| | | | member 6 | |
| NM_009364 | 1.59E−08 | Tfpi2 | tissue factor pathway | |
| | | | inhibitor 2 | |
| NM_009467 | 8.93E−06 | Ugt2b5 | UDP- | |
| | | | glucuronosyltransferase 2 | |
| | | | family, member 5 | |
| NM_009513 | 3.92E−06 | Vmp | vesicular membrain | |
| | | | protein p24 | |
| NM_009521 | 2.33E−06 | Wnt3 | wingless-related MMTV | |
| | | | integration site 3 | |
| NM_009648 | 1.35E−05 | Akap1 | A kinase (PRKA) anchor | |
| | | | protein 1 | |
| NM_009779 | 7.83E−05 | C3ar1 | complement component | Rhodopsin- |
| | | | 3a receptor 1 | like GPCR |
| | | | | superfamily |
| NM_009799 | 2.29E−08 | Car1 | carbonic anhydrase 1 | Carbonic |
| | | | | anhydrase, |
| | | | | eukaryotic |
| NM_009833 | 4.74E−05 | Ccnt1 | cyclin T1 | |
| NM_009845 | 4.23E−05 | Cd22 | CD22 antigen | |
| NM_009864 | 9.33E−06 | Cdh1 | cadherin 1 | |
| NM_009949 | 0.00010919 | Cpt2 | carnitine | Acyltransferase |
| | | | palmitoyltransferase 2 | ChoActase/ |
| | | | | COT/CPT |
| NM_009953 | 9.68E−05 | Crhr2 | corticotropin releasing | G-protein |
| | | | hormone receptor 2 | coupled |
| | | | | receptors |
| | | | | family 2 |
| | | | | (secretin- |
| | | | | like) |
| NM_009983 | 0.000606 | Ctsd | cathepsin D | |
| NM_010000 | 2.64E−05 | Cyp2b9 | cytochrome P450, family | Cytochrome |
| | | | 2, subfamily b, | P450 |
| | | | polypeptide 9 | |
| NM_010007 | 1.85E−06 | Cyp2j5 | cytochrome P450, family | Cytochrome |
| | | | 2, subfamily j, | P450 |
| | | | polypeptide 5 | |
| NM_010023 | 1.53E−05 | Dci | dodecenoyl-Coenzyme A | |
| | | | delta isomerase (3,2 | |
| | | | trans-enoyl-Coenyme A | |
| | | | isomerase) | |
| NM_010062 | 2.07E−07 | Dnase2a | deoxyribonuclease II | |
| | | | alpha | |
| NM_010158 | 1.57E−05 | Khdrbs3 | KH domain containing, | |
| | | | RNA binding, signal | |
| | | | transduction associated 3 | |
| NM_010217 | 1.82E−05 | Ctgf | connective tissue growth | |
| | | | factor | |
| NM_010219 | 3.60E−05 | Fkbp4 | FK506 binding protein 4 | Peptidylprolyl |
| | | | | isomerase, |
| | | | | FKBP-type |
| NM_010284 | 3.59E−08 | Ghr | growth hormone receptor | |
| NM_010324 | 4.84E−05 | Got1 | glutamate oxaloacetate | |
| | | | transaminase 1, soluble | |
| NM_010403 | 3.51E−08 | Hao1 | hydroxyacid oxidase 1, | |
| | | | liver | |
| NM_010447 | 3.12E−09 | Hnrpa1 | heterogeneous nuclear | |
| | | | ribonucleoprotein A1 | |
| NM_010497 | 8.44E−06 | Idh1 | isocitrate dehydrogenase | |
| | | | 1 (NADP+), soluble | |
| NM_010501 | 0.000121245 | Ifit3 | interferon-induced | |
| | | | protein with | |
| | | | tetratricopeptide repeats 3 | |
| NM_010565 | 3.33E−09 | Inhbc | inhibin beta-C | |
| NM_010664 | 1.20E−07 | Krt1-18 | keratin complex 1, | |
| | | | acidic, gene 18 | |
| NM_010686 | 6.63E−05 | Laptm5 | lysosomal-associated | |
| | | | protein transmembrane 5 | |
| NM_010697 | 4.13E−07 | Ldb1 | LIM domain binding 1 | |
| NM_010717 | 0.000100858 | Limk1 | LIM-domain containing, | Serine/Threonine |
| | | | protein kinase | protein |
| | | | | kinase |
| NM_010717 | 0.000100858 | Limk1 | LIM-domain containing, | Tyrosine |
| | | | protein kinase | protein |
| | | | | kinase |
| NM_010718 | 3.38E−05 | Limk2 | LIM motif-containing | Serine/Threonine |
| | | | protein kinase 2 | protein |
| | | | | kinase |
| NM_010718 | 3.38E−05 | Limk2 | LIM motif-containing | Tyrosine |
| | | | protein kinase 2 | protein |
| | | | | kinase |
| NM_010838 | 3.81E−05 | Mapt | microtubule-associated | |
| | | | protein tau | |
| NM_010864 | 5.11E−05 | Myo5a | myosinVa | |
| NM_010950 | 2.15E−05 | Numbl | numb-like | |
| NM_011050 | 5.96E−05 | Pdcd4 | programmed cell death 4 | |
| NM_011068 | 9.42E−06 | Pex11a | peroxisomal biogenesis | |
| | | | factor 11a | |
| NM_011106 | 5.56E−07 | Pkig | protein kinase inhibitor, | |
| | | | gamma | |
| NM_011116 | 9.96E−05 | Pld3 | phospholipase D3 | |
| NM_011134 | 1.63E−06 | Pon1 | paraoxonase 1 | |
| NM_011175 | 0.000119 | Lgmn | legumain | |
| NM_011254 | 1.55E−05 | Rbp1 | retinol binding protein 1, | |
| | | | cellular | |
| NM_011316 | 1.48E−06 | Saa4 | serum amyloid A 4 | |
| NM_011494 | 1.52E−05 | Stk16 | serine/threonine kinase | Serine/Threonine |
| | | | 16 | protein |
| | | | | kinase |
| NM_011494 | 1.52E−05 | Stk16 | serine/threonine kinase | Tyrosine |
| | | | 16 | protein |
| | | | | kinase |
| NM_011579 | 8.26E−05 | Tgtp | T-cell specific GTPase | |
| NM_011656 | 5.54E−06 | Tuft1 | tuftelin 1 | |
| NM_011704 | 1.43E−06 | Vnn1 | vanin 1 | |
| NM_011755 | 2.26E−08 | Zfp35 | zinc finger protein 35 | |
| NM_011764 | 8.97E−06 | Zfp90 | zinc finger protein 90 | |
| NM_011895 | 5.66E−06 | Slc35a1 | solute carrier family 35 | |
| | | | (CMP-sialic acid | |
| | | | transporter), member 1 | |
| NM_013467 | 1.24E−09 | Aldh1a1 | aldehyde dehydrogenase | Aldehyde |
| | | | family 1, subfamily A1 | dehydrogenase |
| NM_013471 | 0.001030896 | Anxa4 | annexin A4 | |
| NM_013543 | 2.34E−06 | H2-Ke6 | H2-K region expressed | Short-chain |
| | | | gene 6 | dehydrogenase/ |
| | | | | reductase |
| | | | | SDR |
| NM_013559 | 1.95E−05 | Hsp105 | heat shock protein | |
| NM_013697 | 1.16E−06 | Ttr | transthyretin | |
| NM_013746 | 7.38E−06 | Plekhb1 | pleckstrin homology | |
| | | | domain containing, | |
| | | | family B (evectins) | |
| | | | member 1 | |
| NM_013867 | 1.94E−06 | Bcar3 | breast cancer anti- | |
| | | | estrogen resistance 3 | |
| NM_015747 | 9.41E−06 | Slc20a1 | solute carrier family 20, | |
| | | | member 1 | |
| NM_015780 | 8.68E−07 | AI194696 | expressed sequence | |
| | | | AI194696 | |
| NM_016723 | 7.29E−06 | Uch13 | ubiquitin carboxyl- | |
| | | | terminal esterase L3 | |
| | | | (ubiquitin thiolesterase) | |
| NM_016772 | 8.60E−06 | Ech1 | enoyl coenzyme A | |
| | | | hydratase 1, peroxisomal | |
| NM_016861 | 3.74E−06 | Pdlim1 | PDZ and LIM domain 1 | |
| | | | (elfin) | |
| NM_016898 | 3.93E−06 | Cd164 | CD164 antigen | |
| NM_016915 | 4.84E−05 | Pla2g6 | phospholipase A2, group | |
| | | | VI | |
| NM_016919 | 2.31E−07 | Col5a3 | procollagen, type V, | |
| | | | alpha 3 | |
| NM_017373 | 1.91E−07 | Nfil3 | nuclear factor, | |
| | | | interleukin 3, regulated | |
| NM_018737 | 1.64E−06 | Ctps2 | cytidine 5′-triphosphate | |
| | | | synthase 2 | |
| NM_018738 | 5.69E−06 | Igtp | interferon gamma | |
| | | | induced GTPase | |
| NM_018879 | 2.75E−05 | Nprl2- | nitrogen permase | |
| | | pending | homolog (S. cerevisiae) | |
| NM_018881 | 2.26E−05 | Fmo2 | flavin containing | |
| | | | monooxygenase 2 | |
| NM_019400 | 6.68E−05 | Rab5ep- | rabaptin 5 | |
| | | pending | | |
| NM_019447 | 2.08E−05 | Hgfac | hepatocyte growth factor | Serine |
| | | | activator | protease, |
| | | | | trypsin |
| | | | | family |
| NM_019477 | 0.000260863 | Facl4 | fatty acid-Coenzyme A | |
| | | | ligase, long chain 4 | |
| NM_019742 | 2.79E−06 | Fus1- | fusion 1 | |
| | | pending | | |
| NM_019750 | 5.38E−06 | Nat6 | N-acetyltransferase 6 | |
| NM_019939 | 7.56E−08 | Mpp6 | membrane protein, | |
| | | | palmitoylated 6 | |
| | | | (MAGUK p55 subfamily | |
| | | | member 6) | |
| NM_019999 | 4.57E−05 | Brp17 | brain protein 17 | |
| NM_020491 | 4.38E−06 | Sssca1 | Sjogren's | |
| | | | syndrome/scleroderma | |
| | | | autoantigen 1 homolog | |
| | | | (human) | |
| NM_020512 | 5.96E−05 | no_official_symbol | no_official_gene_name | Rhodopsin- |
| | | | | like GPCR |
| | | | | superfamily |
| NM_020557 | 2.98E−06 | Tyki | thymidylate kinase | |
| | | | family LPS-inducible | |
| | | | member | |
| NM_020609 | 3.47E−06 | ICRFP703B1614Q5.5 | predicted gene | |
| | | | ICRFP703B1614Q5.5 | |
| NM_021274 | 8.85E−07 | Cxcl10 | chemokine (C—X—C | |
| | | | motif) ligand 10 | |
| NM_021363 | 0.000464 | Svs3 | seminal vesicle secretion 3 | |
| NM_021370 | 6.89E−06 | Inac- | amiloride-sensitive | Na+ |
| | | pending | sodium channel | channel, |
| | | | | amiloride- |
| | | | | sensitive |
| NM_021371 | 3.47E−05 | Caln1 | calneuron 1 | |
| NM_021455 | 4.49E−05 | Wbscr14 | Williams-Beuren | |
| | | | syndrome chromosome | |
| | | | region 14 homolog | |
| | | | (human) | |
| NM_021792 | 3.48E−05 | Iigp- | interferon-inducible | |
| | | pending | GTPase | |
| NM_023123 | 0.000140626 | H19 | H19 fetal liver mRNA | |
| NM_023160 | 2.96E−05 | Cml1 | camello-like 1 | |
| NM_023480 | 2.98E−05 | 1110025H10Rik | RIKEN cDNA | |
| | | | 1110025H10 gene | |
| NM_023625 | 6.22E−05 | 1300012G16Rik | RIKEN cDNA | |
| | | | 1300012G16 gene | |
| NM_024198 | 1.58E−05 | 3110050F08Rik | RIKEN cDNA | |
| | | | 3110050F08 gene | |
| NM_024255 | 2.39E−05 | 2610207I16Rik | RIKEN cDNA | Short-chain |
| | | | 2610207I16 gene | dehydrogenase/ |
| | | | | reductase |
| | | | | SDR |
| NM_025273 | 6.51E−05 | Pcbd | 6-pyruvoyl- | |
| | | | tetrahydropterin | |
| | | | synthase/dimerization | |
| | | | cofactor of hepatocyte | |
| | | | nuclear factor 1 alpha | |
| | | | (TCF1) | |
| NM_025287 | 8.96E−07 | Spop | speckle-type POZ protein | |
| NM_025307 | 3.87E−06 | Nrbf2 | nuclear receptor binding | |
| | | | factor 2 | |
| NM_025318 | 5.77E−05 | 0610009E20Rik | RIKEN cDNA | |
| | | | 0610009E20 gene | |
| NM_025429 | 1.45E−05 | Serpinb1a | serine (or cysteine) | Serpin |
| | | | proteinase inhibitor, | |
| | | | clade B (ovalbumin), | |
| | | | member 1a | |
| NM_025459 | 9.80E−07 | 1810015C04Rik | RIKEN cDNA | |
| | | | 1810015C04 gene | |
| NM_025547 | 3.88E−05 | 2410017I18Rik | RIKEN cDNA | |
| | | | 2410017I18 gene | |
| NM_025558 | 2.95E−08 | Cyb5m- | cytochrome b5 outer | |
| | | pending | mitochondrial membrane | |
| | | | precursor | |
| NM_025582 | 1.69E−05 | 2810405K02Rik | RIKEN cDNA | |
| | | | 2810405K02 gene | |
| NM_025661 | 4.86E−07 | Ormd13 | ORM1-like 3 (S. cerevisiae) | |
| NM_025809 | 0.000100167 | 1200003C23Rik | RIKEN cDNA | |
| | | | 1200003C23 gene | |
| NM_025827 | 1.29E−06 | 1300002A08Rik | RIKEN cDNA | |
| | | | 1300002A08 gene | |
| NM_025830 | 2.04E−07 | Wwp2- | WW domain-containing | |
| | | pending | protein 4 | |
| NM_025844 | 3.52E−05 | Chordc1 | cysteine and histidine- | |
| | | | rich domain (CHORD)- | |
| | | | containing, zinc-binding | |
| | | | protein 1 | |
| NM_025855 | 7.04E−06 | D10Ertd667e | DNA segment, Chr 10, | |
| | | | ERATO Doi 667, | |
| | | | expressed | |
| NM_025877 | 4.26E−06 | 2310067G05Rik | RIKEN cDNA | |
| | | | 2310067G05 gene | |
| NM_025882 | 1.83E−05 | Pole4 | polymerase (DNA- | |
| | | | directed), epsilon 4 (p12 | |
| | | | subunit) | |
| NM_025950 | 4.17E−05 | Cdc371 | cell division cycle 37 | |
| | | | homolog (S. cerevisiae)- | |
| | | | like | |
| NM_025994 | 3.22E−05 | D4Wsu27e | DNA segment, Chr 4, | |
| | | | Wayne State University | |
| | | | 27, expressed | |
| NM_026086 | 1.81E−06 | 1600031M04Rik | RIKEN cDNA | |
| | | | 1600031M04 gene | |
| NM_026164 | 4.33E−05 | Ipla2(gamma)- | intracellular membrane- | |
| | | pending | associated calcium- | |
| | | | independent | |
| | | | phospholipase A2 | |
| | | | gamma | |
| NM_026172 | 2.67E−06 | Decr1 | 2,4-dienoyl CoA | Short-chain |
| | | | reductase 1, | dehydrogenase/ |
| | | | mitochondrial | reductase |
| | | | | SDR |
| NM_026178 | 2.99E−05 | Mmd | monocyte to macrophage | |
| | | | differentiation-associated | |
| NM_026271 | 8.17E−07 | 1110018M03Rik | RIKEN cDNA | |
| | | | 1110018M03 gene | |
| NM_026402 | 4.48E−05 | Apg3- | autophagy Apg3p/Aut1p- | |
| | | pending | like | |
| NM_026508 | 1.00E−05 | 2410002K23Rik | RIKIEN cDNA | ATP- |
| | | | 2410002K23 gene | binding |
| | | | | region, |
| | | | | ATPase- |
| | | | | like |
| NM_026527 | 0.000340188 | 2510006C20Rik | RIKEN cDNA | |
| | | | 2510006C20 gene | |
| NM_027149 | 3.30E−07 | 2310040A13Rik | RIKEN cDNA | |
| | | | 2310040A13 gene | |
| NM_028288 | 3.09E−05 | Cul4b | cullin 4B | |
| NM_030611 | 5.70E−08 | Akrlc6 | aldo-keto reductase | Aldo/keto |
| | | | family 1, member C6 | reductase |
| NM_030686 | 2.42E−07 | Dhrs4 | dehydrogenase/reductase | Short-chain |
| | | | (SDR family) member 4 | dehydrogenase/ |
| | | | | reductase |
| | | | | SDR |
| NM_030687 | 0.000262172 | Slc21a5 | solute carrier family 21 | |
| | | | (organic anion | |
| | | | transporter), member 5 | |
| NM_030717 | 1.91E−06 | Lactb | lactamase, beta | |
| NM_031170 | 6.99E−05 | Krt2-8 | keratin complex 2, basic, | |
| | | | gene 8 | |
| NM_031188 | 3.14E−08 | Mup1 | major urinary protein 1 | |
| ri\|1500015I04\| | 5.40E−06 | | | |
| R000020J15\|\| | | | | |
| 2001 | | | | |
| ri\|1500031A22\| | 7.88E−05 | | | |
| R000021K03\|\| | | | | |
| 2109 | | | | |
| ri\|1700069L09\| | 7.96E−07 | | | |
| ZX00076G01\|\| | | | | |
| 1089 | | | | |
| ri\|2010005F17\| | 2.85E−05 | | | |
| ZX00043H02\|\| | | | | |
| 1460 | | | | |
| ri\|2410008L21\| | 0.000112377 | | | |
| ZX00055D17\|\| | | | | |
| 2078 | | | | |
| ri\|2510029O03\| | 1.10E−05 | | | |
| ZX00048A13\|\| | | | | |
| 1650 | | | | |
| ri\|2610002K09\| | 0.000142594 | | | |
| ZX00060D02\|\| | | | | |
| 2140 | | | | |
| ri\|2610311I19\| | 3.41E−07 | | | |
| ZX00062O01\|\| | | | | |
| 2289 | | | | |
| ri\|2700089E24\| | 7.89E−06 | | | |
| ZX00056N16\|\| | | | | |
| 1998 | | | | |
| ri\|2810018E08\| | 3.61E−06 | | | |
| ZX00046M23\|\| | | | | |
| 1688 | | | | |
| ri\|2810019D12\| | 0.000118517 | | | |
| ZX00046O21\|\| | | | | |
| 1653 | | | | |
| ri\|2900002G15\| | 1.53E−06 | | | |
| ZX00055K23\|\| | | | | |
| 2117 | | | | |
| ri\|4631422C05\| | 7.26E−06 | | | |
| PX00011L02\|\| | | | | |
| 3327 | | | | |
| ri\|4930533H01\| | 9.99E−05 | | | |
| PX00034G21\|\| | | | | |
| 1871 | | | | |
| ri\|4930568E03\| | 1.60E−06 | | | |
| PX00036G15\|\| | | | | |
| 2120 | | | | |
| ri\|4933404M19\| | 3.35E−10 | | | |
| PX00019F10\|\| | | | | |
| 1119 | | | | |
| ri\|4933407I02\| | 7.02E−05 | | | |
| PX00019L22\|\| | | | | |
| 1832 | | | | |
| ri\|5033417E09\| | 5.33E−06 | | | |
| PX00037J06\|\| | | | | |
| 1727 | | | | |
| ri\|5430401P15\| | 2.02E−06 | | | |
| PX00022K17\|\| | | | | |
| 1812 | | | | |
| ri\|5730494J16\| | 1.65E−06 | | | |
| PX00005E23\|\| | | | | |
| 1882 | | | | |
| ri\|5730522G15\| | 0.000757844 | | | |
| PX00005H22\|\| | | | | |
| 2024 | | | | |
| ri\|5830435F03\| | 5.13E−06 | | | |
| PX00039I17\|\| | | | | |
| 1920 | | | | |
| ri\|6330403M23\| | 4.52E−05 | | | |
| PX00093M24\|\| | | | | |
| 1385 | | | | |
| ri\|6330556D22\| | 4.75E−06 | | | |
| PX00044E05\|\| | | | | |
| 2245 | | | | |
| ri\|6430411L14\| | 2.72E−05 | | | |
| PX00044N10\|\| | | | | |
| 2184 | | | | |
| ri\|9330120I09\| | 6.97E−07 | | | |
| PX00104P02\|\| | | | | |
| 1567 | | | | |
| ri\|95300907G24\| | 7.41E−05 | | | |
| PX00114C02\|\| | | | | |
| 1922 | | | | |
| ri\|A930014C21\| | 8.62E−05 | | | |
| PX00066C21\|\| | | | | |
| 1837 | | | | |
| ri\|A930023P06\| | 0.000174956 | | | |
| PX00066B22\|\| | | | | |
| 1477 | | | | |
| ri\|C030048F16\| | 0.000132892 | | | |
| PX00075B03\|\| | | | | |
| 1341 | | | | |

Step 710.

The eQTL for the 438 transcripts in association set D were computed using QTL analysis with the program QTL Cartographer. Basten et al., 1999, QTL Cartographer User's Manual, Department of Statistics, North Carolina State University, Raleigh, N.C.

Step 712.

In step 712, all transcripts from association set D that do not have at least two eQTL that are coincident with the cQTL for OFPM were removed from association set D in order to form the candidate causative cellular constituent set (set 204, FIG. 2). In particular, all eQTL with LOD scores over 2.0 from the eQTL set formed by the cellular constituents in the association set D (the set of 438 genes) upon QTL analysis in accordance with step 710 were identified and intersected with the OFPM cQTL. This resulted in a set of 114 transcripts with at least two eQTL overlapping at least two OFPM QTL. This set of 114 transcripts represents the candidate causative gene set (FIG. 2, set 204). The remaining transcripts that do not have at least two eQTL that overlap with the cQTL of the OFPM cQTL from the candidate reactive candidate set (set 206, FIG. 2). Step 712 serves to decompose the original pattern of expression associated with OFPM into two components: a candidate causative component and a candidate reactive component. Identification of the candidate causative gene set using the genetics serves to highlight those encoding transcripts that may sit between the causative and reactive boundaries defined in FIG. 2, and that may potentially modulate OFPM via the action of the OFPM QTL.

Loose cuts on LOD scores have been made up to this point to minimize the chance of excluding key genes that are able to explain a significant amount of OFPM variation in a causal way. While the set of 114 causal genes could contain false positives, it is unlikely any key causal drivers have been excluded from the experimental data that explain a significant proportion of the OFPM trait.

Step 716. To further prioritize the list of 114 candidate causal genes, each gene expression trait is considered in a joint analysis with the OFPM trait at each of the QTL in the union of eQTL and OFPM cQTL sets. This joint analysis leads to a joint LOD score as described by Jiang et al., 1995, Genetics 140:1111, and applied by Schadt et al., 2003, Nature 422:297 to gene expression traits. Bivariate trait QTL with LOD scores over 4.5 (p-value=0.00003) were identified in 267 of the overlapping QTL. Because this score is close to genome-wide significance for this type of analysis, only genes with QTL in this set were considered further, resulting in a reduced set of candidate causal genes. The complete rank ordered list for the 114 genes is given in Table 5. In Table 5, all 114 candidate causal genes are rank ordered according to the percent of genetic variation they causally explain in the OFPM trait. Column 1 lists the GenBank/RefSeq accession numbers, column 2 gives the official gene symbol, column 3 gives the number of gene expression QTL overlapping OFPM QTL; column 4 gives the number of QTL overlapping from column 3 that tested causal, and column 5 provides the percent genetic variation in the OFPM trait causally explained by the gene expression trait. Those genes with a druggable domain are preferred targets for a obesity drug discovery program.

TABLE 5
Prioritized causal gene list for OFPM.

| | | | | Percent | |
|---|---|---|---|---|---|
| | | | Number | Genetic | |
| | | | of Overlapping | Variation in | |
| | | Number of | QTL | OFPM | |
| Accession | | Overlapping | Testing | Causally | Drug |
| Number | Official Symbol | QTL | Causal | Explained | gable |
| NM_011764 | Zfp90 | 3 | 3 | 0.684598881 | 0 |
| AY027436 | | 3 | 3 | 0.684598881 | 0 |
| AI506234 | | 3 | 3 | 0.684598881 | 0 |
| NM_008288 | Hsd11b1 | 4 | 3 | 0.612809417 | 1 |
| AK004942 | Gpx3 | 3 | 3 | 0.612809417 | 0 |
| NM_030717 | Lactb | 3 | 2 | 0.519088825 | 0 |
| NM_026508 | 2410002K23Rik | 3 | 2 | 0.519088825 | 1 |
| AK004980 | Mod1 | 3 | 2 | 0.519088825 | 0 |
| NM_008509 | Lpl | 4 | 2 | 0.455492189 | 1 |
| NM_008194 | Gyk | 4 | 2 | 0.455492189 | 0 |
| AK004307 | Grhpr | 4 | 2 | 0.455492189 | 0 |
| NM_024198 | 3110050F08Rik | 3 | 2 | 0.455492189 | 0 |
| NM_011116 | Pld3 | 3 | 2 | 0.455492189 | 0 |
| NM_009779 | C3ar1 | 3 | 2 | 0.455492189 | 1 |
| NM_009052 | Rex3 | 3 | 2 | 0.455492189 | 0 |
| NM_008508 | Lor | 3 | 2 | 0.455492189 | 0 |
| AK017818 | 5730543C08Rik | 3 | 2 | 0.455492189 | 0 |
| AK009964 | 2310057K14Rik | 3 | 2 | 0.455492189 | 0 |
| AK009768 | DXImx50e | 3 | 2 | 0.455492189 | 0 |
| AK003567 | 1110008E19Rik | 3 | 2 | 0.455492189 | 0 |
| AF149291 | | 3 | 2 | 0.455492189 | 0 |
| NM_010565 | Inhbc | 3 | 2 | 0.447299361 | 0 |
| NM_009198 | Slc17a1 | 3 | 2 | 0.447299361 | 0 |
| ri\|2010005F17\|ZX00043H02\|\|1460 | | 4 | 2 | 0.394616747 | 0 |
| NM_010000 | Cyp2b9 | 4 | 2 | 0.394616747 | 1 |
| AI875925 | | 4 | 2 | 0.394616747 | 1 |
| ri\|1500031A22\|R000021K03\|\|2109 | | 3 | 2 | 0.394616747 | 0 |
| AF296075 | Wdr10 | 3 | 2 | 0.394616747 | 0 |
| NM_013746 | Phret1 | 4 | 2 | 0.386423919 | 0 |
| AK017049 | 4933433P14Rik | 4 | 2 | 0.386423919 | 0 |
| AK005804 | 1700009P17Rik | 3 | 2 | 0.386423919 | 0 |
| ri\|4933407I02\|PX00019L22\|\|1832 | | 3 | 2 | 0.322827283 | 0 |
| ri\|4933404M19\|PX00019F10\|\|1119 | | 3 | 2 | 0.322827283 | 0 |
| NM_025429 | Serpinb1a | 3 | 2 | 0.322827283 | 1 |
| NM_011704 | Vnn1 | 3 | 2 | 0.322827283 | 0 |
| NM_011106 | Pkig | 3 | 2 | 0.322827283 | 0 |
| L31783 | Umpk | 3 | 2 | 0.322827283 | 0 |
| AK020362 | | 3 | 2 | 0.322827283 | 0 |
| AK006159 | 1700020G04Rik | 3 | 2 | 0.322827283 | 0 |
| AK003165 | G0s2 | 3 | 2 | 0.322827283 | 0 |
| ri\|2510029O03\|ZX00048A13\|\|1650 | | 3 | 1 | 0.289982134 | 0 |
| AK012404 | 2700049M22Rik | 3 | 1 | 0.289982134 | 0 |
| AK008884 | 2210410E06Rik | 3 | 1 | 0.289982134 | 0 |
| AK003861 | 1110020H15Rik | 3 | 1 | 0.289982134 | 1 |
| ri\|2700089E24\|ZX00056N16\|\|1998 | | 3 | 1 | 0.229106691 | 0 |
| NM_019742 | Fus1-pending | 3 | 1 | 0.229106691 | 0 |
| NM_016898 | Cd164 | 3 | 1 | 0.229106691 | 0 |
| AK018146 | 6330408K17Rik | 3 | 1 | 0.229106691 | 0 |
| AF047725 | Cyp2c38 | 3 | 1 | 0.229106691 | 1 |
| AB041561 | Gfer | 3 | 1 | 0.229106691 | 0 |
| X66225 | Rxrg | 4 | 1 | 0.165510056 | 1 |
| NM_024255 | 2610207I16Rik | 4 | 1 | 0.165510056 | 1 |
| NM_016772 | Ech1 | 4 | 1 | 0.165510056 | 0 |
| NM_011175 | Lgmn | 4 | 1 | 0.165510056 | 0 |
| BC003794 | Stip1 | 4 | 1 | 0.165510056 | 0 |
| AK020256 | 9030616G12Rik | 4 | 1 | 0.165510056 | 0 |
| AK016624 | 4933402L21Rik | 4 | 1 | 0.165510056 | 0 |
| AK003394 | 1110003P13Rik | 4 | 1 | 0.165510056 | 0 |
| NM_026172 | Decr1 | 3 | 1 | 0.165510056 | 1 |
| NM_020491 | Sssca1 | 3 | 1 | 0.165510056 | 0 |
| NM_018879 | Nprl2-pending | 3 | 1 | 0.165510056 | 0 |
| NM_015780 | | 3 | 1 | 0.165510056 | 0 |
| NM_011494 | Stk16 | 3 | 1 | 0.165510056 | 1 |
| NM_011068 | Pex11a | 3 | 1 | 0.165510056 | 0 |
| NM_010686 | Laptm5 | 3 | 1 | 0.165510056 | 0 |
| NM_010158 | Etle | 3 | 1 | 0.165510056 | 0 |
| NM_010023 | Dci | 3 | 1 | 0.165510056 | 0 |
| NM_009949 | Cpt2 | 3 | 1 | 0.165510056 | 1 |
| NM_008382 | Inhbe | 3 | 1 | 0.165510056 | 0 |
| NM_007980 | Fabp2 | 3 | 1 | 0.165510056 | 0 |
| NM_007813 | Cyp2b13 | 3 | 1 | 0.165510056 | 1 |
| AK018666 | Crim1 | 3 | 1 | 0.165510056 | 0 |
| AK013507 | 2900009J20Rik | 3 | 1 | 0.165510056 | 0 |
| AK012685 | 2810007J24Rik | 3 | 1 | 0.165510056 | 0 |
| AK009269 | 2310010G13Rik | 3 | 1 | 0.165510056 | 0 |
| AK007299 | 1700127F16Rik | 3 | 1 | 0.165510056 | 0 |
| AK005641 | l700003H21Rik | 3 | 1 | 0.165510056 | 0 |
| AK004971 | 1300012D20Rik | 3 | 1 | 0.165510056 | 0 |
| AK004567 | Crot | 3 | 1 | 0.165510056 | 1 |
| AK004285 | 1110057K04Rik | 3 | 1 | 0.165510056 | 0 |
| AK002691 | D14Ucla2 | 3 | 1 | 0.165510056 | 1 |
| AK002535 | 0610011F06Rik | 3 | 1 | 0.165510056 | 0 |
| AI874739 | AI874739 | 3 | 1 | 0.165510056 | 0 |
| AI503986 | | 3 | 1 | 0.165510056 | 0 |
| AI255955 | AI255955 | 3 | 1 | 0.165510056 | 0 |
| AK014100 | 2310016E22Rik | 3 | 1 | 0.157317227 | 1 |
| AK004889 | Acadsb | 3 | 1 | 0.157317227 | 0 |
| AK002723 | 0610031G08Rik | 3 | 1 | 0.157317227 | 0 |
| AF085220 | Prdx5-rs1 | 3 | 1 | 0.157317227 | 0 |
| NM_025827 | 1300002A08Rik | 4 | 0 | 0 | 0 |
| NM_010007 | Cyp2j5 | 4 | 0 | 0 | 1 |
| M11310 | Aprt | 4 | 0 | 0 | 1 |
| AK016470 | D6Wsu176e | 4 | 0 | 0 | 0 |
| AK004984 | 1300013D18Rik | 4 | 0 | 0 | 1 |
| ri\|A930014C21\|PX00066C21\|\|1837 | | 3 | 0 | 0 | 0 |
| NM_031188 | Mup1 | 3 | 0 | 0 | 0 |
| NM_030686 | D14Ucla2 | 3 | 0 | 0 | 1 |
| NM_028288 | Cul4b | 3 | 0 | 0 | 0 |
| NM_025318 | 0610009E20Rik | 3 | 0 | 0 | 0 |
| NM_021371 | | 3 | 0 | 0 | 0 |
| NM_021370 | Inac-pending | 3 | 0 | 0 | 1 |
| NM_020512 | | 3 | 0 | 0 | 1 |
| NM_010717 | Limk1 | 3 | 0 | 0 | 1 |
| NM_010284 | Ghr | 3 | 0 | 0 | 0 |
| NM_009467 | Ugt2b5 | 3 | 0 | 0 | 0 |
| NM_008163 | Grb2 | 3 | 0 | 0 | 0 |
| NM_007898 | Ebp | 3 | 0 | 0 | 0 |
| AV346241 | | 3 | 0 | 0 | 0 |
| AK020578 | 9530027K23Rik | 3 | 0 | 0 | 0 |
| AK011847 | 2610111M19Rik | 3 | 0 | 0 | 0 |
| AK011679 | 2610034P21Rik | 3 | 0 | 0 | 0 |
| AK010892 | 2610034N03Rik | 3 | 0 | 0 | 0 |
| AK008788 | 2210401F17Rik | 3 | 0 | 0 | 0 |

Step 718.

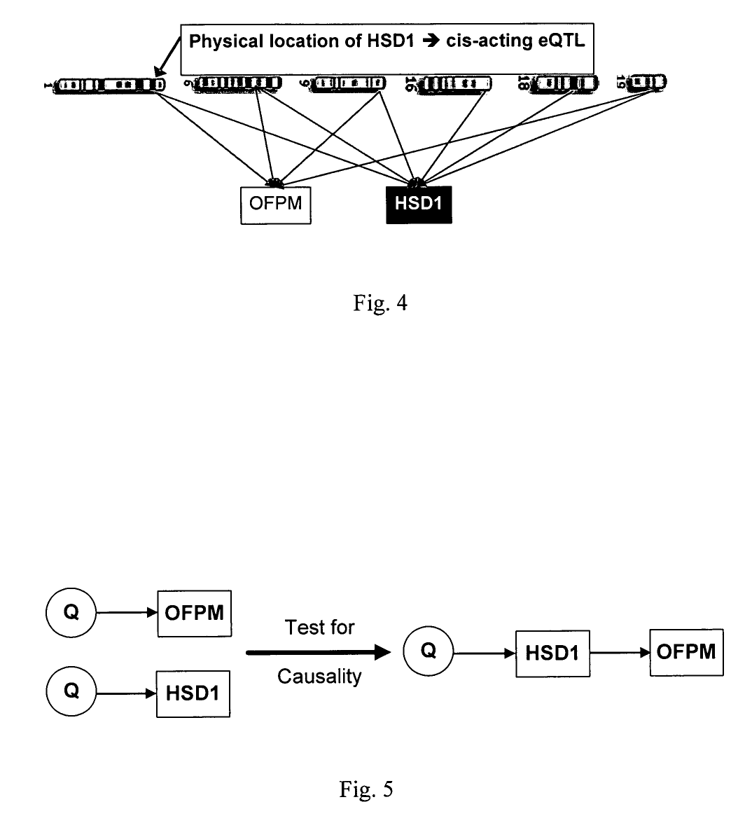

A causality test was applied to each of the eQTL from the set of 114 candidate causal genes overlapping the OFPM QTL. FIG. 5 outlines the starting information that is available to motivate application of the causality test in the case of HSD1. Four QTL (points of eQTL/cQTL overlap from FIG. 4) have been detected that control for variation in both OFPM and HSD1 (pleiotropic effects), and therefore, a determination is warranted as to whether the relationship to the right of the test arrow in FIG. 5 holds for each of the four QTL. The same situation holds for the other 118 genes. Of the 267 overlapping eQTL/cQTL represented by the 114 genes in association set D, the null hypothesis that the gene expression trait was causative for the disease trait (e.g., the cQTL for OFPM conditional on gene expression did not have significant LOD scores) was accepted for 134 (50%) of them. The same set of gene expression QTL were also tested using the reactive model, and in this case, 23 (9%) were accepted as reactive (e.g., the QTL for the gene expression traits condition on OFPM were not significant). After testing each of these eQTL in this manner, the set was rank-ordered based on the percent of genetic variation in OFPM causally explained by variation in the transcript abundances of these genes. The top 10 genes based on this rank ordering are given in Table 6. This set of genes represents the strongest set of causal candidates for the OFPM trait in this mouse population that could be determined from monitoring transcript abundances of more then 23,000 genes in liver. In Table 6, column 1 lists the GenBank or RefSeq accession numbers, column 2 gives the HUGO gene name, if assigned, column 3 is the correlation coefficient and p-value for the gene expression and OFPM trait, column 4 gives the number of gene expression QTL overlapping the OFPM QTL, column 5 gives the number of QTL overlapping from column 4 that tested as causal, and column 6 provides the percent genetic variation in the OFPM trait causally explained by the gene expression trait.

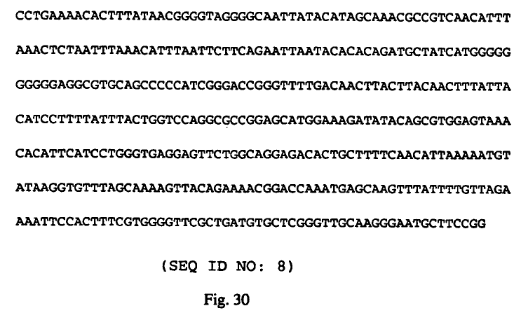

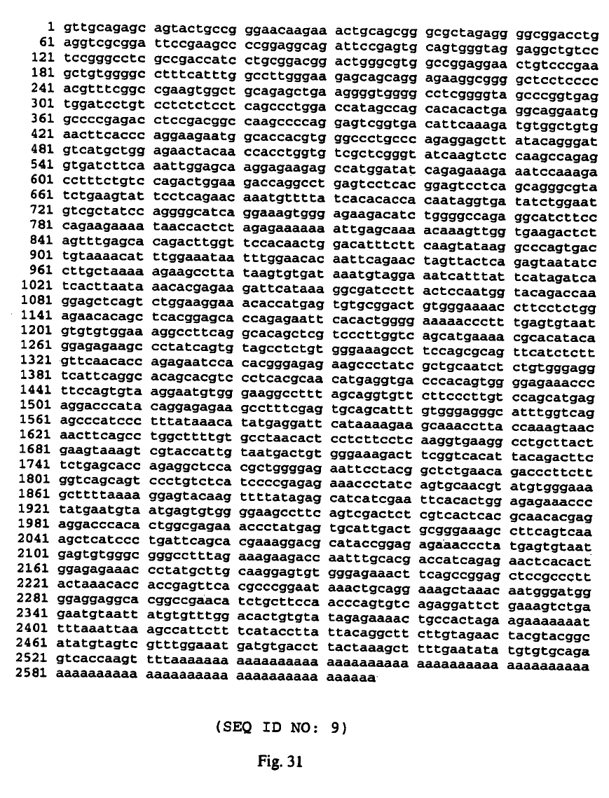

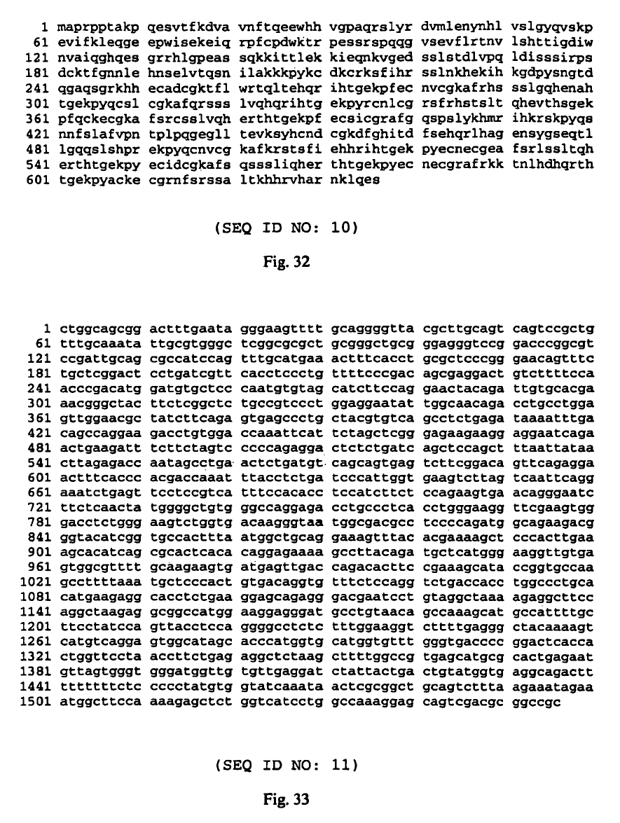

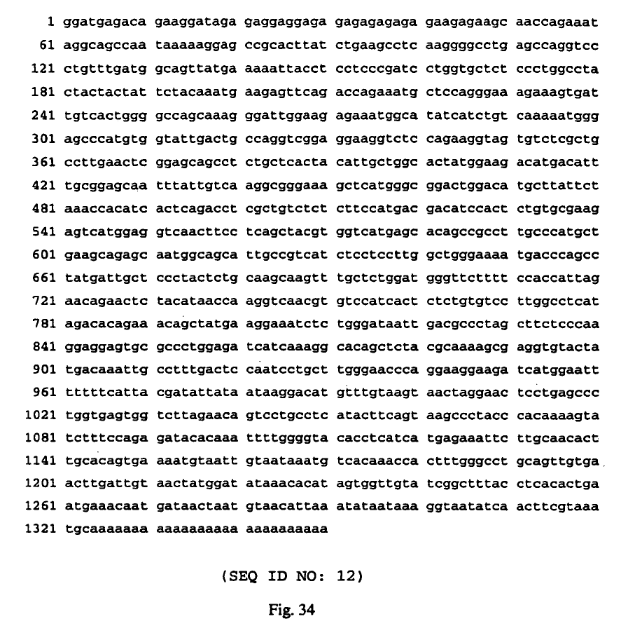

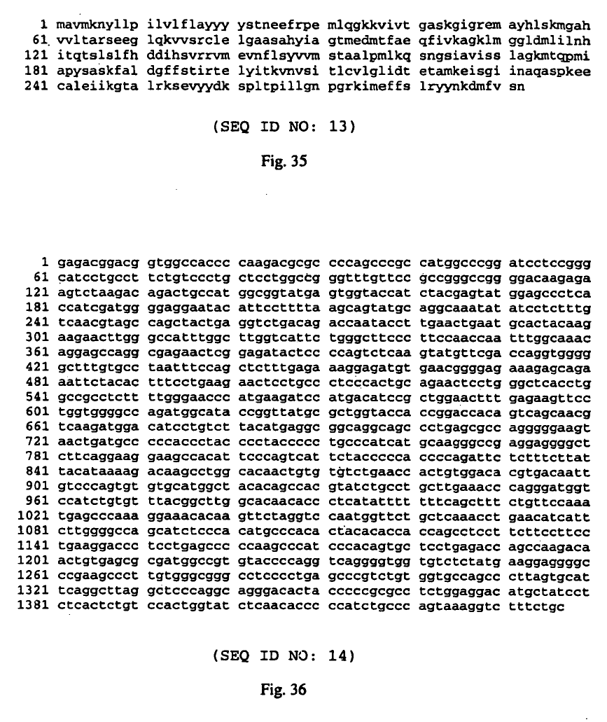

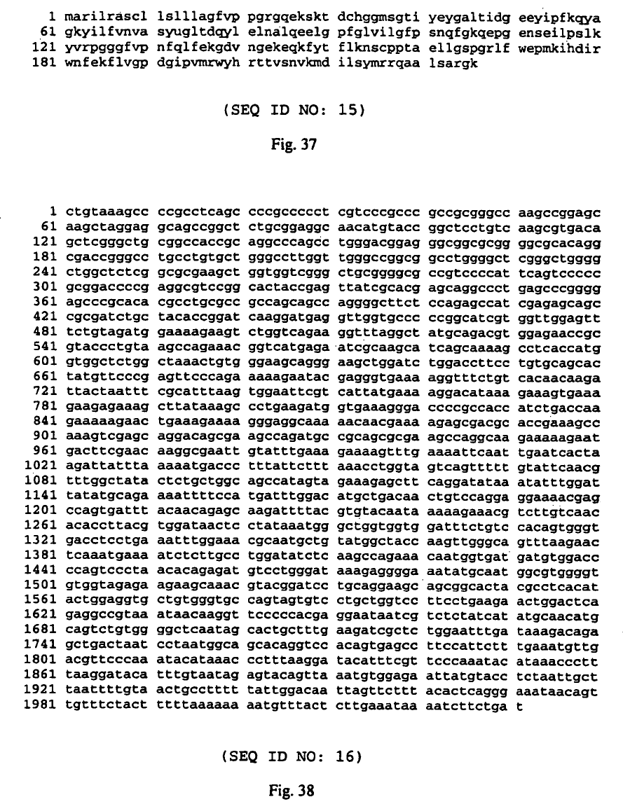

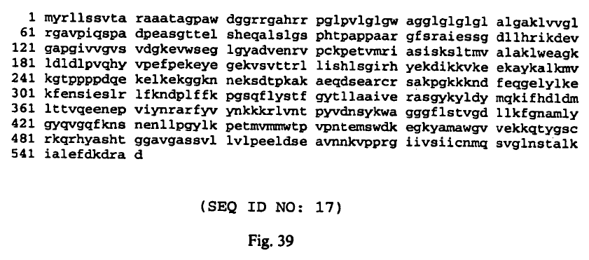

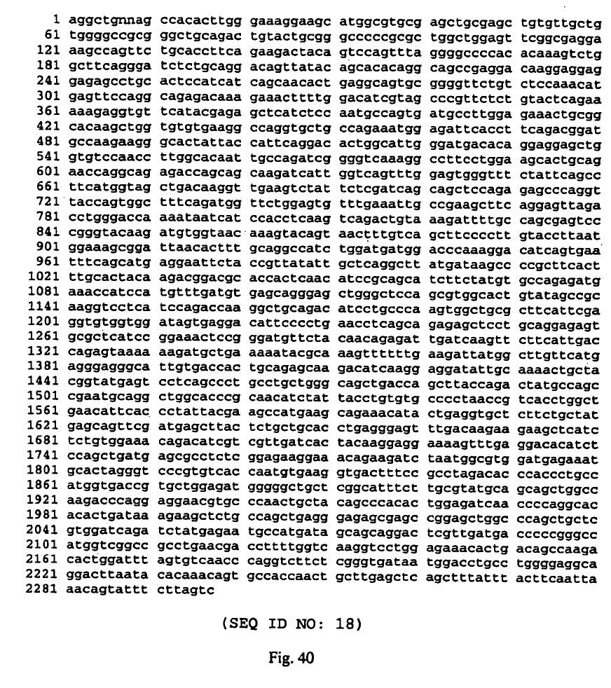

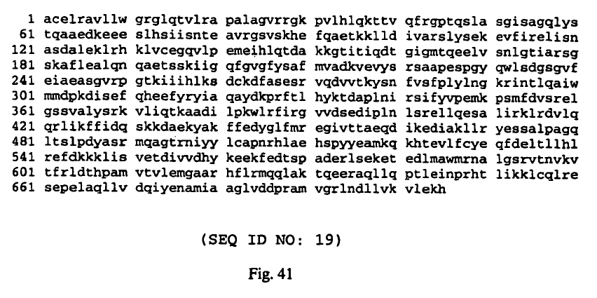

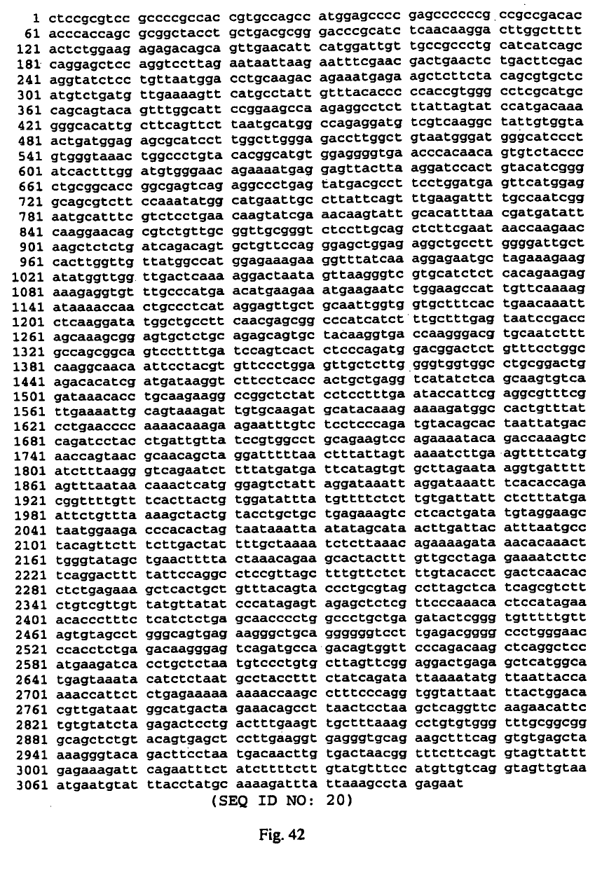

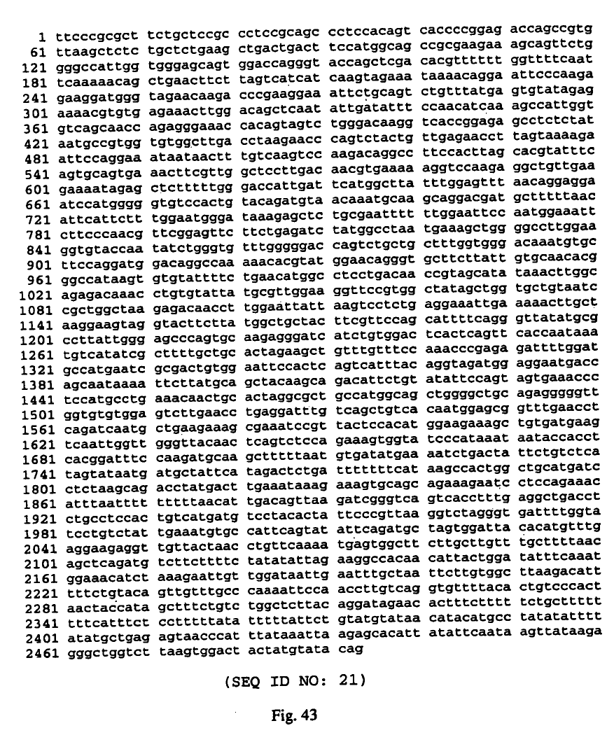

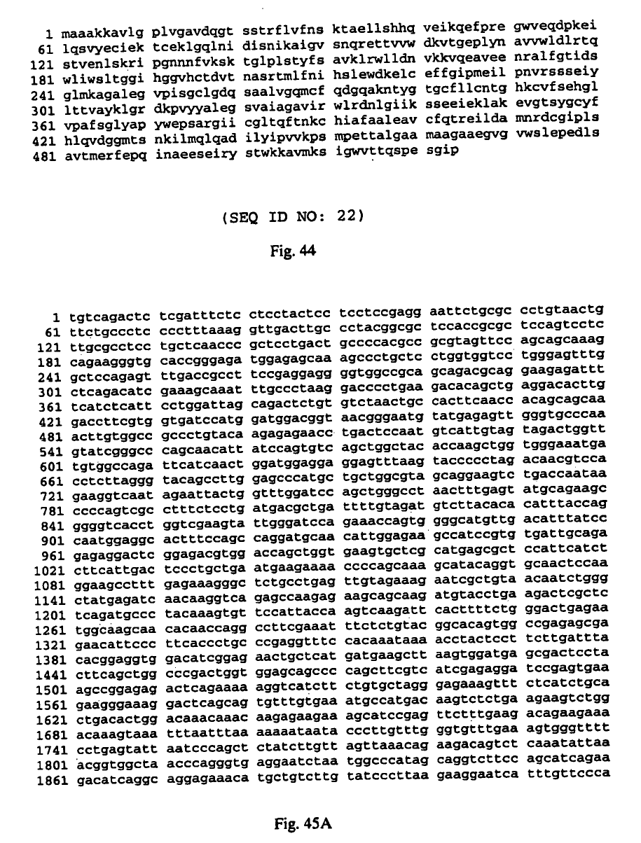

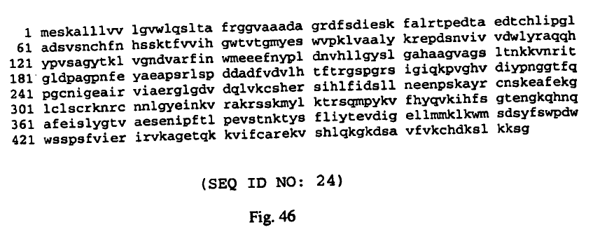

TABLE 6
Top ten gene expression traits correlated with and testing as
significantly causal for the OFPM trait.

| | | Gene | | | Percent |
|---|---|---|---|---|---|
| | | Expression | | Number of | Genetic |
| | | Correlation | Number | overlapping | Variation |
| | Gene Name | with | of | QTL | in OFPM |
| Accession | (Gene | OPFM (p- | overlapping | Testing | Causally |
| Number | Symbol) | value) | QTL | Causal | Explained |
| AI506234 | NA | 0.49 | 3 | 3 | 68 |
| (SEQ ID NO: | | (1.3E[−5]) | | | |
| 8) FIG. 30 | | | | | |
| NM_011764 | Zinc finger | 0.45 | 3 | 3 | 68 |
| (SEQ ID NO: | protein 90 | (6.8E[−5]) | | | |
| 9) FIG. 31 | (Zfp90) | | | | |
| | gi: 28279474 | | | | |
| | (SEQ ID | | | | |
| | NO: 10) FIG. | | | | |
| | 32 | | | | |
| AY027436 | NA | 0.42 | 3 | 3 | 68 |
| (SEQ ID NO: | | (2.1E[−4]) | | | |
| 11) FIG. 33 | | | | | |
| NM_008288* | Hydroxysteroid | 0.51 | 4 | 3 | 61 |
| (SEQ ID NO: | 11-beta | (5.4E[−6]) | | | |
| 12) FIG. | dehydrogenase | | | | |
| 34 | 1 (HSD1) | | | | |
| | (SEQ ID | | | | |
| | NO: 13) FIG. | | | | |
| | 35 | | | | |
| AK004942 | Glutathione | 0.43 | 4 | 4 | 61 |
| (SEQ ID NO: | peroxidase 3 | (1.4E[−4]) | | | |
| 14) FIG. 36 | (Gpx3) | | | | |
| | (SEQ ID | | | | |
| | NO: 15) FIG. | | | | |
| | 37 | | | | |
| NM_030717 | Lactamase | 0.54 | 3 | 2 | 52 |
| (SEQ ID NO: | beta (Lactb) | (1.3E[−6]) | | | |
| 16) FIG. 38 | (SEQ ID | | | | |
| | NO: 17) | | | | |
| NM_026508* | 2410002K23 | 0.50 | 3 | 2 | 52 |
| (SEQ ID NO: | Rik (SEQ | (8.6E[−6]) | | | |
| 18) FIG. 40 | ID NO: 19) | | | | |
| AK004980 | Malic | 0.40 | 3 | 2 | 52 |
| (SEQ ID NO: | enzyme | (4.1E[−4]) | | | |
| 20) FIG. 42 | (Mod1, SEQ | | | | |
| | ID: 2) | | | | |
| NM_008194 | Glycerol | 0.57 | 4 | 2 | 46 |
| (SEQ ID NO: | kinase (Gyk) | (2.6E[−7]) | | | |
| 21) FIG. 43 | (SEQ ID | | | | |
| | NO: 22) | | | | |
| NM_008509 | Lipoprotein | 0.49 | 3 | 2 | 46 |
| (SEQ ID NO: | lipase (Lpl) | (1.3E[−5]) | | | |
| 23) FIG. 45 | (SEQ ID | | | | |
| | NO: 24) FIG. | | | | |
| | 46 | | | | |

*Indicates gene has druggable properties of interest.

Of the top genes listed in Table 6, HSD1 was the most significant of the druggable genes of interest. FIG. 4 represents the extent of QTL overlap between HSD1 and OFPM. Interestingly, HSD1 was ranked 152 of 438 genes in the association set and 25^{th} of the 61 genes identified as druggable from the full set of 438. This difference in ranking highlights the value gained in understanding the underlying genetic contributions to gene expression before trying to interpret observed correlations between gene expression data and a disease trait. FIG. 5 illustrates the starting information that is available to motivate application of the causality test in the case of HSD1. QTL have been detected that control for variation in both OFPM and HSD1 (pleiotropic effects), and therefore, a determination is warranted as to whether the relationship to the right of the test arrow in FIG. 5 holds for each of the QTL.

FIG. 6 highlights the application of the causality test to one of the four overlapping QTL regions between HSD1 and OFPM (the chromosome 1 QTL). The joint LOD score for HSD1 and OFPM is significant at this QTL, and when the LOD score for OFPM conditional on HSD1 expression is computed, the LOD score drops essentially to zero. This result indicates that HSD1 effectively blocks the transmission of information from the chromosome 1 QTL to OFPM, thereby supporting the causal role of HSD1 given in FIG. 5. In FIG. 6, curve 602 represents omental fat pad mass, curve 604 represents HSD1 expression, curve 606 represents joint omental fat pad mass and HSD1, curve 608 represents omental fat pad mass conditional on HSD1, and curve 610 represents HSD1 conditional on omental fat pad mass. Conversely, when the LOD score for HSD1 conditional on OFPM is computed, it is seen in FIG. 6 that the LOD score is still significantly greater than zero, further supporting that HSD1 is not reactive, but is causal for OFPM. A similar analysis of the remaining three overlapping QTL for HSD1 gene expression and OFPM lead to similar conclusions for all but the chromosome 6 QTL, where the tests were inconclusive. The full HSD1 results from these analyses are provided in Table 7. In Table 7, columns 1 and 2 and columns 3 and 4 give the overlapping QTL locations for the OFPM and HSD1 expression trait, respectively; columns 3 and 6 give the LOD scores for the OFPM and HSD1 QTL, respectively; column 7 gives the joint OFPM/HSD1 LOD score at each of the OFPM QTL positions; and column 8 and 9 give the causal test p-values and reactive test p-values, respectively. The p-value in column 8 was computed under the NULL hypothesis that there is no significant linkage of OFPM to the indicated position once we condition on HSD1 expression (causal), and similarly the p-value in column 9 was computed under the NULL hypothesis that there is no significant linkage of HSD1 to the indicated position once we condition on OFPM (reactive).

TABLE 7
Overlapping QTL for HSD1 expression and OFPM and testing for causality

| OFPM QTL | OFPM | OFPM | HSD1 | HSD1 | HSD1 | HSD1/OF | | |
|---|---|---|---|---|---|---|---|---|
| Chromosome | QTL cM | LOD | QTL | QTL cM | LOD | PM Joint | Causal P- | Reactive |
| Location | Location | Score | Location | Location | Score | QTL LOD | Value | P-Value |
| 1 | 95 | 2.10 | 1 | 97 | 3.87 | 5.2 | 0.29 | 0.001 |
| 6 | 43 | 2.84 | 6 | 39 | 2.43 | 4.7 | 0.04 | 0.05 |
| 9 | 8 | 2.53 | 9 | 1 | 3.48 | 5.4 | 0.21 | 0.04 |
| 19 | 28 | 1.92 | 19 | 35 | 3.10 | 4.8 | 0.17 | 0.02 |

Step 724. The association of HSD1 with visceral fat mass has been previously established through the construction of a transgenic mouse overexpressing HSD1 in adipose tissue. See Masuzaki et al., 2001, Science 294:2166. Because higher expression of HSD1 in liver led to higher amounts of visceral fat in the F₂ population described here, not only was it possible to identify HSD1 as a key target, but the physiology initially described by Masuzaki et al., 2001, Science 294:2166 is present here as well. Further, recent human studies have examined HSD1 activity levels and mRNA levels and shown these to be significantly correlated with fat mass and insulin sensitivity in humans, again supporting HSD1 as a relevant target for human obesity. See Rask et al. 2002, J. Clin. Endocrinol. Metabl. 87:3330-3336; Paulmyer-Lacroix et al., 2002, J. Clin. Endocrinol. Metab. 87:2701-2705. Thus the data presented here indicates that inhibiting the activity of HSD1 would lead to a decrease in visceral fat levels, a result supported in the HSD1 transgenic mouse. (See Masuzaki et al., 2001, Science 294:2166). The techniques described here could also be used in conjunction with other phenotypes such as insulin levels, glucose levels and body mass index to establish cause and effect relationships among these traits and HSD1, as these traits relate to obesity and insulin sensitivity. Others have recently noted that this causality issue is still a problem that needs to be further dissected in human populations. See Rask et al. 2002, J. Clin. Endocrinol. Metabl. 87:3330-3336; Paulmyer-Lacroix et al., 2002, J. Clin. Endocrinol. Metab. 87:2701-2705.

The HSD1 example offers experimental validation of the discovery process described in Section 5.1. The identification of HSD1 resulted from an objective process that was entirely driven by the data. Other genes in the full list of gene expression traits associated with OFPM make interesting candidates for further study given their genetic association with the OFPM trait. The ability to position these genes with respect to a disease trait and with respect to themselves using the causality test of step 718 (FIG. 7B), provides a general framework as well to reconstruct trait-specific gene networks.

### 6.1. Methods of Ranking

Rank-ordering association sets after application of the causality test applied in Section 6.0. Expression changes between two samples were quantified as log₁₀ (expression ratio) where the ‘expression ratio’ was taken to be the ratio between normalized, background-corrected intensity values for the two channels for each spot on the array. The two channels for each array consisted of cRNA from the liver of a single F₂ animal and a “self” reference pool, comprising equal amounts of cRNA from each of the F₂ samples. Standard Pearson correlation coefficients were computed between the expression ratio measures and the omental fat pad mass (OFPM) measures for each mouse. The OFPM measurements taken for these mice are described in Drake et al, 2001, Physiol Genomics 5:205-15. Genes with expression values significantly correlated with the OFPM trait were included in the association set.

The association set was extended by considering those genes with mean expression ratio measures that differed significantly between two groups defined by the OFPM extremes. These two groups were formed by identifying those mice in the upper and lower 25^{th} percentile for the OFPM trait. A standard t test was then applied to determine if the mean expression ratios for each group were significantly different. Those genes with Pearson correlation coefficient p-values or t test p-values less than 0.0001 were included in the association set.

After application of the Causality Test to each of the gene expression traits discussed in Section 6.0, the percent of genetic variation in the OFPM trait causally explained by the gene expression trait was computed as follows. The total genetic variation for the OFPM trait was taken to be the total variation explained by the four QTL detected for the OFPM trait as highlighted in the text. A full genetic model based on these four QTL, allowing for the possibility of interactions between these QTL, was carried out using multiple interval mapping techniques as implemented in the Mlmapqtl program. See Drake et al., 2001, Physiol Genomics 5:205-15. For each gene expression trait QTL overlapping an OFPM QTL as described in Section 6.0, the Causality Test was applied, and the percent variation for each OFPM QTL associated with an expression trait testing causal was summed and taken as the total genetic variation causally explained by the respective gene expression trait. This percent was then divided by the total genetic variation for the OFPM trait to obtain the desired measure.

### 6.2. Fat Pad Mass Example

The following example illustrates one embodiment of the present invention.

Step A. An F2 intercross was constructed from C57BL/6J and DBA/2J strains of mice. Mice were on a rodent chow diet up to 12 months of age, and then switched to an atherogenic high-fat, high-cholesterol diet for another four months. More details on this cross are described in Drake et al., 2001, Physiol. Genomics 5:205. Parental and F2 mice were sacrificed at 16 months of age. At death the livers were immediately removed, flash-frozen in liquid nitrogen and stored at −80° C. Total cellular RNA was purified from 25 mg portions using an Rneasy Mini kit according to the manufacturer's instructions (Qiagen, Valencia, Calif.). Competitive hybridizations were performed by mixing fluorescently labeled cRNA (5 mg) from each of 111 female F2 liver samples, 5 DBA/2J liver samples, and 3 C57BL/6J liver samples, with the same amount of cRNA from a reference pool comprised of equal amounts of cRNA from each of the 111 liver samples profiled.

The F2 mice constructed from the inbred strains C57BL/6J and DBA/2J as described above model the spectrum of disease in a natural population, with many mice developing atherosclerotic lesions, and others having significantly higher fat-pad masses, higher cholesterol levels and larger bone structures than others in the same population. See, for example, Drake, 2001, J. Orthop. Res. 19:511, and Drake, 2001, Physiol. Genomics 5:205, which is hereby incorporated by reference in its entirety.

The competitive expression values for genes from the livers of the 111 F2 mice were determined using a microarray that included 23,574 genes. Array images were processed as described in Hughes, 2000, Cell 102:109 to obtain background noise, single channel intensity, and associated measurement error estimates. Expression changes between liver samples and reference pools were quantified as log₁₀ (expression ratio) where the ‘expression ratio’ was taken to be the ratio between normalized, background-corrected intensity values for the two channels (red and green/liver sample and reference pool) for each spot on the array. An error model for the log ratio was applied as described in Roberts, 2000, Science 287:873, which is hereby incorporated by reference in its entirety, to quantify the significance of expression changes between the liver sample and the reference pool.

Step B—Yes. The class predictor used in this example is derived from a collection of informative genes that are differentially expressed in various subdivisions of the complex trait subcutaneous fat pad mass (FPM). FPM is a quantifiable mouse phenotypic trait. See, for example, Schadt et al., 2003, Nature. 422:297, which is hereby incorporated by reference in its entirety. To this end, 280 genes were selected as the most differentially expressed set of genes in mice comprising the upper and lower 25th percentiles of the subcutaneous fat pad mass (FPM) trait. This set of genes (the FPM set) can be considered as the most transcriptionally active set of genes for mice falling in the tails of the FPM trait distribution. The selection of this gene set was not biased by selecting genes based on their ability to discriminate between the FPM trait extremes.

Step C. Rather than using the 280 genes in a supervised classification scheme, they were used in an unsupervised classification scheme. For step C, expression vectors for each of the 280 genes was constructed. Each expression vector included the expression value of a given gene in the set of 280 genes across all mice in the F2 population. Thus, for example, the expression vector for a given gene i in the set of 280 genes included 111 expression values, with each expression value representing the expression of gene i in a respective mouse in the F2 population.

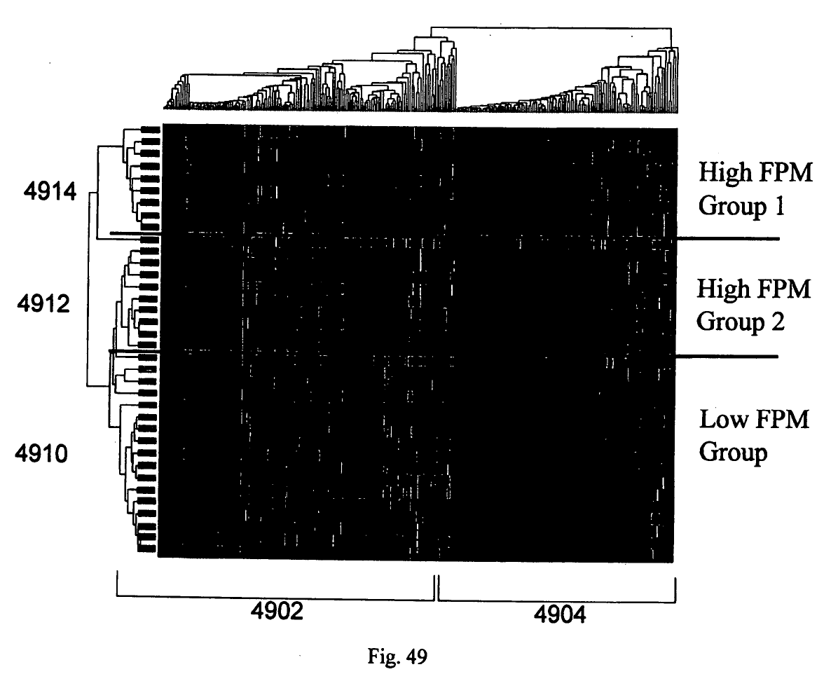

FIG. 49 represents a two-dimensional cluster analysis. On the x-axis, the expression vectors for each of the 280 genes are clustered. To form the clustering on the y-axis, a vector was constructed for each of the 111 mice. Each such vector includes the expression value for each of the 280 genes considered in the respective mouse associated with the vector. Then these vectors are clustered along the y-axis. Thus, in FIG. 49, the x-axis clusters genes that express similarly across the population of mice and the y-axis clusters mice that have similar gene expression values for the set of 280 genes. Each x,y coordinate in the two-dimensional graph represents the expression level of a gene in a given organism. Although not clearly shown in FIG. 49, each x,y coordinate in the two-dimensional graph is color coded to indicate the expression level of the gene in the given organism relative to a reference pool.

The two-dimensional cluster analysis illustrated in FIG. 49 allows for the determination of subgroups in the population. Clearly such subpopulations will be defined by clusters on the y-axis. However, the patterns produced by the clustering on the x-axis aid in defining the subpopulations on the y-axis. Namely, each subgroup on the y-axis should have a similar patterns of expression across the 280 member gene set. Analysis of FIG. 49 reveals three such sets. The y-axis was not clustered based on a clinical trait. Nevertheless, the mice on the y-axis cluster into distinct phenotypic groups. The first set is the low fat pad mass group. The low fat pad mass group is defined by two factors. First, the low fat pad mass group define a cluster on the y-axis. Second, genes in the low fat pad mass group that are in set 4902 tend to be green-shifted relative to the reference pool whereas as genes in set 4904 tend to be red-shifted relative to the reference pool. The expression pattern of the genes in the 280 member set along the y-axis serve to validate that the low fat pad mass group in not, in fact, a composite of two or more subgroups. Continuing with this form of analysis, two other groups (high fat pad mass 1 and high fat pad mass 2) are defined on the y-axis and validated by the pattern of expression along the y-axis as summarized in the following table:

| | | X-axis - | |
|---|---|---|---|
| Name | Y-axis | gene set 4902 | X-axis - gene set 4904 |
| Low FPM | Cluster 4910 | Green | Red |
| High FPM 2 | Cluster 4912 | Green | Red |
| High FPM 1 | Cluster 4914 | Green/red | Green |

Steps D and E. The patterns realized in FIG. 49 serve to define the obesity trait, FPM. In fact, these patterns refine the definition of FPM beyond what would be possible without the expression data. There are clearly two distinct patterns associated with high FPM mice depicted in FIG. 49 (High FPM 2 and High FPM 1). Heterogeneity of expression patterns associated with a clinical trait, almost certainly points to heterogeneity in the clinical trait itself.

To further elucidate this clinical trait, the 111 F2 animals for which clinical and gene expression data existed were classified into one of the three groups depicted in FIG. 49. Subsequently, separate linkage analyses were performed on two sets of animals: 1) those classified as high FPM group 1 or low FPM, and 2) those classified as high FPM group 2 or low FPM. In this linkage analysis, the quantitative trait FPM was analyzed using the above-identified subpopulations rather than the whole population.

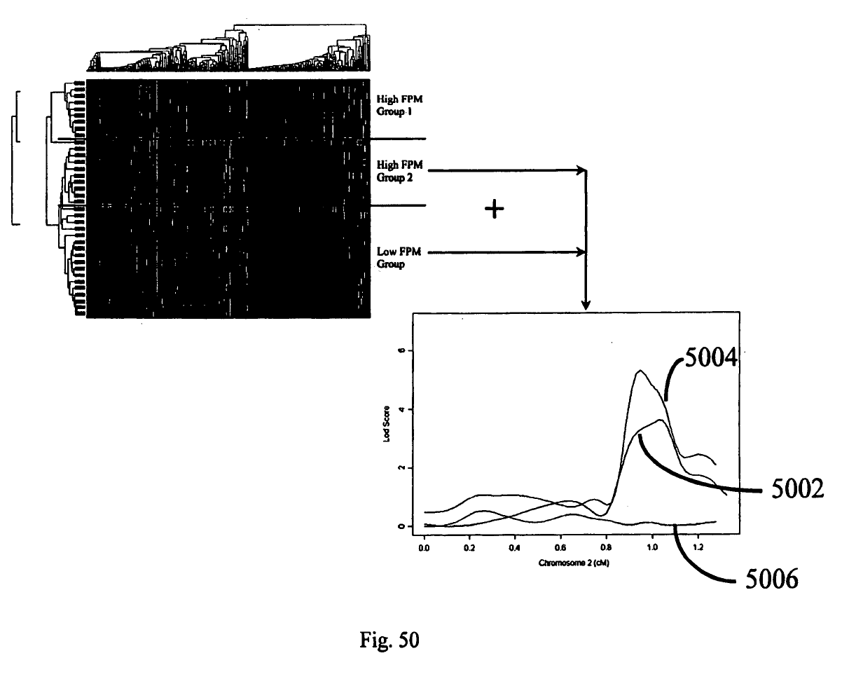

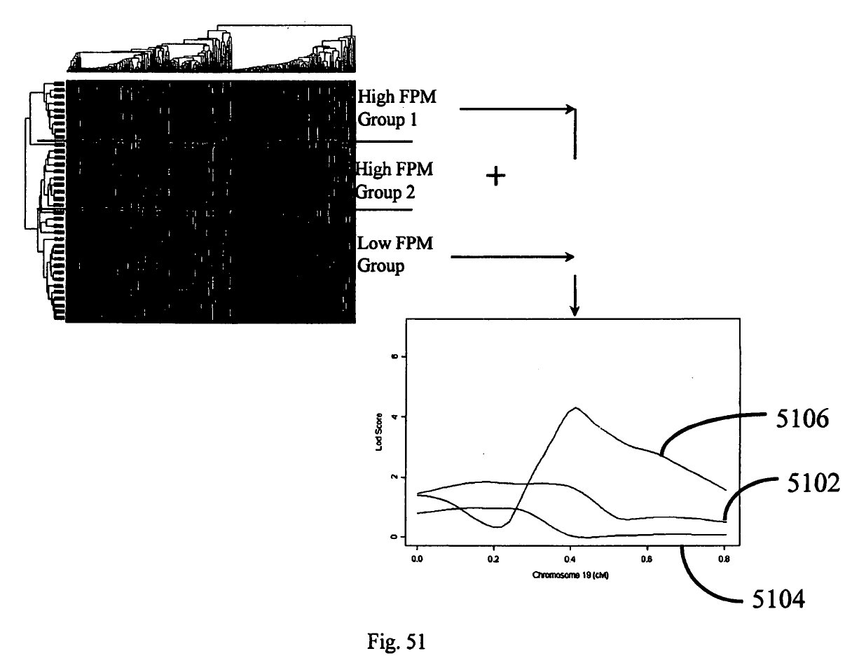

FIGS. 50 and 51 depict the results of these analyses for two chromosomes. The chromosome 2 FPM QTL (FIG. 50) was the largest of four QTL originally identified for FPM when all animals were considered together. The magnitude of the QTL at this position of chromosome 2 using all mice in the linkage analysis is depicted by curve 5002. However, this QTL vanishes when considering the high FPM group 1 with the low FPM group (FIG. 50, curve 5006), but then increases by almost 2 lod units over curve 5002 when considering the high FPM group 2 with the low FPM group (FIG. 50, curve 5004).

FIG. 51 depicts a locus for which the original analysis on the full set of mice yielded no significant QTL for the FPM trait on chromosome 19 (FIG. 51, curve 5102), but the high FPM group 2 considered with the low FPM group gave rise to a QTL (FIG. 51, curve 5106) with a significant lod score, while the high FPM group 1 considered with the low FPM group was less significant than the that of the full set (FIG. 51, curve 5104).

The results of this example indicate that the chromosome 2 and 19 QTL each significantly affect only a subset of the F2 population, a form of heterogeneity that speaks directly to the complexity underlying traits such as obesity. Further, the chromosome 19 QTL explains 19% of the variation in the FPM trait for the high FPM group 1/low FPM subset, but would have been completely missed if the expression data had not been used to define the subphenotypes. The significances of the QTL with the highest lod scores depicted in FIGS. 50 and 51 were assessed by repeatedly sampling (10,000 times) from the full set of F2 animals so that groups equal in size to the high FPM group 1/low FPM and high FPM group 2/low FPM groups were obtained for each iteration. None of the 10,000 samplings obtained QTL approaching the significances of those given in FIGS. 50 and 51.

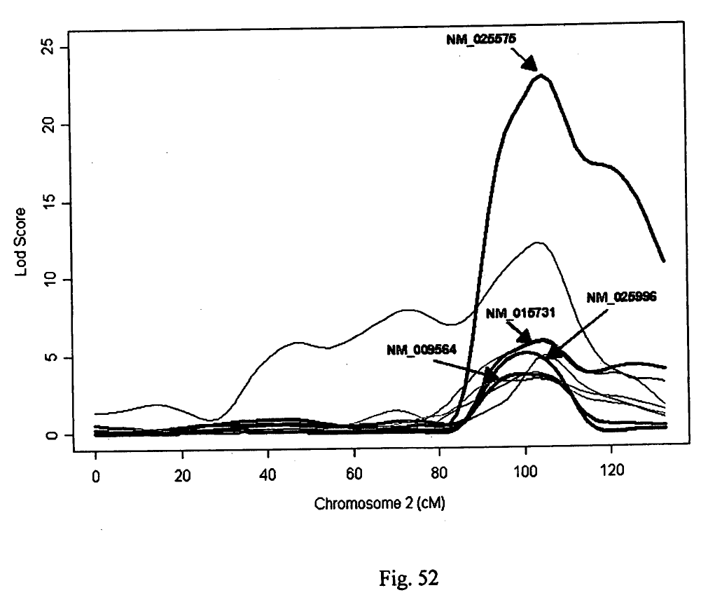

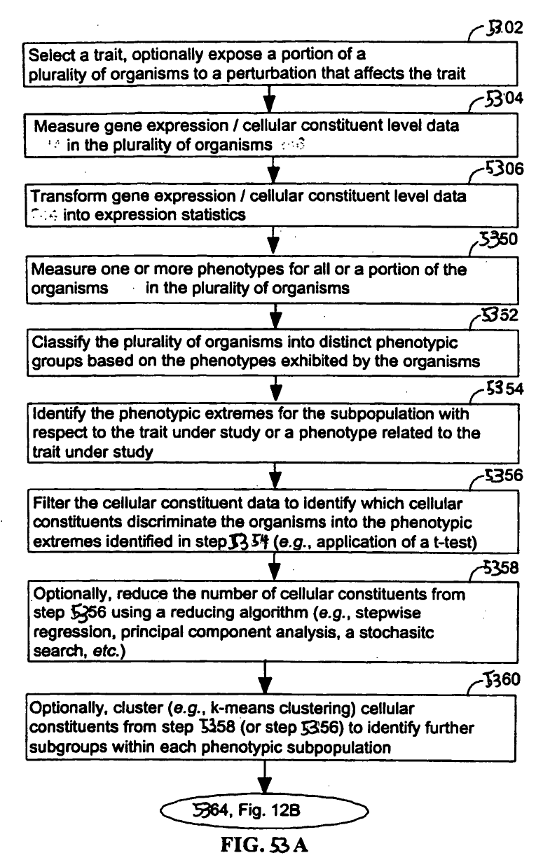

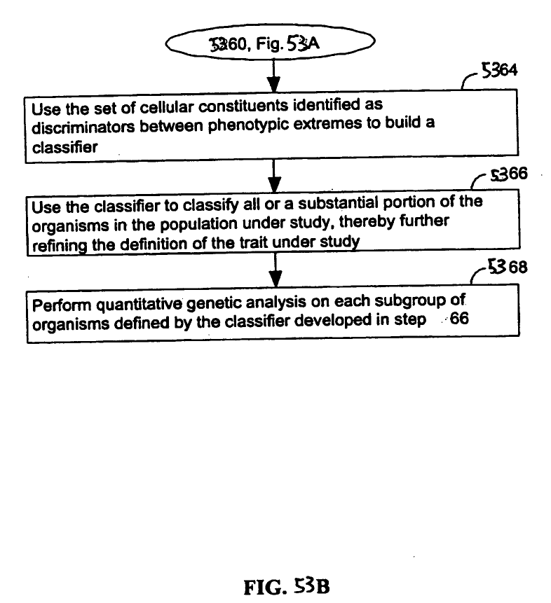

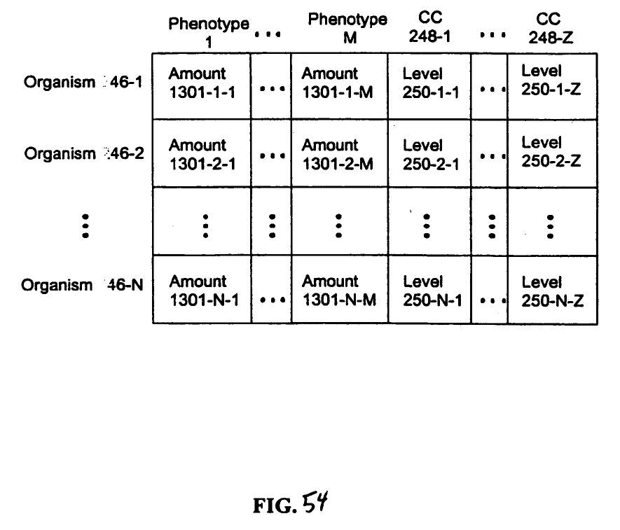

An expanded view of the clinical traits and a portion of the gene expression traits linking to the chromosome 2 locus discussed above and described in FIG. 50, is given in FIG. 52. Co-localized with the FPM QTL are other QTL for obesity-related traits described by Drake et al., 2001, Physiol. Genomics 5: 205, which is hereby incorporated by reference in its entirety. These traits include adiposity, fat pad mass, plasma lipid levels and bone density. FIG. 52 shows the lod score curves for four of the obesity-related traits. Interestingly, a group of major urinary protein genes (MUP1, MUP4 and MUP5) are linked to the chromosome 2 locus, in addition to seven other loci (all with LOD score exceeding 2.0), four of which co-localize with adiposity or fat pad mass traits. The MUP1 gene stands out because it was the most highly correlated with many other genes known to be involved in obesity-related pathways, including retinoid X receptor (RXR) gamma (R=0.75/P-value<<1.0E⁻¹⁵), acyl-Coenzyme A oxidase 1 (R=0.65/P-value=3.78E⁻¹⁵), and leptin receptor (R=−0.74/P-value<<1.0E⁻¹⁵), in addition to having QTL that co-localize with other genes like peroxisome proliferator activated receptor (PPAR) gamma, RXR interacting protein and LPR6, all known to be involved in these pathways. Mutations in the leptin receptor in mice and man cause hyperphagia and extreme obesity. See, fore example, Chen et al., 1996, Cell 84:492; Chua et al., 1996, Science 271:994, Clement et al., 1998, Nature 392:398, Montague et al., 1997, Nature 387:903; Strobel et al., 1998, Nat. Genet. 18:213; and Tsigos et al., 2002, J. Pediatr. Endocrinol. Metab. 15:241, each of which is hereby incorporated by reference in its entirety. RXR is the obligate partner of many nuclear receptors including PPARα and PPARγ that are involved in many aspects of the control of lipid metabolism, glucose tolerance and insulin sensitivity. See, for example, Chawla, 2001, Science 294:1866. This demonstrates that the chromosome 2 locus draws together adiposity, fat pad mass, cholesterol and triglyceride levels and is linked to genes with proven roles in obesity and diabetes. Further, the MUP genes are members of the lipocalin protein family, and while they are known to play a central role in phermone-binding processes that affect mouse physiology and behavior (Timm et al., 2001, Protein Science 10:997, which is hereby incorporated by reference in its entirety), variations in MUP expression have been associated with variations in body weight and bone length (Metcalf et al., 2000, Nature 405:1068, which is hereby incorporated by reference in its entirety), as well as VLDL levels (Swift et al., 2001, J. Lipid Res. 42:218, which is hereby incorporated by reference in its entirety).

The region supporting the chromosome 2 locus is homologous to human chromosome 20q12-q13.12, a region that has previously been linked to human obesity-related phenotypes. See, for example, Borecki et al., 1994, Obesity Research 2:213; Lembertas, 1997, J. Clin. Invest. 100:1240, each of which is hereby incorporated by reference in its entirety). The human homologues for genes NM_{—}025575 and NM_{—}015731 highlighted in 11 reside in the human chromosome 20 region and have not been completely characterized; they have not been implicated in obesity-related traits before. While other genes such as melanocortin 3 receptor (MC3R) have been suggested as possible candidates for obesity at this locus (Lembertas et al., 1997, J. Clin. Invest. 100:1240, which is hereby incorporated by reference in its entirety), the data in this example suggests that the genes NM_{—}025575 and NM_{—}015731 may be responsible for the underlying QTL, which are not only significantly linked to the murine chromosome 2 locus, but that are also significantly interacting with several of the fat pad mass traits also linked to the chromosome 2 locus. The expression levels for MC3R are not linked to the chromosome 2 locus, and there were no SNPs annotated in the exons or introns of this gene between the C57/BL6 and DBA/2J strains in a recent build of the Celera RefSNP database. Unless polymorphic expression of MC3R in the brain partially drives expression in the liver for genes linked to the chromosome 2 locus, these facts would suggest that MC3R is not the gene underlying the chromosome 2 linkage in this case.

In summary, F2 animals were classified into one of three groups (high FPM 1, high FPM 2, and low FPM) using the methods of the present invention. The animals were then genetically analyzed using QTL methods applied to the different high FPM groups, each combined with the low FPM group for the analysis. The results for the distal end of chromosome 2 were presented. The FPM QTL in this region of chromosome 2 completely vanishes when considering one of the high FPM groups of mice, but then increases by almost 2 lod units over the original lod score when considering the other high FPM group of mice. In addition, another interesting locus was discovered on chromosome 19 that had been completely missed when all mice were considered simultaneously. In this instance, the high FPM group of mice that was not under the influence of chromosome 2 QTL, gave rise to a QTL with a significant lod score, while the other high FPM group had a lod score that was less significant than that obtained for the full set.

The results of this example provide evidence that gene expression patterns can be used to refine the definition of a clinical trait into subtypes that are under the control of different genetic loci. The implications for drug discovery are significant and speak directly to the difficulty in dissecting complex diseases. Clearly, developing a compound that targeted only the gene underlying the FPM chromosome 2 QTL would be completely ineffective for those in the high FPM group 1 (since they are not controlled by this locus), but would be quite effective for those in the high FPM 2 group (since they are controlled by this locus). Treating all obese individuals together in one group would result in a much less efficacious treatment than could otherwise be achieved by identifying those that would respond to the treatment. Further, by defining the subpopulation most likely to respond to a given drug treatment as one of many subpopulations making up the population of all obese patients, the drug development and diagnostic components of the pharmaceutical industry will tend toward a natural restructuring that allows each component to become more productive by stratifying populations according to treatment groups at the earliest possible stages of drug development. This progressive strategy will more intimately link the two classically independent worlds of drug development and diagnostics. Similar arguments can be made for studying toxicity, since adverse response to a drug is also a complex trait that can be dissected in a fashion similar to that described above.

### 6.3 Functional Analyses of Exemplary Genes Identified from Causality Study

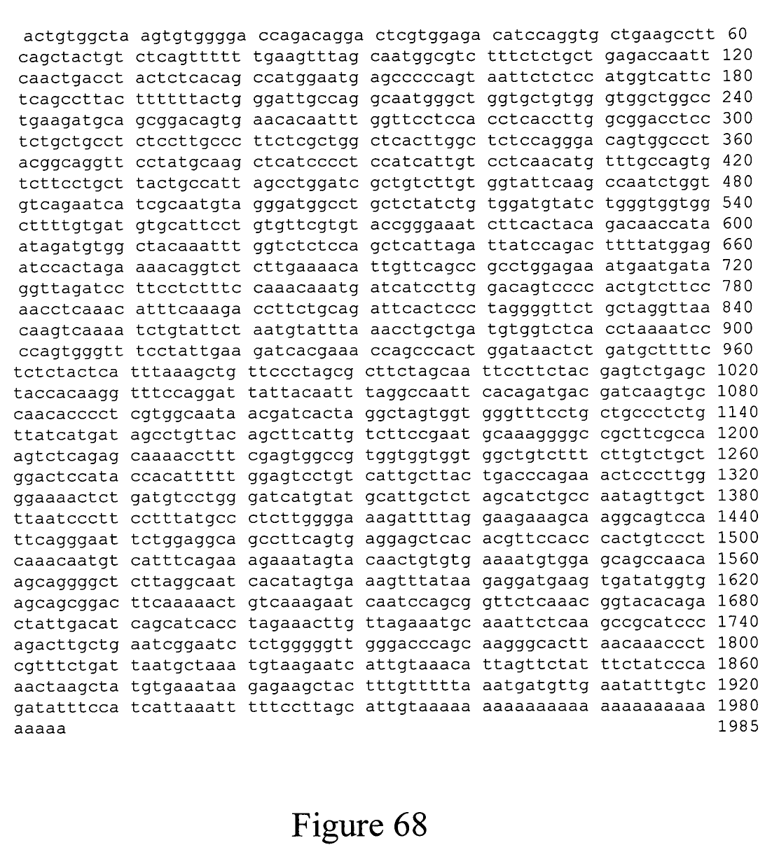

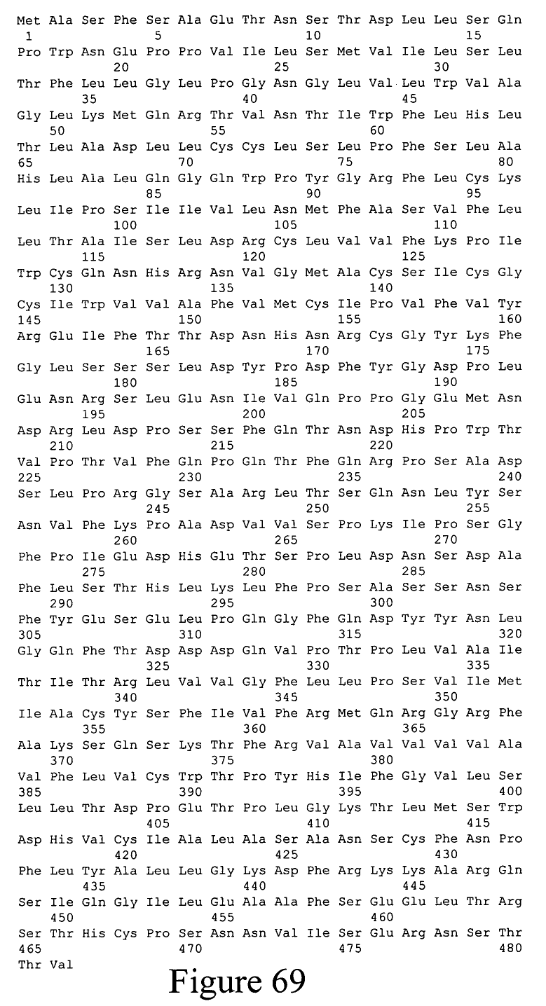

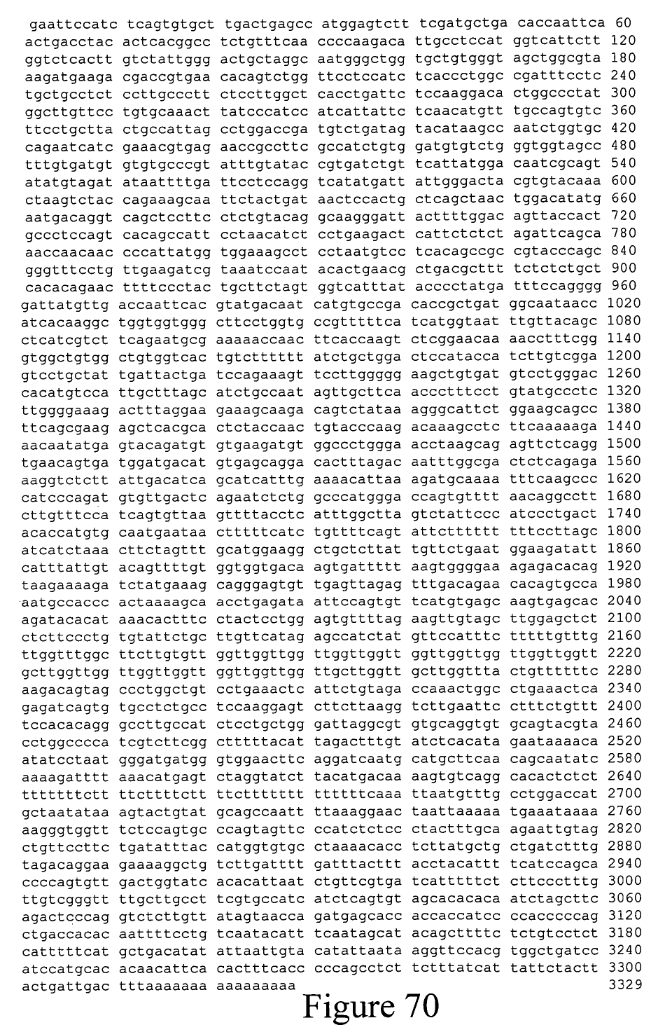

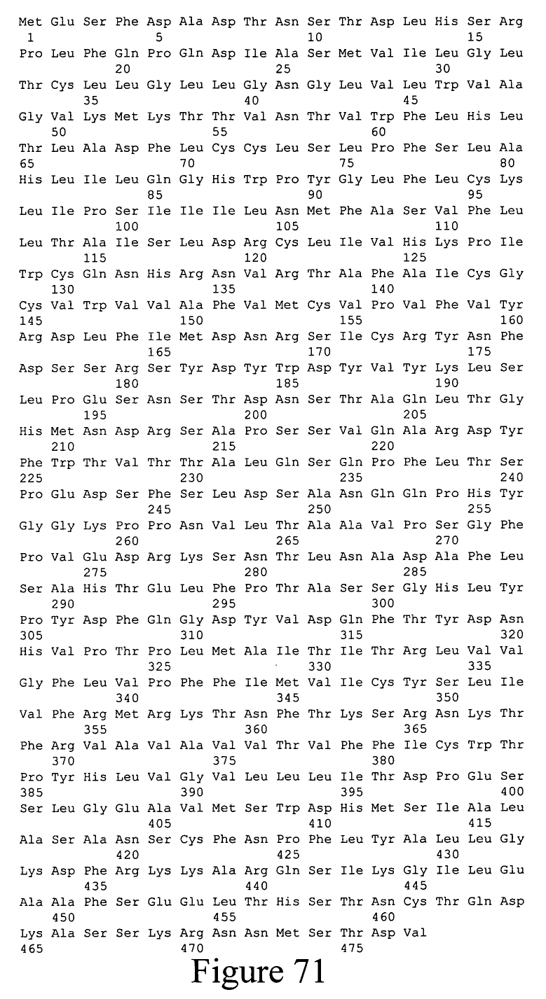

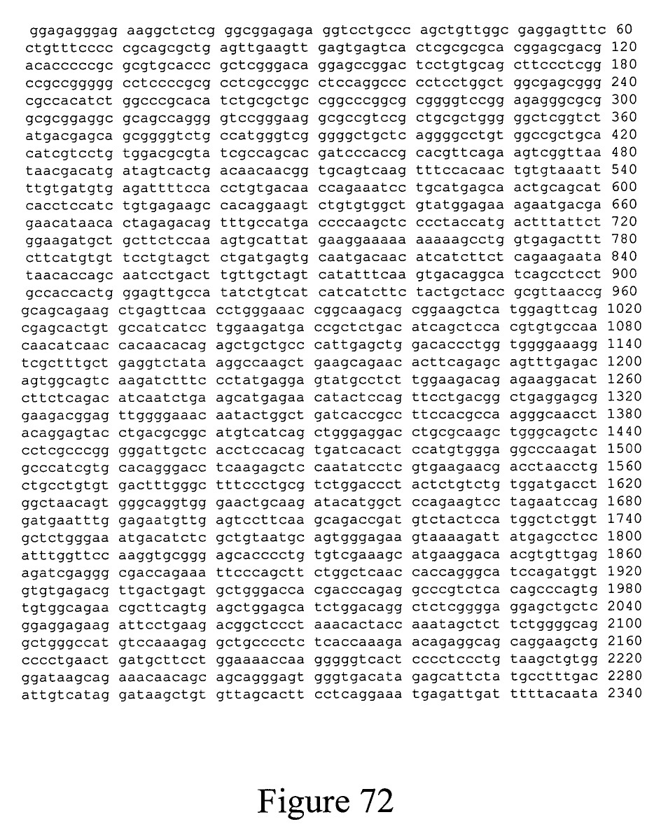

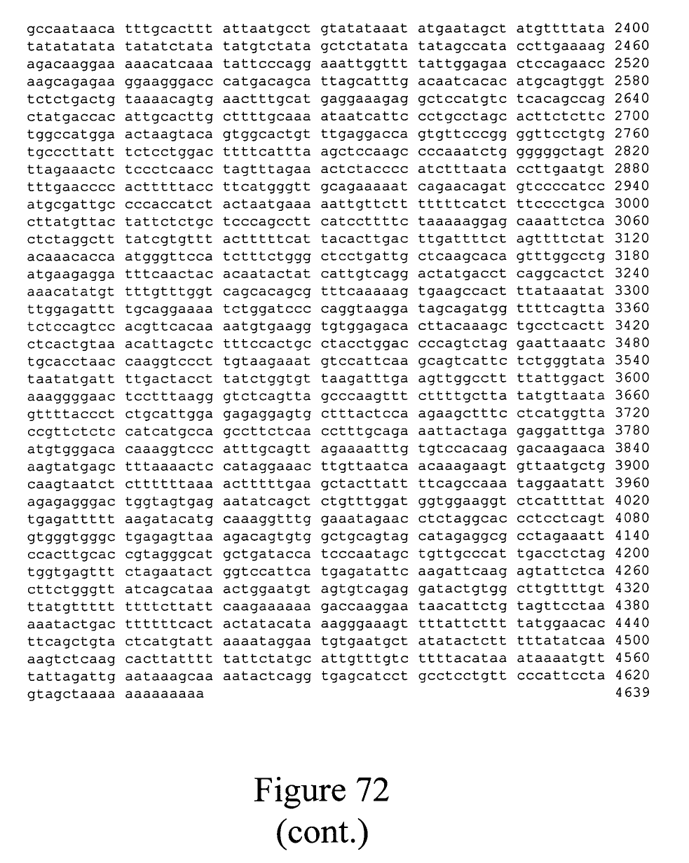

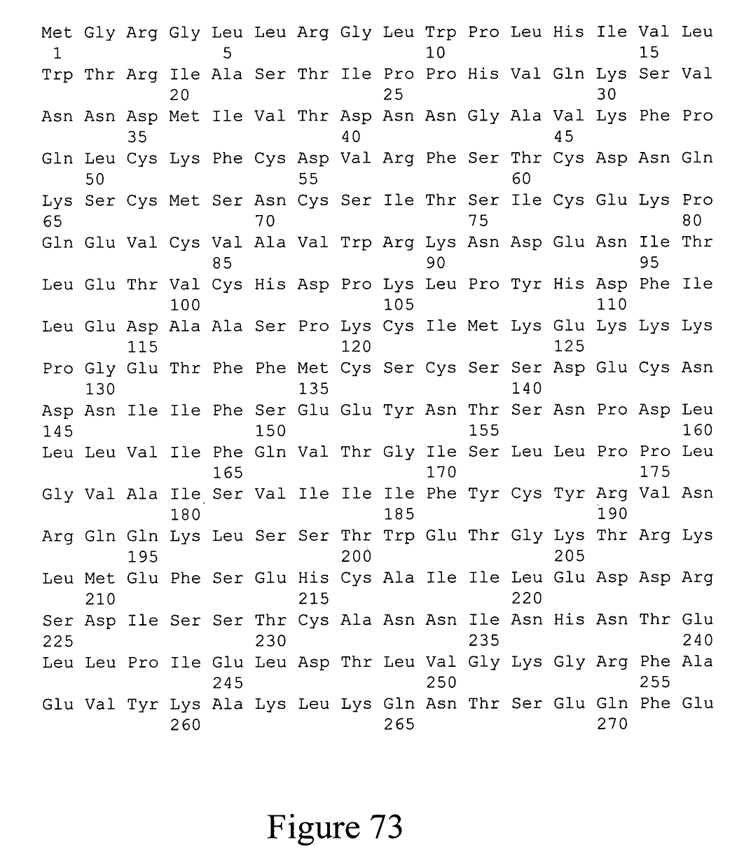

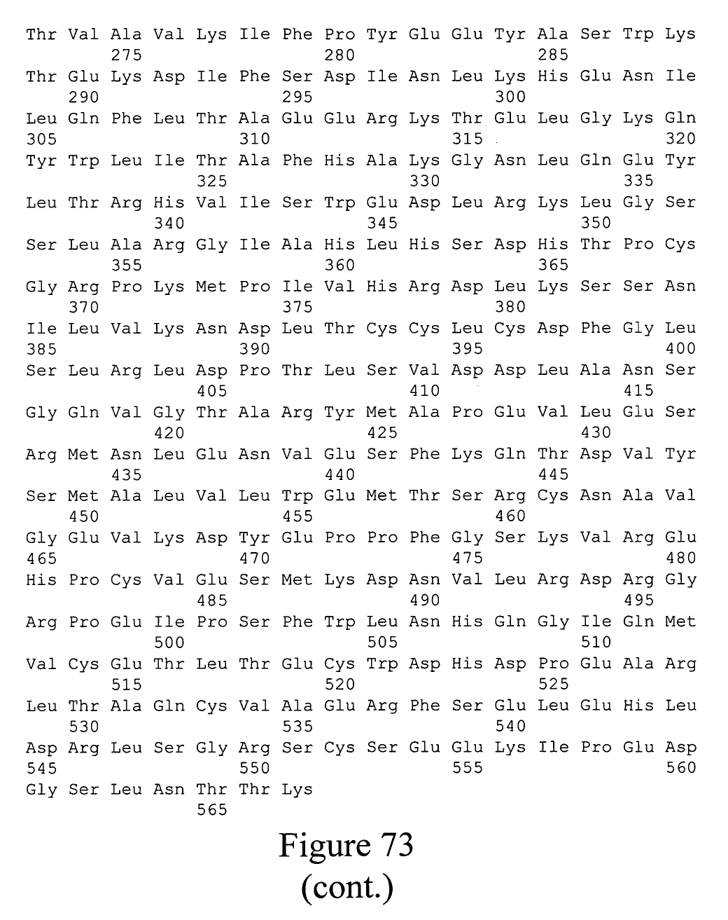

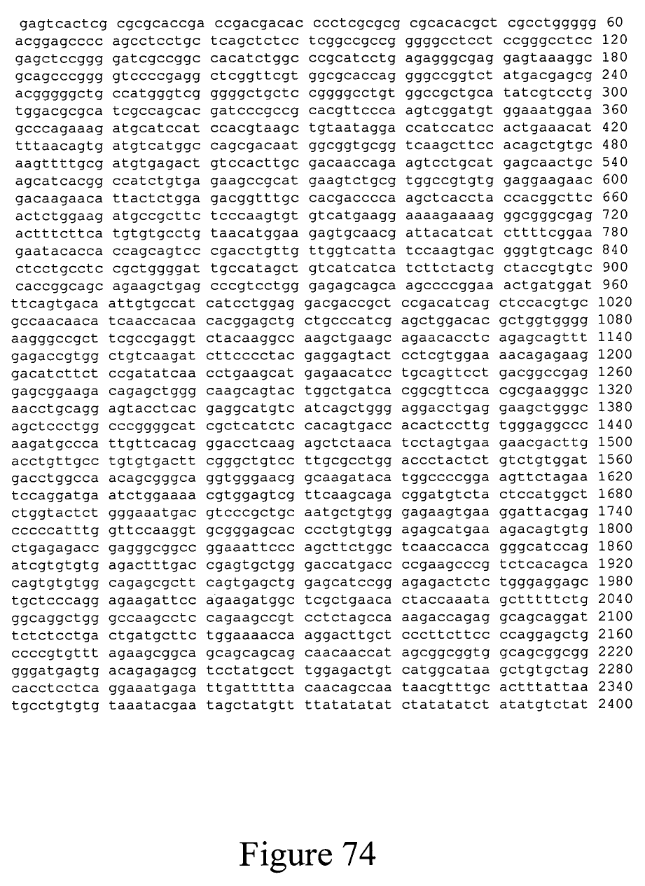

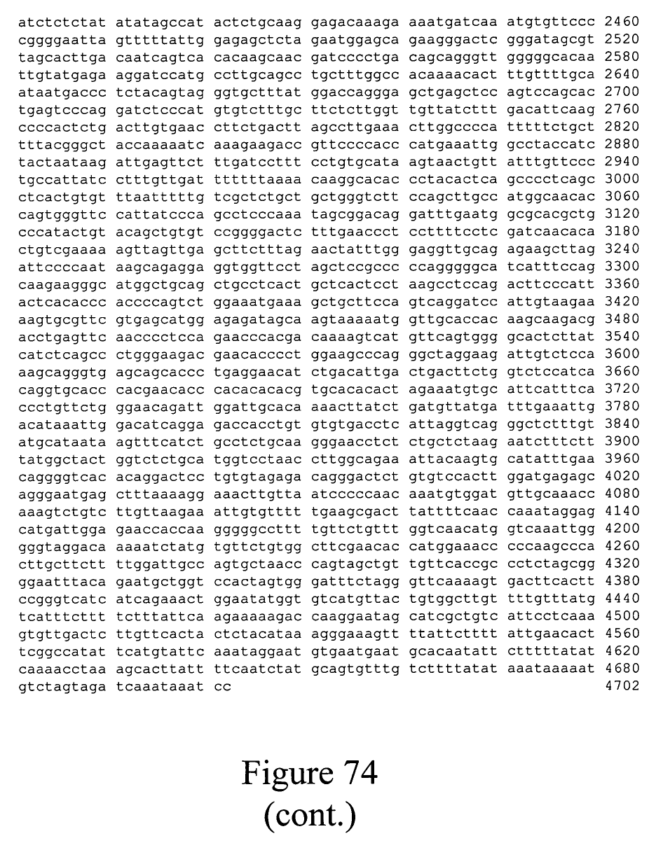

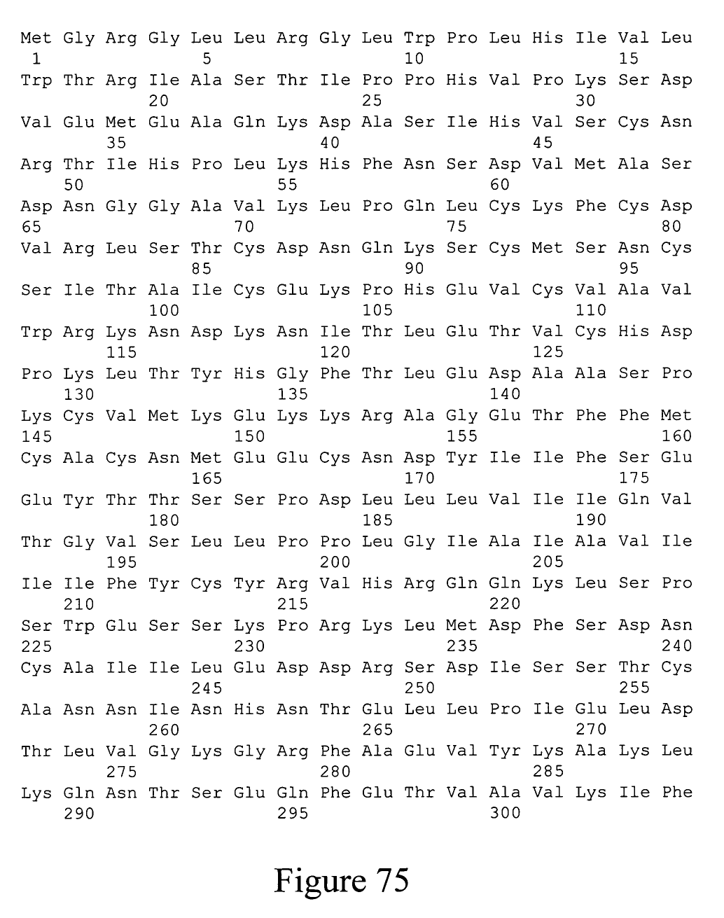

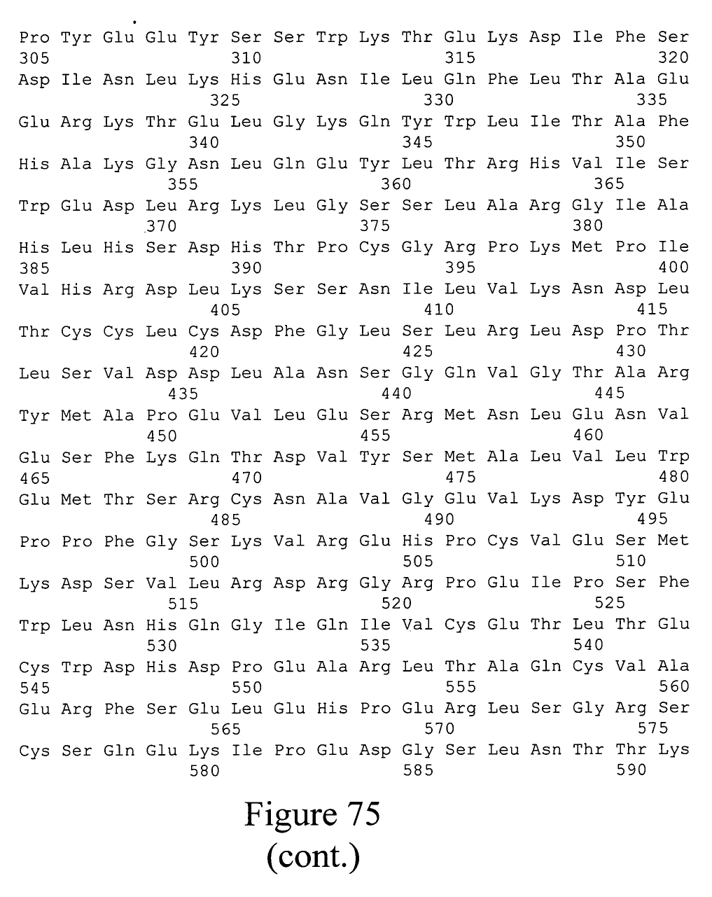

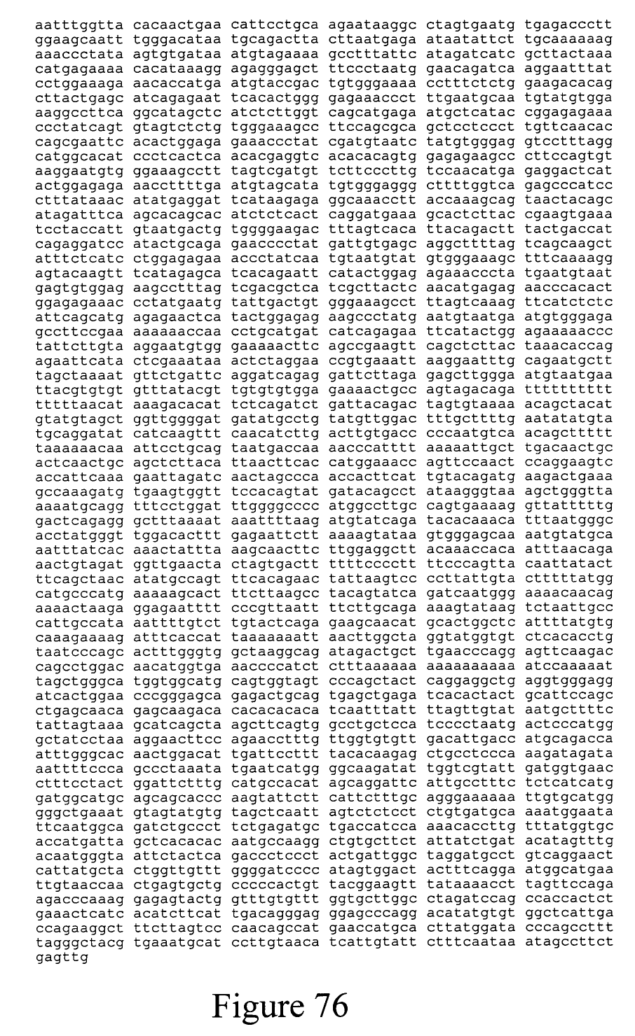

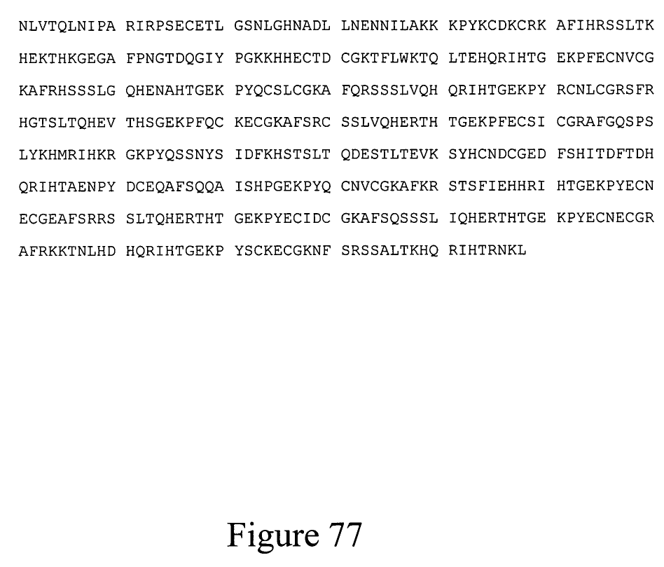

Among the genes with liver gene-expression traits significantly correlated with OFPM in the BxD cross (e.g., Table 4), around 90 genes (e.g., Table 5) have at least two eQTL overlapping OFPM QTL tested for causal associations to OFPM and have thus been prioritized as the causal genes associated with OFPM. In order to evaluate and validate the results of causality studies, selected target genes were further analyzed to assess their functional importance. The standard for validating this type of prediction was the construction of animals that were genetically altered with respect to the activity of the gene of interest followed by screens for variations in the trait of interest. Transgenic mice were thus created to evaluate four target genes: Mod1 (Malic enzyme, SEQ ID No: 2 for murine protein, SEQ ID NOs: 1, 3 and 4 for human proteins), Zfp90 (Zinc finger protein 90, SEQ ID No: 10 for murine protein, SEQ ID No: 34 for human protein), C3ar1 (Complement component 3a receptor 1, SEQ ID No: 28 for murine protein), and Tgfbr2 (Transforming growth factor beta receptor II, SEQ ID No: 32 for murine protein). A Mod1 null mouse strait was discovered through spontaneous mutation analysis. C3ar1 and Tgfbr2 (numbers 14 and 29 in the list in Table 5, respectively) knockout mice were commercially available from Deltagen, Inc. (San Carlos, Calif.). A BAC transgenic mouse strain was constructed for Zfp90, which was one of the top ten gene expression traits correlated with and testing was significantly causal for the OFPM trait as shown in Table 6. Details on creating the transgenic mice strains are found in Sections 6.3.2.1 and 6.3.2.2. Sequence information for Mod1, Zfp90, C3ar1 and Tgbr2 is described in FIGS. 68 through 75.

For each target gene, the mutant mice and wild-type mice were subjected to high fat or high sucrose carbohydrate diets. The body compositions of both mutant and WT mice, lean mass and fat mass, were analyzed to assess the target genes' effects on diet induced obesity. Exemplary statistical tools for analyzing the fat mass differences between wild-type and knock-out mice are summarized below.

Given that the experimental design for assessing fat mass differences between wild-type (WT) and knock-out (KO) animals involved multiple repeated measures over a number of time points for each animal, these longitudinal data were leveraged to enhance the power to detect differences at any given time point using autoregressive models (Shumway and Stoffer, 2000, Time Series Analysis and Its Applications, Springer, N.Y., xiii, 549, which is hereby incorporated herein by reference in its entirety). In particular, if yₜₗ represents the fat mass measure for animal l at time point t, then the autoregressive model of interest is:

$${y}_{tl} = {γ}_{0 t} + {γ}_{1 t} {Q}_{l} + {\sum }_{j = 1}^{l} {ϕ}_{tj} ( {y}_{t - j , l} - {{y}^{⋒}}_{t - j , l} ) + {w}_{tl}$$

for seven different time points: 7, 6, 5, 4, 3, 2, 1=t (e.g., the seven time points over which fat mass measures were taken), where var (wₜₗ)=σₜ², for l=1, . . . , n, where n was the number of animals in the study. Here, Qₗ is the genotype indicator for the gene of interest, taking the value 0 for wildtype animals and 1 for KO animals. y_{t-j,l}−ŷ_{t-j,l} represents the fat mass measures at time point t−j+1, where ŷ_{t-j,l} is the prediction of y_{t-j,l} from the previous model. In taking this difference as the fat mass measure for a time point of interest, the effect of genotype on fat mass at previous time points was effectively removed.

After fitting the model at the desired time point, the parameter yₜₗ can be tested for significance using a standard t test. Therefore, the null hypothesis for the test was that there is no difference in fat mass between the KO and WT groups, conditional on genotypic effects from the previous time points.

### 6.3.1. Validating Mod1 as an Obesity Target

Causality analysis examines associations between obesity chromosomal QTLs (cQTL) and expression QTLs (eQTL). Once obesity eQTLs of a gene were identified as co-localizing with obesity cQTLs, a novel statistical test was used to determine if the expression trait was causal, reactive or independent for the obesity traits. By separating causal genes from reactive and independent genes, target identification could be significantly facilitated. In a recent F2 analysis of a cross between two strains of mice differing in obesity traits, Mod1, the mouse homolog of cytosolic malic enzyme, was identified as one of the genes causally linked to obesity (Schadt et al., 2005, Nature Genetics 37:710, which is hereby incorporated by reference herein in its entirety). Mod1 over-expression was predicted by the causality test to drive adiposity and obesity. Mod1 was listed as one of the top ten gene-expression traits correlated with the supported as causal candidates for OFPM (see Table 6 in Section 5, above).

### 6.3.1.1. Cytosolic and Hepatic Mod1

Malic enzyme (Mod1) is found in the cytosol as well as in the liver. Cytosolic Mod1 is a homotetrameric enzyme that catalyzes a reversible oxidative decarboxylation of malate to yield pyruvate and carbon dioxide. This reaction generates cytosolic reducing agent NADPH necessary for the de novo synthesis of long chain fatty acids (see Frenkel, 1975, Curr. Top. Cell. Regul. 9:157, which is hereby incorporated herein by reference in its entirety). In mammals, two additional isoforms of malic enzyme reside in mitochondria. One mitochondria variant uses NAD as the cofactor, while the other variant prefers NADP but can also use NAD.

Hepatic Mod1 is reduced markedly during starvation, and rebounded upon refeeding a carbohydrate-rich diet. A high carbohydrate/low fat diet also induces malic enzyme synthesis, together with glucose-6-phosphate dehydrogenase and 6-phospho-gluconate dehydrogenase. All three are considered lipogenic enzymes because of their concerted induction by high carbohydrate/low fat diet and their capability in providing NADPH for the biosynthesis of long-chain fatty acids or steroid. In lipogenic tissues like liver and adipose tissue, more than 90% of malic enzyme activity is present in the cytoplasmic fraction (Zelewski et al., 1991, Eur. J. Biochem. 201:339, which is hereby incorporated herein by reference in its entirety).

Cytosolic Mod1 appears to play an important role in fatty acid synthesis and lipid accumulation when utilizing high carbohydrate diet. It is down regulated by high fat diet and plays a lesser role when dietary fat is abundant. Studies in obese mice and rats show that higher levels of obesity generally associated with elevation of Mod1 expression (Yen et al., 1976, Horm. Meta. Res. 8:159; Huupponen et al., 1989, Diabetes Res. 10:143; Cheema et al., 1996, Biochem. Biophys. Acta. 16:284; and Becker et al., 2004, J. Mol. Endocrino. 32:195, each of which is hereby incorporated herein by reference in its entirety), suggesting that Mod1 could contribute to the development of obesity. Since several other lipogenic enzymes were also associated with an increase in obesity, the relative contribution of Mod1 to obesity was not defined.

### 6.3.1.2. Analyzing the Function of Mod1 by Genotyping

A spontaneously occurring strain of Mod1 null mice was used to verify that Mod1 contributes to the development of obesity. In the null mice, aberrant Mod1 mRNA carries a 522 basepair duplication corresponding to nucleotide 1027-1548 in the wild-type Mod1 transcript. The duplication results in the lack of production of cytosolic Mod1 (Brown et al., 1988, J. Biol. Chem. 263:4494, which is hereby incorporated herein by reference in its entirety).

The mice were housed in polypropylene cages under murine pathogen free conditions with continuous health monitoring at Taconic Biotechnology, Rensselaer N.Y. Husbandry and manipulations were performed in accordance with IACUC approved standard operating procedures as part of an AAALAC-accredited animal care program.

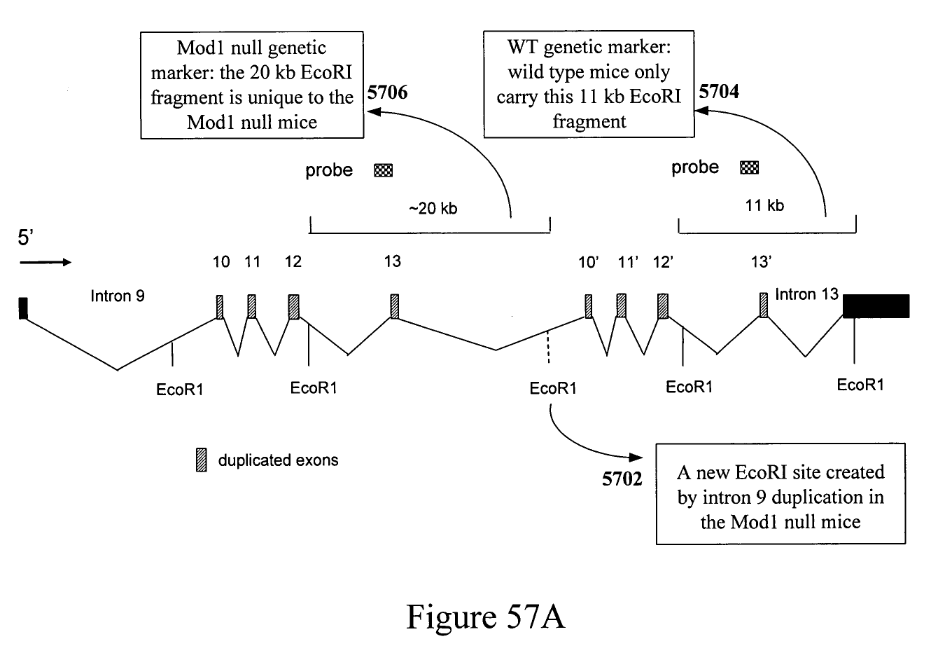

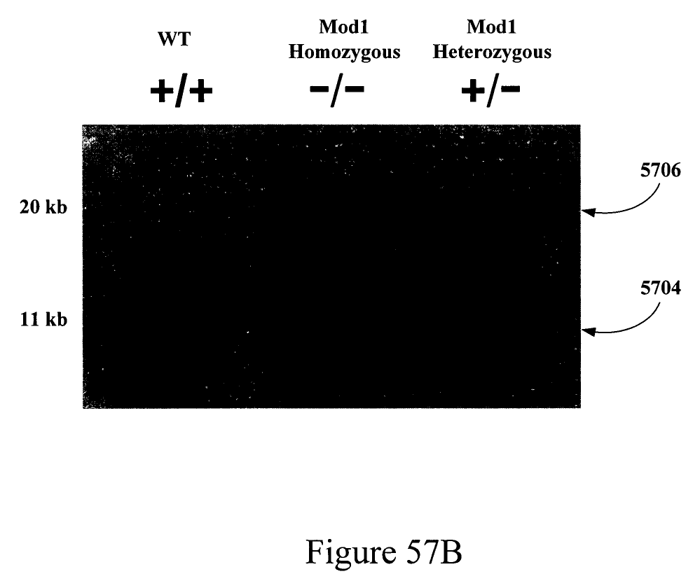

FIG. 57A illustrates the Mod1 null gene structure between exon 9 and exon 14. A region spanning exon 10 to 13 was duplicated in the null Mod1 gene. The inter-allelic recombination between intron 9 and intron 13 of the Mod1 gene was responsible for the 522 basepair duplication in Mod1 mRNA in Mod1 null mice. In a WT mouse, EcoRI site probing between intron 12 and exon 13 junction detected only a 11 kb EcoRI fragment (e.g. 5704 in FIG. 57A). By EcoRI restriction digest, the 11 kb fragment of 5704 can be released from both WT and Mod1 null mice. In a Mod1 null mouse, however, the new recombinant intron between exon 13 and duplicated exon 10′ contained a duplicated intron 9 EcoRI site (e.g. 5702 in FIG. 57A), which created a 20 kb EcoRI fragment in addition to the 11 kb EcoRI fragment. Being unique to the Mod1 null mice, the 20 kb EcoRI fragment was thus used as a unique genetic marker for the Mod1 null mice (e.g. 5706 in FIG. 57A).

The homozygous Mod1 mice were crossed to WT C57B6 mice. The heterozygous progenies were interbred to generate littermate homozygous Mod1 null mice and WT control mice. Based on the different EcoRI restriction patterns generated by different genotypes, a Southern blot method was developed to genotype heterozygous, homozygous and WT Mod1 mice (FIG. 57B). For Southern blot analysis, DNA samples of three types of mice were prepared from tail samples. Tail samples were lysed overnight by proteinase K digestion. The lysates were treated with 50 μg/ml RNase for 30 minutes at 42° C., followed by 1.5 mg/ml proteinase K digestion and phenol-chloroform extraction. DNA was ethanol precipitated and resuspended in 0.2×TE buffer. An aliquot of 15 μg genomic DNA was digested overnight with EcoRI in a 200 μl volume, ethanol precipitated, resuspended in 20 ul, and ran on a 0.7% agarose gel. The DNA was transferred to GeneScreen Plus (NEN Products, Boston, Mass.) by alkaline transfer following vendor's protocol. The blots were hybridized with a random-prime ³²P-labeled probe in PerfectHyb Plus (Sigma-Aldrich, St Louis, Mo.). The probe is a 480 bp fragment spanning the intron12-exon13 junction of the mod1 gene.

FIG. 57B depicts the result of Southern blot analysis in all three type of mice. In WT mice (+/+), a probe across intron 12 and exon 13 junction detected only an 11 kb EcoRI fragment (e.g., 5704 in FIGS. 57A and B). This probe detected an additional 20 kb EcoRI fragment (e.g., 5706 in FIGS. 57A and B) in heterozygous mice (+/−). Because the 11 kb EcoRI fragment (e.g., 5704 in FIGS. 57A and B) was present in both the WT and mutant alleles, it exhibited greater intensity than the 20 kb EcoRI fragment (e.g., 5704 in FIGS. 57A and B), which was present in only one copy in heterozygous mice. Comparing with the heterozygotes, homozygous null mouse (−/−) had 2 copies of the 20 kb EcoRI fragment, and 2 copies of the 11 EcoRI kb fragment. Therefore, the 20 kb EcoRI band was of greater intensity relative to the 11 EcoRI kb band than that in the heterozygous mouse (FIG. 57B).

### 6.3.1.3. Analyzing the Function of Mod1 by Diet Studies

Both Mod1 null mice and WT mice were acclimated to individual housing for one week prior to diet challenge studies. Animals were fed ad-lib on sterilized diet and water (acidified or hyper-chlorinated). The light cycle was maintained at 12 hours light and 12 hours dark. Animals were housed in solid bottom polypropylene cages with sterilized bedding. Mice at 12-13 week of age were divided into high sucrose and high fat groups. The high sucrose groups were fed for 12-weeks on diet RDI D0042801 (Research Diet, New Brunswick, N.J., 76.5% kcal from carbohydrate, 21.1% kcal from protein, 2.3% kcal from fat; 3.66 kcal/g). The high fat groups were maintained for 8 weeks on diet RDI 12451 (New Brunswick, N.J., 44.9% kcal from fat; 35.1% kcal from carbohydrate; 20.0% kcal from protein; 4.73 kcal/g).

At the onset and end of the diet studies, the mice were scanned by NMR to determine the body composition (lean mass, fat mass). Detailed exemplary methods for the statistical analysis of the fat mass comparison between WT and null mice are included in the beginning of Section 6.3. Body weights of the mice were recorded once a week. Food and water consumption were recorded twice per week. The body weight and food intake measurements were presented as mean±sem, and analyzed by Student's T-test. A P-value of <0.05 was considered statistically significant.

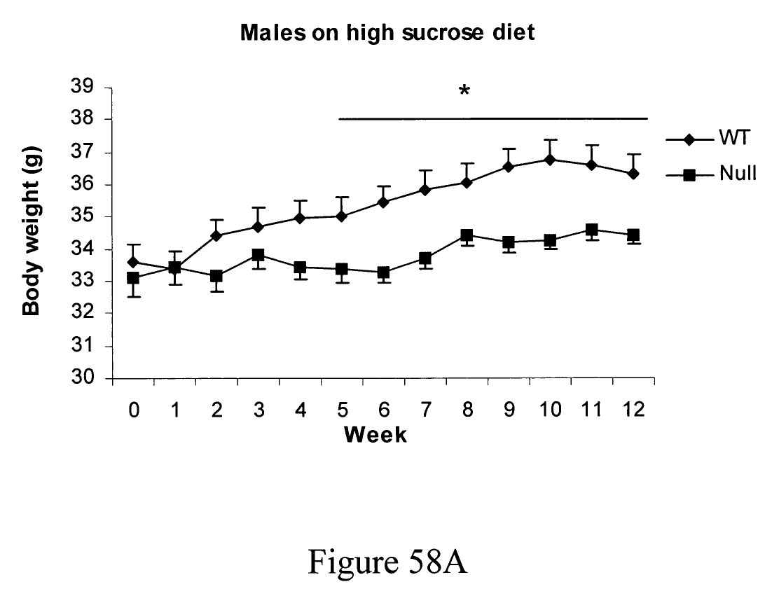

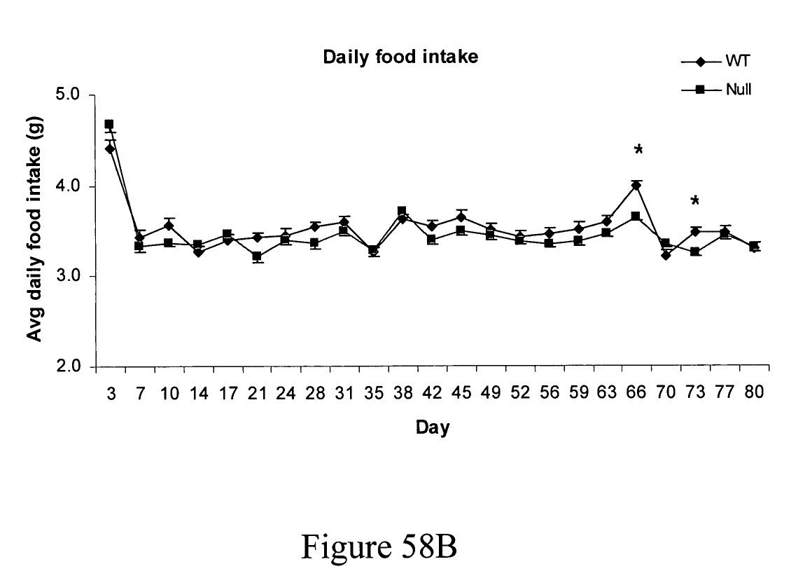

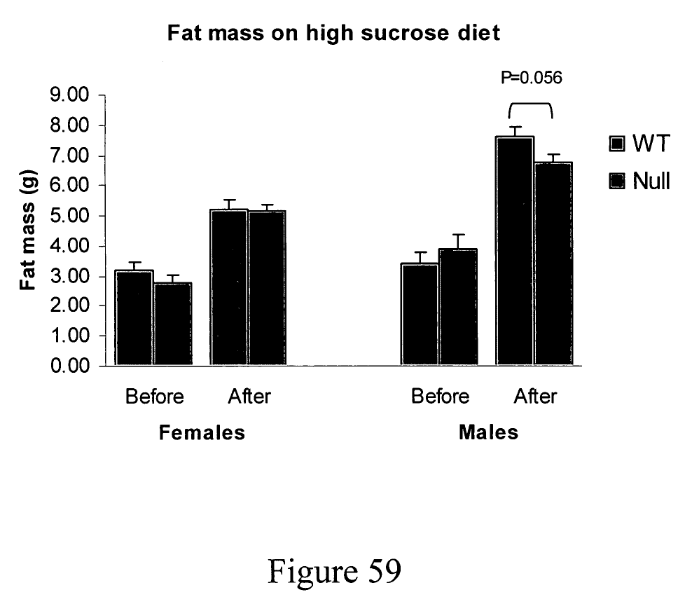

High Sucrose Carbohydrate Diet. After twelve weeks of feeding on the high sucrose carbohydrate-rich diet, male Mod1 nulls gained less weight than WT control mice. As shown in FIG. 58A, the difference between the WT and the Mod1 null mice was modest. The average body weight of the Mod1 null mice was around 1.9 grams (5.5%) less than that of the WT control mice. Daily food intakes of male Mod1 mutant and wild-type control mice appear comparable (compare to FIG. 58B). NMR scanning further revealed reduced fat mass in male Mod1 null mice relative to controls (P=0.056, FIG. 59). Such differences, however, were not observed between the female Mod1 null and WT control mice being fed with the same diet (FIG. 59). In addition, no differences in body weight or food intake were observed between female null and WT control mice (data not shown). Lean mass, OGTT and terminal glucose levels were comparable between WT and Null mice for both genders.

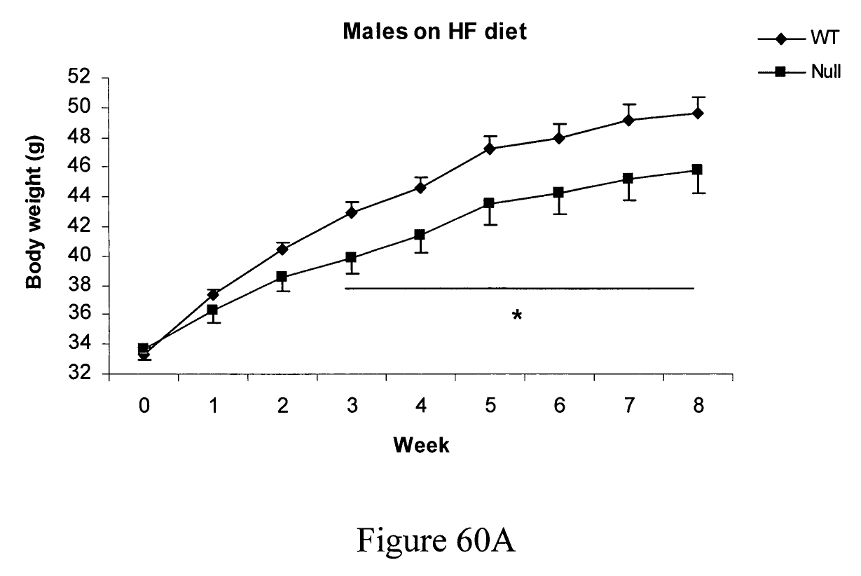

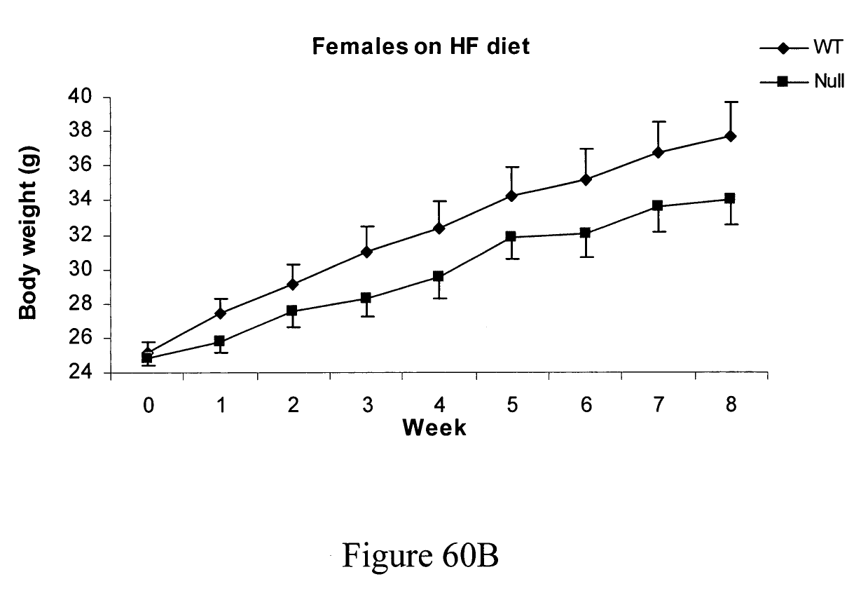

High Fat Diet. The high fat diet challenge is a standard test for diet induced obesity (DIO) sensitivity in mutant mouse strains. Both Mod1 nulls and WT controls were also challenged with high fat diets. After an eight week feeding on the high fat diet, male null mice gained less body weight than WT mice. The average body weight of the male null mice was 45.8 grams, which is 3.9 grams less than that of WT control mice at 49.7 grams (FIG. 60A). This weight difference reflects a 7.8% difference in the average body weight. The weight difference was statistically significant since week three, with a Student's t-test P-value of smaller than 0.05. Female nulls also gained less weight than WT controls when fed with high fat diet (FIG. 60B). At week eight, average body weight of the female Mod1 null mice was 3.6 g (9.6%) less than that of the WT female control mice. However, due to larger variation, the weight difference between female WT and null mice did not pass the Student's t-test to reach statistical significance.

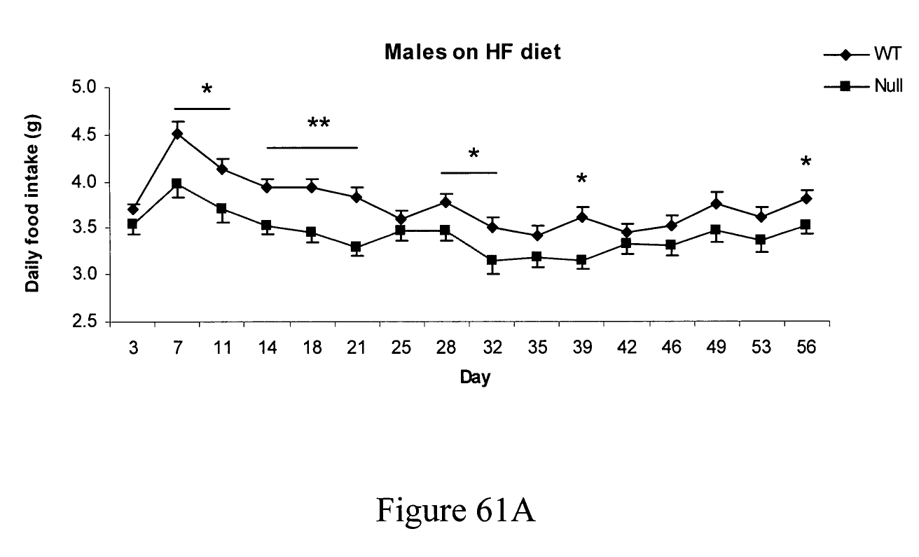

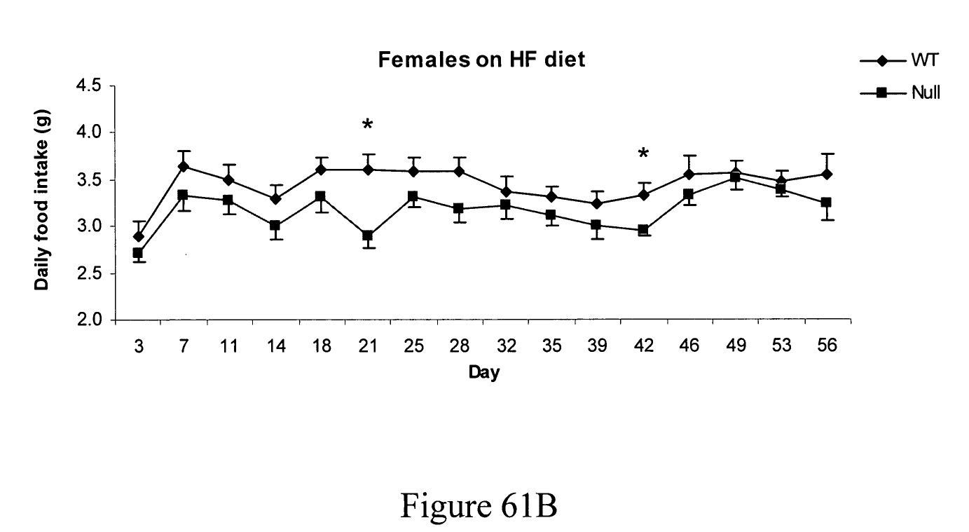

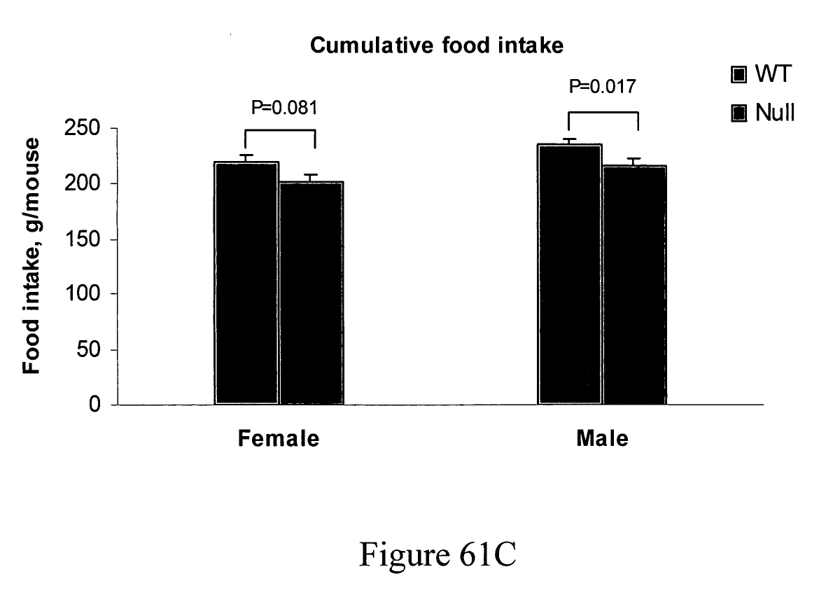

Examination of both daily and cumulative food intakes suggested that reduced food intake accounts for the body weight difference among mice being fed with high fat diet. FIGS. 61A and 61B illustrate that both male Mod1 and female Mod1 mice had lower daily food intake than the WT controls. FIG. 61C further illustrates that the cumulative food intake of the male nulls was 8.4% less than that of wild-type male mice (P=0.017), while female nulls ate 7.7% less that controls (P=0.081).

In conclusion, Mod1 null mutant mice were challenged with a high sucrose and a high fat diet for obesity susceptibility. On the high sucrose diet, male Mod1 null mice gained less weight and body fat than wild-type controls. More significantly, both male and female Mod1 null mice exhibited not only reduced weight gain, as predicted by the Causality analysis, but also reduced food intake on the high fat diet. These results strongly support the conclusions of the causality analysis and validate Mod1 as a novel obesity drug target.

### 6.3.2. Validating Zfp90, C3Ar1, and Tgfbr2 as Obesity Targets

Zinc finger protein 90 (Zfp90, SEQ ID: 10 for murine protein) was also identified in the causality study (Table 4 in Section 5). As illustrated in Table 6 in Section 5, Zfp90 and Mod1 are listed as two of the top ten gene-expression trait correlated with the supported as causal candidates for the OFPM trait.

### 6.3.2.1. Constructing the Zfp90 Knock-Out Mice

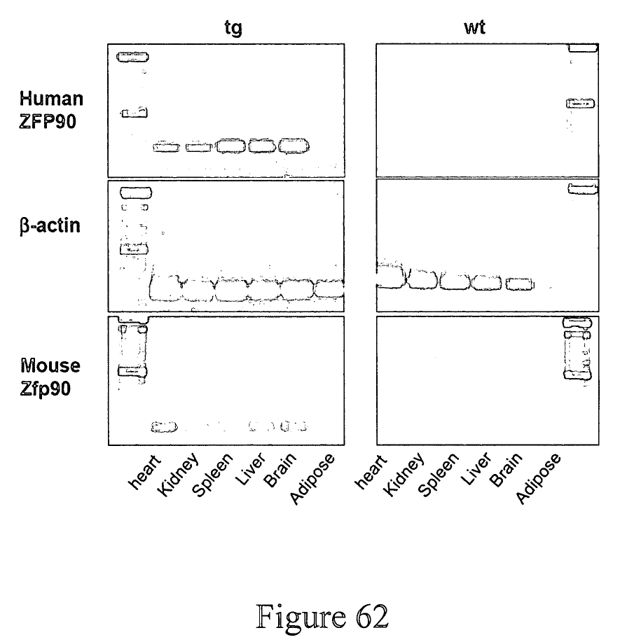

The BAC clone CTD-2339M9, which covers the human Zfp90 gene sequence with minimal overlaps with neighboring genes, was purchased from Invitrogen (Carlsbad, Calif.) and the sequence was confirmed using PCR primers specific to the two BAC ends and the Zfp90 gene sequence. The clone was cultured in LB medium containing 12.5 μg/ml chloramphenicol. BAC DNA was extracted and purified with a Large-Construct kit (QIAGEN, Valencia, Calif.) and subsequently quantified using pulse field electrophoresis (CHEF-DR™ II Electrophoresis System, BioRad, Hercules, Calif.) along with High DNA Mass Ladder (Invitrogen, Carlsbad, Calif.). The purified circular BAC DNA was injected into pronucleus of fertilized FVB eggs and surviving eggs were transferred to pseudo-pregnant FVB female mice at UCI Transgenic Mouse Facility (available through the University of California, Irvine). Zfp90 transgenic founders were identified from DNA isolated from tail biopsies by PCR using BAC-end-specific and gene-specific primers. The integration of the entire BAC sequence was confirmed in all founders. Using RT-PCR, human Zfp90 transcript was identified from total RNA samples isolated from various mouse tissues, including brain, heart, liver, kidney, and spleen, but not from the adipose tissue (FIG. 62).

Control FVB/NJ mice used for comparison to the Zfp90 transgenic were bred in house and at the Jackson Laboratory (Sacramento) from known homozygous parental breeders. All animals were housed four per cage at 25° C. on a 10-hour dark/14-hour light cycle and had ad libitum access to water and to regular rodent chow (e.g., Purina diet # 5015).

### 6.3.2.2. Constructing the C3Ar1 and Tgfbr2 Knock-Out Mice

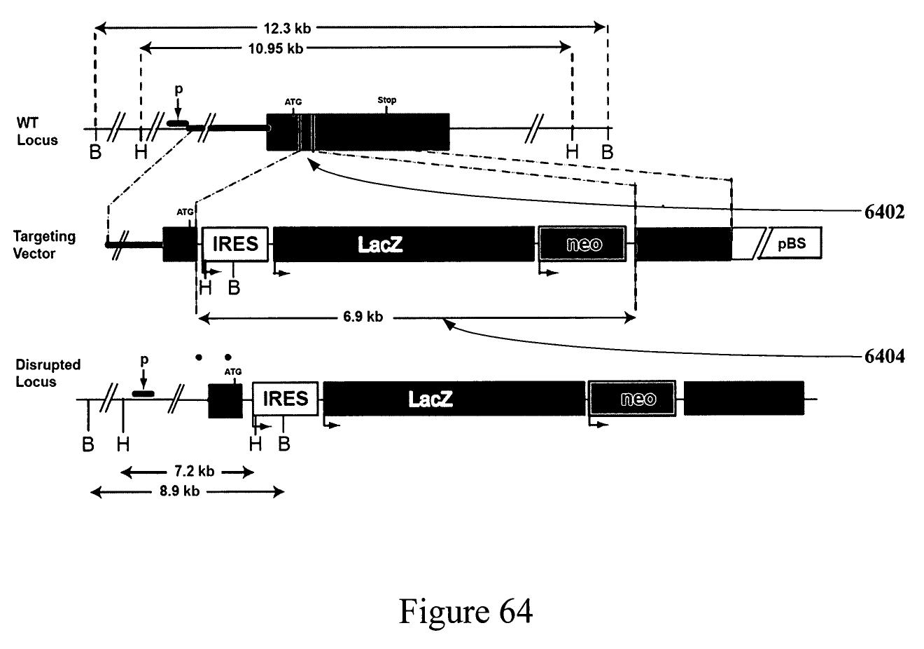

C3ar1 knock-out mice. Both C3ar1 and Tgfbr2 transgenic mice were commercially available. C3ar1−/− mice were obtained from Deltagen, Inc. (San Carlos, Calif.). A 6.93 kb IRESlacZ reporter and neomycin resistance cassette (IRES-lacZ-neo) was sub-cloned into a 5.0 kb fragment isolated from a mouse genomic phage library, such that 197 base pairs coding for the protein were replaced by IRES-LacZ-neo (FIG. 64).

FIG. 64 depicts the structure of wild-type and mutant C3ar1 loci. Thick solid lines denote genomic sequence contained within the targeting. construct. A 197 basepair region (6402 in FIG. 64) of the C3ar1 coding sequence was replaced by a 6.9 kb IRES-LacZ reporter and neomycin resistance cassette (IRES-LacZ-neo, 6404 in FIG. 64). B and H indicate restriction sites for BamHI and HindIII, respectively. Two overlapping oligonucleotide probes used to hybridize Southern blots are indicated by p. pBS denotes Bluescript vector sequence.

The IRES-lacZ-neo cassette was flanked by 3.4 kb of mouse genomic DNA at its 5′ aspect and 1.6 kb of mouse genomic DNA at its 3′ aspect. The targeting vector was linearized and electroporated into 129/OlaHsd mouse embryonic (ES) stem cells. ES cells were selected for G418 resistance, and colonies carrying the homologously integrated neo DNA were identified by PCR amplification using a 5′ neo-specific primer (5′-GGGATCTTGGCCATGGTAAGCTGAT-3′) paired with a primer located outside the targeting homology arms on the 5′ side (GS 1: 5′-CAGCATCAAAAGCTGCACAGCGAGG-3′). The homologous recombination event was confirmed on the 3′ side using a 3′ neo-specific primer (5′-ACGTACTCGGATGGAAGCCGGTCTT-3′) paired with a primer located outside the targeting homology arm on the 3′ side (GS2: 5′-GTGGCATTTGGCACTGTGTTCTGTC-3′).

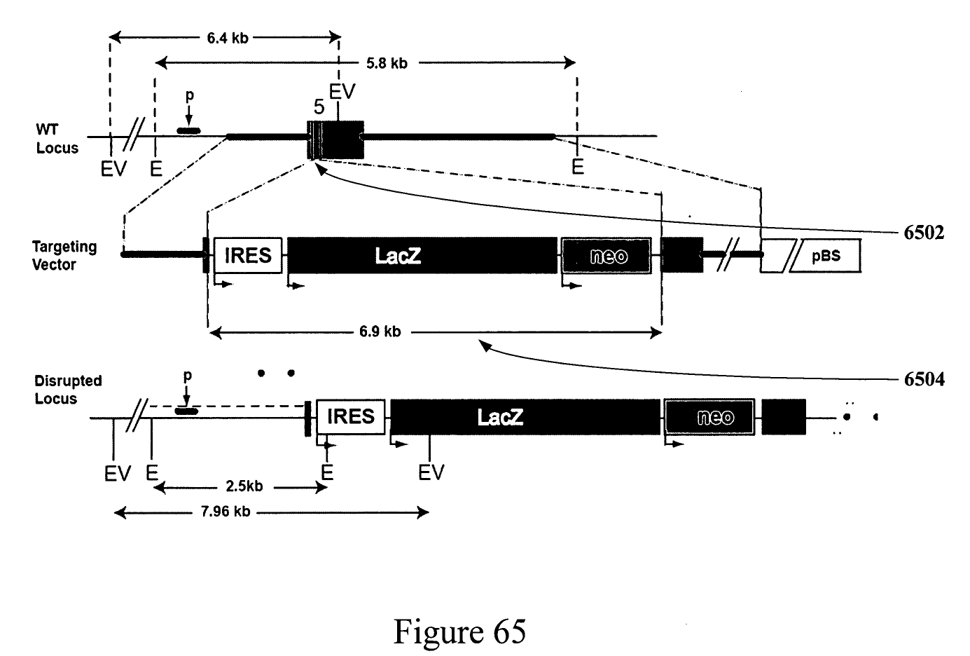

Tgfbr2 knock-out mice. Tgfbr2+/− mice were also obtained from Deltagen, Inc. (San Carlos, Calif.). A 6.93 kb IRES-lacZ reporter and neomycin resistance cassette (IRES-lacZ-neo) was sub-cloned into a 4.2 kb fragment isolated from a mouse genomic phage library, such that 106 base pairs coding for the protein were replaced by IRES-LacZ-neo (FIG. 65).

FIG. 65 illustrates the structure of wild-type and mutant Tgfbr2 loci. Thick solid lines denote genomic sequence contained within the targeting construct. A 106 basepair region (6502 in FIG. 65) of the Tgfbr2 coding sequence was replaced by a 6.9 kb IRES-LacZ reporter and neomycin resistance cassette (IRES-LacZ-neo, 6504 in FIG. 65). The numbers designate the exons. E and EV indicate restriction sites for EcoRI and EcoRV, respectively. Two overlapping oligonucleotide probes used to hybridize Southern blots are indicated by “P.” pBS denotes the Bluescript vector sequence.

The IRES-lacZ-neo cassette was flanked by 1.2 kb of mouse genomic DNA at its 5′ end and 3.0 kb of mouse genomic DNA at its 3′ end. The targeting vector was linearized and electroporated into 129/OlaHsd mouse embryonic (ES) stem cells. ES cells were selected for G418 resistance, and colonies carrying the homologously integrated neo DNA were identified by PCR amplification using a 5′ neo-specific primer (5′-GGGATCTTGGCCATGGTAAGCTGAT-3′) paired with a primer located outside the targeting homology arms on the 5′ side (GS 1: 5′-GCACAACCTGATCATACTGTATCCA-3′). The homologous recombination event was confirmed on the 3′ side using a 3′ neo-specific primer (5′-ACGTACTCGGATGGAAGCCGGTCTT-3′) paired with a primer located outside the targeting homology arm on the 3′ side. (GS2: 5′-TACCTCATGGCCCATATGACATAAT-3′).

Confirmation of mutation. For both C3ar1−/− and Tgfbr2+/− mice, colonies that gave rise to the correct size PCR product were confirmed by Southern blot analysis using a probe adjacent to the 5′ region of homology. The presence of a single neo cassette was confirmed by Southern blot analysis using a neo gene fragment as a probe. Male chimeric mice were generated by injection of the targeted ES cells into C57Bl/6J blastocysts. Chimeric mice were bred with C57Bl/6J mice to produce F1 heterozygotes. Germline transmission was confirmed by PCR analysis. Initial germline heterozygotes were also tested for the homologous recombination event using the primers described above (located outside of the targeting construct) (See Supplementary FIGS. 3 and 4 from Schadt et al., 2005, Nature Genetics 37:710, which is hereby incorporated by reference herein in its entirety). Following confirmation of the targeting event in animals, subsequent genotyping tracked transmission of the targeting construct (See Supplementary FIGS. 3 and 4 from Schadt et al., 2005, Nature Genetics 37:710, which is hereby incorporated by reference herein in its entirety). F 1 heterozygous males and females were mated to produce F2 wild-type, heterozygous and homozygous null mutant animals. Viable embryos for Tgfbr2−/− mice were identified, but none survived to birth, so that homozygous knockouts for this gene were determined to be lethal. Mice were backcrossed with C57BL/6J mice and all phenotypic analysis was performed in a hybrid C57Bl/6J/129 background (75%/25%, respectively).

### 6.3.2.3. Analyzing the Functional Importance of Zfp90, C3Ar1, and Tgfbr2

Zfp90. As depicted in FIG. 62, the expression of the human ZFP90 transgene and the murine Zfp90 gene were examined in six mouse tissues. The human ZFP90 transgene (SEQ ID No: 33) in transgenic animals and the Zfp90 mouse gene (SEQ ID No: 9) in the wildtype and transgenic mice were seen to be expressed in liver where the association to fat mass was seen in the BxD data set described in the main text.

Construction of Zfp90 transgenic mice resulted in two males and one female transgenic with respect to the human ZFP90 gene. After 20 weeks of breeding the transgenic mice to wild-type mice, no litters were produced. The failure of these mice to breed could be related to the fact that this gene product is predicted to be involved in spermatogenesis (Lange et al., 1995, DNA Cell Biol 14:971, which is hereby incorporated by reference herein in its entirety).

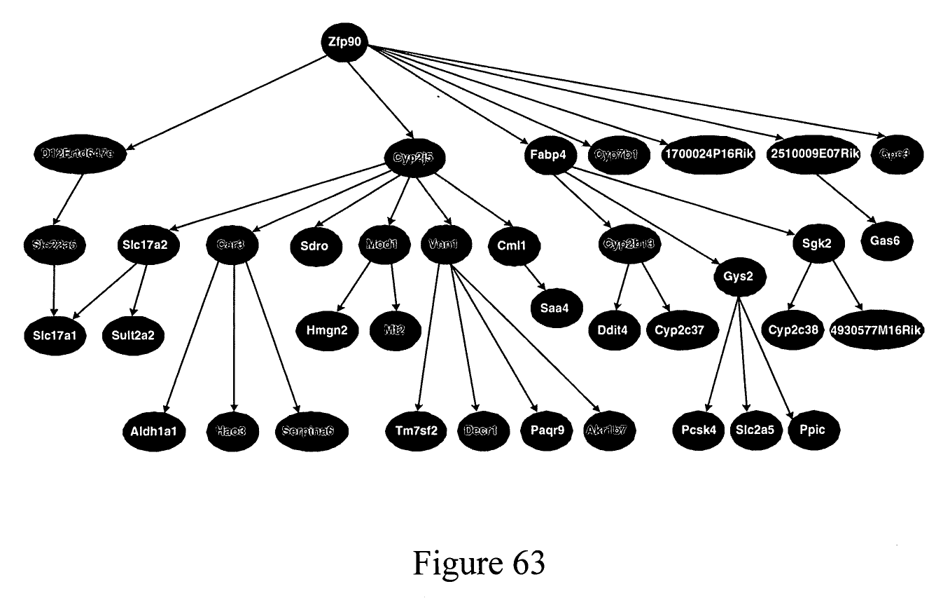

Quantitative nuclear magnetic resonance measurements were taken on the three Zfp90 transgenic mice at 32 weeks of age. Their fat mass to lean mass ratios were nearly three times higher than those of 22-week-old control mice that had been on a high-fat diet for 14 weeks and were nearly 1.7 times higher than those of age-matched control mice (see Table 8, below). These preliminary data suggest that Zfp90 may have an uncharacterized role in the regulation of obesity traits. To identify genes that are closely related to Zfp90, we examined the previously described genetic network constructed from the BxD liver expression data 13. Zfp90 is a central node in this liver transcriptional network (FIG. 63). Zfp90 falls upstream of several key genes predicted to be causally associated with the OFPM trait, including Mod1, Hao3, Vnn1 and Car3 (Also see Table 5 in Section 5).

FIG. 63 illustrates a genetic subnetwork for liver expression in the BxD cross as previously described (Zhu et al., 2004, Cytogenet. Genome Res. 105:363, which is hereby incorporated by reference herein in its entirety). The result from the subnetwork construction represents a very significant enrichment for obesity-related genes in this independently derived liver-specific genetic network driven by Zfp90.

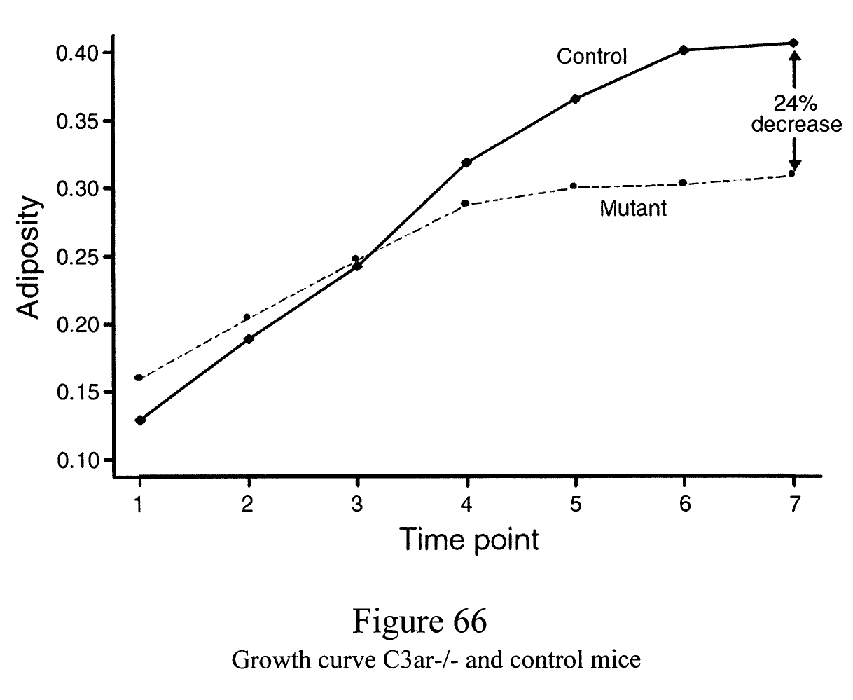

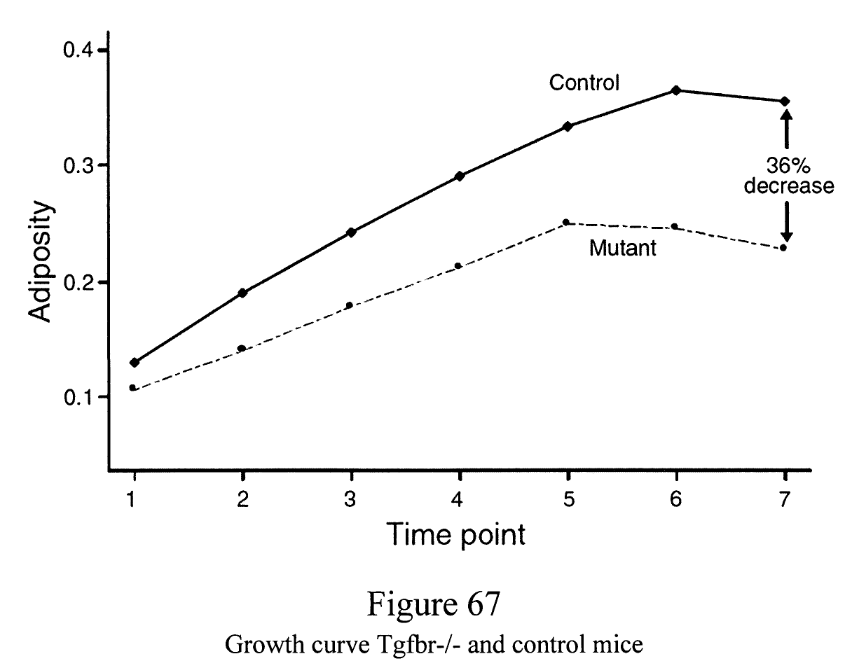

C3ar1 and Tgfbr2. The weight, fat mass and lean mass for male homozygous C3ar1−/− (n=5-7 where n was the number of mice used in the study), heterozygous Tgfbr2+/− (n=5-7 where no was the number of mice used in the study; Tgfbr2−/− mice died) and wild-type littermate control (n=5-10 where n was the number of mice used in the study) mice were recorded every 2 weeks starting at 10 weeks of age for 12 weeks using quantitative nuclear magnetic resonance. The growth curves for C3ar1−/− and Tgfbr2+/− mice were significantly different from those of controls (FIGS. 66 and 67), and at each subsequent time point, the difference in fat mass increased.

FIG. 66 illustrates the growth curves for C3ar1−/− mice and control mice over seven time points. FIG. 67 illustrates the growth curves for Tgfbr2+/− mice and control mice over seven time points. Growth is depicted as adiposity (fat mass to lean mass ratio). At the final quantitative nuclear magnetic resonance measurement on 22-week-old mice, the mean fat mass to lean mass ratios were significantly different in C3ar1 and Tgfbr2 knockout mice versus their respective wild-type controls (Table 8), validating the predictions made from the BxD crosses.

TABLE 8
Mean fat mass to lean mass ratios for Zfp90 transgenic,
C3ar1−/−, and Tgfbr2+/− mice

| | | Fat mass | Fat mass to | | |
|---|---|---|---|---|---|
| | | to lean | lean mass | | |
| | Mutant | mass ratio | ratio in | Fat mass | Mutant |
| | number | in mutants | controls | difference | versus |
| Mouse | (control | (mean ± | (mean ± | P- | control |
| Model | number) | s.d.) | s.d.) | value | P-value |
| Zfp90 | 3 (12) | 0.45 ± 0.05 | 0.15 ± 0.06 | NA | 6.5E[−7] |
| transgenic | | | | | |
| versus | | | | | |
| high | | | | | |
| fat control | | | | | |
| Zfp90 | 3 (8) | 0.45 ± 0.05 | 0.27 ± 0.07 | NA | 0.0021 |
| transgenic | | | | | |
| versus | | | | | |
| chow | | | | | |
| control | | | | | |
| C3ar1−/− | 5 (7) | 0.31 ± 0.11 | 0.41 ± 0.10 | 0.0026 | NA |
| Tgfbr2+/− | 7 (7) | 0.23 ± 0.09 | 0.36 ± 0.10 | 1.3E[−6] | NA |

Tgfbr2 is active in the TGF-β signaling pathway, which regulates cell proliferation and differentiation and extracellular matrix production. Although no direct evidence for the involvement of Tgfbr2 in obesity was previously established, elevated expression of TGF-β and TGF-β polymorphisms were associated with body mass index, obesity, (including abdominal obesity) and type 2 diabetes (see Alessi et al., 2000, Diabetes 49:1374; Romano et al., 2003, J. Clin. Endocrinol. Metab. 88:5321; Rosmond et al., 2003, Horm. Res. 59:191; and Samad et al., 1997, Proc. Natl. Acad. Sci. U.S.A. 94:14349, each of which is hereby incorporated herein by reference in its entirety). Therefore, the association between TGF-β and obesity suggests that Tgfbr2 may have a role in obesity development through the TGF-β signaling pathway. C3ar1 is active during complement activation, and C3ar1 knockout mice are protected against airway hyper-responsiveness in response to challenge with an antigen. Similarly, although there is no direct evidence supporting the role of C3ar1 in obesity, indirect evidence from its ligand C3a suggests a link between C3ar1 and obesity-related traits. For example, injecting C3a in the hypothalamic region of rats increased their food and water intake in response to catecholamine stimulation (see Schupf et al., 1983, J. Neuroimmunol. 5:305, which is hereby incorporated herein by reference in its entirety). In addition, increased levels of C3a are correlated with obesity, cholesterol, lipid levels and familial combined hyperlipidemia (see Choy and Spiegelman, 1996, Obes. Res. 4:521; Pomeroy et al., 1997, Clin. Exp. Immunol. 108:507; and Ylitalo et al., 1997, Atherosclerosis 129:271, which is hereby incorporated by reference in its entirety).

### 6.3.3. Conclusions

A naturally occurring null mice strain (Mod1) and three transgenic mice strains, Zfp90, C3ar1−/−, and Tgfbr2(+/1), experimentally validated the involvement of these genes in susceptibility to obesity.

### 7. REFERENCES CITED

All references cited herein are incorporated herein by reference in their entirety and for all purposes to the same extent as if each individual publication or patent or patent application was specifically and individually indicated to be incorporated by reference in its entirety for all purposes.

The present invention can be implemented as a computer program product that comprises a computer program mechanism embedded in a computer readable storage medium. For instance, the computer program product could contain the program modules shown in FIG. 1. These program modules may be stored on a CD-ROM, magnetic disk storage product, or any other computer readable data or program storage product. The software modules in the computer program product can also be distributed electronically, via the Internet or otherwise, by transmission of a computer data signal (in which the software modules are embedded) on a carrier wave.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

What is claimed is:

1. A method for determining whether a candidate molecule affects a body weight disorder associated with an organism, comprising:
(a) contacting a cell from said organism with, or recombinantly expressing within the cell from said organism, said candidate molecule;
(b) determining whether the RNA expression or protein expression in said cell of at least one open reading frame is changed in step (a) relative to the expression of said open reading frame in the absence of the candidate molecule, each said open reading frame being regulated by a promoter native to a nucleic acid sequence selected from the group consisting of SEQ ID NO: 5, SEQ ID NO: 6, SEQ ID NO: 7, SEQ ID NO: 8, SEQ ID NO: 9, SEQ ID NO: 11, SEQ ID NO: 12, SEQ ID NO: 14, SEQ ID NO: 16, SEQ ID NO: 18, SEQ ID NO: 20, SEQ ID NO: 21, SEQ ID NO: 23 and homologs of each of the foregoing; and
(c) determining that the candidate molecule affects a body weight disorder associated with said organism when the RNA expression or protein expression of said at least one open reading frame is changed, or determining that the candidate molecule does not affect a body weight disorder associated with said organism when the RNA expression or protein expression of said at least one open reading frame is unchanged.

2. The method of claim 1 wherein a cell from said organism contacted with the candidate molecule exhibits a lower expression level of a protein sequence selected from the group consisting of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, and homologs of each of the forgoing, than a cell from said organism that is not contacted with said candidate molecule.

3. The method of claim 1, wherein step (b) comprises determining whether RNA expression is changed.

4. The method of claim 1, wherein step (b) comprises determining whether protein expression is changed.

5. The method of claim 1, wherein step (b) comprises determining whether RNA or protein expression of at least two of said open reading frames is changed.

6. The method of claim 1, wherein step (a) comprises contacting the cell with the candidate molecule, and wherein step (a) is carried out in a liquid high throughput-like assay.

7. The method of claim 1, wherein the cell comprises a promoter region of at least one gene selected from the group consisting of SEQ ID NO: 5, SEQ ID NO: 6, SEQ ID NO: 7, SEQ ID NO: 8, SEQ ID NO: 9, SEQ ID NO: 11, SEQ ID NO: 12, SEQ ID NO: 14, SEQ ID NO: 16, SEQ ID NO: 18, SEQ ID NO: 20, SEQ ID NO: 21, SEQ ID NO: 23, and homologs of each of the foregoing, each promoter region being operably linked to a marker gene; and wherein step (b) comprises determining whether the RNA expression or protein expression of the marker gene(s) is changed in step (a) relative to the expression of said marker gene in the absence of the candidate molecule.

8. The method of claim 1, wherein the marker gene is selected from the group consisting of green fluorescent protein, red fluorescent protein, blue fluorescent protein, luciferase, LEU2, LYS2, ADE2, TRP1, CAN1, CYH2, GUS, CUP1 and chloramphenicol acetyl transferase.

9. The method of claim 1, wherein said body weight disorder is obesity, anorexia nervosa, bulimia nervosa or cachexia.

10. The method of claim 1, wherein each said open reading frame is regulated by a promoter native to SEQ ID NO: 7.

11. A method of treating or preventing a body weight disorder comprising administering to a subject in which treatment is desired a therapeutically effective amount of a compound that antagonizes in the subject a protein comprising a sequence selected from the group consisting of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24 and homologs of each of the foregoing.

12. The method of claim 11, wherein said subject is human.

13. The method of claim 11, in which the compound:
(i) inhibits a function of one or more of the group consisting of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, and homologs of each of the foregoing, and
(ii) is selected from the group consisting of:
an antibody that binds to one of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, and homologs of each of the foregoing or a fragment or derivative therefore containing the binding region thereof, or is selected from the group consisting of:
a nucleic acid complementary to the RNA produced by transcription of a gene encoding one of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, and homologs of each of the foregoing.

14. The method of claim 13 in which the compound that inhibits a function of one or more of the group consisting of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, and homologs of each of the foregoing, is an oligonucleotide that:
(a) consists of at least six nucleotides;
(b) comprises a sequence complementary to at least a portion of an RNA transcript of a gene encoding one of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, and homologs of each of the foregoing; and
(c) is hybridizable to the RNA transcript under moderately stringent conditions.

15. The method of claim 11, wherein the protein comprises SEQ ID NO: 1.

16. A method of treating or preventing a body weight disorder comprising administering to a subject in which treatment is desired a therapeutically effective amount of a compound that enhances a function of one or more of the group consisting of SEQ ID NO: 1, SEQ ID NO: 2, SEQ ID NO: 3, SEQ ID NO: 4, SEQ ID NO: 10, SEQ ID NO: 13, SEQ ID NO: 15, SEQ ID NO: 17, SEQ ID NO: 19, SEQ ID NO: 22, SEQ ID NO: 24, and homologs of each of the foregoing.

17. The method of claim 16, wherein said subject is human.

18. The method of claim 16, wherein the therapeutically effective amount of the compound enhances a function of SEQ ID NO: 1.

19. A method of diagnosing a disease or disorder or the predisposition to said disease or disorder, wherein the disease or disorder is characterized by an aberrant level of one of SEQ ID NO: 1 through SEQ ID NO: 24, or a homolog thereof, in a subject, the method comprising measuring the level of any one of SEQ ID NO: 1 through SEQ ID NO: 24, or a homolog thereof, in a sample derived from the subject, in which an increase or decrease in the level of one of SEQ ID NO: 1 through SEQ ID NO: 24, or a homolog thereof, in said sample, relative to the level of a corresponding one of said SEQ ID NO: 1 through SEQ ID NO: 24, or a homolog thereof, found in an analogous sample not having the disease or disorder, indicates the presence of the disease or disorder in the subject.

20. The method of claim 19, wherein the disease or disorder is a body weight disorder.

21. The method of claim 19, wherein the disease or disorder is obesity, anorexia nervosa, bulimia nervosa, or cachexia.

22. The method of claim 19, wherein the disease or disorder is characterized by an aberrant level of SEQ ID NO: 1, or a homolog thereof, in a subject.

23. A method of diagnosing or screening for the presence of or predisposition for developing a disease or disorder involving a body weight disorder in a subject comprising detecting one or more mutations in at least one of SEQ ID NO: 1 through SEQ ID NO: 24, or a homolog thereof, in a sample derived from the subject, in which the presence of said one or more mutations indicates the presence of the disease or disorder or a predisposition for developing said disease or disorder.
